(19) United States
(12) Patent Application Publication
(10) Pub. No.: US 2008/0290987 A1
(43) Pub. Date: Nov. 27, 2008

(54) METHODS AND APPARATUS RELATED TO CONTENT SHARING BETWEEN DEVICES

(76) Inventor: Lehmann Li, Studio City, CA (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 12/107,649

(22) Filed: Apr. 22, 2008

Related U.S. Application Data
(60) Provisional application No. 60/913,295, filed on Apr. 22, 2007.

(51) Int. Cl. G08C 15/00; G10L 11/00

(52) U.S. Cl. 340/5.1; 704/270; 704/E11.001

(57) ABSTRACT

In one embodiment, a method includes receiving a signal from a communication device via a communication channel. The method also includes determining, based on the signal, a parameter value used for identification of a product of interest. A duration of the receiving is modified when a threshold condition is unsatisfied based on a probability value calculated based on the parameter value. The probability value is associated with identification of the product of interest.

### CROSS REFERENCE TO RELATED APPLICATION

The present application claims benefit of U.S. Provisional Patent Application No. 60/913,295, entitled “Systems, Methods, Apparatuses, and Computer Program Products for Enabling Any Device to Interact with Content Displayed on Another Device and Exchange Data with One or More Other Devices,” filed on Apr. 22, 2007.

### BACKGROUND

The Internet has enabled advertisers to pay a media operator, e.g., a search engine, only when the advertisement performs or generates a lead, e.g., when a search engine user clicks-through the advertisement. When an user clicks-through the advertisement, the Internet media operator typically charges the advertiser a cost based on a cost-per-click (CPC). In general, Internet advertisers have preferred paying for advertisements on the basis of CPC, rather than cost-per-thousand (CPM) impressions, the traditional means of charging advertisers for advertisements displayed in traditional media like television, radio, and print.

When an user clicks-through an Internet advertisement, the media operator performs a variety of functions, including, but not limited to: recording the user click-through; associating with the hyperlink selected by the user some code identifying the media operator; and billing the advertiser for the click-through.

Just as an advertiser can pay an Internet media operator only when the Internet advertisement performs or generates a lead, an advertiser can value paying an operator in other media only when the advertisement displayed in that media performs or generates a lead. In general, an advertiser currently pays for an advertisement displayed in traditional media like television, radio, and print on the basis of CPM. An advertiser can value paying a television, radio, or print operator on the basis of CPC or even cost-per-sale (CPS).

For example, cable television operators have tried to enable interactive television through: (1) the viewer responding to a television advertisement by using the remote control device to select some action; (2) the remote control device transmitting a signal to a set-top box; (3) the set-top box relaying the signal to a headend server; and (4) the headend server relaying the signal to an advertiser through either a proprietary network or an open network, e.g., the Internet.

There are at least four disadvantages of trying to enable interactive television through a remote control device, a set-top box, and the cable television return channel. First, the remote control device has historically been a complex device not easy for consumers to use. In contrast, many consumers, especially younger consumers, find a wireless device easy to use. Second, interactive television requires a digital set-top box. However, it has taken and will continue to take a long time for cable television operators to upgrade all or a selected portion of set-top boxes to enable interactive television. In contrast, consumers typically replace their mobile phones frequently. Third, while a cable television operator can identify the unique characteristics of any given television household, it cannot determine which particular individual in any given television household is definitively viewing a television program. In contrast, a wireless operator can identify the wireless device transmitting any message and infer that the subscriber of the wireless device transmitted the message. Fourth, while a cable television operator can enable a viewer to respond to a television advertisement where the response involves communicating with a web server or a call center, a cable television operator cannot enable a viewer to respond to a television advertisement where the response requires communicating with any other device, e.g., a personal computer or a Point-of-Sale (POS) device. In contrast, a wireless device utilizing one or more input/output (I/O) devices can record if an user responds to an advertisement displayed on any other media device and exchanges data with any other device which can support the I/O device.

In addition, there are existing methods of utilizing another device to identify if a media device, e.g., a television or radio, displays an advertisement. However, these methods cannot identify if the user of the other device takes some action to respond to the advertisement, especially if the user responds after the termination of the display of the advertisement.

### SUMMARY

In one embodiment, a method includes receiving a signal from a communication device via a communication channel. The method also includes determining, based on the signal, a parameter value used for identification of a product of interest. A duration of the receiving is modified when a threshold condition is unsatisfied based on a probability value calculated based on the parameter value. The probability value is associated with identification of the product of interest.

### BRIEF DESCRIPTION OF THE DRAWINGS

FIG. 1 depicts a block diagram of an exemplary data processing unit that can be used to implement the entities described herein.

FIG. 2A illustrates a schematic block diagram of an exemplary system enabling any media device to interact with content displayed on another media device.

FIG. 2B depicts a high-level block diagram of an exemplary system enabling any media device, e.g., a wireless device, to interact with content displayed on another media device and purchase or facilitate the purchase of a product promoted on another media device without exchanging data with the other media device.

FIG. 3 depicts a block diagram of an exemplary wireless device.

FIG. 4 depicts an exemplary ad metadata file.

FIG. 5 depicts an exemplary program metadata file.

FIG. 6 depicts an exemplary broadcast spot schedule.

FIGS. 7A, 7B, 7C, 7D, 7E, and 7F depict a flowchart of an exemplary method for enabling any media device, e.g., a wireless device, to interact with content displayed on another media device and purchase or facilitate the purchase of a product promoted on another media device without exchanging data with the other media device.

FIG. 8 depicts a block diagram of an exemplary system enabling: (a) wireless device to connect to a metadata server to obtain more information about the product of interest or buy the product of interest; (b) the system to identify the advertiser and/or media buyer to bill for the wireless device click-through enabled by metadata server and any entities to credit for enabling the wireless device click-through; and/or (c) bill and/or credit the appropriate entities.

FIG. 9 depicts a high-level block diagram of an exemplary system enabling any media device, e.g., a wireless device, to interact with content displayed on another media device and purchase or facilitate the purchase of a product promoted on the other media device by exchanging data with the other media device.

FIG. 10 depicts a flowchart of an exemplary method for enabling any media device, e.g., a wireless device, to interact with content displayed on another media device and purchase or facilitate the purchase of a product promoted on the other media device by exchanging data with the other media device.

FIG. 13 depicts an exemplary data structure associating any given channel with a media operator.

FIG. 14 depicts an exemplary data structure associating any given fingerprint with a media operator.

FIG. 15 depicts an exemplary data structure associating any given media operator with an advertisement and/or programming.

FIG. 16 depicts an exemplary data structure associating an ad metadata file and/or program metadata file with an advertisement and/or programming.

FIG. 17 depicts a block diagram of an exemplary system enabling the identification of an advertisement displayed on a media device by utilizing a fingerprinting system.

FIG. 18 depicts a flowchart of an exemplary method enabling the identification of an advertisement displayed on a media device by utilizing a fingerprinting system.

FIG. 19 depicts a block diagram of an exemplary system enabling the identification of an advertisement displayed on a media device through a wireless device receiving data from the media device.

FIG. 20 depicts a flowchart of an exemplary method enabling the identification of an advertisement displayed on a media device through a wireless device receiving data from the media device.

FIG. 21A depicts a block diagram of an exemplary system enabling a wireless device to call automatically a variety of functions upon the detection of a signal from another media device.

FIG. 21B depicts a block diagram of an exemplary system enabling a wireless device to call automatically a variety of functions upon reception and processing of a signal from another media device.

FIG. 22 depicts a flowchart of an exemplary method enabling a wireless device to call automatically a variety of functions upon reception of a signal from another media device.

FIG. 23 depicts a block diagram of an exemplary system enabling a wireless device to identify a media operator by processing an infrared signal.

FIG. 24 depicts a flowchart of an exemplary method enabling a wireless device to identify a media operator by processing an infrared signal.

FIG. 25 depicts a block diagram of an exemplary system enabling a wireless device to transmit a request and a server to process the request

FIG. 26 depicts a flowchart of an exemplary method enabling a wireless device to transmit a request and a server to process the request.

FIG. 27 depicts a block diagram of an exemplary system enabling a wireless device to transmit a request over a voice channel and a server to process the request.

FIG. 28 depicts a flowchart of an exemplary method enabling a wireless device to transmit a request over a voice channel and a server to process the request.

FIG. 29 depicts an exemplary chart showing how different combinations of one type of user generated identification data and one type of wireless device generated identification data can increase the probability of correctly identifying the Advertisement of interest.

FIG. 30 depicts a flowchart of an exemplary method enabling the implementation of an algorithm which can find combinations of user generated identification data, wireless device generated identification data, and/or network identification data which meet certain objectives.

FIG. 32 depicts exemplary cases of the system identifying different advertisements.

FIG. 33 depicts a diagram of an exemplary system of data and/or data structures enabling the identification of an Advertisement displayed on a Media Device.

FIG. 34 depicts a flowchart of an exemplary method enabling the identification of an advertisement displayed on a media device.

FIG. 35 depicts an exemplary distribution of the probability of a wireless device user response over a time period during and some period after the display of the advertisement of interest.

FIG. 36 depicts a flowchart of an exemplary method enabling the adjustment of weights.

FIG. 37 depicts a flowchart of an exemplary method enabling the identification of an advertisement displayed on a media device.

FIG. 38 depicts a flowchart of an exemplary method enabling the identification of an advertisement displayed on a media device.

FIG. 39 depicts a diagram of an exemplary system of data elements enabling the transmission of data in response to an user request independent of an advertisement and/or programming.

FIG. 40 depicts a flowchart of an exemplary method utilizing data elements enabling the transmission of data in response to an user request independent of an advertisement and/or programming.

FIG. 41A depicts a diagram of an exemplary Bayesian network outlining the relationships among the observable variables and non-observable variables.

FIG. 41B depicts a table specifying an exemplary set of conditional probabilities that wireless device transmitted an user request given certain instances of the observable variables.

FIG. 42 depicts a flowchart of an exemplary method utilizing Bayesian inference to identify the most likely even stimulating a wireless device user to transmit an user request specifying the product of interest.

FIG. 43 depicts a set of exemplary sequences of television channels which can precede the media operator displaying an advertisement and/or programming at the time a wireless device user initiates an user initiating input.

FIG. 44 depicts a set of functions enabling a wireless device user utilizing a typical remote control device to change from one media operator to another media operator.

FIG. 45 depicts a set of exemplary sequences of television media operators selected utilizing the next channel key.

FIG. 46 depicts a flowchart of an exemplary method of retrieving data describing the media operator sequence_{<UII} directly from a media device.

FIG. 47 depicts an exemplary architecture of a hidden Markov model for identifying the actual or most likely media operator sequences_{<UII}.

FIG. 48 depicts an exemplary set of potential media operator sequences_{<UII} which can originate at one or more initial states and terminates at the observed state.

FIG. 49 depicts a flowchart of an exemplary method of identifying the most likely media operator sequence_{<UII} given the sequence of observed signal samples utilizing a Viterbi algorithm.

FIG. 53 is a schematic block diagram related to keywork identification.

FIG. 54 is a schematic block related to keywork identification.

FIG. 65 depicts a block diagram of an exemplary system: (a) enabling an advertiser to verify that any given advertisement is directly related to a purchase in a physical retailer; and (b) billing the advertiser and crediting any entity enabling the transaction.

FIG. 66 depicts a flowchart of an exemplary method for (a) enabling an advertiser to verify that any given advertisement is directly related to a purchase in a physical retailer; and (b) billing the advertiser and crediting any entity enabling the transaction.

### DETAILED DESCRIPTION

A media device can be configured to interact with content displayed on another media device and purchase or facilitate the purchase of a product promoted on another media device.

A media device (e.g., a wireless device) can be configured to: (1) transmit through a wireless network a request for or receive from a wireless network or another media device data about the content displayed on the other media device (e.g., Other Device Metadata); (2) display on the wireless device screen the Other Device Metadata; (3) accept an input by the wireless device user selecting an action (e.g., Wireless Device User Input); (4) incorporate other data in the wireless device and/or other devices with the Wireless Device User Input; and/or (5) either: (a) transmit to a server through a wireless network the Wireless Device User Input, in the case of a wireless device communicating with a server over the Internet and/or the public switched telephone network (PSTN); or (b) store some or all of the Other Device Metadata in the wireless device for subsequent transmission to any device at a physical retailer, e.g., a POS device.

A wireless network can be enabled to: (1) receive from a server data about any advertisement, programming, and/or product promoted in the advertisement and/or programming for population of one or more databases; (2) receive from any media device, e.g., a wireless device, a request for Other Device Metadata; (3) query one or more databases containing data, including, but not limited to: (a) the media network associated with the channel number received from a wireless device; (b) the advertisement and/or programming associated with the media network; and/or (c) a file containing data describing: (i) the advertisement and/or programming displayed on the media device; and/or (ii) the product promoted in the advertisement and/or programming displayed on the media device (collectively can be referred to as a Ad Metadata File or a Program Metadata File); (4) transmit to a wireless device the Ad Metadata File and/or Program Metadata File associated with the channel number or media network identified by the wireless device; (5) receive from the wireless device the Wireless Device User Input; (6) read in Wireless Device User Input certain data enabling the wireless network to perform a variety of functions, including, but not limited to: (a) billing a party for enabling the wireless device to communicate with a server over the Internet and/or PSTN; (b) billing a party for enabling the wireless device to transmit to a physical retailer any Other Device Metadata; (c) reading any data located in one or more devices in the wireless network related to the wireless device user; and/or (d) processing the Wireless Device User Input and other data to generate data analyzing the value of any given Wireless Device User Input; and/or (7) collect from one or more wireless devices the number of times the wireless device transmits a Wireless Device User Input.

The identification can be enabled if the user of a device responds to an advertisement displayed on another media device, especially if the user responds after the termination of the display of the advertisement. In some embodiments, (1) the identification while helping reduce the amount and/or type of data a user must input into a wireless device; (2) the utilization of a variety of data to increase the accuracy of identifying the advertisement stimulating an user response; (3) a wireless device to obtain information about or buy a product promoted in an advertisement displayed on another media device more easily and faster than existing methods.

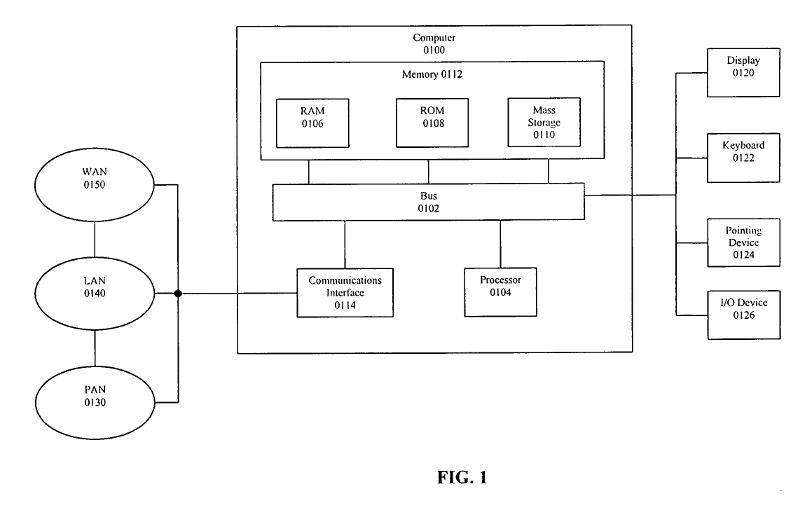

FIG. 1 depicts a block diagram of an exemplary Data Processing System 0100 that can be used to implement the entities described herein. Any number of data processing systems can be used to implement the entities described herein, and the configuration actually used can depend on the specific implementation.

Data Processing System 0100 can represent any type of device which can process data, including, but not limited to: a personal computer, a set-top box (STB), a portable computer, a hand-held computer, a personal digital assistant, a portable media device, a wireless device, a smart card, a server, a workstation, and/or a mainframe computer. The type of data processing system used to implement the entities described herein can depend on the specific implementation.

One or more of these devices can be configured to communicate with each other utilizing any protocol over any network, including, but not limited to: HyperText Transport Protocol (HTTP), file transport protocol (FTP), simple mail transport protocol (SMTP), post office protocol (POP), and/or Internet mail access protocol (IMAP) over a network, e.g., the Internet.

Data Processing System 0100 can include one or more components, including, but not limited to: any communications medium, wired and/or wireless (e.g., a Bus 0102), or any other means of transmitting and/or receiving data among components; a general- or special-purpose Processor 0104 or any other means of processing data; a random access memory (RAM) Device 0106 coupled to Bus 0102 capable of storing data and instructions executed by Processor 0104 or temporary variables or other intermediate data during the execution of instructions by Processor 0104; a read-only memory (ROM) Device 0108 coupled to Bus 0102 capable of storing data and instructions executed by Processor 0104; a Mass Storage Device 0110 (which can be a non-removable device, e.g., a hard disk drive, or a removable device, e.g., a floppy disk drive, a compact disc drive, a tape drive, a magneto-optical disc drive, or a chip, e.g., a chip as part of a subscriber identity module (SIM) card) coupled to Bus 0002 or Data Processing System 0100 capable of storing data and instructions executed by Processor 0104; a Display Device 0120 coupled to Bus 0102 or Data Processing System 0100 capable of displaying data to a computer user; a Keyboard or Keypad Device 0122 coupled to Bus 0102 or Data Processing System 0100 capable of communicating data and/or enabling command selection to Processor 0104; a Pointing Device 0124 coupled to Bus 0102 or Data Processing System 0100 capable of communicating direction information and/or enabling command selection to Processor 0104; an I/O Device 0126 (which can enable any other type of input and/or output) coupled to Bus 0102 or Data Processing System 0100 capable of communicating direction information and/or enabling command selection to Processor 0104; and/or a Communications Interface 0114 coupled to Bus 0102 or Computer System 0100 capable of transmitting data to and/or receiving data from other Data Processing Systems through any type of network, including, but not limited to, a personal area network (PAN) 0130, a local area network (LAN) 0140, a metropolitan area network (MAN) (not pictured), and/or a wide area network (WAN) 0150, e.g., the Internet. Processor 0104 can reside at a single physical location or be distributed across a multiple physical locations, e.g., on one client and one server. Memory 0112 can include any device coupled to Bus 0102 capable of storing data and/or instructions executed by Processor 0104, including, but not limited to: RAM Device 0106, ROM Device 0108, Mass Storage Device 0110, a data cache, a data object, and/or any other type of short-term or long-term storage device. Memory 0112 can reside at a single physical location or can be distributed across multiple physical locations.

The instructions can include code from a computer-programming language and/or a script, including, but not limited to: C, C++, Basic, Java, JavaScript, Pascal, Perl, Smalltalk, Structured Query Language (SQL), VBScript, and/or Visual Basic. Communications Interface 0014 can include a modem, a network interface card, and/or any other device capable of coupling Data Processing System 0100 to any PAN 0130, LAN 0140, and/or WAN 0150. Communications Interface 0114 can include an antenna enabling wireless communication utilizing any wireless protocol with PAN 0130, LAN 0140 and/or WAN 0150. An Antenna can include any of the components to transmit and/or receive an electromagnetic signal, e.g., a radio signal. Such components can include not only a physical material capable of conducting such a signal, but also any component which can perform any function desirable to process such signal, including, but not limited to: modulation, demodulation, spreading, despreading, analog-to-digital conversion (ADC), digital-to-analog conversion (DAC), compression, decompression, upconversion, and/or downconversion. PAN 0130, LAN 0140 and/or WAN 0150 can enable communication through a wired, wireless, or combination of wired and wireless signals. Keyboard 0122 can include any device enabling an user of Data Processing System 0100 to input any alphanumeric character, including, but not limited to a Keyboard connected to a Personal Computer, and/or a Keypad connected to or integrated with a Wireless Device. An I/O Device is any device attached to and/or integrated with a Data Processing System 0100 which can enable such system to transmit data to and/or receive data from another device.

Data Processing System 0100 can implement any or all of the portions of the methods described herein through programmable logic, hard-wired logic, any combination of programmable and hard-wired logic, or any other type of logic. Control logic or software may be stored in Memory 0112 and/or computer program products. In some embodiments, Data Processing System 0100 can have one or more Processors 0104 execute one or more instructions stored in RAM 0106. RAM 0106 can retrieve the instructions from any other Computer/Processor/Machine Readable/Accessible Medium, e.g., Mass Storage 0110. In some embodiments, Data Processing System 0100 can have one or more Processors 0104 execute one or more instructions that are predefined or hard-wired. In some embodiments, Data Processing System 0100 can have one or more Processors 0104 execute one or more instructions utilizing a combination of programmable and hard-wired logic.

In some embodiments, any of the methods (or portion thereof) can be embodied in machine-executable instructions. Instructions can be processed using one or more techniques, including, but not limited to: utilizing one or more general- or special-purpose processors programmed with the instructions to execute any portion of the methods described herein, equivalent or related methods, other or additional methods, or any subset thereof; utilizing one or more hardware components that contain hardwired logic to execute the portions in any of the methods, equivalent or related methods, other or additional methods, or any subset thereof; or utilizing any combination of modules (e.g., programmed processors and/or hardware components) to execute the portions in any of the methods described herein, equivalent or related methods, other or additional methods, or any subset thereof. The software can be configured to execute on any type of hardware located at or distributed among one or more entities, including, but not limited to: an advertiser, a media buyer, a media operator, a media device, a wireless device, a retailer, or any third party (e.g., third party hardware).

In general, a computer program product can include any of the functions enabling the execution of the methods described herein. When loaded in, for example, a Data Processing System 0100 or a Computer/Machine Readable/Accessible Medium, a computer program product can execute the functions described herein and cause a computer, general- or special-purpose processor, and/or other hardware to execute any of the methods described herein.

The computer- or machine-readable or -accessible medium can include, but is not limited to: floppy disks, magnetic disks, optical disks, magneto-optical disks, CD-ROMs, ROM, RAM, programmable read-only memory (PROM), erasable programmable read-only memory (EPROM), electrically erasable programmable read-only memory (EEPROM), magnetic or optical cards, or any other type of media or computer- or machine-readable or -accessible media capable of storing instructions (e.g., a Computer/Machine Readable/Accessible Medium).

The functionality described herein can be distributed and/or downloaded as a computer program product. Methods described herein can be distributed from a remote computer, e.g., a server, to another computer, e.g., a client, through any wired and/or wireless channel over a network, e.g., the Internet.

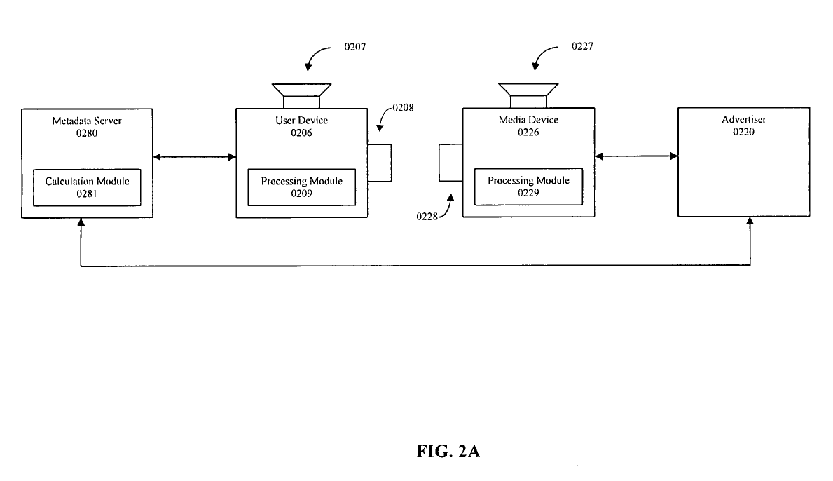

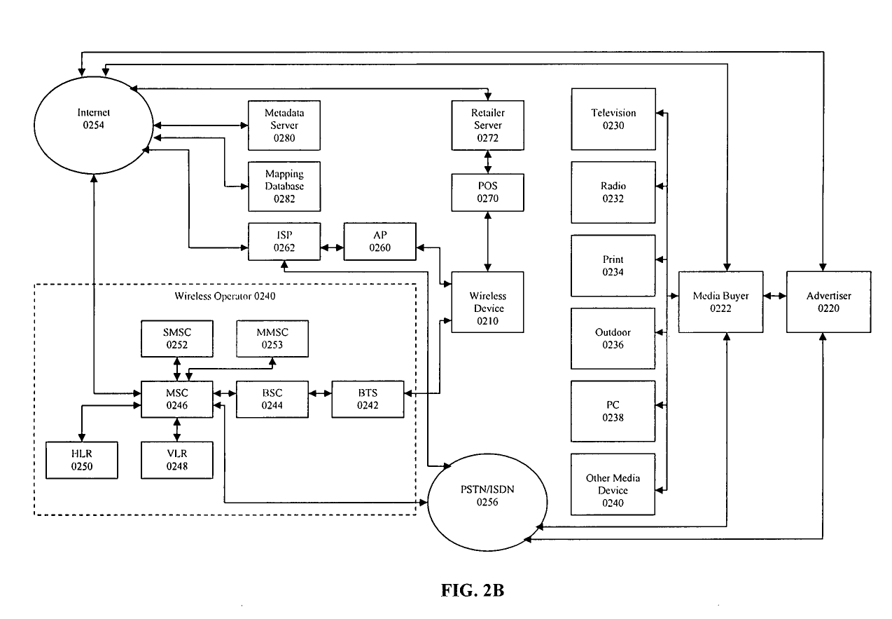

FIG. 2A illustrates a schematic block diagram of an exemplary system enabling any media device to interact with content displayed on another media device. The system can be configured to utilize a subset of the following components, or additional, related, alternative, and/or equivalent components. The system can include, but is not limited to, the following components.

User Device 0206 can be a Data Processing System which can transmit and/or receive data through any communications channel, including wireless, wireline, or any combination thereof. User Device 0206 can include one or more components, including, but not limited to: an Audio Receiving Component 0207, e.g., a microphone; an I/O Device 0208 capable of transmitting and/or receiving data through any communications channel, including wireless, wireline, or any combination thereof; and a Processing Module 0209 capable of receiving, processing, and/or transmitting any data.

User Device 0206 can represent a class of objects which share the same functions. A first example of User Device 0206 can be Wireless Device 0210 into which an user can speak and/or which can receive and/or transmit data. For example, an user viewing another media device, e.g., Media Device 0226, can speak into Wireless Device 0210 one or more words describing a product of interest displayed on Media Device 0226. A second example of User Device 0206 can be a personal computer which can include an Audio Receiving Component 0207; an I/O Device 0208, and a Processing Module 0209. For example, an user viewing another media device, e.g., Media Device 0226, can speak into the personal computer one or more words describing a product of interest displayed on Media Device 0226.

Media Device 0226 can be a Data Processing System which can transmit and/or receive data through any communications channel, including wireless, wireline, or any combination thereof. Media Device 0226 can include one or more components, including, but not limited to: an Audio Receiving Component 0227, e.g., a microphone; an I/O Device 0228 capable of transmitting and/or receiving data through any communications channel, including wireless, wireline, or any combination thereof; and a Processing Module 0229 capable of receiving, processing, and/or transmitting any data.

Media Device 0226 can represent a class of objects which share the same functions. The examples of Media Device 0226 can include, but are not limited to: Television 0230; Radio 0232; Print 0234; Outdoor 0236; PC 0238; and/or Other Media Device 0240.

For example, an user viewing another Media Device 0226 can speak directly into Audio Receiving Component 0227 one or more words describing a product of interest displayed on Media Device 0226.

Advertiser 0220 is a Data Processing System which can, for example, perform the functions described in FIG. 2B.

Metadata Server 0280 is a Data Processing System which can, for example, perform the functions described in FIG. 2B.

Calculation Module 0281 is a module which can perform a variety of functions, including, but not limited to, the following: (1) receiving any type of data from one or more Data Processing Systems, which can include, but are not limited to, User Devices 0206, e.g., Wireless Device 0210; Media Devices 0226; and/or Advertiser 0220; (2) storing such data; (3) processing such data by applying one or more methods or algorithms disclosed; (4) looking up one or more data structures for related data; and/or (5) transmitting any data to any Data Processing System, which can include, but is not limited to, User Devices 0206, Media Devices 0226, and/or Advertiser 0220. Calculation Module 0281 can be hardware, software, or firmware.

FIG. 2B illustrates a schematic block diagram of an exemplary system enabling any media device, e.g., a wireless device, to interact with content displayed on another media device and purchase or facilitate the purchase of a product promoted on another media device. The system can be configured to utilize a subset of the following components, or additional, related, alternative, and/or equivalent components. The system can include, but is not limited to, the following components.

Wireless Device 0210 is a Data Processing System which can be configured to transmit and/or receive data wirelessly to and/or from other devices and which an user can transport (e.g., move) with him or her when the user changes geographical location. Exemplary Wireless Devices 0210 include, but are not limited to: a wireless phone, a portable computer, a personal digital assistant, an email device, a camera, a portable game player, a watch, a pager, or any device that combines one or more of these functions. Wireless Device 0210 can include one or more I/O Devices attached to or integrated with it that are capable of transmitting and/or receiving data wirelessly to and/or from one or more other devices.

Wireless Device 0210 can be configured to transmit and/or receive data wirelessly to and/or from any other device, including, but not limited to: Base Transceiver Station (BTS) 0242; Access Point 0260; and/or Point of Sale (POS) device 0270. Wireless Device 0210 can exchange data wirelessly with any other device through any type of network, including, but not limited to: a wireless PAN; a wireless LAN, a wireless MAN, and/or a wireless WAN. Wireless Device 0210 can exchange data wirelessly with any other device utilizing any protocol, including, but not limited to: 802.11; 802.15.3a or ultra wideband (UWB); 802.16; high performance radio metropolitan area network (HIPERMAN); wireless broadband (WiBro); 802.20; advance mobile phone system (AMPS); Bluetooth; code division multiple access (CDMA); CDMA2000; any extensions of CDMA2000; wideband CDMA (WCDMA); any extensions of WCDMA; digital video broadcasting-handheld (DVB-H); enhanced data rates for global evolution (EDGE); general packet radio service (GRPS); global system for mobile communications (GSM); high speed downlink packet access (HSDPA); HomeRF; infrared data association (IrDA); satellite digital multimedia broadcasting (S-DMB); terrestrial digital multimedia broadcasting (T-DMB); terrestrial integrated services digital broadcasting (ISDB-T); time division multiple access (TDMA); wireless IEEE 1394; wireless USB; and/or any equivalent or successor standards.

A Wireless Device 0210 can be configured, in some embodiments, to interact with content displayed on another Media Device and purchase or facilitate the purchase in any retail channel of a product promoted on another Media Device. Any Media Device configured based on the systems, methods, apparatuses, and computer programs described herein, can interact with content displayed on another Media Device and purchase or facilitate the purchase in any retail channel of a product promoted on the other Media Device.

Advertiser 0220 can be a Data Processing System which can perform a variety of functions, including, but not limited to: exchanging data with any other Data Processing System, including, but not limited to, Wireless Device 0210; Media Buyer 0222; mobile switching center (MSC) 0246; Internet Service Provider (ISP) 0262; Retailer Server 0272; Metadata Server 0280; and/or Mapping Database 0282. The data can include, but is not limited to: one or more Ad Metadata Files; one or more Program Metadata Files; and/or one or more Media Buy Schedules.

Advertiser 0220 can include a variety of components enabling the exchange of data with any other Data Processing System, including, but not limited to: a web server which can exchange data with any Media Device; and/or a Call Center which can communicate with one or more users of a Wireless Device 0210 through a voice communication.

Media Buyer 0222 can be a Data Processing System which can perform a variety of functions, including, but not limited to: exchanging data with any other Data Processing System, including, but not limited to: Wireless Device 0210; Advertiser 0220; MSC 0246; ISP 0262; Retailer Server 0272; Metadata Server 0280; and/or Mapping Database 0282. The data can include, but is not limited to: one or more Ad Metadata Files; one or more Program Metadata Files; and/or one or more Media Buy Schedules. Media Buyer 0222 can be operated by a media buyer, a media planner, an advertising agency, or any third party.

An Advertisement can be any information displayed on a Media Device promoting a product, brand, or vendor.

A Programming can be any information displayed on a Media Device which is not an Advertisement.

A Media Device (e.g., media processing device) can be any Data Processing System which can be configured to receive and display an Advertisement and/or Programming. A Media Device can be a Print 0234 and Outdoor 0236, even if it does not include one or more of the components constituting a Data Processing System. A Media Device can include, but is not limited to, the following Data Processing Systems:

Television 0230 is a Data Processing System which can comprise a variety of components, including, but not limited to: a set-top box (STB); a digital video recorder (DVR); and/or a display, e.g., a television screen. Television 0230 can perform a variety of functions, including, but not limited to: displaying an Advertisement and/or Programming; and/or transmitting and/or receiving data to and/or from another device, including a headend in the case of a cable television operator; a satellite in the case of a direct broadcast satellite television operator; an antenna in the case of a terrestrial television broadcaster; and/or a server in the case of an Internet television operator.

Radio 0232 is a Data Processing System which can perform a variety of functions, including, but not limited to: displaying an Advertisement and/or Programming; and/or transmitting and/or receiving data to and/or from another device, including an antenna in the case of a terrestrial radio broadcaster; and/or a satellite in the case of a direct broadcast satellite radio operator. While a Radio 0232 typically transmits an audio signal constituting an Advertisement and/or Programming and does not literally display an Advertisement and/or Programming, displaying can include the presentation of an Advertisement and/or Programming to an user of Wireless Device 0210 in any format, including, but not limited to, any form which the user can view, hear, touch, and/or smell.

Print 0234 is a publication printed on some form of paper. Print 0234 can include one or more I/O Devices capable of transmitting and/or receiving data to and/or from one or more I/O Devices. Print 0234 can display an Advertisement and/or Programming without one or more components constituting a Data Processing System. Exemplary Print 0234 include, but are not limited to: a newspaper; a magazine; and/or a package containing a product.

Outdoor 0236 is a Data Processing System which can perform a variety of functions, including, but not limited to: displaying an Advertisement and/or Programming; and/or transmitting and/or receiving data to and/or from another device through one or more I/O Devices. Outdoor 0236 can display an Advertisement and/or Programming without one or more components constituting a Data Processing System. Exemplary Outdoor 0236 include, but are not limited to: a billboard; a poster; and/or any electronic display outside a home or business.

Personal Computer 0238 is a Data Processing System which can perform a variety of functions, including, but not limited to: displaying an Advertisement and/or Programming; and/or transmitting and/or receiving data to and/or from another device through one or more I/O Devices.

Other Media Device 0240 is a Data Processing System other than a Television 0230, a Radio 0232, a Print 0234, an Outdoor 0236, or Personal Computer 0238 which can perform a variety of functions, including, but not limited to: displaying an Advertisement and/or Programming; and/or transmitting and/or receiving data to and/or from another device through one or more I/O Devices. Exemplary Other Media Devices 0240 include, but are not limited to: another Wireless Device 0210; and/or any other device capable of displaying an Advertisement and/or Programming.

Wireless Operator 0240 is any entity operating any type of wireless network, including, but not limited to: a wireless PAN, a wireless LAN, a wireless MAN, and/or a wireless WAN. Wireless Operator 0240 can utilize any wireless protocol, including, but not limited to: 802.11; 802.15.3a or UWB; 802.16; high performance radio metropolitan area network (HIPERMAN); wireless broadband (WiBro); 802.20; advance mobile phone system (AMPS); Bluetooth; code division multiple access (CDMA); CDMA2000; any extensions of CDMA2000; wideband CDMA (WCDMA); any extensions of WCDMA; digital video broadcasting-handheld (DVB-H); enhanced data rates for global evolution (EDGE); general packet radio service (GRPS); global system for mobile communications (GSM); high speed downlink packet access (HSDPA); HomeRF; IrDA; satellite digital multimedia broadcasting (S-DMB); terrestrial digital multimedia broadcasting (T-DMB); terrestrial integrated services digital broadcasting (ISDB-T); time division multiple access (TDMA); wireless IEEE 1394; wireless USB; and/or any equivalent or successor standards.

Wireless Operator 0240 network can include, but is not limited to, the following components.

BTS 0242 is a Data Processing System which can perform a variety of functions, including, but not limited to: exchanging data with one or more Wireless Devices 0210 and/or one or more base station controllers (BSC) 0244.

BSC 0244 is a Data Processing System which can perform a variety of functions, including, but not limited to: exchanging data with one or more BTS 0242 and/or one or more MSC 0246.

While the system includes a BTS 0242, a BSC 0244, and other components of a Wireless Operator 0240 network, the system is not limited to that embodiment. The system can support any components capable of exchanging data between one or more Wireless Devices 0210 and a Wireless Operator 0240, including, but not limited to, any equivalent or successor component to a BTS 0242, a BSC 0244, or any other component of a Wireless Operator 0240 network.

MSC 0246 is a Data Processing System which can perform a variety of functions, including, but not limited to: exchanging data with one or more BSC 0244; one or more visitor location registers (VLR) 0248; one or more home location registers (HLR) 0250; one or more short message service centers (SMSC) 0252; and/or one or more multimedia messaging service centers (MMSC) 0253. MSC 0246 can exchange a short message service (SMS) message between one or more Wireless Devices 0210 and one or more SMSC 0252. MSC 0246 can exchange a multimedia messaging service (MMS) between one or more Wireless Devices 0210 and one or more MMSC 0253. MSC 0246 can exchange data with any device over any type of network, including, but not limited to: a VLR 0248 over signaling system number 7 (SS7) or any other protocol, a HLR 0250 over SS7 or any other protocol; a SMSC 0252 over SS7 or any other protocol; a MMSC 0253 over SS7 or any other protocol; a WAN, e.g., the Internet 0254, over Internet protocol (IP); and/or a PSTN or integrated services digital network (ISDN) 0256 over any relevant voice and/or data protocols.

VLR 0248 is a database which can store temporary information about wireless subscribers who roam in the coverage area of a MSC 0246 with which VLR 0248 can communicate. VLR 0248 can be separate from, collocated with, or integrated with a MSC 0246.

HLR 0250 is a database which can store information about subscribers of a Wireless Operator 0240. MSC 0246 can request from HLR 0250 any information about subscribers to authenticate and register a given subscriber. HLR 0250 data can include, but is not limited to: the service profile, the location information, and/or activity status of a given subscriber.

SMSC 0252 is a Data Processing System which can perform a variety of functions, including, but not limited to: receiving, relaying, and/or storing and forwarding one or more short messages; interrogating a HLR 0250 for routing information; and/or transmitting a short message to the visited MSC 0246 of the recipient Wireless Device 0210. SMSC 0252 can exchange a short message with a Wireless Device 0210 and/or any other media device utilizing any protocol, including, but not limited to: SS7; and/or transmission control protocol/internet protocol (TCP/IP).

Internet 0254 is an exemplary WAN which can utilize any protocol, e.g., IP.

PSTN/ISDN 0256 is an exemplary WAN which can utilize any protocol, e.g., synchronous digital hierarchy (SDH), synchronous optical networking (SONET), and/or X.25.

A Wireless Operator 0240 or another entity, including, e.g., a Wireless Device 0210 user, can operate a wireless LAN enabling one or more Wireless Devices 0210 to exchange data with any other device. The wireless LAN can include, but is not limited to, the following components.

AP 0260 is a Data Processing System which can perform a variety of functions, including, but not limited to: exchanging data with one or more Wireless Devices 0210 and one or more ISPs 0262.

ISP 0262 is any entity operating a network enabling the exchange of data among two or more devices utilizing IP.

POS 0270 is a Data Processing System which can perform a variety of functions, including, but not limited to: receiving data through any type of I/O Device, including, but not limited to, a touch-sensitive Display 0120, a Keyboard 0122, a Pointing Device 0124, a barcode scanner, a radio frequency identification (RFID) reader, and/or a payment reader, e.g., a device enabling the input of data from a credit or debit account through any means; processing the data to execute a transaction involving the purchase of a product; and/or transmitting any data, e.g., a payment receipt recording the purchase of a product, to any device including, but not limited to, a Wireless Device 0210, and/or a Retailer Server 0272. POS 0270 can receive any data related to the purchase of a product, whether the data is in electronic- or non-electronic-form. POS 0270 can read electronic-based data, e.g., where an automobile dealer can input into a Personal Computer information about the user of a Wireless Device 0210. POS 0270 can read non-electronically-based data, e.g., where it can electronically scan a check written by an user of Wireless Device 0210.

Retailer Server 0272 is a Data Processing System which can perform a variety of functions, including, but not limited to: receiving data from one or more POS 0270; processing the data to perform a variety of functions, including, but not limited to, executing a transaction involving the purchase of a product, storing data about the transaction, product, and/or customer, querying databases about the transaction, product, and/or customer, and/or analyzing the data; and/or transmitting any data about one or more transactions, products, and/or customers. Retailer Server 0272 can be any entity capable of enabling the user of a Wireless Device 0210 to purchase a product, including, but not limited to: (a) a Physical Retailer, which is any entity that can sell a product at a physical location, examples of which can include, but are not limited to: a supermarket; a mass merchandiser; a drugstore; a dealer (e.g., an automobile dealer); a manufacturer (e.g., a company that owns and/or operates a store that sells products it manufactures); an outlet store; a vending machine; a kiosk; a store which can sell services; a financial institution (e.g., a bank branch or ATM); and/or a movie theater; (b) an online retailer; (c) a call center enabling the purchase of a product through a phone call; and/or (d) an entity which can enable the purchase of a product through transmission of a purchase order through a physical communications channel, e.g., mail-order.

Retailer Server 0272 can transmit to any entity data about one or more of the products it offers for sale. These data can include, but are not limited to: the description of a product; the availability of a product at any given Physical Retailer at any given time, e.g., not only the availability of a product, but the availability in any given size, color, material, or any other product feature; and/or the price of the product at any given Physical Retailer at any given time. Other devices can utilize the product data to enable the purchase of the product. These devices can include, but are not limited to: (a) Advertiser 0220 and/or Media Buyer 0222, which can import product availability, price, or any other product data into an Ad Metadata File and/or Program Metadata File, e.g., an Advertiser 0220 promoting a movie can import data about the real-time availability of movie tickets at any given movie theater within the immediate geographical area of any given user of a Wireless Device 0210; and/or (b) Metadata Server 0280, which can import product availability, price, or any other product data into an Ad Metadata File and/or Program Metadata File to enable the user of a Wireless Device 0210 to view the real-time availability of any product promoted in an Advertisement and/or Programming.

Metadata Server 0280 is a Data Processing System which can perform a variety of functions, including, but not limited to: (a) receiving from Advertiser 0220 and/or Media Buyer 0222 any Ad Metadata File, Program Metadata File, Media Buy Schedule, and/or any other data enabling Metadata Server 0280 to identify an Advertisement and/or Programming of interest to a Wireless Device 0210 user; (b) storing any Ad Metadata File, Program Metadata File, and/or Media Buy Schedule in one or more databases; (c) updating any Ad Metadata File and/or Program Metadata File to reflect in real-time the description, availability, price, or any other data related to any product identified in an Ad Metadata File and/or Program Metadata File; (d) receiving from Wireless Operator 0240 and/or ISP 0262 a request for one or more Ad Metadata Files and/or Program Metadata Files; (e) processing the request for one or more Ad Metadata Files and/or Program Metadata Files; (f) transmitting to Wireless Operator 0240 and/or ISP 0262 one or more Ad Metadata Files and/or Program Metadata Files; (g) receiving from Wireless Operator 0240, ISP 0262, and/or Wireless Device 0210 a record of the action taken by the Wireless Device 0210 user in response to the reception of data in the Ad Metadata File and/or Program Metadata File (e.g., a Wireless Device User Response); (h) storing Wireless Device User Response data in a database; (i) analyzing the click-through rate (CTR) for one or more media operators to enable an Advertiser 0220 and/or Media Buyer 0222 to compare the CTR across different advertising channels; and/or (j) transmitting reports analyzing the effectiveness of any given advertising channel.

In addition, Metadata Server 0280 can be configured to, for example, act as a proxy server capable of performing as an intermediary between a client, e.g., a Wireless Device 0210, and another server (e.g., a Destination Server), which can include, but is not limited to: Advertiser 0220; Media Buyer 0222; Mapping Database 0282; and/or any third-party server. One or more Wireless Devices 0210 can establish connections to Metadata Server 0280, which can transmit to the Wireless Devices 0210 any data received from the Destination Server and/or data stored locally at Metadata Server 0280. Metadata Server 0280 can transmit to one of more Destination Servers any data received from one or more Wireless Devices 0210 and/or data stored locally at Metadata Server 0280.

Metadata Server 0280 can be configured to, for example, convert data: (a) received from one or more Wireless Devices 0210 in any messaging format or protocol, e.g., SMS, into data in another format or protocol, e.g., TCP/IP, which can be processed by one or more Destination Servers, e.g., a web server; and/or (b) received from one or more Destination Servers, e.g., a web server in any format or protocol, e.g., TCP/IP, into another format or protocol, e.g., SMS, which can be processed by one or more Wireless Devices 0210.

Metadata Server 0280 can present to one or more Wireless Devices 0210 dynamic content from one or more Destination Servers through a variety of means, including, but not limited to, the following. First, when receiving a request from one or more Wireless Devices 0210 for information about a product or data enabling the purchase of a product, Metadata Server 0280 can request from one or more Destination Servers any Dynamic Data, which is data that can change: (a) over the period of time when a Wireless Device 0210 can request information about a product or buy a product of interest; (b) depending on the location of a Wireless Device 0210 requesting information about a product or buying a product of interest; and/or (c) depending on the specific Wireless Device 0210 requesting information about a product or buying a product of interest. Dynamic Data can include, but is not limited to, Dynamic Advertisement Data described in more detail in Section 2.3.

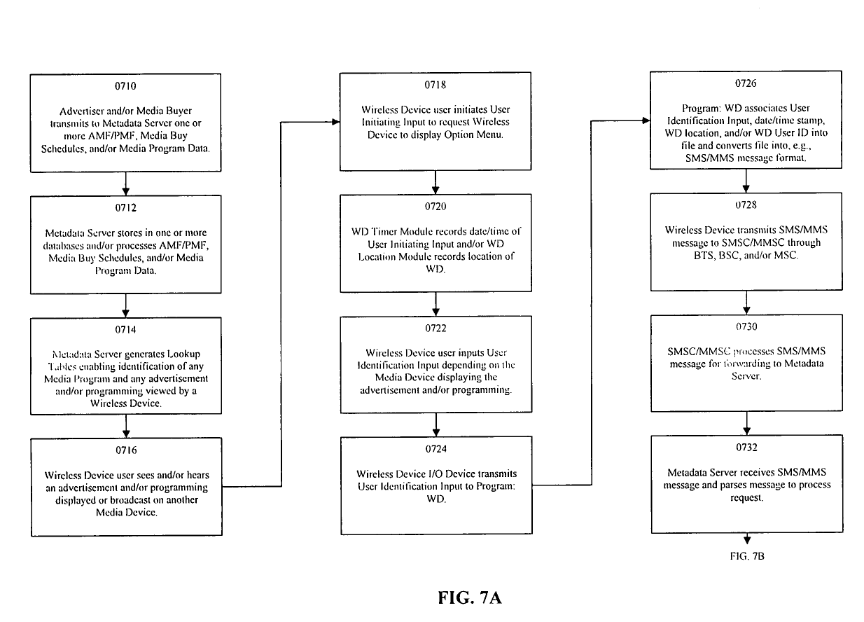

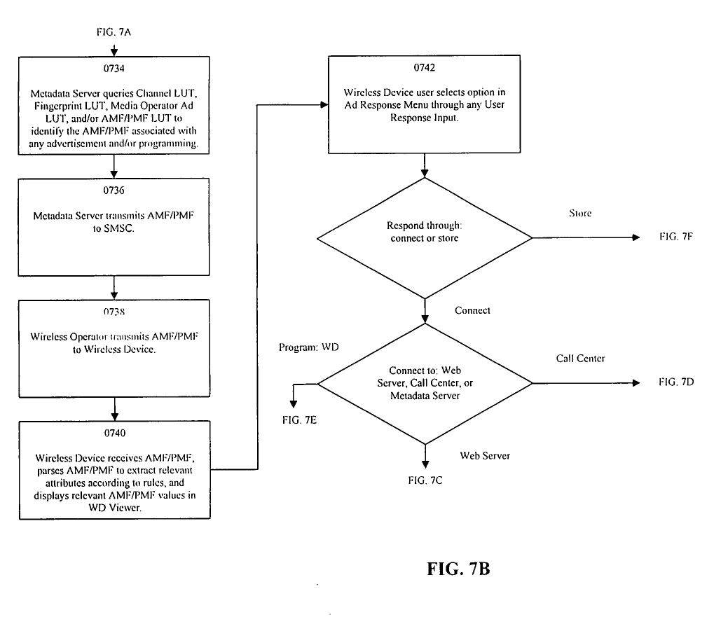

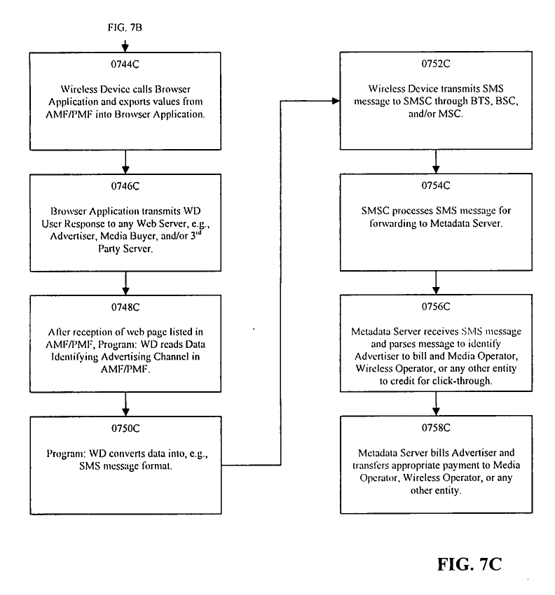

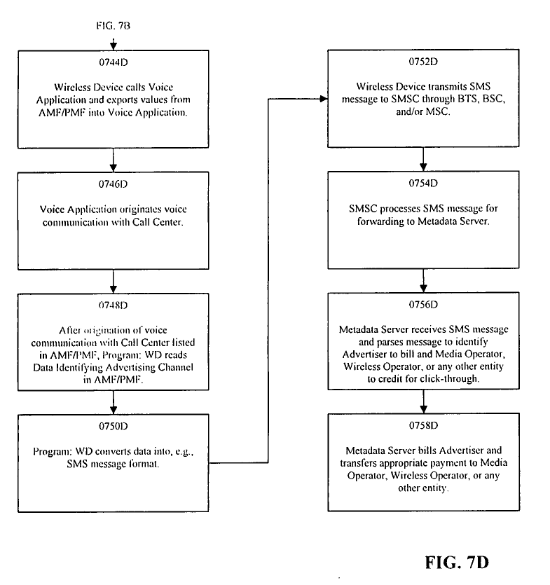

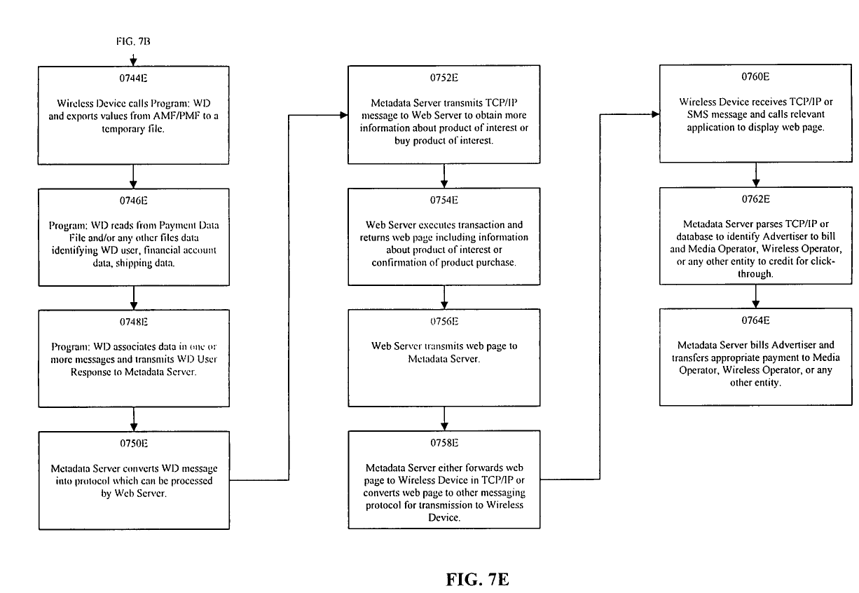

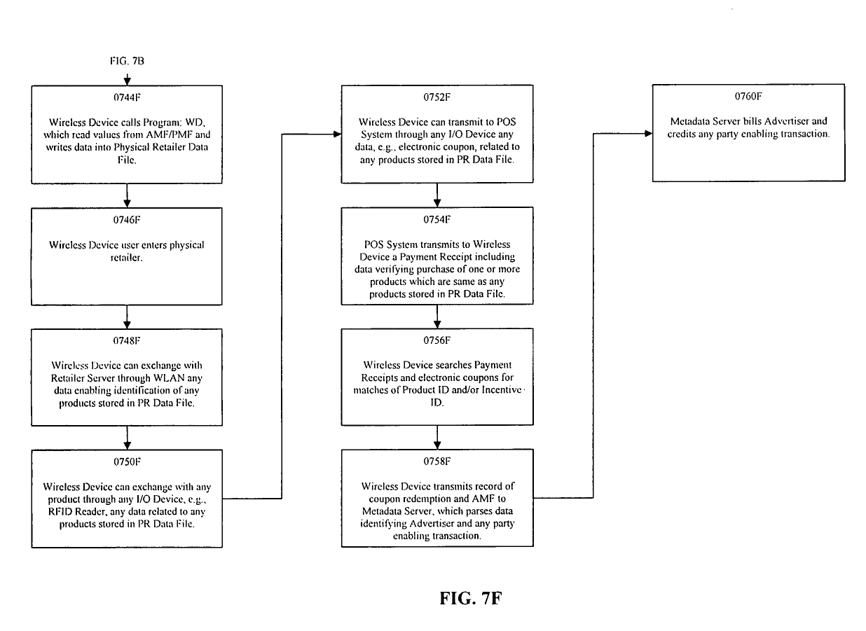

For example, a Wireless Device 0210 user can request the purchase of a product through an application other than a Browser Application 0330, e.g., through a method described in more detail in FIG. 7E. One event in the transaction can be the verification of a credit card utilized by Wireless Device 0210 to pay for the product. Instead of Wireless Device 0210 transmitting credit card account data directly to a web server utilizing a Browser Application 0330, Wireless Device 0210 can be configured to transmit credit account data in any messaging format or protocol, e.g., SMS, to Metadata Server 0280, which can extract the credit account data from the SMS message and convert it to a format or protocol where the credit account data can be read and processed by a web server with the capability of verifying a credit card.

Second, the periodic updating of any Dynamic Data can be enabled by having Metadata Server 0280 periodically polling one or more Destination Servers for any data updating one or more records in any databases stored in Metadata Server 0280; and/or one or more Destination Servers periodically transmitting any data updating one or more records in any database stored in Metadata Server 0280.

In some embodiments, a Metadata Server 0280 can present to one or more Wireless Devices 0210 dynamic content from one or more Destination Servers by requesting from the Destination Server any Dynamic Data or periodically updating any Dynamic Data stored in Metadata Server 0280. In some embodiments, additional functions, including, but not limited to: (a) the caching at Metadata Server 0280 of any applications, executable code, documents, and/or any other data stored at one or more Destination Servers; and/or (b) the processing at Metadata Server 0280 or at one or more Wireless Devices 0210 any applications, executable code, documents, and/or any other data cached at Metadata Server 0280 can be performed.

In some embodiments, a Metadata Server 0280 can be configured to perform the above functions as a separate Data Processing System located separately from a Wireless Operator 0240, an Advertiser 0220, a Media Buyer 0222, or any other entity. The functions of Metadata Server 0280 can be executed at one or more Data Processing Systems co-located with, integrated with, and/or embedded in any Data Processing System that is part of a Wireless Operator 0240, an Advertiser 0220, a Media Buyer 0222, or any other entity. For example, the co-location of a Metadata Server 0280 with a MSC 0246, a VLR 0248, a HLR 0250, and/or any other Data Processing System operated by one or more Wireless Operators 0240 can be supported. In addition, the storage of the data in a Metadata Server 0280 and/or execution of the functions of a Metadata Server 0280 directly by a MSC 0246, a VLOR 0248, a HLR 0250, and/or any other Data Processing System operated by one or more Wireless Operators 0240 can be supported.

Mapping Database 0282 is a Data Processing System, which can include a database and can perform a variety of functions, including, but not limited to: receiving from Advertiser 0220 and/or Media Buyer 0222 any data related to the description, availability, pricing, or any other data related to a product identified in an Ad Metadata File and/or Program Metadata File; receiving from one or more Retailer Servers 0272 any data related to the description, availability, pricing, or any other data related to a product identified in an Ad Metadata File and/or Program Metadata File and the geographical location of one or more Physical Retailers offering the product; receiving from one or more Wireless Devices 0210, Metadata Servers 0280, and/or any other device a request for data from Mapping Database 0282; processing the request by querying the Mapping Database 0282 to filter records of one or more products and/or Physical Retailers offering the product; and/or transmitting the query results.

### 2.2 Wireless Device System

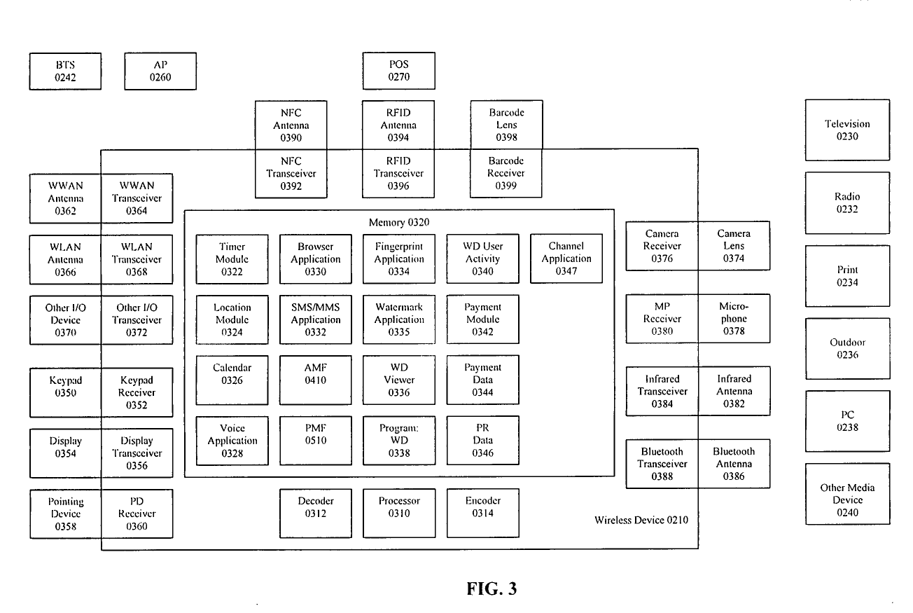

FIG. 3 depicts a block diagram of an exemplary wireless device. In some embodiments, the system can be configured to utilize a subset of the following components, or additional, related, alternative, and/or equivalent components. The system can include, but is not limited to, the following components.

Wireless Device 0210 can include a variety of other components not depicted in FIG. 3 which are typically required by a Wireless Device 0210 to receive, store, process, and/or transmit data, including, but not limited to, components capable of performing the following functions: modulation, demodulation, spreading, despreading, ADC, DAC, compression, decompression, upconversion, and/or downconversion. Wireless Device 0210 can include, but is not limited to, the following components capable of performing various functions.

Processor 0310 can be, for example, one or more general- or special-purpose Processor 0104.

Encoder 0312 can be, for example, one or more devices capable of encoding a signal into a format or protocol for transmission by one or more I/O Devices of Wireless Device 0210.

Decoder 0314 can be configured to, for example, decode the format or protocol of a signal received from one or more I/O Devices of Wireless Device 0210.

Memory 0320 can be configured to, for example, perform any of the functions of Memory 0112, including, but not limited to, storing any application and/or data in Wireless Device 0210.

Timer Module 0322 can be configured to, for example, record a date/time stamp associated with any event received or processed by a Wireless Device 0210 application.

Location Module 0324 can be configured to, for example, record the location of Wireless Device 0210 at the date/time of any event received or processed by a Wireless Device 0210 application.

Calendar 0326 can be configured to, for example, perform any function related to a calendar application.

Voice Application 0328 can be, for example, a computer program product can be configured to, for example, perform any function related to an application originating, processing, and/or terminating a voice communications by a Wireless Device 0210.

Browser Application 0330 can be configured to, for example, perform any function related to an Internet browser.

SMS/MMS Application 0332 can be, for example, a computer program product can be configured to, for example, perform any function related to a SMS or MMS application.

In addition, SMS/MMS Application 0332 can perform any function which can be performed by, for example, a sniffer program. The sniffer program can enable Wireless Device 0210 to intercept (e.g., receive) the transmission and/or reception of one or more SMS/MMS messages including data enabling the processing of any portion of the methods disclosed herein. By intercepting the SMS/MMS message, the sniffer program can pass the message to one or more applications, e.g., Program: WD 0338, instead of displaying the contents of the message on Display 0354 of Wireless Device 0210 for viewing by the user.

Ad Metadata File 0410.

Program Metadata File 0510.

Fingerprint Application 0334 can be, for example, a computer program product that can be configured to, for example, perform any function related to recording a sample of any information signal, extracting a fingerprint from the sample, and/or searching for matching fingerprints in a fingerprint database.

Watermark Application 0335 can be configured to, for example, performing any function related to detecting a watermark from any information signal, and/or extracting any data embedded in the watermark.

WD Viewer 0336 can be configured to, for example, perform a variety of functions, including, but not limited to: receiving from Program: WD 0338 any data which Wireless Device 0210 can display on Display 0354; and/or transmitting to Program: WD 0338 any Wireless Device 0210 user action related to Display 0354, including, but not limited to, User Identification Input described in more detail in FIG. 7A, and/or User Response Input described in more detail in FIG. 7B.

Program: WD 0338 is a computer program product capable of performing a variety of functions, including, but not limited to: (a) reading any Ad Metadata File 0410 and/or Program Metadata File 0510; (b) extracting any value from Ad Metadata File 0410 and/or Program Metadata File 0510 and writing the value into: (i) any Wireless Device 0210 application, e.g., writing into Calendar 0326 a date/time and event description from an Ad Metadata File 0410 describing a future Television program promoted by the associated Advertisement, writing into WD Viewer 0336 any value from Ad Metadata File 0410 for display on Display 0354, writing into Browser Application 0330 the uniform resource locator (URL) from Ad Metadata File 0410, or writing into Voice Application 0328 the Phone Number from Ad Metadata File 0410; and/or (ii) any Wireless Device 0210 file, e.g., writing into WD User Activity File 0340 the Advertisement ID describing the associated Advertisement to which Wireless Device 0210 user is responding, or writing into Physical Retailer Data File 0346 the Purchase Incentive from Ad Metadata File 0410; (c) receiving from WD Viewer 0336 any Wireless Device 0210 user action related to Display 0354, including, but not limited to, User Identification Input described in more detail in FIG. 7A, and/or User Response Input described in more detail in FIG. 7B; and/or (d) storing in WD User Activity File 0340 one or more events received or processed by a Wireless Device 0210 application, including, but not limited to, the transmission of any URLs, the retrieval of any web pages, the transmission of any email addresses, the transmission of any SMS and/or MMS messages, the origination of any voice communications, the purchase of any products through Wireless Device 0210, the purchase from any retailers, whether online, Call Centers, or Physical Retailers, through Wireless Device 0210, the downloading of any content to Wireless Device 0210, and/or the downloading of any applications to Wireless Device 0210.

In addition to the above functions reading, storing, and/or writing data from and/or to any Wireless Device 0210 application and/or data file, Program: WD 0338 can process instructions and/or data to perform a variety of functions, including, but not limited to: (a) determining the collection of different type of data and/or amount of data desirable and/or required to identify the Advertisement and/or Programming of interest, functions described in more detail in Section 5.1.3; and/or (b) evaluating any data stored in WD User Activity File to identify an Advertisement and/or Programming to transmit to a Media Device in the vicinity of Wireless Device, functions described in more detail in Section 18.

Payment Module 0342 is a computer program product capable of performing a variety of functions, including, but not limited to: retrieving from Payment Data File 0344 any financial account data associated with the user of Wireless Device 0210; processing a transaction executed by any Wireless Device 0210 application, including, but not limited to, Voice Application 0328, Browser Application 0330, SMS/MMS Application 0332, and/or Program: WD 0338; and/or transmitting to any Data Processing System one or more records of transactions executed by any Wireless Device 0210 application.

Payment Data File 0344 can include any data describing one or more financial accounts associated with the user of Wireless Device 0210, including, but not limited to: any credit card account data; any debit card account data; any checking account data; any Internet payment account data; and/or any phone bill account data.

Physical Retailer Data File 0346 can include any data which Wireless Device 0210 can transmit to and/or receive from any I/O Device and/or Data Processing System located in a Physical Retailer. A user of a Wireless Device 0210 can interact with an Advertisement and/or Programming displayed on another Media Device and purchase or facilitate the purchase of the product promoted on the other Media Device in any retailer, including a Physical Retailer. The purchase (or facilitating the purchase) of the product using a variety of means are described in more detail in connection with FIG. 7F.

Media Device Channel Application 0347 is a computer program product capable of performing a variety of functions, including, but not limited to: reading from any signal or file data representing the channel to which another Media Device is tuned; processing the data to identify the channel; and/or transmitting the data to any other computer program product and/or Data Processing System. For example, in Section 5.1.1.6 a method of collecting data transmitted by a device capable of controlling a Media Device remotely (e.g., a Remote Control Device) to enable identification of the channel to which a Media Device controlled by the Remote Control Device is tuned is described. MD Channel Application 0347 can receive, process, and transmit the data.

Keypad 0350 can be configured to perform any of the functions of, for example, Keyboard or Keypad 0122. Keypad Receiver 0352 can be configured to receive data from, for example, Keypad 0350 and transmit the data to one or more components in, for example, Wireless Device 0210.

Display 0354 can be configured to perform any of the functions of, for example, Display 0120. Display Transceiver 0356 can be configured to exchange data between, for example, Display 0354 and one or more components in Wireless Device 0210.

Pointing Device 0358 can be configured to perform any of the functions of, for example, Pointing Device 0124. Pointing Device Receiver 0360 can be configured to receive data from, for example, Pointing Device 0358 and transmitting the data to one or more components in Wireless Device 0210.

WWAN Antenna 0362 can be configured to perform any of the functions of, for example, Communications Interface 0114 with respect to a wireless WAN, e.g., a typical cellular network. WWAN Transceiver 0364 can be configured to exchange data between, for example, WWAN Antenna 0362 and one or more components in Wireless Device 0210.

WLAN Antenna 0366 can be configured to perform any of the functions of, for example, Communications Interface 0114 with respect to a wireless LAN. WLAN Transceiver 0368 can be configured to exchange data between, for example, WLAN Antenna 0366 and one or more components in Wireless Device 0210.

Other I/O Device 0370 can be configured to perform, for example, any of the functions of Communications Interface 0114 with respect to any wireless network other than a wireless WAN or a wireless LAN. Other I/O Transceiver 0372 can be configured to, for example, exchange data between Other I/O Device 0370 and one or more components in Wireless Device 0210.

Camera Lens 0374 can be configured to, for example, receive one or more images, e.g., one still image or a plurality of images constituting a video. Camera Receiver 0376 can be configured to, for example, receive data from Camera Lens 0374 and transmitting the data to one or more components in Wireless Device 0210.

Audio Receiving Component 0378, e.g., a microphone, is a device capable of receiving audio signals. Audio Receiving Component Receiver 0380 is a device capable of receiving data from Audio Receiving Component 0378 and transmitting the data to one or more components in Wireless Device 0210.

Infrared Antenna 0382 can be configured to, for example, receive and/or transmit infrared signals. While Media Devices typically utilize an infrared light-emitting diode (LED) to transmit infrared signals, in some embodiments, an Infrared Antenna 0382 as including the capability of acting as an infrared LED is defined. Infrared Transceiver 0384 can be configured to, for example, receive data from Infrared Antenna 0382 and transmitting the data to one or more components in Wireless Device 0210 and/or receiving data from one or more components in Wireless Device 0210 and transmitting the data to Infrared Antenna 0382.

Bluetooth Antenna 0386 can be configured to, for example, perform any of the functions of Communications Interface 0114 utilizing the Bluetooth or similar protocol. Bluetooth Transceiver 0388 can be configured to, for example, exchange data between Bluetooth Antenna 0386 and one or more components in Wireless Device 0210.

NFC Antenna 0390 can be configured to performing any of the functions of Communications Interface 0114 utilizing the near field communications (NFC) or similar protocol. NFC Transceiver 0392 can be configured to, for example, exchange data between NFC Antenna 0390 and one or more components in Wireless Device 0210.

RFID Antenna 0394 can be configured to, for example, receive and/or transmit radio signals utilizing the RFID or similar protocol. RFID Transceiver 0384 can be configured to, for example, receive data from RFID Antenna 0394 and transmitting the data to one or more components in Wireless Device 0210 and/or receiving data from one or more components in Wireless Device 0210 and transmitting the data to RFID Antenna 0394.

Barcode Lens 0398 can be configured to, for example, receive and/or transmit a light source. Barcode Transceiver 0399 can be configured to, for example, receive a light source from Barcode Lens 0398, converting the optical signal into an electrical signal, and transmitting the data to one or more components in Wireless Device 0210 and/or receiving data from one or more components in Wireless Device 0210, converting the electrical signal to an optical signal, and transmitting the data to Barcode Lens 0398.

### 2.3 Ad Metadata File

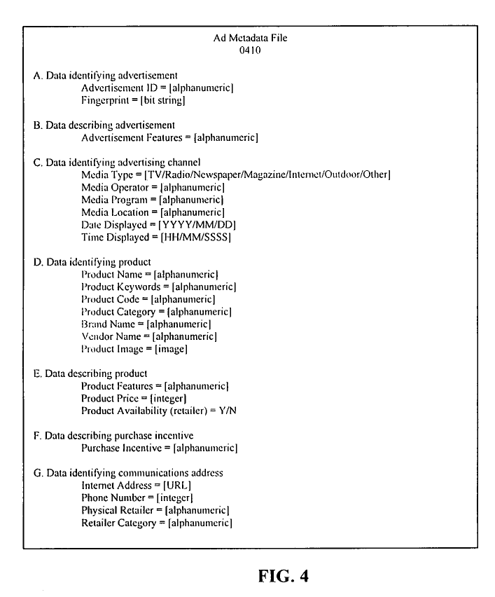

FIG. 4 depicts an exemplary ad metadata file. In some embodiments, the data can be organized as presented in FIG. 4. The Ad Metadata File 0410 can include, but is not limited to, the following types of data.

A. Data identifying the Advertisement associated with the Ad Metadata File 0410.

The Advertisement ID field can include any data uniquely identifying the Advertisement associated with Ad Metadata File 0410, including, but not limited to: (a) a standard code, e.g., the industry standard commercial codes (ISCI), and/or advertising digital identification (Ad-ID); and/or (b) a proprietary code utilized by a given Advertiser 0220 and/or Media Buyer 0222. The data can be in the form of an alphanumeric string. For example, the ISCI code has an 8-digit format, where the first four digits are alphabetical and the last four digits are alphanumerical, i.e., XXXX1234. The Ad-ID code has a 12-digit format, where the first four digits are alphabetical and the last eight digits are alphanumerical, i.e., XXXX12345678. The alphabetical digits represent the specific advertiser and the alphanumerical digits represent the specific Advertisement. Ad Metadata File 0410 can include a first field identifying the type of code utilized to identify uniquely the Advertisement, e.g., ISCI or Ad-ID; and a second field including the specific ISCI or Ad-ID value uniquely identifying the Advertisement.

The Fingerprint field can include one or more strings of bits which are sufficient to identify an Advertisement (e.g., a Fingerprint). There are existing methods of generating and detecting a digital Fingerprint in an information signal for one or more data types, including, but not limited to: audio; image; and/or video. Ad Metadata File 0410 can include the bit string(s) enabling the system to identify the Advertisement associated with Ad Metadata File 0410. The system can: (a) transmit the Fingerprint to a Wireless Device 0210 requesting Ad Metadata File 0410, where the Wireless Device 0210 can execute the process of matching the Fingerprint extracted from an information signal received by Wireless Device 0210 or another Media Device with Fingerprints in a database; (b) transfer the Fingerprint from Ad Metadata File 0410 to another database to reduce the size of Ad Metadata File 0410 for transmission to Wireless Device 0210; and/or utilize the Fingerprint at Metadata Server 0280 and/or any other Data Processing System to execute the process of matching the Fingerprint extracted from an information signal received and/or transmitted by Wireless Device 0210 with Fingerprints in a database.

B. Data describing the Advertisement associated with the Ad Metadata File 0410. The data can be in the form of an alphanumeric string. The data can include any information the Advertiser 0220 and/or Media Buyer 0222 wish to include in Ad Metadata File 0410 to describe one or more features of the associated Advertisement.

C. Data identifying the advertising channel through which Advertiser 0220 and/or Media Buyer 0222 are transmitting the associated Advertisement. The data in this section of Ad Metadata File 0410 can include, but are not limited to, the following data.

The Media Type field can include any data identifying the type of advertising channel, which can include, but is not limited to, the following media types: television, radio, newspaper, magazine, Internet, outdoor, and/or other media. The data identifying the advertising channel can be in the form of an alphanumeric string.

The Media Operator is any entity operating the media program and/or media location which displays the Advertisement associated with Ad Metadata File 0410. The Media Operator can include, but is not limited to, the following entities associated with each advertising channel: a television network displaying an Advertisement on Television 0230; a radio network displaying an Advertisement on Radio 0232, a print publisher displaying an Advertisement on Print 0234; an outdoor network displaying an Advertisement on Outdoor 0236; a web site displaying an Advertisement on Personal Computer 0238 or any other Media Device capable of displaying an Internet Advertisement; and/or any other Media Operator displaying an Advertisement on an Other Media Device 0240. The data identifying the Media Operator can be in the form of an alphanumeric string.

A producer of a television or radio Advertisement and/or Programming typically transmits to a television network or radio network, respectively, both: (a) the Advertisement and/or Programming; and (b) metadata describing the Advertisement and/or Programming (e.g., Ad Metadata or Program Metadata). The Ad Metadata typically includes one or more data which the system can utilize, including, but not limited to: a system code uniquely identifying a cable television operator, a cable television network, regional network, interconnect, or other cable television entities, e.g., a proprietary four-digit identification number assigned by Advanced Media Systems; and/or a broadcast call letter uniquely identifying a broadcast television network. The Media Operator field in Ad Metadata File 0410 can include any data uniquely identifying the Media Operator operating the media program and/or media location which displays the Advertisement associated with Ad Metadata File 0410, including, but not limited to: a standard code, e.g., the system code or broadcast call letter utilized in the television and radio industries; and/or a proprietary code utilized by a given Advertiser 0220 and/or Media Buyer 0222. Ad Metadata File 0410 can include a first field identifying the type of code utilized to identify uniquely the Media Operator, e.g., a system code; and a second field including the specific system code value uniquely identifying the Media Operator.

A Media Program is any specific content displaying an Advertisement and/or Programming. The Media Program can include, but is not limited to, the following types of content associated with each Media Operator: a television program which can display an Advertisement on Television 0230; a radio program which can display an Advertisement on Radio 0232; a newspaper or magazine issue which can display an Advertisement and/or Programming on Print 0234; a billboard which can display an Advertisement and/or Programming on Outdoor 0236; a web site or web page which can display an Advertisement and/or Programming on Personal Computer 0238; and/or any other type of content which can display an Advertisement and/or Programming on Other Media Device 0240. The data identifying the Media Program can be in the form of an alphanumeric string. The Media Program field in Ad Metadata File 0410 can include any data uniquely identifying the Media Program, including, but not limited to: a standard code; and/or a proprietary code utilized by a given Advertiser 0220 and/or Media Buyer 0222.

A Media Location is any slot in which a Media Operator can place an Advertisement with any dimension, including, but not limited to: space, time, embedded, any other dimension, or any combination thereof.

A space slot can include, but is not limited to: a web page; a section of a web page; a keyword utilized by a search engine; a word utilized in Internet content, e.g., a news story; a section of a screen in a television Advertisement; a page in a Print publication; a section of a page in a Print publication; an insert in a Print publication; or a section of product package.

A time slot can be any period of time in which a Media Operator can place an Advertisement. The time slot can be as short as a few seconds to as long as an entire Media Program, e.g., where a Media Operator leases for an infomercial a block of time typically reserved for an entire Media Program. The television and radio industry commonly refer to an advertising break in programming as a pod. Pod n would signify the nth advertising break in a given Programming. A television or radio network typically aggregates a plurality of spots in any given pod.

An embedded slot can include, but is not limited to: the display of a product in a Media Program or what is commonly referred to as product placement. A combination space-time slot can include, but is not limited to: a space slot that is available for a certain period of time, e.g., a rotating Advertisement available to different Advertisers 0220 and/or Media Buyers 0222 over time. An exemplary space-time slot can be a single Outdoor 0236 which displays one Advertisement for one time period and then displays another Advertisement for another time period.

Date Displayed is a date string identifying the date an Advertiser 0220 and/or Media Buyer 0222 plans to display the associated Advertisement. The Date Displayed can be a fixed date in the case of an Advertiser 0220 and/or Media Buyer 0222 buying a specific Media Location in advance for placement of the associated Advertisement. The Date Displayed can be a range of dates in the case of an Advertiser 0220 and/or Media Buyer 0222 buying a range of Media Locations in advance and where a Media Operator has discretion to display the associated Advertisement.

Time Displayed is a time string identifying the time an Advertiser 0220 and/or Media Buyer 0222 plans to display the associated Advertisement. The Time Displayed can be a fixed time in the case of an Advertiser 0220 and/or Media Buyer 0222 buying a specific Media Location in advance for placement of the associated Advertisement. An exemplary fixed Time Displayed is the specific time slot in a Media Program bought in advance by Advertiser 0220 and/or Media Buyer 0222, where the Media Program has predetermined time slots. The Time Displayed can be a range of times in the case of an Advertiser 0220 and/or Media Buyer 0222 buying a range of Media Locations in advance for placement of the associated Advertisement. An exemplary variable Time Displayed is the range of time slots in a Media Program bought in advance by Advertiser 0220 and/or Media Buyer 0222, where the Media Program has a range of potential time slots in which a Media Operator can place the associated Advertisement. For example, a Media Operator displaying a live sports program on a Television 0230, Radio 0232, Personal Computer 0238, and/or a Wireless Device 0210 typically cannot commit in advance to a specific time slot in which to place an Advertisement, because of the unpredictability of the game displayed. However, a Media Operator displaying a live sports program can typically commit to a range of specific time slots, which the Time Displayed field can describe.

D. Data identifying the product promoted in the associated Advertisement. The data in this section of Ad Metadata File 0410 can include, but are not limited to, the following data.

The Product Name field can include any data identifying the name of the product promoted in the associated Advertisement. The data can be in the form of an alphanumeric string.

The Product Keywords/Keyphrases field can include any data which a Wireless Device 0210 user is likely to associate with the name of the product, name of the brand, name of the vendor of the product, name of the category of the product promoted in the associated Advertisement, and/or any word and/or phrase the user is likely to associate with the product promoted in the associated Advertisement. Any entity can provide the Product Keywords/Keyphrases, including, but not limited to: Advertiser 0220; Media Buyer 0222; and/or Metadata Server 0280.

The benefits of including Product Keywords/Keyphrases in Ad Metadata File 0410 can include, but are not limited to, the following benefits. The invention can enable any Media Device, e.g., a Wireless Device 0210, to interact with content displayed on another Media Device with or without exchanging data with the other Media Device if the system can identify the specific Advertisement and/or Programming of interest to the Wireless Device 0210 user. Even if the system can identify the Media Operator and/or Media Program displaying the Advertisement and/or Programming of interest to the Wireless Device 0210 user, the system still must identify the specific Advertisement and/or Programming of interest. For certain Media Devices, e.g., Television 0230 or Radio 0232, a Media Operator and/or Media Program can typically display about a half dozen 30-second Advertisements every 10 minutes.

If the Wireless Device 0210 user identifies the specific Advertisement and/or Programming of interest before the Media Operator and/or Media Program stops displaying the Advertisement and/or Programming, then the system can utilize the data identifying the specific Advertisement and/or Programming and select the associated Ad Metadata File 0410 and/or Program Metadata File 0510 for transmission to Wireless Device 0210.

If the Wireless Device 0210 user identifies the specific Advertisement and/or Programming of interest after the Media Operator and/or Media Program stops displaying the Advertisement and/or Programming, then the system would have to transmit to Wireless Device 0210 user a plurality of Ad Metadata Files 0410 and/or Program Metadata Files 0510 without data supplied by Wireless Device 0210 user about the specific Advertisement and/or Programming of interest.

The system can utilize a variety of methods utilizing information provided by Wireless Device 0210 user to help identify the specific product of interest and/or the Advertisement and/or Programming promoting the product of interest (e.g., a User Generated Identification Data), even after the Media Operator and/or Media Program stops displaying the Advertisement and/or Programming of interest, including, but not limited to, the following methods. The user can provide to a Metadata Server 0280 one or more Keywords and/or Keyphrases that can enable the Metadata Server 0280 to narrow the range of Advertisements and/or Programming of interest to the user. Wireless Device 0210 user can associate with the specific name of the product, brand, and/or vendor promoted in an Advertisement and/or Programming of interest a variety of Keywords. For example, if a Wireless Device 0210 user viewed an Advertisement promoting a specific automobile model XYZ that is part of a specific brand BBB produced by vendor VVV, a typical Wireless Device 0210 user can associate with the specific product, brand, and/or vendor a variety of related Keywords/Keyphrases, e.g., “car,” “auto,” “automobile,” “SUV,” and/or “sports utility vehicle.”

The system can utilize Keywords/Keyphrases which describe not only the type of product or product category of the product of interest, but also any characteristic, including, but not limited to, feature, person, endorser, character, problem, and/or issue, a Wireless Device 0210 user would probably associate with the specific product, brand, and/or vendor. For example, a Wireless Device 0210 user can associate with a product like a movie one or more leading actors or actresses starring in the movie. A Keyword/Keyphrase can be the name of the actor or actress in the movie. A Wireless Device 0210 user can associate with an Advertisement the endorser, e.g., a celebrity. A Keyword/Keyphrase can be the name of the endorser in the Advertisement. A Wireless Device 0210 user can associate with an Advertisement a character in the Advertisement, e.g., a caveman. A Keyword/Keyphrase can be the word, “caveman.” For example, many pharmaceutical drugs have brand names or product names which can be difficult to remember. A typical Wireless Device 0210 user can in some cases be more likely to remember the disease addressed by the product. A Keyword/Keyphrase can be the problem or disease the product in the Advertisement can address, e.g., “heart disease” in addition to the brand name or product name of the drug promoted in the Advertisement and/or Programming.

The system can utilize Keywords/Keyphrases which can also identify and/or describe the Media Operator and/or Media Program displaying the Advertisement promoting the product of interest. For example, a viewer watching a Television 0230 or listening to a Radio 0232 can input into his/her Wireless Device 0210 using any of its I/O Devices data identifying the Media Operator, Media Program, and/or the logical channel displaying one or more Advertisements and/or Programming transmitted by the Media Operator. In another example, an user reading a Print Publication 0234 can input into his/her Wireless Device 0210 using any of its I/O Devices data identifying the Media Operator, Media Program, and/or issue, edition, or any other information identifying the particular Print Publication 0234. For example, a Print Publication 0234 named, “The XYZ Newspaper,” or “The XYZ Magazine,” can display in an issue dated Jan. 15, 2007 on page XYZ an Advertisement promoting a Product A offered by Vendor B. Keywords/Keyphrases can include data identifying not only the vendor, brand, product, and/or product category, but also the name of the Print Publication, the specific issue, and/or the number of the page displaying the Advertisement. In the present example, a reader can input into his/her Wireless Device 0210 the Keywords: “Get Vendor B Product A in The XYZ Magazine, January 15 issue, on page XYZ.”

In some embodiments, such as, for example, in Section 5.1.2, methods for enabling a Wireless Device 0210 user to input Commands and/or Keywords/Keyphrases by speaking into Audio Receiving Component 0378 are described. For example, a Wireless Device 0210 user can speak into Audio Receiving Component 0378 the words: “Get Vendor B Product A in The XYZ Magazine, January 15 issue, on page XYZ.”

If Metadata Server 0280 stored in its database the Keywords/Keyphrases most likely to be used by a typical Wireless Device 0210 user to help identify the product, brand, and/or vendor promoted in an Advertisement and/or Programming of interest and/or the Media Operator, Media Program, logical channel displaying Advertisement and/or Programming on any Media Device, and/or any information identifying a particular Print Publication 0234, issue, and/or page number, then Metadata Server 0280 can utilize the Keywords/Keyphrases provided by Wireless Device 0210 user to narrow the range of Advertisements and/or Programming of interest to the user.

In some embodiments, User Generated MO Identification Data can be defined as any User Generated Identification Data which identifies the Media Operator displaying the Advertisement of interest to Wireless Device 0210 user. In some embodiments, User Generated MP Identification Data can be defined as any User Generated Identification Data which identifies the Media Program displaying the Advertisement of interest to Wireless Device 0210 user.

In the present example, identifying the Media Operator and/or Media Program displaying the Advertisement of interest can narrow the range of specific Advertisements in which the user is interested to six Advertisements, including a first Advertisement promoting a home mortgage loan, a second Advertisement promoting an apparel item, a third Advertisement promoting the automobile model XYZ, a fourth Advertisement promoting a frozen food, a fifth Advertisement promoting a Television program, and a sixth Advertisement promoting a retailer. If the Wireless Device 0210 user provided to Metadata Server 0280 a Keyword “auto” or “SUV” and Metadata Server 0280 included in its database those Keywords in one or more fields associated with the record including data about the Advertisement promoting the automobile model XYZ, then Metadata Server 0280 can query the database to narrow the range of specific Advertisements of interest to the third Advertisement promoting the automobile model XYZ.

In some embodiments, if the Wireless Device 0210 user provided to Metadata Server 0280 the name of the specific automobile model XYZ, the name of the specific brand BBB, or the name of the vendor VVV, then Metadata Server 0280 can query the database to search for any record including a product field including the value of XYZ, a brand field including the value of BBB, or a vendor field including the value of VVV. The identification of the value can enable Metadata Server 0280 to narrow the range of specific Advertisements of interest to the third Advertisement promoting the automobile model XYZ.

In some embodiments, the exact Keyword, Keyphrase, product model name, brand name, vendor name, and/or name of the product category provided by Wireless Device 0210 user can be recognized. In some embodiments, any approximation of these inputs can be recognized. Existing methods enable the matching of approximate strings. For example, a Wireless Device 0210 user can provide a Keyword, “check,” and the Keyword database can include a Keyword, “checking account.” The method can utilize any method, including, but not limited to, approximate string matching or approximate pattern matching, for matching two or more Keywords. In addition, the system can utilize existing methods for matching approximate inputs provided by Wireless Device 0210 user in any form, including, but not limited to: speech; text; and/or handwriting.

In some embodiments, speech presented in any accent of a given language can be recognized (e.g., accent detection; acoustic model adaptation; and/or pronunciation adaptation). in some embodiments, speech presented in any language can be recognized.

In some embodiments, the Advertiser 0220 and/or Media Buyer 0222 transmitting the Ad Metadata File 0410 and/or Program Metadata File 0510 can generate and/or transmit the Keywords/Keyphrases most likely to be associated with a product, brand, and/or vendor promoted in an Advertisement and/or Programming of interest to a Wireless Device 0210 user. In addition, Metadata Server 0280 and/or any other Data Processing System can generate and input into the Ad Metadata File 0410 and/or Program Metadata File 0510 the Keywords/Keyphrases most likely to be associated with a product, brand, and/or vendor promoted in an Advertisement and/or Programming of interest to a Wireless Device 0210 user.

The Product Code field can include any data uniquely identifying the product promoted in the associated Advertisement, including, but not limited to: a standard code, e.g., the universal product code (UPC), the European article numbering (EAN) system, and/or the global trade identification number (GTIN); and/or a proprietary code utilized by a given Advertiser 0220 and/or Media Buyer 0222. The data can be in the form of an alphanumeric string. Ad Metadata File 0410 can include a first field identifying the type of code utilized to identify uniquely the product, e.g., UPC; and a second field including the specific UPC value uniquely identifying the product.

The Product Category field can include any data uniquely identifying the category of the product promoted in the associated Advertisement, including, but not limited to: (a) a standard code, e.g., the North American Product Classification System (NAPCS); the North American Industry Classification System (NAICS); the European Classification of Products by Activity (CPA); the Central Product Classification (CPC); and/or the International Standard Industrial Classification of all Economic Activities (ISIC); and/or (b) a proprietary code utilized by a given Advertiser 0220 and/or Media Buyer 0222. The data can be in the form of an alphanumeric string. Ad Metadata File 0410 can include a first field identifying the type of code utilized to identify uniquely the product category, e.g., NAPCS; and a second field including the specific NAPCS value uniquely identifying the product category.

In some embodiments, a variety of useful functions, including, but not limited to, the following can be enabled by including the Product Category field. For example, data in the Product Category field can be utilized to increase the probability of identifying the Advertisement promoting a product in which a Wireless Device 0210 user is interested and/or the product itself. Methods of identifying an Advertisement of interest and/or a product of interest are described in more detail in Section 6.2.1. In some embodiments, a Wireless Device 0210 user's reference to a Product Category can be utilized, in addition to other data received, collected, and/or generated by Wireless Device 0210, to narrow the number of potential Advertisements of interest and/or products of interest.

The Brand Name field can include any data identifying the brand of the product promoted in the associated Advertisement. The data can be in the form of an alphanumeric string.

The Vendor Name field can include any data identifying the vendor of the product promoted in the associated Advertisement. The data can be in the form of an alphanumeric string.

The Product Image field can include any data constituting an image of the product promoted in the associated Advertisement. The data can be in the form of any image data type, including, but not limited to: joint photographic experts group (JPEG) or any successor standard. By including the Product Image field, a Wireless Device 0210 can be enabled to display an image of the product in a viewer, e.g., WD Viewer 0336, by extracting the image file from an Ad Metadata File 0410 associated with the Advertisement promoting the product of interest.

E. Data describing the product promoted in the associated Advertisement. The data in this section of Ad Metadata File 0410 can include, but are not limited to, the following data.

The Product Features field can include any data the Advertiser 0220 and/or Media Buyer 0222 wish to include in Ad Metadata File 0410 to describe one or more features of the product promoted in the associated Advertisement. The Product Features can include, but are not limited to: price; size; dimensions; weight; mass; shape; color; taste; ingredients; material; style; performance; date (e.g., in the case of an event); and/or duration. In some embodiments, the data in Product Features field can be used to describe the product promoted in the associated Advertisement on the Display 0120 of a Wireless Device 0210.

The Product Features field can include any data in the format of a standard code or a proprietary code utilized by a given Advertiser 0220 and/or Media Buyer 0222. Ad Metadata File 0410 can include a first field identifying the type of code utilized to identify uniquely a given Product Feature and a second field including the specific system code value uniquely identifying the Product Feature. The data can be in the form of an alphanumeric string.

The Product Price field can include the price of the product promoted in the associated Advertisement. The data can be in the form of an integer string with the relevant currency sign.

The Product Availability field can include any data the Advertiser 0220 and/or Media Buyer 0222 wish to include in Ad Metadata File 0410 to indicate the availability at any given retailer of the product promoted in the associated Advertisement. The data can be in the form of an alphabetical string indicating whether or not the product is available at any given retailer.

F. Data describing the incentive offered by the Advertiser 0220 and/or Media Buyer 0222 to encourage the user of Wireless Device 0210 to purchase the product promoted in the associated Advertisement. The Purchase Incentive field can include any data uniquely identifying the incentive offered to encourage the purchase of the product promoted in the associated Advertisement, including, but not limited to: the basic UCC Coupon Code; the UCC/EAN 128 Coupon Extended Code; and/or the corresponding version for any given country/region. The data can be in the form of an alphanumeric string. Ad Metadata File 0410 can include a first field identifying the type of code utilized to identify uniquely the incentive, e.g., UCC Coupon Code; and a second field including the specific UCC Coupon Code value uniquely identifying the incentive.

Data identifying the communications address to which a Wireless Device 0210 can transmit data and/or from which a Wireless Device 0210 can receive data. The data in this section of Ad Metadata File 0410 can include, but are not limited to, the following data.

An Internet Address field can include any data identifying a resource in which Wireless Device 0210 user is interested, including, but not limited to: the uniform resource locator (URL).

The Phone Number field can include the phone number with which a Wireless Device 0210 can exchange data and/or enable a Wireless Device 0210 user to communicate with a Call Center through a voice communication. The Phone Number field can include data in any format which can be implemented by a Wireless Operator 0240, including, but not limited to: the North American Numbering Plan (NANP); and/or the corresponding numbering plans for other regions.

The Physical Retailer field can include any data identifying one or more Physical Retailers offering the product promoted in the associated Advertisement. In addition, the Physical Retailer field can include any data identifying the location of one or more Physical Retailers offering the product promoted in the associated Advertisement.

The Retailer Category field can include any data uniquely identifying the category of the retailer offering for sale the product promoted in the associated Advertisement, including, but not limited to: (a) a standard code, e.g., the NAPCS; the NAICS; the European CPA; the CPC; and/or the ISIC; and/or (b) a proprietary code utilized by a given Advertiser 0220 and/or Media Buyer 0222. The data can be in the form of an alphanumeric string. Ad Metadata File 0410 can include a first field identifying the type of code utilized to identify uniquely the retailer category, e.g., NAPCS; and a second field including the specific NAPCS value uniquely identifying the retailer category.

Ad Metadata File 0410 can include both static and/or dynamic Advertisement data. Ad Metadata File 0410 can include Static Advertisement Data, which is data included by Advertiser 0220 and/or Media Buyer 0222 that does not change: (a) over the period of time when a Wireless Device 0210 can request the Ad Metadata File 0410; (b) depending on the location of a Wireless Device 0210 requesting the Ad Metadata File 0410; and/or (c) depending on the specific Wireless Device 0210 requesting the Ad Metadata File 0410.

Ad Metadata File 0410 can include Dynamic Advertisement Data, which is data included by Advertiser 0220 and/or Media Buyer 0222 that can change: (a) over the period of time when a Wireless Device 0210 can request the Ad Metadata File 0410; (b) depending on the location of a Wireless Device 0210 requesting the Ad Metadata File 0410; and/or (c) depending on the specific Wireless Device 0210 requesting the Ad Metadata File 0410.

Exemplary Dynamic Advertisement Data can include, but are not limited to, the following data. The first data can be the Product Price and/or Purchase Incentive fields, where Advertiser 0220 and/or Media Buyer 0222 can change the Product Price to reflect: (a) any change in conditions between the time Advertiser 0220 and/or Media Buyer 0222 transmit Ad Metadata File 0410 and the time a given Wireless Device 0210 requests the Ad Metadata File 0410, e.g., change in demand for and/or supply of the product; and/or (b) any data received from the Personalization System which can affect the price at which Advertiser 0220 and/or Media Buyer 0222 might be willing to offer the product. For example, if the Personalization System provides data suggesting the price at which a given Wireless Device 0210 user would be willing to purchase the product, then Advertiser 0220 and/or Media Buyer 0222 can utilize such data to adjust the Product Price at the time when the Wireless Device 0210 requests the Ad Metadata File 0410.

The second data can be the Product Availability and/or Physical Retailer fields, where Advertiser 0220, Media Buyer 0222, and/or any third party can change the Product Availability to reflect: (a) any change in conditions between the time Advertiser 0220 and/or Media Buyer 0222 transmit Ad Metadata File 0410 and the time a given Wireless Device 0210 requests the Ad Metadata File 0410, e.g., change in demand for and/or supply of the product; and/or (b) any data received from Wireless Device 0210, Wireless Operator 0240; and/or the Personalization System concerning the location of Wireless Device 0210, which can relate to the Physical Retailers in the immediate vicinity of the Wireless Device 0210 and the available inventory in such Physical Retailers. For example, a Wireless Device 0210 user listening to a Radio 0232 in an automobile can request more information about an automobile promoted in an Advertisement. Advertiser 0220 can change the Physical Retailer field to include information about the dealer selling the automobile promoted in the Advertisement which is closest in location to Wireless Device 0210 at the time of the request.

### 2.4 Program Metadata File

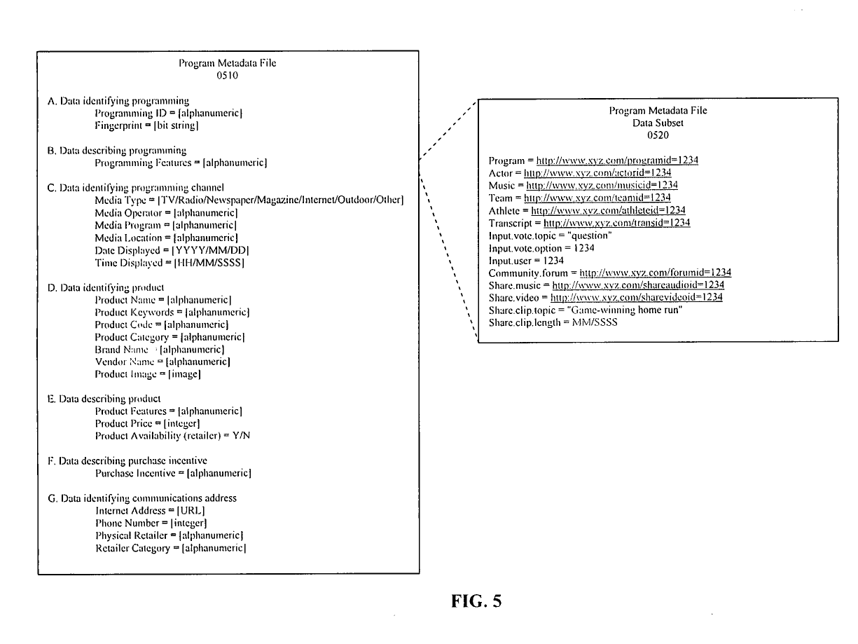

FIG. 5 depicts an exemplary program metadata file.

### 2.5 Media Buy Schedule

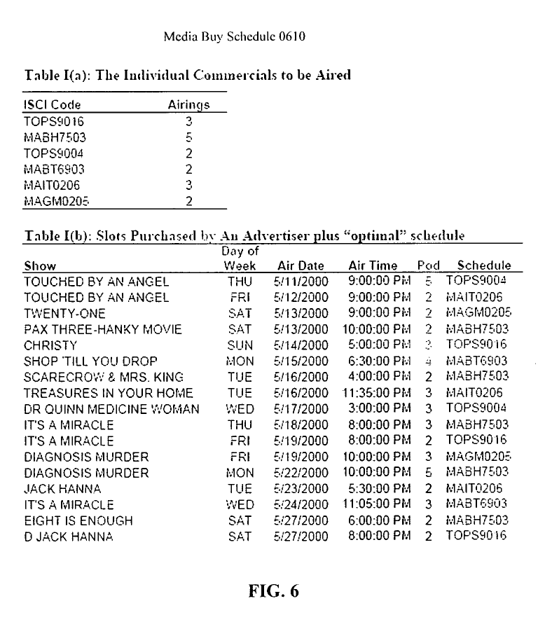

FIG. 6 depicts an exemplary broadcast television advertisement schedule. The exemplary broadcast spot schedule is presented in Bollapragada et al. Table I(a) depicts the specific Advertisements of a given advertiser with the associated ISCI codes. Table I(b) depicts the specific time slots bought by the advertiser during a given time period on a specific television network.

A Media Buy Schedule can be, for example, any schedule including one or more data identifying one or more Advertisements and/or Programming and the date/time when a given Media Operator plans to display the Advertisement and/or Programming.

A Media Buy Schedule 0610 can utilize a subset of, additional, related, alternative, and/or equivalent data, data types, and/or fields depicted in FIG. 6. In some embodiments, (a) a new Media Buy Schedule 0610 can be imported into one or more values from an existing Media Buy Schedule 0610 generated by one or more Advertisers 0220 and/or Media Buyers 0222; and/or (b) the existing Media Buy Schedule received from one or more Advertisers 0220 and/or Media Buyers 0222 can be received and stored. The data in the exemplary Media Buy Schedule 0610 can include, but are not limited to, the following data.

Advertisement ID, which can have the same or similar characteristics as Advertisement ID described in Ad Metadata File 0410.

Air Date, which can have the same or similar characteristics as Date Displayed described in Ad Metadata File 0410.

Air Time, which can have the same or similar characteristics as Time Displayed described in Ad Metadata File 0410. A typical existing broadcast spot schedule can include the time block in which a given Programming will be broadcast. The typical broadcast spot schedule may or may not specify the exact time at which it will initiate broadcast of a given Advertisement. The combination of the time block in which a Media Operator will broadcast a given Programming and another data, e.g., the Pod in the case of FIG. 6, can enable the identification of the exact time at which the Media Operator will initiate broadcast of a given Advertisement. In the case of FIG. 6, the Pod or any other similar data can specify the exact time and/or the order in which a Media Operator will initiate broadcast of a given Advertisement.

Media Program, which can have the same or similar characteristics as Media Program described in Ad Metadata File 0410.

Media Location, which can have the same or similar characteristics as Media Location described in Ad Metadata File 0410.

2.6 Overall Method Where a First Media Device Does Not Exchange Data with a Second Media Device

FIGS. 7A, 7B, 7C, 7D, 7E, and 7F depict a flowchart of an exemplary Method 0700 for enabling any media device, e.g., a wireless device, to interact with content displayed on another media device and purchase or facilitate the purchase of a product promoted on another media device without exchanging data with the other media device. The flowchart with reference to the systems and elements depicted in FIGS. 2-6 are described. However, the flowchart is not limited to that embodiment. The flowchart can be implemented with reference to systems utilizing a subset of the components, or additional, related, alternative, and/or equivalent components depicted in FIGS. 2-6. The flowchart can be implemented by executing a subset of the methods, executing portions of the methods in a different order, and/or executing other or additional related or equivalent methods. Moreover, the flowchart with reference to a Wireless Device 0210 is described. However, the flowchart is not limited to that embodiment. The flowchart can be implemented with reference to any Media Device utilized by an user viewing an Advertisement and/or Programming on another Media Device.

Method 0700, in some embodiments, is associated with enabling any media device, e.g., Wireless Device 0210, to interact with content displayed on another Media Device. Wireless Device 0210 can be configured to obtain more information about a product, purchase a product, download an electronic coupon related to a product, and/or perform any other action relating to a product without interacting with content displayed on another Media Device. The disclosed systems, methods, and computer program products can be adapted to enable a Wireless Device 0210 user to perform these actions without having seen, heard, or read an Advertisement displayed on another Media Device.

At 0710, Advertiser 0220 and/or Media Buyer 0222 can transmit to Metadata Server 0280 any data that can be related to a request by a Wireless Device 0210 for information about a product promoted in an Advertisement and/or Programming displayed on another media device. The data can include, but are not limited to: one or more Ad Metadata Files 0410; Program Metadata Files 0510; Media Buy Schedules 0610; and/or Media Program Data.

Media Program Data can be configured to, for example, identify the Media Operator, Media Program, and/or Media Location displaying the Advertisement and/or Programming to which an user of Wireless Device 0210 is responding. Media Program Data can be in the form of any data type, including, but not limited to: the same Advertisement and/or Programming displayed on one or more Media Devices on which any user of Wireless Device 0210 can view, hear, and/or read the Advertisement and/or Programming; and/or any bit string representing a Fingerprint or Watermark uniquely identifying any given Advertisement and/or Programming. Media Program Data can be received from any source, including, but not limited to: Advertiser 0220; Media Buyer 0222; and/or any entity which can generate Media Program Data, e.g., a third-party server in the business of monitoring or verifying the display of Advertisements on any Media Operator.

At 0712, Metadata Server 0280 can store in one or more databases and/or process one or more Ad Metadata Files 0410, Program Metadata Files 0510, Media Buy Schedules 0610, and/or Media Program Data.

In some embodiments, Metadata Server 0280 stores locally any data from Ad Metadata Files 0410, Program Metadata Files 0510, Media Buy Schedules 0610, and/or Media Program Data and serves Ad Metadata File 0410 and/or Program Metadata File 0510 in response to a request from one or more Wireless Devices 0210. The benefits of storing the data locally at Metadata Server 0280 can include, but are not limited to: obviating the need to make any changes in the hardware or software of a Wireless Operator 0240.

In some embodiments, Metadata Server 0280 transfers any data from Ad Metadata Files 0410, Program Metadata Files 0510, Media Buy Schedules 0610, and/or Media Program Data to any other Data Processing System, including, but not limited to: VLR 0248; HLR 0250; and/or Retailer Server 0272. In some embodiments, Advertiser 0220 and/or Media Buyer 0222 can transmit directly to any other Data Processing System the Ad Metadata Files 0410, Program Metadata Files 0510, Media Buy Schedules 0610, and/or Media Program Data. The benefits of storing the data in a Data Process System like VLR 0248 or HLR 0250 can include, but are not limited to: storing the data at a server closer to a Wireless Device 0210 to reduce (e.g., substantially reduce) the time to respond to a request from the Wireless Device 0210; and storing the data at a server like VLR 0248 or HLR 0250 can enable integration more closely of any data related a subscriber of Wireless Operator 0240 and the Ad Metadata Files 0410 and/or Program Metadata Files 0510. For example, VLR 0250 can include data on the location of a given Wireless Device 0210 at any given time, which could be integrated with certain data from Ad Metadata File 0410 which depends on the location of the Wireless Device 0210 requesting information about a product promoted in the associated Advertisement.

In some embodiments, systems, methods, apparatuses, and computer program products where Metadata Server 0280 stores locally any data from Ad Metadata Files 0410, Program Metadata Files 0510, Media Buy Schedules 0610, and/or Media Program Data are supported. In some embodiments, any system, method, apparatus, and computer program product where any other Data Processing System stores any data from Ad Metadata Files 0410, Program Metadata Files 0510, Media Buy Schedules 0610, and/or Media Program Data can be supported.

At 0714, Metadata Server 0280 can generate one or more Lookup Tables enabling the system to identify any Media Program and any Advertisement and/or Programming displayed before, during, or after the Media Program.

The system can generate one or more Lookup Tables (LUT) described in more detail in Section 3.3. These Lookup Tables can include, but are not limited to: (a) one or more LUTs including data describing the relationship between any channel and any Media Operator; (b) one or more LUTs including data describing the relationship among any Fingerprint, one or more Media Programs transmitted by a Media Operator, one or more Media Locations, and/or any Media Operator; (c) one or more LUTs including data describing the relationship among any Media Operator, one or more Media Programs transmitted by the Media Operator, one or more Media Locations, and/or one or more Advertisements and/or Programming transmitted by the Media Operator; and/or (d) one or more LUTs including data describing the relationship between any Advertisement and/or Programming and the associated Ad Metadata File 0410 and/or Program Metadata File 0510. The first LUT including data describing the relationship between any channel and any Media Operator can enable the system to identify the Media Operator transmitting an Advertisement and/or Programming if a given Wireless Device 0210 or any other Data Processing System transmits the channel to which another Media Device displaying the Advertisement and/or Programming is tuned. The channel can be either: (a) a physical channel, e.g., a radio frequency (RF) carrying the program stream of the Advertisement and/or Programming; or (b) a logical channel, which can differ from the physical channel carrying the program stream. In a digital television system, a cable television operator can transmit a given television network over a physical channel which differs from the channel tuned by a digital STB.

At 0716, Wireless Device 0210 user can see and/or hear an Advertisement and/or Programming displayed on another Media Device.

At 0718, Wireless Device 0210 user can initiate an User Initiating Input to request Wireless Device 0210 to display an Option Menu. User Initiating Input is any action taken by the Wireless Device 0210 user to request Wireless Device 0210 to display an Option Menu. The system can support the input of User Initiating Input in any form, including, but not limited to: touching on a touch-sensitive Display 0354 a symbol or icon; pressing one or more keys in Keypad 0350 in a preprogrammed sequence of key presses; navigating Pointing Device 0358 to select a symbol or icon displayed on Display 0354; and/or speaking into Audio Receiving Component 0378 one or more audio commands, e.g., (a) “Get,” or (b) “Get” and one or more Keywords identifying, e.g., the name of the product promoted in the Advertisement (collectively can be referred to as Wireless Device Input Method). Inputting any of the above User Initiating Inputs can cause Wireless Device 0210 to display an Option Menu. In some embodiments, inputting any of the above User Initiating Inputs can cause Wireless Device 0210 to record automatically any data received, collected, generated, and/or retrieved by Wireless Device 0210 which can help identify the specific product of interest and/or the Advertisement and/or Programming promoting the product of interest (e.g., a Wireless Device Generated Identification Data).

Option Menu is a menu of options and/or instructions presented to the user of Wireless Device 0210 relating to one or more Media Devices displaying an Advertisement and/or Programming of interest to Wireless Device 0210 user. The options and/or instructions can direct the Wireless Device 0210 user to input at 0722 any User Identification Input.

In some embodiments, Wireless Device 0210 can automatically call Option Menu in response to the reception of any Media Device Vicinity Data, which can be any data identifying the presence of a Media Device when Wireless Device 0210 is within the transmission range of: (a) one or more I/O Devices of the Media Device utilizing a short-range wireless protocol; (b) one or more Media Device I/O Devices transmitting any other type of signal, e.g., a sound wave; and/or (c) any component of the Media Device emitting an electromagnetic signal, e.g., a local oscillator (LO) signal described in more detail in Section 5.1.1.5. The system can further limit Media Device Vicinity Data to those data identifying the presence of a Media Device when Wireless Device 0210 is within the transmission range of one or more I/O Devices of the Media Device where the range is limited to the dimensions of the room in which the Media Device is located. For example, most surfaces can reflect an infrared signal, which can limit the transmission range of an I/O Device like Infrared Antenna 1912. Therefore, if a Wireless Device 0210 can receive an infrared signal from a Media Device, the system can typically conclude that the Wireless Device 0210 is in the same room as the Media Device. In another example, an antenna can limit the direction and range of any signal, e.g., a Bluetooth Antenna 1914 or other antennas can be modified to limit the azimuth and strength of the signal to the dimensions of a typical room. In another example, the system can infer that if a Audio Receiving Component 0378 of a Wireless Device 0210 can receive a sound wave, e.g., an audio signal transmitted by one or more speakers integrated with or attached to a Television 0230, then Wireless Device 0210 is probably in the same room as the Television 0230.

At 0720, Wireless Device Timer Module 0322 can record the date/time of an User Initiating Input and/or Wireless Device Location Module 0324 can record the location of Wireless Device 0210 at the date/time of an User Initiating Input. The benefits of recording a date/time stamp and/or the Wireless Device 0210 location when the Wireless Device 0210 user inputs an User Initiating Input can include, but are not limited to, the following benefits. If a Wireless Device 0210 user is interested in obtaining more information about an Advertisement and/or Programming, then he/she can initiate an User Initiating Input. Recording the date/time stamp and the location stamp can enable Metadata Server 0280 to determine which Media Operator and/or Media Program was displaying the Advertisement and/or Programming of interest.

At 0722, Wireless Device 0210 user can input User Identification Input depending on the Media Device displaying the Advertisement and/or Programming. The system can support enabling a Wireless Device 0210 user to input User Identification Input for one or more Media Devices displaying the Advertisement and/or Programming. For example, the system can support enabling a Wireless Device 0210 user to respond only to a Television Advertisement, in which case Option Menu can request Wireless Device 0210 user to input any type of User Identification Input, e.g., the Television channel displaying the Advertisement and/or Programming of interest. In some embodiments, the system can support enabling a Wireless Device 0210 user to respond to Advertisements displayed on a plurality of Media Devices, in which case Option Menu can offer Wireless Device 0210 user the option to input User Identification Input for each of the respective Media Devices.

The system can support a variety of User Identification Inputs, including, but not limited to, the following types of inputs: (a) User Generated Identification Data; and/or

### (b) Wireless Device Generated Identification Data.

First, an user of Wireless Device 0210 can input User Generated Identification Data, i.e., inputting data into Wireless Device 0210 enabling the system to identify the product of interest, the Advertisement and/or Programming promoting the product of interest, and/or the Media Operator and/or Media Program displaying an Advertisement and/or Programming of interest. These actions can include, but are not limited to: inputting the channel number displayed on a STB; inputting the name and/or symbol of the television network displaying the Advertisement and/or Programming; inputting the AM/FM frequency of the radio network displaying the Advertisement and/or Programming; inputting the name and/or symbol of the radio network displaying the Advertisement and/or Programming; inputting the name and/or symbol of the Print publication displaying the Advertisement and/or Programming (collectively can be referred to as a User Generated MO/MP Identification); and/or inputting one or more Keywords/Keyphrases associated with the product, brand, and/or vendor promoted by the Advertisement and/or Programming of interest.

The system can support the input of User Generated Identification Data in any form, including, but not limited to: touching on a touch-sensitive Display 0354 one or more symbols or icons, which action can cause Display 0354 to transmit to one or more Wireless Device 0210 components the User Generated Identification Data, e.g., touching one or more virtual alphanumeric keys on Display 0354 to input one or more integers or letters; pressing one or more keys in Keypad 0350, which action can cause Keypad 0350 to transmit to one or more Wireless Device 0210 components the User Generated Identification Data; and/or speaking into Audio Receiving Component 0378 any data, e.g., one or more integers, letters, words, or phrases, which action can cause Audio Receiving Component 0378 to transmit to one or more Wireless Device 0210 components the User Generated Identification Data. The system can utilize any method of storing and/or transmitting any data input into Audio Receiving Component 0378 in raw format, e.g., 16 bit pulse code modulation (PCM).

In addition, the Wireless Device 0210 user can input User Generated Identification Data by utilizing one or more I/O Devices to record any image, audio, video, and/or any combination of image, audio, and video displayed by another Media Device for processing by Wireless Device 0210 or for transmission by Wireless Device 0210 to Metadata Server 0280 to enable Metadata Server 0280 to identify the Media Operator and/or Media Program displaying an Advertisement and/or Programming of interest and/or identify directly the Advertisement and/or Programming of interest.

The recording of any image, audio, video, and/or combination thereof displayed by another Media Device can include, but is not limited to, the following. First, the Wireless Device 0210 user can utilize one or more I/O Devices to record an image and/or video displayed on a Television 0230, Print 0234, Outdoor 0236, Personal Computer 0238, and/or Other Media Device 0240. These methods are described in more detail in Section 5.1.2. Second, Wireless Device 0210 user can utilize one or more I/O Devices to record an audio displayed on a Television 0230, Radio 0232, Outdoor 0236, Personal Computer 0238, and/or Other Media Device 0240. These methods are described in more detail in Section 5.1.2.

Second, Wireless Device 0210 can input Wireless Device Generated Identification Data, i.e., where Wireless Device 0210 can automatically record data enabling the system to identify the Media Operator and/or Media Program displaying an Advertisement and/or Programming of interest to the user in response to an event, e.g., an User Initiating Input. These methods are described in more detail in Section 5.1.1.

At 0718 through 0722, a Wireless Device 0210 user can input User Identification Input in response to options presented in an Option Menu. In some embodiments, the present method can enable Wireless Device 0210 to act automatically in response to an User Initiating Input to collect and/or retrieve data enabling the system to identify the Media Operator and/or Media Program displaying an Advertisement and/or Programming of interest to the user. That is, the present method can skip the display of an Option Menu and automatically obtain the relevant User Identification Input. For example, upon receiving an event, e.g., any User Initiating Input, an event handler in a computer program product in Wireless Device 0210, e.g., Program: WD 0338, can process the event by calling any application or function, e.g., a function included in Fingerprint Application 0334 or Watermark Application 0335 recording, extracting, or detecting a Fingerprint or Watermark of an audio, video, or audio-video signal transmitted by another Media Device in the vicinity of Wireless Device 0210.

At 0724, one or more I/O Devices of Wireless Device 0210 can transmit one or more User Identification Inputs to Program: WD 0338 or any other computer program product capable of receiving, processing, and transmitting one or more User Identification Inputs and other data which the system can utilize to identify the Media Operator and/or Media Program displaying an Advertisement and/or Programming of interest and/or identify directly the Advertisement and/or Programming of interest.

At 0726, Program: WD 0338 can associate into one or more files (e.g., a WD Ad/Program ID File) the combination of one or more User Identification Inputs, one or more date/time stamps, one or more Wireless Device location stamps, any data uniquely identifying Wireless Device 0210 (e.g., a Wireless Device User ID), and/or any other data the system can utilize to identify the Media Operator and/or Media Program displaying an Advertisement and/or Programming of interest and/or identify directly the Advertisement and/or Programming of interest.

Wireless Device User ID can include, but is not limited to: an electronic identification number (EIN) of the Wireless Device 0120; a SIM card number associated with the Wireless Device 0210 user; and/or any code identifying the participation of the customer in any type of shopper loyalty program (e.g., a Shopper Loyalty ID), which can be any code supplied by a retailer and/or any existing code enabling a retailer to identify uniquely the Wireless Device 0210 user, e.g., the user's phone number.

The User Identification Inputs can include not only alphanumeric data inputted by a Wireless Device 0210 user, but also media files recorded by one or more I/O Devices of Wireless Device 0210. For example, Wireless Device Generated Identification Data can include a variety of media files, including, but not limited to: (a) an image stored in any image standard, including, but not limited to, JPEG or any successor standard; (b) a video stored in any video standard, including, but not limited to, any moving pictures experts group (MPEG) standard or any successor standard; H.263 standard; H.264 standard; and/or any successor to H.264; and/or (c) an audio stored in any audio standard, including, but not limited to, adaptive multi-rate (AMR); advanced audio coding (AAC); and/or MPEG-1 audio layer 3 (MP3).

The media files can be either files including an original image, video, and/or audio file or files the system can convert, process, and/or compress into another file, e.g., a Fingerprint.

The present method can convert the WD Ad/Program ID File(s) into any messaging format or protocol, including, but not limited to: SMS; enhanced messaging service (EMS); MMS; a hypertext markup language (HTML) document; an extensible markup language (XML) document; and/or any proprietary format or protocol. The present method can transmit the data in WD Ad/Program ID Files in one SMS message or segment the data over a plurality of SMS messages and apply the same process to any other messaging format or protocol.

The present method can utilize any method, apparatus, and/or computer program product to enable Wireless Device 0210 to compress WD Ad/Program ID File before transmission and/or Metadata Server 0280 to decompress WD Ad/Program ID File after reception.

The present method can transmit one or more WD Ad/Program ID Files over any communications format or protocol Wireless Device 0210 can utilize to transmit data over any wireless network. These communications formats or protocols can include, but are not limited to: ISDN-Primary Rate Interface (PRI); SS7; FTP; and/or TCP/IP.

At 0728, Wireless Device 0210 can transmit one or more SMS/MMS messages including the data in WD Ad/Program ID Files to SMSC 0252 and/or MMSC 0253 through one or more BTS 0242, BSC 0244, and/or MSC 0246.

At 0730, one or more SMSC 0252 and/or MMSC 0253 can utilize any method to process one or more SMS/MMS messages for forwarding to Metadata Server 0280.

At 0732, Metadata Server 0280 can receive one or more SMS/MMS messages and parse the messages to process the request for one or more Ad Metadata Files 0410 and/or Program Metadata Files 0510 associated with the Advertisement and/or Programming of interest to the Wireless Device 0210 user.

At 0734, Metadata Server 0280 can query one or more databases generated in 0712. Metadata Server 0280 can search for the specific Ad Metadata File 0410 and/or Program Metadata File 0510 associated with the Advertisement and/or Programming of interest to the Wireless Device 0210 user through a variety of means, including, but not limited to, the following methods.

First, Metadata Server 0280 can identify the Media Operator and/or Media Program displaying the Advertisement and/or Programming of interest by selecting the record with a field specifying the channel to which a STB is tuned, RF to which a STB or Radio 0232 is tuned, or any other logical and/or physical channel to which any other Media Device is tuned whose value equals the value of the channel number, RF, or any other logical and/or physical channel inputted by Wireless Device 0210 user at 0722.

Second, Metadata Server 0280 can identify the Media Operator and/or Media Program displaying the Advertisement and/or Programming of interest by selecting the record with a field specifying the name and/or symbol of the television network, radio network, Print publication, or any other Media Operator whose value equals the value of the name and/or symbol of the Media Operator inputted by Wireless Device 0210 user at 0722.

Third, Metadata Server 0280 can identify the Media Operator and/or Media Program displaying the Advertisement and/or Programming of interest by selecting the record with a field specifying one or more Keywords/Keyphrases whose value(s) equal the value of one or more Keywords/Keyphrases inputted by Wireless Device 0210 user at 0722.

Fourth, Metadata Server 0280 can identify the Media Operator and/or Media Program displaying the Advertisement and/or Programming of interest by selecting the record with a field specifying a video Fingerprint which matches a video Fingerprint extracted by one or more I/O Devices of Wireless Device 0210 from the video signal carrying the Advertisement and/or Programming of interest.

Fifth, Metadata Server 0280 can identify the Media Operator and/or Media Program displaying the Advertisement and/or Programming of interest by selecting the record with a field specifying an audio Fingerprint which matches an audio Fingerprint extracted by one or more I/O Devices of Wireless Device 0210 from the audio signal carrying the Advertisement and/or Programming of interest.

Sixth, Metadata Server 0280 can identify the Media Operator and/or Media Program displaying the Advertisement and/or Programming of interest by selecting the record with a field specifying a combined audio-video Fingerprint which matches a combined audio-video Fingerprint extracted by one or more I/O Devices of Wireless Device 0210 from the audio and video signal carrying the Advertisement and/or Programming of interest.

Seventh, Metadata Server 0280 can identify the Media Operator and/or Media Program displaying the Advertisement and/or Programming of interest by selecting the record with a field specifying a video Watermark which matches a video Watermark extracted by one or more I/O Devices of Wireless Device 0210 from the video signal carrying the Advertisement and/or Programming of interest.

Eighth, Metadata Server 0280 can identify the Media Operator and/or Media Program displaying the Advertisement and/or Programming of interest by selecting the record with a field specifying an audio Watermark which matches an audio Watermark extracted by one or more I/O Devices of Wireless Device 0210 from the audio signal carrying the Advertisement and/or Programming of interest.

Ninth, Metadata Server 0280 can identify the Media Operator and/or Media Program displaying the Advertisement and/or Programming of interest by selecting the record with a field specifying the Media Operator and/or Media Program which matches the Media Operator and/or Media Program specified by a data transmission received from the Media Device displaying the Advertisement and/or Programming of interest through one or more I/O Devices of Wireless Device 0210 over through one or more wireless communications protocols, including, but not limited to, Bluetooth, infrared, and/or wireless LAN.

Tenth, Metadata Server 0280 can identify the Media Operator and/or Media Program displaying the Advertisement and/or Programming of interest by selecting the record with a field specifying a local oscillating (LO) frequency or other electromagnetic frequency which matches the LO frequency or other electromagnetic frequency received from the STB displaying a Television Advertisement and/or Programming of interest or a Radio 0232 displaying a Radio Advertisement and/or Programming of interest detected by a LO frequency detector in Wireless Device 0210.

Eleventh, Metadata Server 0280 can identify the Media Operator and/or Media Program displaying the Advertisement and/or Programming of interest by selecting the record with a field specifying a logical channel which matches the logical channel recorded by Wireless Device 0210 either: (a) acting as a Remote Control Device selecting the logical channel of another Media Device, e.g., Television 0230; or (b) receiving the infrared transmission of a logical channel selected by another Remote Control Device.

The system can utilize any data manipulation language (DML) to insert, delete, update, and/or retrieve data in a database. These DMLs can include, but are not limited to: structured query language (SQL). The system can utilize any DML command to retrieve zero or more records from one or more tables in a database, e.g., the SELECT command in SQL.

After identifying the Media Operator and/or Media Program displaying the Advertisement and/or Programming of interest, the present method can lookup the Advertisement and/or Programming displayed by the Media Operator and/or Media Program at the date/time recorded by Timer Module 0322 of Wireless Device 0210 and at the location recorded by Location Module 0324 of Wireless Device 0210 and/or a computer program product located within Wireless Operator 0240 which can identify the location of Wireless Device 0210.

After identifying the Advertisement and/or Programming of interest, the present method can lookup the Ad Metadata File 0410 and/or Program Metadata File 0510 associated with the Advertisement and/or Programming of interest.

At 0736, Metadata Server 0280 can convert the Ad Metadata File 0410 and/or Program Metadata File 0510 of interest into any messaging format or protocol, including, but not limited to: SMS; EMS; MMS; HTML; XML; and/or any proprietary format or protocol. The present method can transmit the data in Ad Metadata File 0410 and/or Program Metadata File 0510 in one SMS message or segment the data over a plurality of SMS messages and apply the same process to any other messaging format or protocol.

At 0738, Metadata Server 0280 can transmit to the requesting Wireless Device 0210 one or more Ad Metadata Files 0410 and/or Program Metadata Files 0510 over any communications format or protocol Wireless Operator 0240 can utilize to transmit data to any Wireless Device 0210. These communications formats or protocols can include, but are not limited to: ISDN-PRI; SS7; FTP; and/or TCP/IP.

At 0740, Wireless Device 0210 can: (a) receive one or more Ad Metadata Files 0410 and/or Program Metadata Files 0510; (b) parse the files according to any rules to extract the attributes which contain values that can enable the Wireless Device 0210 user to decide whether to: (i) connect to a Web Server or Call Center to obtain more information about the product of interest or to buy the product of interest; (ii) store data, e.g., a Purchase Incentive, for future purchase in a Physical Retailer of the product of interest; and/or (c) display the values selected from the Ad Metadata File 0410 and/or Program Metadata File 0510 in WD Viewer 0336.

At 0742, Wireless Device 0210 user can select an option in Ad Response Menu through any User Response Input. Ad Response Menu can be the presentation of one or more actions Wireless Device 0210 user can select, e.g., “Buy,” “Get,” or “Save.” The system can support the input of User Response Input through any Wireless Device Input Method. Inputting any of the above User Response Inputs can cause an event handler in a computer program product, e.g., Program: WD 0338, to process the event by calling any function, e.g., a function executing a Browser Application 0330 request of the web page identified by the URL included in the Ad Metadata File 0410 and/or Program Metadata File 0510 received by Wireless Device 0210.

Depending on the option selected by Wireless Device 0210 user at 0742, the present method can enable Wireless Device 0210 to implement additional methods for different options selected. The different options can include, but are not limited to: (a) connecting immediately to a resource, which can enable Wireless Device 0210 to obtain more information about the product of interest or buy the product of interest; or (b) store any data, e.g., an electronic coupon or a Purchase Incentive, enabling or facilitating the future purchase in a Physical Retailer of the product of interest. If Wireless Device 0210 user selects an option of connecting immediately to a resource, then the system can enable Wireless Device to connect to a Web Server, a Call Center, or Metadata Server 0280.

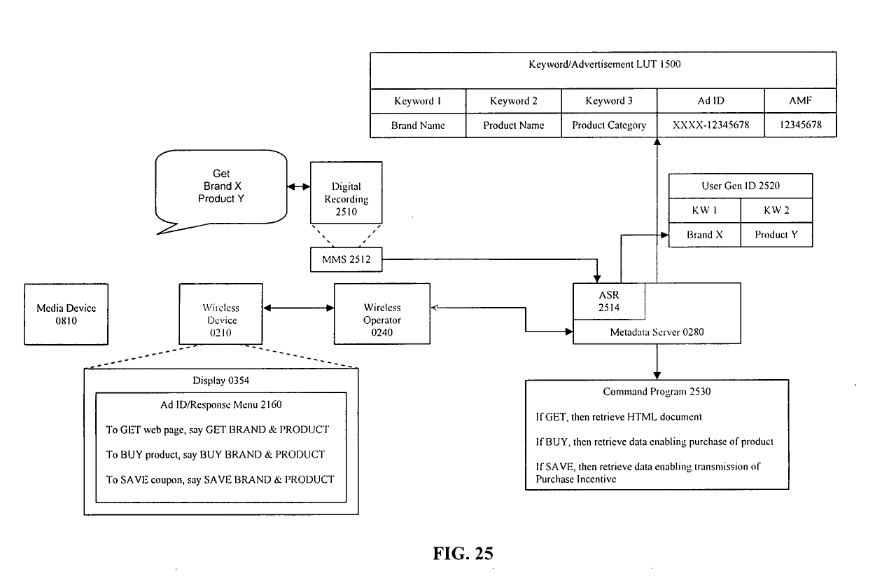

The present method describes how the Wireless Device 0210 user can select an option in Ad Response Menu at 0742. However, the system is not limited to that embodiment. The system can enable Wireless Device 0210 to display Ad Response Menu, instead of Option Menu, at 0718. This is described in more detail in connection with FIGS. 25-28.

FIG. 7C is a flowchart depicts the a method for enabling: (a) Wireless Device 0210 to connect to a Web Server through a Browser Application 0330; (b) the system to identify the Advertiser 0220 and/or Media Buyer 0222 to bill for the connection of Wireless Device 0210 to a Web Server in response to an Advertisement and/or Programming displayed on another Media Device and any entities to credit for enabling the connection; and/or (c) bill and/or credit the appropriate entities.

In some embodiments, a WD Click-Through can be defined as the act of Wireless Device 0210 exchanging any data with any resource capable of transmitting data or executing a transaction involving a product promoted in an Advertisement and/or Programming displayed on another Media Device. The resources can include, but are not limited to: (a) a Web Server; (b) a Call Center; (c) any other entity capable of processing a request for data or executing a transaction involving a product promoted in an Advertisement and/or Programming displayed on another Media Device, e.g., Metadata Server 0280; and/or (d) a POS System 0270.

A Media Device can click-through an Internet Advertisement by selecting the hyperlink of an object in a web page. The system can enable a Wireless Device 0210 to click-through an Advertisement and/or Programming displayed on another Media Device by: (a) receiving on Display 0354 data including at least the URL, phone number, or any other data enabling Wireless Device 0210 to connect to Advertiser 0220 and/or Media Buyer 0222; and/or (b) selecting the URL through any User Response Input.

FIG. 7D depicts the methods enabling: (a) Wireless Device 0210 to connect to a Call Center through a Voice Application 0328; (b) the system to identify the Advertiser 0220 and/or Media Buyer 0222 to bill for WD Click-Through to a Call Center and any entities to credit for enabling the WD Click-Through; and/or (c) bill and/or credit the appropriate entities.

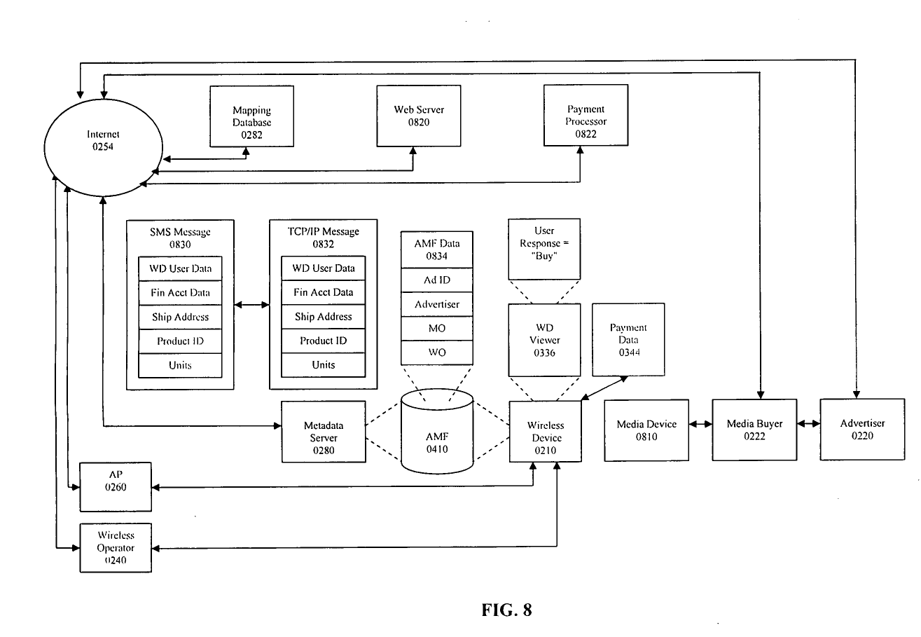

FIG. 7E depicts the methods enabling: (a) Wireless Device 0210 to connect to a Metadata Server 0280 to obtain more information about the product of interest or buy the product of interest; (b) the system to identify the Advertiser 0220 and/or Media Buyer 0222 to bill for the WD Click-Through enabled by Metadata Server 0280 and any entities to credit for enabling the WD Click-Through; and/or (c) bill and/or credit the appropriate entities. The flowchart is described with reference to the system depicted in FIG. 8. However, the flowchart is not limited to that embodiment. The system can implement the flowchart with reference to systems utilizing a subset of the components, or additional, related, alternative, and/or equivalent components depicted in FIG. 8.

FIG. 8 depicts a block diagram of an exemplary system enabling: (a) Wireless Device 0210 to connect to a Metadata Server 0280 to obtain more information about the product of interest or buy the product of interest; (b) the system to identify the Advertiser 0220 and/or Media Buyer 0222 to bill for the WD Click-Through enabled by Metadata Server 0280 and any entities to credit for enabling the WD Click-Through; and/or (c) bill and/or credit the appropriate entities. The system can utilize a subset of the following components, or additional, related, alternative, and/or equivalent components. The system can include, but is not limited to, the following components not disclosed earlier herein.

Media Device 0810 can be any Media Device displaying an Advertisement and/or Programming promoting a product of interest to Wireless Device 0210 user.

Web Server 0820 is a Data Processing System to which Wireless Device 0210 can connect by selecting one or more Internet Addresses included in Ad Metadata File 0410 and/or Program Metadata File 0510.

Payment Processor 0822 is a Data Processing System capable of processing any transaction enabling the purchase of one or more products offered for sale by Web Server 0820. Payment Processor 0822 can process a transaction utilizing any payment method, including, but not limited to: credit card; debit card; checking account; and/or Internet payment method.

SMS Message 0830 can include any data transmitted by Wireless Device 0210 to execute a request for more information about a product of interest or a request to buy the product of interest. The data can include, but are not limited to: data identifying the Wireless Device 0210 user, which a Web Server 0820 can require for billing and/or shipping purposes, e.g., the name, address, phone number, and/or email address; any financial account data included in Payment Data File 0344; any shipping address data included in Payment Data File 0344; any data uniquely identifying the product of interest, e.g., UPC; and/or any data identifying the number of units Wireless Device 0210 user wants to buy. In some embodiments, the system can include a SMS Message 0830. The system can enable Wireless Device 0210 to transmit data to execute a request for more information about a product of interest or a request to buy the product of interest in any messaging format or protocol.

TCP/IP Message 0832 can include any data transmitted by Wireless Device 0210 included in SMS Message 0830. Metadata Server 0280 can convert the data included in SMS Message 0830 into any format or protocol, e.g., TCP/IP, which can be processed by Web Server 0820.

AMF Data File 0834 can include any subset of data included in Ad Metadata File 0410. The data can include, but are not limited to, any additional data the present method can be configured to: (a) execute a request for more information about a product of interest or a request to buy the product of interest; and/or (b) identify the Advertiser 0220 and/or Media Buyer 0222 to bill for the WD Click-Through enabled by Metadata Server 0280 and any entities to credit for enabling the WD Click-Through.

For example, AMF Data File 0834 can include data uniquely identifying: (a) the Advertisement and/or Programming promoting the product of interest, e.g., the Ad-ID of the Advertisement; (b) the Advertiser 0220 and/or Media Buyer 0222 transmitting the Advertisement and/or Programming promoting the product of interest; (c) the Media Operator and/or Media Program displaying the Advertisement and/or Programming promoting the product of interest, e.g., a system code or broadcast call letter; and/or (d) the Wireless Operator 0240 transmitting any data, e.g., SMS Message 0830, enabling Wireless Device 0210 to obtain more information about the product of interest or buy the product of interest.

The system can enable any Data Processing System to generate AMF Data File 0834, including, but not limited to: Wireless Device 0210; and/or Metadata Server 0280. Wireless Device 0210 can generate AMF Data File 0834 by reading one or more data fields in Ad Metadata File 0410 and/or Program Metadata File 0510 received from Metadata Server 0280. Metadata Server 0280 can generate AMF Data File 0834 by reading one or more data fields in a copy of the Ad Metadata File 0410 and/or Program Metadata File 0510 it transmitted to Wireless Device 0210. Metadata Server 0280 can identify the Wireless Operator 0240 receiving the Wireless Device User Response from Wireless Device 0210 by reading the data in any header of the message received from Wireless Operator 0240 which identifies the specific Wireless Operator 0240. For example, if Metadata Server 0280 receives a Wireless Device User Response from Wireless Device 0210 transmitting or forwarding a TCP/IP message, Metadata Server 0280 can read the source address field in the message header. Metadata Server 0280 can then query a database of IP addresses and their associated entity to identify the specific Wireless Operator 0240 transmitting or forwarding the TCP/IP message.

The system can enable Metadata Server 0280 to identify the specific Ad Metadata File 0410 and/or Program Metadata File 0510 providing the data enabling Wireless Device 0210 to respond to the Advertisement and/or Programming of interest through a variety of means, including, but not limited to: Metadata Server 0280 assigning an unique code to each transmission of an Ad Metadata File 0410 and/or Program Metadata File 0510 to a Wireless Device 0210 (e.g., a Unique Transmission Code) and searching for the Unique Transmission Code in the Wireless Device User Response received from Wireless Device 0210.

In FIG. 7E, the system can implement the flowchart by executing a subset of the methods, executing the subsets of the methods in different order, and/or executing other or additional related or equivalent portions.

At 0744E, Wireless Device 0210 can call Program: WD 0338, which can read one or more data from Ad Metadata File 0410 and/or Program Metadata File 0510 and write the data to any file, e.g., a temporary file storing the data.

At 0746E, Program: WD 0338 can read from Payment Data File 0344 and/or any other file stored in Memory 0320 any data a Web Server 0820 can require for billing and/or shipping purposes.

At 0748E, Program: WD 0338 can associate in one or more messages any data read from Ad Metadata File 0410 and/or Program Metadata File 0510 with any data read in 0746E and any other data a Web Server 0820 can utilize to execute a request for more information about a product of interest or a request to buy the product of interest (collectively can be referred to as a Wireless Device User Response). The other data can include, but are not limited to: any data generated by Timer Module 0322; any data generated by Location Module 0324; and/or any data stored in WD User Activity 0340. Program: WD 0338 can utilize any messaging format or protocol, e.g., SMS, to transmit the Wireless Device User Response.

At 0750E, Metadata Server 0280 can convert the Wireless Device User Response from the messaging format or protocol utilized by Wireless Device 0210 into any format or protocol, e.g., TCP/IP, which can be processed by Web Server 0820.

At 0752E, Metadata Server 0280 can transmit the TCP/IP message to Web Server 0820.

At 0754E, Web Server 0820 can execute the transaction utilizing any method to generate a web page: (a) displaying information about the product of interest; or (b) confirming the purchase of the product of interest.

At 0756E, Web Server 0820 can transmit the web page to Metadata Server 0280.

At 0758E, Metadata Server 0280 can either: (a) forward the web page to Wireless Device 0210 in the original TCP/IP protocol; or (b) convert the web page into another messaging format or protocol for transmission to Wireless Device 0210.

At 0760E, Wireless Device 0210 can receive the TCP/IP message, SMS message, or the message in any other format or protocol and call an application capable of processing and displaying the data included in the web page.

At 0762E, Metadata Server 0280 can identify the Advertiser 0220 and/or Media Buyer 0222 to bill for WD Click-Through to a POS System 0270 and any entities to credit for enabling the WD Click-Through through a variety of means, including, but not limited to: (a) parsing the TCP/IP message received from Web Server 0820 if it includes the data Metadata Server 0280 originally associated in Wireless Device User Response, e.g., AMF Data File 0834; and/or (b) query one or more databases in Metadata Server 0280 including one or more records associating the data in AMF Data File 0834 with the Wireless Device User Response. Any of these methods should enable the system to identify Advertiser 0220, Media Buyer 0222, and/or any entities enabling the WD Click-Through associated with the specific Wireless Device 0210 action in response to the display of an associated Advertisement and/or Programming on another Media Device.

For example, the system can enable a Wireless Device 0210 user viewing a Television Advertisement to receive on Display 0354 a URL, phone number, or any other data enabling Wireless Device 0210 to connect to Advertiser 0220 and/or Media Buyer 0222 transmitting the Television Advertisement. After the user selects the URL, phone number, or other connection data, Wireless Device 0210 can include AMF Data File 0834 in the SMS Message 0830 it transmits to Metadata Server 0280. Metadata Server 0280 can read the fields in AMF Data File 0834 to identify: (a) the Advertiser 0220 and/or Media Buyer 0222 transmitting the Advertisement and/or Programming of interest; and/or (b) one or more entities enabling the WD Click-Through, including, but not limited to: (i) the Television Media Operator and/or Television Program transmitting the Advertisement and/or Programming of interest; (ii) the cable television operator transmitting the Advertisement and/or Programming of interest; and/or (iii) the Wireless Operator 0240 transmitting or forwarding the SMS Message 0830. In some embodiments, a Television Media Operator can be defined as a Media Operator capable of transmitting one or more Media Programs to a Television 0230. The system can distinguish between a Television Media Operator and a cable television operator capable of operating a physical network which can transmit signals carrying a plurality of Television Media Operator Programming.

At 0764E, Metadata Server 0280 can bill the identified Advertiser 0220 and/or Media Buyer 0222 for the WD Click-Through and credit any entities for enabling the WD Click-Through.

In some embodiments, the system can enable Metadata Server 0280 to execute a request from Wireless Device 0210 for more information about a product of interest or buy a product of interest without exchanging data with Web Server 0820 after Wireless Device 0210 transmits any given request. Metadata Server 0280 can cache from Web Server 0820 any web document presenting more information about a product of interest and/or any web document and/or web application enabling the purchase of a product of interest. For example, if Wireless Device 0210 user requests more information about a product of interest, Metadata Server 0280 can serve a web page it previously cached that is the resource identified by the URL included in Ad Metadata File 0410 and/or Program Metadata File 0510.

The benefits of utilizing the method described in FIGS. 7A, 7B, and 7E can include, but are not limited to, the following. First, the present method can enable Wireless Device 0210 user to obtain more information about a product of interest or buy a product of interest without calling an application, e.g., Browser Application 0330, which can require additional procedures and time required to process the transaction. For example, buying a product of interest through a Browser Application 0330 can require the following methods implemented by Wireless Device 0210 user: (a) Wireless Device 0210 user must select a function calling a Browser Application 0330; (b) Wireless Device 0210 user must move a cursor on Display 0354 to a box enabling the input of a URL; (c) Wireless Device 0210 user must input the URL and select, e.g., “Enter”; (d) Wireless Device 0210 must exchange with Web Server 0820 one or more web pages until Web Server 0820 presents the web page enabling the input of data processing the purchase of the product; (e) Wireless Device 0210 user must input the values specified by the web page, e.g., name, address, phone number, email address, and credit/debit account data and select, e.g., “Buy”; and (f) Web Server 0820 must return a web page confirming the product purchase.

In contrast, the present method can enable Wireless Device 0210 user to obtain more information about a product of interest or buy a product of interest in the following methods implemented by Wireless Device 0210 user: (a) Wireless Device 0210 user can input User Identification Input at 0722; (b) Wireless Device 0210 user can select an option, e.g., “Buy,” at 0742; and (c) Metadata Server 0280 can transmit data, e.g., a web page displayed in Browser Application 0330 or data displayed in WD Viewer 0336, confirming the product purchase at 0760E.

Second, by transmitting to and/or receiving from Web Server 0820 only the data it requires to process the transaction, the present method can exchange smaller files between a Wireless Device 0210 and BTS 0242 than exchanging web pages, which can reduce the amount of bandwidth required from Wireless Operator 0240. For example, a web page at Advertiser 0220 can display a large number of objects that are unnecessary to execute a request for more information about a product of interest or buy a product of interest. The present method can obviate the need to exchange these objects in any web page received by Wireless Device 0210 and/or transmitted by Wireless Device 0210 and thus reduce the amount of bandwidth required from Wireless Operator 0240.

FIG. 7F depicts the methods enabling: (a) Wireless Device 0210 to store any data enabling or facilitating the future purchase in a Physical Retailer of the product of interest; (b) the system to identify the Advertiser 0220 and/or Media Buyer 0222 to bill for WD Click-Through to a POS System 0270 and any entities to credit for enabling the WD Click-Through; and/or (c) bill and/or credit the appropriate entities.

At 0744F, Wireless Device 0210 can call Program: WD 0338, which can read one or more data from Ad Metadata File 0410 and/or Program Metadata File 0510 and write the data to Physical Retailer Data File 0346. The data can include, but are not limited to: any data identifying a product promoted in an Advertisement and/or Programming of interest, e.g., any data in category D in FIG. 4; any data describing a purchase incentive provided by Advertiser 0220 and/or Media Buyer 0222 to encourage the purchase of the product promoted in an Advertisement and/or Programming of interest, e.g., any data in category F in FIG. 4; and/or any data describing and/or code unique identifying an incentive provided by Advertiser 0220 and/or Media Buyer 0222 to encourage the sampling of the product promoted (e.g., a Sample Incentive). Physical Retailer Data File 0346 can store one or more records of products for which the Wireless Device 0210 user has selected to save data, e.g., Purchase Incentive.

At 0746F, Wireless Device 0210 user can enter a Physical Retailer.

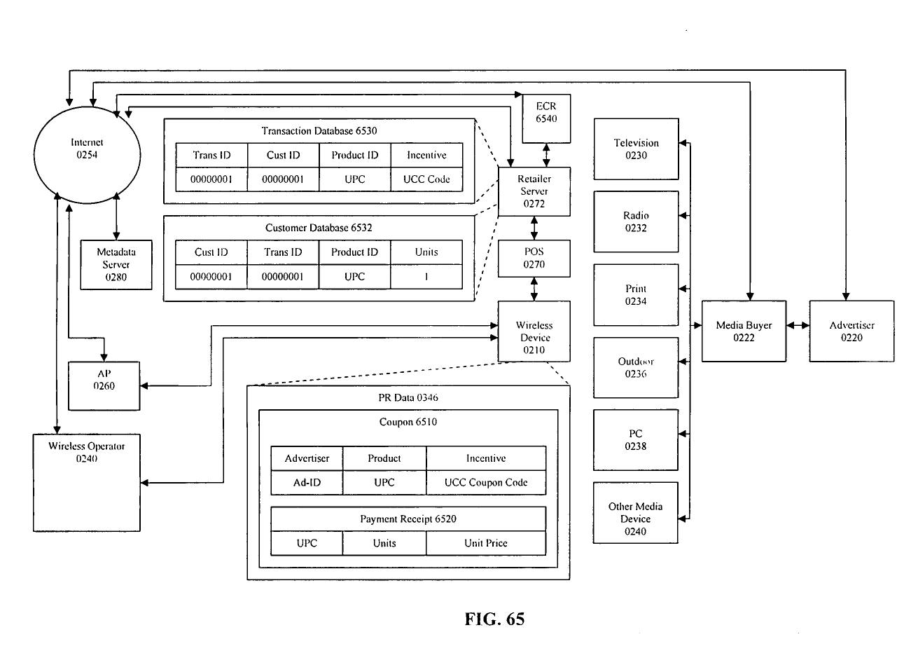

At 0748F, Wireless Device 0210 can exchange with Retailer Server 0272 through any wireless network, e.g., a wireless LAN operated by the Physical Retailer, any data enabling Wireless Device 0210 to identify any products available in the Physical Retailer which match any products stored in Physical Retailer Data File 0346. For example, Retailer Server 0272 can include one or more databases described in more detail in FIG. 65, which can contain a Product ID uniquely identifying the products available for sale in Physical Retailer. If any of the products stored in Physical Retailer Data File 0346 with a Product ID matching the Product ID of any of the products stored in a Retailer Server 0272 database, then Wireless Device 0210 can generate an alert to the user notifying him/her of the presence of the products at the given Physical Retailer.

At 0750F, Wireless Device 0210 can exchange with any product through any I/O Device, e.g., RFID Antenna 0394, any data enabling Wireless Device 0210 to identify any products available in the Physical Retailer within range of the I/O Device which match any products stored in Physical Retailer Data File 0346. Exchanging the data can enable Wireless Device 0210 to generate an alert to the user notifying him/her of the presence of the products within range of the I/O Device, e.g., when the Wireless Device 0210 passes a shelf including a product with a RFID tag read by the Wireless Device 0210 RFID reader 0394.

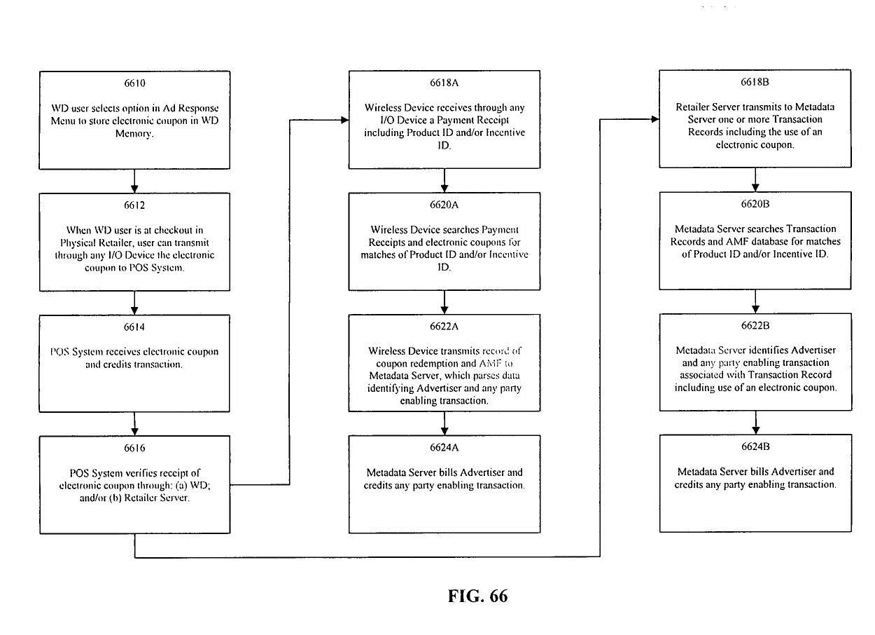

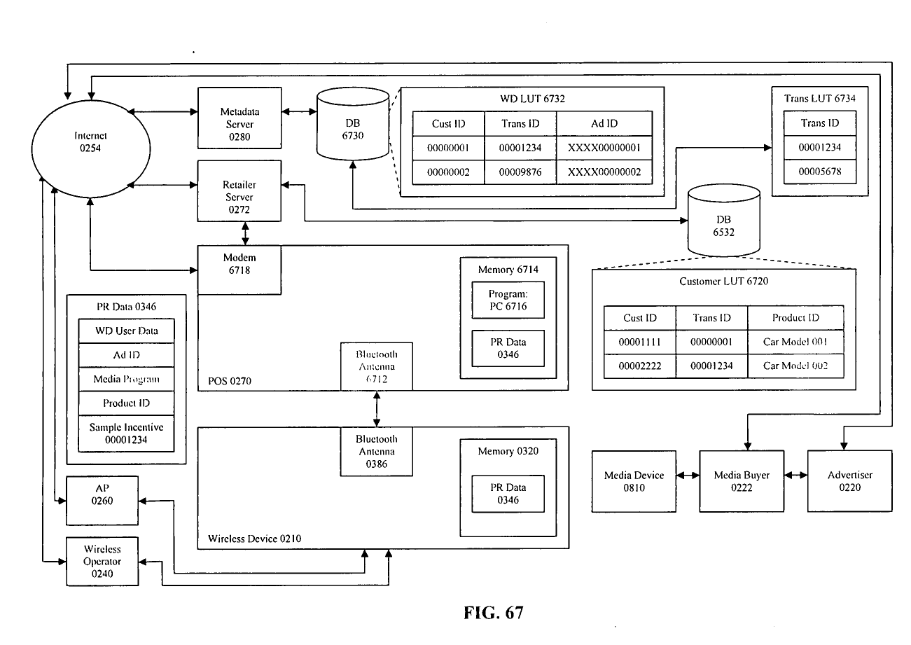

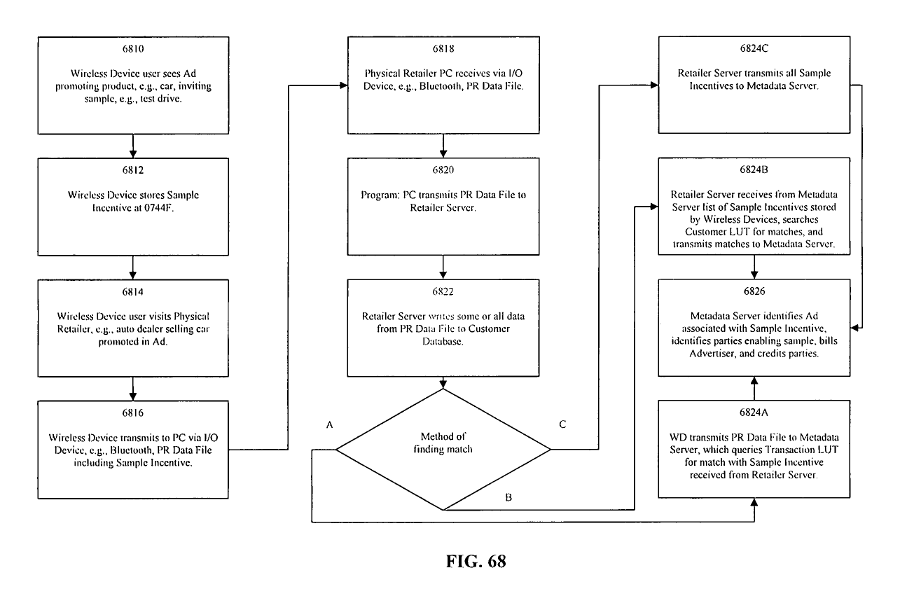

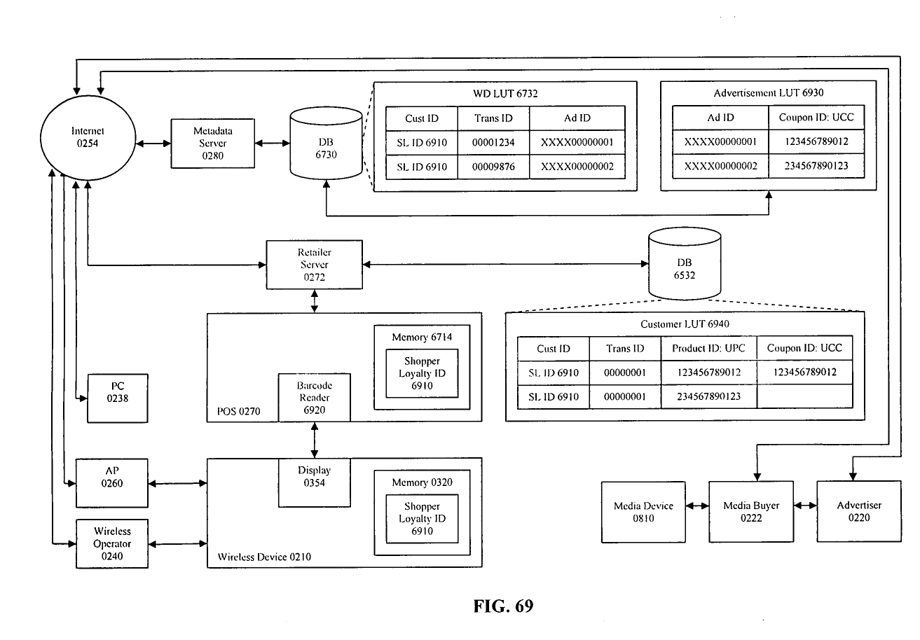

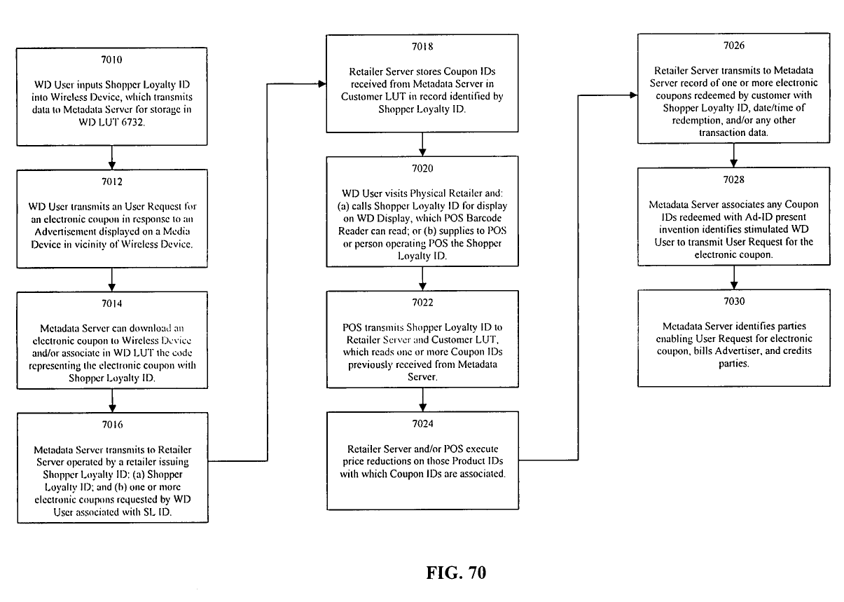

At 0752F through 0760F, the present method can implement methods described in more detail in FIG. 66.

Method 0700 can enable Wireless Device 0210 to buy a variety of products promoted in an Advertisement and/or Programming displayed on another Media Device, including, but not limited to: (a) a digital product which can be downloaded to Wireless Device 0210 and/or any other Media Device; (b) a physical good which can be delivered to Wireless Device 0210 user at any physical address specified by the user; and/or (c) a service which can be consumed by Wireless Device 0210 user at any physical location specified by the user.

An exemplary implementation of the purchase of a digital product can include the following methods implemented by Wireless Device 0210 user which are processed by Method 0700: (a) after seeing a Television Advertisement promoting a digital product, Wireless Device 0210 user can input User Identification Input identifying the Television Media Operator displaying the Television Advertisement at 0722; (b) Wireless Device 0210 user can select an option, e.g., “Buy,” to buy the digital product at 0742; and (c) Metadata Server 0280 can download to Wireless Device 0210 the purchased digital product at 0760E.

An exemplary implementation of the purchase of a physical good can include the following methods implemented by Wireless Device 0210 user which are processed by Method 0700: (a) after seeing a Television Advertisement promoting a physical product, e.g., pizza offered for delivery, Wireless Device 0210 user can input User Identification Input identifying the Television Media Operator displaying the Television Advertisement at 0722; (b) Wireless Device 0210 user can select an option, e.g., “Buy,” to buy the pizza at 0742; and (c) Metadata Server 0280 can transmit to Wireless Device 0210 data confirming the pizza purchase at 0760E. Method 0700 can enable Web Server 0820 to implement the delivery of the pizza to the shipping address data included in Payment Data File 0344.

An exemplary implementation of the purchase of a service can include the following methods implemented by Wireless Device 0210 user which are processed by Method 0700: (a) after seeing a Television Advertisement promoting a service, e.g., scheduling a test drive of an automobile promoted in the Advertisement, Wireless Device 0210 user can input User Identification Input identifying the Television Media Operator displaying the Television Advertisement at 0722; (b) Wireless Device 0210 user can select an option, e.g., “Sample,” to schedule a test drive at 0742; (c) Metadata Server 0280 can transmit to Wireless Device 0210 data, e.g., a web page displayed in Browser Application 0330 or data displayed in WD Viewer 0336, offering the user the ability to input the date and time he/she wishes to schedule a test drive at any given automobile dealer at 0760E; and/or (d) Program: WD 0338 can read any data specifying the date/time and/or location selected by Wireless Device 0210 user and write the data in Calendar 0326.

2.7 Overall Method where a First Media Device can Exchange Data with a Second Media Device

The system can enable Wireless Device 0210 to exchange any data with another Media Device through a variety of means, including, but not limited to: (a) directly from one or more I/O Devices of the Media Device displaying the Advertisement and/or Programming; and/or (b) from any Data Processing System in the network transmitting the Advertisement and/or Programming to the Media Device, e.g., the Headend Server transmitting the Advertisement to a Television 0230 or a radio broadcast antenna transmitting the Advertisement to a Radio 0232. The data Wireless Device 0210 can exchange with another Media Device can include, but are not limited to: (a) transmitting any request for data from Metadata Server 0280, Advertiser 0220, and/or Media Buyer 0222; and/or (b) receiving Ad Metadata File 0410 and/or Program Metadata File 0510 associated with an Advertisement and/or Programming displayed on the Media Device.

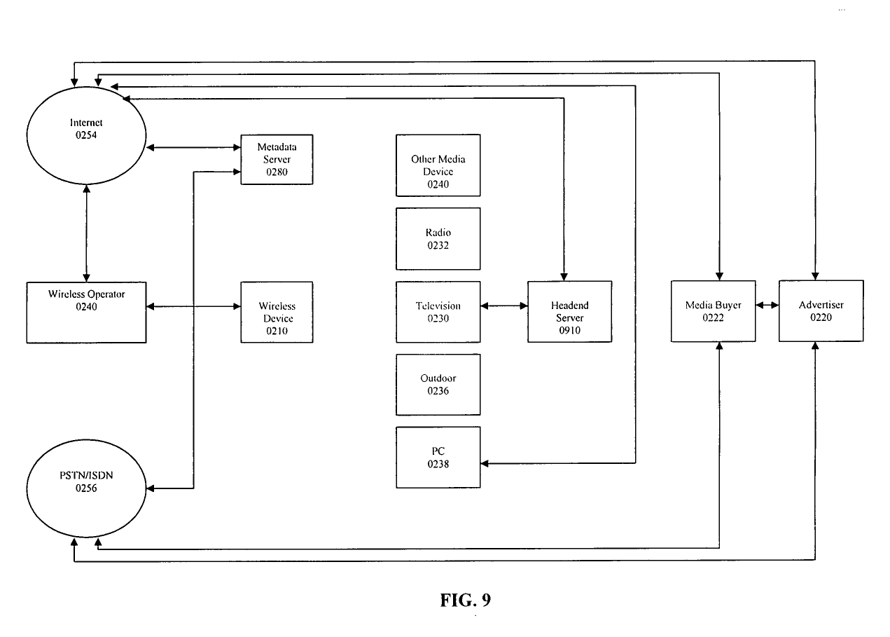

FIG. 9 depicts a high-level block diagram of an exemplary system enabling any Media Device, e.g., a Wireless Device 0210, to interact with content displayed on another Media Device and purchase or facilitate the purchase of a product promoted on the other Media Device by exchanging data with the other Media Device. The system can be configured to utilize a subset of the following components, or additional, related, alternative, and/or equivalent components. The system can include, but is not limited to, the following components not disclosed earlier herein.

Headend Server 0910 is a Data Processing System which can perform a variety of functions, including, but not limited to: exchanging data with one or more STB 1910 and any other Data Processing System operated by a Television Operator or any other entity, e.g., Metadata Server 0280.

While not shown in FIG. 9, other Data Processing Systems can perform functions similar or comparable to Headend Server 0910 by exchanging data between a Media Device and Metadata Server 0280. For example, Outdoor 0236 can be an electronic billboard capable of exchanging data with another Data Processing System through a WAN, e.g., the Internet. Outdoor 0236 can connect to a Data Processing System performing functions comparable to Headend Server 0910 enabling Outdoor 0236 to transmit and/or receive data with Metadata Server 0280.

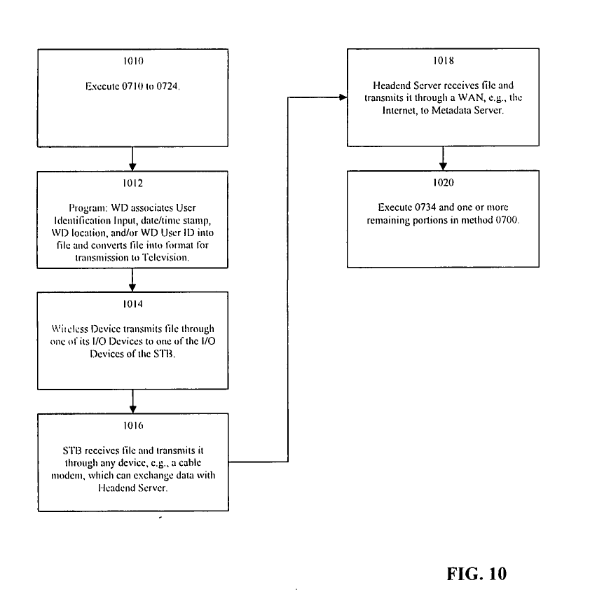

FIG. 10 depicts a flowchart of an exemplary Method 1000 for enabling any Media Device, e.g., a Wireless Device 0210, to interact with content displayed on another Media Device and purchase or facilitate the purchase of a product promoted on the other Media Device by exchanging data with the other Media Device. In some embodiments, a Wireless Device 0210 can be configured to exchange data with a STB. However, the system is not limited to that embodiment. The system can support the exchange of data between a Wireless Device 0210 and any Media Device. The flowchart is described with reference to the system depicted in FIG. 9. However, the flowchart is not limited to that embodiment. The system can implement the flowchart with reference to systems utilizing a subset of the components, or additional, related, alternative, and/or equivalent components depicted in FIG. 9.

Most of the systems, methods, apparatuses, and computer program products disclosed in the system can enable a Wireless Device 0210 to exchange data with a Metadata Server 0280, Advertiser 0220, and/or Media Buyer 0222 through a Wireless Operator 0240. However, the system is not limited to that embodiment. The system can apply the disclosed systems, methods, apparatuses, and computer program products to enable a Wireless Device 0210 to exchange any data with Metadata Server 0280, Advertiser 0220, and/or Media Buyer 0222 through a Media Device and any Data Processing Systems, e.g., Headend Server 0910, connecting the Media Device to a network, e.g., the Internet.

### 3.1.4 Content of AMF/PMF

The system can enable a variety of methods of identifying any data constituting Ad Metadata File 0410 and/or Program Metadata File 0510, including, but not limited to: (a) reading any data from Ad Metadata File 0410 and/or Program Metadata File 0510 provided by Advertiser 0220 and/or Media Buyer 0222; and/or (b) reading any data from: (i) the Advertisement and/or Programming displayed on a Media Device; and/or (ii) any communications channel transmitting data about the Advertisement and/or Programming displayed on a Media Device.

A typical Advertisement transmitted to a Television 0230 and/or Print 0234 displays somewhere in the Advertisement a communications address, e.g., URL and/or phone number, which the Advertiser 0210 wants a viewer to visit or call. The system can utilize any method of searching through a media file and extracting certain data. The system can transmit any communications address extracted from a media file and write the data to an Ad Metadata File 0410 and/or Program Metadata File 0510 associated with the searched Advertisement and/or Programming.

### 3.3 Lookup Tables

The system can utilize one or more LUTs, each of which can include a variety of data, including, but not limited to: (a) any User Generated Identification Data, including, but not limited to, one or more logical channel numbers to which a Media Device displaying an Advertisement and/or Programming of interest is tuned, and/or one or more Keywords/Keyphrases that can enable Metadata Server 0280 to narrow the range of Advertisements and/or Programming of interest; (b) any Wireless Device Generated Identification Data, including, but not limited to, one or more Fingerprints or subsets of Fingerprints summarizing any object in any data type constituting part or all of an Advertisement and/or Programming transmitted by any Media Operator, one or more RF carrying a program stream of an Advertisement and/or Programming displayed on a Television 0230, Radio 0232, and/or any other Media Device, and/or one or more remote control codes identifying and/or facilitating the identification of the logical channel to which a Media Device displaying an Advertisement and/or Programming of interest is tuned; (c) any data associating the location of a logical channel number and a Media Operator for any given operator of a television system, radio system, or any other system capable of transmitting Advertisement and/or Programming; (d) any data identifying one or more Media Operators transmitting Advertisement and/or Programming; (e) any data identifying one or more Advertisements and/or Programming; (f) any data describing one or more Advertisements and/or Programming; (g) any data identifying the date/time at which one or more Media Operators is transmitting an Advertisement and/or Programming; and/or (h) one or more Ad Metadata Files 0410 and/or Program Metadata Files 0510 or any subset of the data included in Ad Metadata File 0410 and/or Program Metadata File 0510.

The system can include a variety of LUTs, including, but not limited to: Channel/Operator LUT 1300; Fingerprint/Operator LUT 1400; Operator/Advertisement/Programming LUT 1500; Advertisement/Programming/AMF/PMF LUT 1600; and/or any other table desirable to enable the identification of the Ad Metadata File 0410 and/or Program Metadata File 0510 associated with the Advertisement and/or Programming displayed on a Media Device in the vicinity of Wireless Device 0210. A system and methods can be configured to utilize separate Channel/Operator LUT 1300, Fingerprint/Operator LUT 1400, Operator/Advertisement/Programming LUT 1500, and/or Advertisement/Programming/AMF/PMF LUT 1600. In some embodiments, a system including any single table or combination of tables including data in one or more of the above tables can also be supported.

The LUTs included in the system can include data provided by any party, including, but not limited to: Advertiser 0220; Media Buyer 0222; any Media Operator; Retailer Server 0272; Metadata Server 0280; and/or any other Data Processing System.

### 3.3.1 Media Operator LUT

### 3.3.1.1 User Generated Identification Data

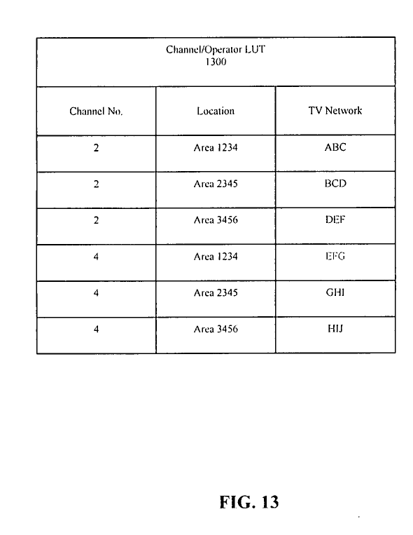

FIG. 13 depicts an exemplary data structure Channel/Operator LUT 1300, which can include a variety of data, including, but not limited to: one or more records with data identifying a channel number; a geographical area of a Television Operator, e.g., a cable television operator or direct broadcast satellite television operator; and/or any data identifying the Media Operator assigned by the Television Operator to the channel number. In some embodiments, Channel/Operator LUT 1300 can include data related to a Television Operator and/or Television Media Operator. Channel/Operator LUT 1300 can include data enabling the identification of any Media Operator.

### 3.3.1.2 Wireless Device Generated Identification Data

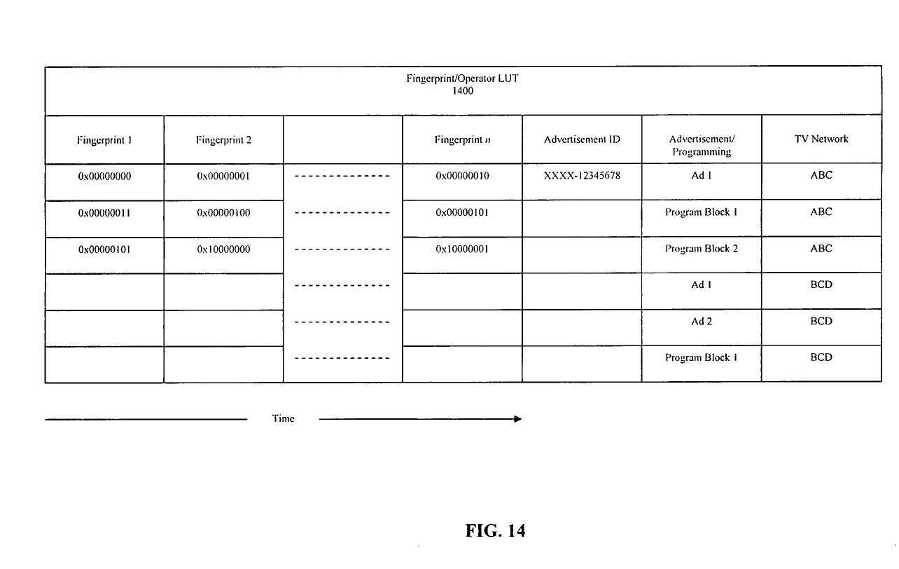

FIG. 14 depicts an exemplary data structure Fingerprint/Operator LUT 1400, which can include a variety of data, including, but not limited to: one or more records with data including one or more Fingerprints or subsets of Fingerprints summarizing any object in any data type constituting part or all of an Advertisement and/or Programming transmitted by any Media Operator; any data uniquely identifying an Advertisement and/or Programming; any data describing an Advertisement and/or Programming; and/or any data identifying the Media Operator. In some embodiments, Fingerprint/Operator LUT 1400 can include data related to a Television Operator and/or Television Media Operator. Fingerprint/Operator LUT 1400 can include data enabling the identification of any Media Operator.

### 3.3.2 Media Operator and Advertisement/Programming LUT

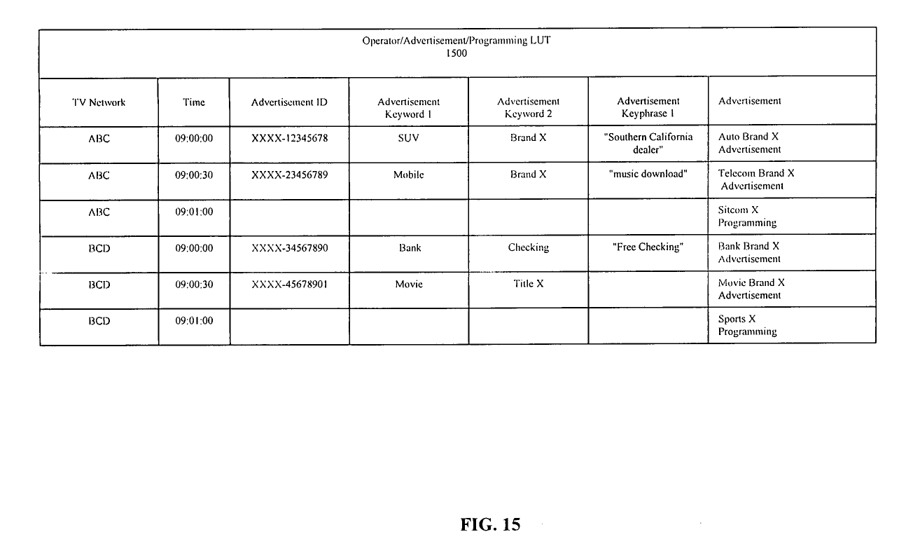

FIG. 15 depicts an exemplary data structure Operator/Advertisement/Programming LUT 1500, which can include a variety of data, including, but not limited to: one or more records with data identifying a Media Operator; data identifying a Media Program; data identifying the date/time the Media Operator transmits an Advertisement and/or Programming for display on any given Media Device; any data uniquely identifying an Advertisement and/or Programming; one or more Keywords/Keyphrases associated with the product, brand, and/or vendor promoted in the Advertisement and/or Programming; and/or any data describing an Advertisement and/or Programming. In some embodiments, Operator/Advertisement/Programming LUT 1500 can include data related to a Television Operator, Television Media Operator, and/or Television Media Program. Operator/Advertisement/Programming LUT 1500 can include data enabling the identification of any Media Operator and/or Media Program. In the case of a Print Publication 0234, LUT 1500 can include data specifying one or more Print Publications 0234 and one or more Advertisements and/or Programming displayed in any given issue or edition of a Print Publication 0234. For example, LUT 1500 can include one or more records including data identifying the name of a Print Publication 0234, an issue date, a page number, and/or one or more Advertisements and/or Programming displayed on the page number. If a Wireless Device 0210 user transmits Keywords/Keyphrases identifying the name of the Print Publication 0234, the issue date, the page number, the name of the vendor, brand, product, and/or product category, the system can utilize the Keywords/Keyphrases to identify the product of interest and/or the Advertisement promoting the product of interest.

### 3.3.3 Advertisement/Programming and AMF/PMF LUT

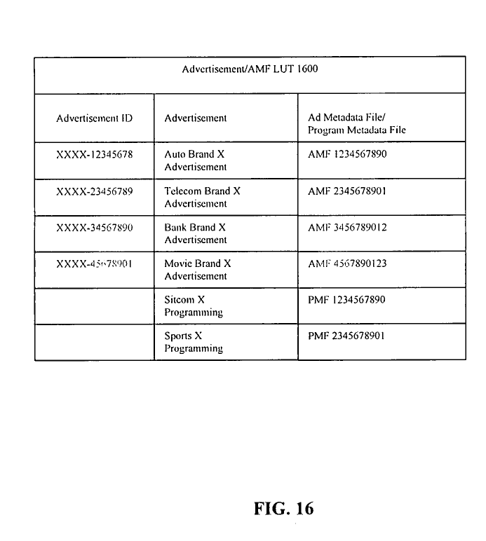

FIG. 16 depicts an exemplary data structure Advertisement/Programming/AMF/PMF LUT 1600, which can include a variety of data, including, but not limited to: one or more records with data uniquely identifying an Advertisement and/or Programming; data describing an Advertisement and/or Programming; and the Ad Metadata File 0410 and/or Program Metadata File 0510 associated with the Advertisement and/or Programming.

In some embodiments, LUT 1600 and/or any other LUT can include data provided by any Data Processing System, e.g., Advertiser 0220 and/or Media Buyer 0222. LUT 1600 and/or any other LUT can include data describing an Advertisement and/or Programming generated after receiving Ad Metadata File 0410 and/or Program Metadata File 0510. For example, Ad Metadata File 0410 can include the URL or phone number displayed in the associated Advertisement. In some embodiments, Metadata Server 0280 or any other Data Processing System can scan any given Advertisement as a Media Operator is transmitting the Advertisement, read the URL and/or phone number displayed in the Advertisement, and/or write the URL and/or phone number into LUT 1600 and/or any other LUT in a record including data describing the Advertisement.

### 4. Wireless Device User Setup

### 5. Wireless Device Request for Data about Advertisement and/or Programming

5.1 Identification of Advertisement and/or Programming

The system can identify the Advertisement and/or Programming of interest to Wireless Device 0210 user through generating, transmitting, processing, and/or receiving a plurality of data, including, but not limited to: (a) Wireless Device Generated Identification Data, i.e., data generated automatically by Wireless Device 0210 in response to an event; and/or (b) User Generated Identification Data, i.e., data generated by the Wireless Device 0210 user, which he/she can input into Wireless Device 0210 through one or more I/O Devices.

### 5.1.1 Wireless Device Generated Identification Data

The system can support a variety of means of identifying through one or more I/O Devices of Wireless Device 0210 receiving, generating, collecting, and/or retrieving data: (a) an Advertisement and/or Programming of interest to Wireless Device 0210 user; and/or (b) the Media Operator and/or Media Program displaying an Advertisement and/or Programming of interest to Wireless Device 0210 user. These means include, but are not limited to: detecting a Watermark and/or Fingerprint of a video signal; detecting a Watermark and/or Fingerprint of an audio signal; detecting a Watermark and/or Fingerprint of an audio-video signal; detecting data carried in a radio, infrared, or other electromagnetic signal transmitted by the Media Device displaying an Advertisement and/or Programming of interest to the Wireless Device 0210 user; detecting an unintentional electromagnetic signal emitted by the Media Device displaying an Advertisement and/or Programming of interest to the Wireless Device 0210 user; and/or detecting an infrared or other electromagnetic signal transmitted by the Wireless Device 0210 and/or a Remote Control Device.

By receiving, generating, collecting, and/or retrieving User Generated Identification Data, Wireless Device Generated Identification Data, and/or Network Identification Data, the system can identify the Advertisement and/or Programming of interest to Wireless Device 0210 user and/or Media Operator and/or Media Program displaying an Advertisement and/or Programming of interest to an user of Wireless Device 0210 and lookup the associated Ad Metadata File 0410 and/or Program Metadata File 0510 for transmission to the Wireless Device 0210 user.

The system can utilize existing methods of watermarking and fingerprinting to identify the Advertisement and/or Programming of interest to a Wireless Device 0210 user. Existing methods can detect Fingerprints despite a variety of sources of degradation or change in the sampled signal, including, but not limited to: lack of synchronization between the extracted Fingerprint and the Fingerprints stored in a database; pitching, i.e., the playing of the sampled signal at a speed faster or slower than the stored signal; equalization; DAC; ADC; compression; decompression; and/or background noise.

The system can utilize a variety of means of obtaining a sampled signal for extraction of one or more Fingerprints, including, but not limited to: (a) Wireless Device 0210 recording a sample received through one or more I/O Devices and transmitting to Metadata Server 0280 the sample in raw format, e.g., 16 bit PCM; (b) Wireless Device 0210 recording a sample received through one or more I/O Devices and extracting one or more Fingerprints from the sample before transmission of the Fingerprint to Metadata Server 0280. In addition, the system can support Wireless Device 0210 recording a sample received through one or more I/O Devices, extracting one or more Fingerprints from the sample, matching the Fingerprint extracts with Fingerprints stored in a database located at Wireless Device 0210, and transmitting any metadata associated with the matching Advertisement and/or Programming to Metadata Server 0280.

The system can support the reception, processing, storage, and/or transmission of Fingerprints represented in any form, including, but not limited to: representation of Fingerprints as bit strings; and/or representation of Fingerprints as vectors of real numbers, where each vector component expresses the weight of a given perceptual feature of the sampled signal.

The system can support a variety of means of detecting a Watermark or Fingerprint of a video and/or audio signal, including, but not limited to: (a) recording or extracting a Watermark or Fingerprint of a video and/or audio signal generated from the same source as the video and/or audio signal transmitted to Metadata Server 0280 and/or another Data Processing System generating a Watermark or Fingerprint database against which the extracted Watermark or Fingerprint can be matched; and/or (b) recording or extracting a Watermark or Fingerprint of a video and/or audio signal generated from a different source than the video and/or audio signal transmitted to Metadata Server 0280 and/or another Data Processing System generating a Watermark or Fingerprint database against which the extracted Watermark or Fingerprint can be matched.

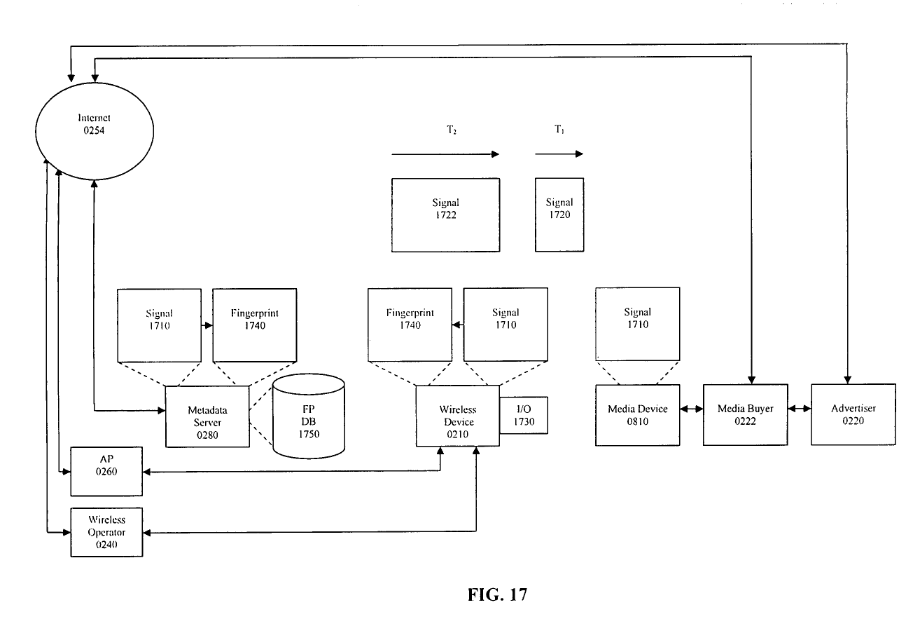

FIG. 17 depicts a block diagram of an exemplary system enabling the identification of an Advertisement displayed on a Media Device by utilizing a fingerprinting system. The system can implement the system by utilizing a subset of the following components, or additional, related, alternative, and/or equivalent components. The system can include, but is not limited to, the following components not disclosed earlier herein.

Signal 1710 can be a signal carrying data representing an Advertisement and/or Programming received by Wireless Device 0210, including an Advertisement and/or Programming of interest to Wireless Device 0210 user. Signal 1710 can be in any form, including, but not limited to: audio; video; image; text; symbol, e.g., a barcode; and/or any combination thereof. For example, Signal 1710 can be an audio signal transmitted by Television 0230 or Radio 0232. Signal 1710 can be in the form of a mechanical wave or electromagnetic wave. A mechanical wave can include, but is not limited to, a sound wave. An electromagnetic wave can include, but is not limited to, a radio wave.

The system can enable Wireless Device 0210 to record utilizing one or more I/O Devices a Signal 1710, which can be a sample of the Advertisement and/or Programming of interest. The sample can be a subset of the Advertisement and/or Programming or a copy of the entire Advertisement and/or Programming.

Signal 1720 and Signal 1722 can be a signal representing a subset or a copy of the entire Advertisement and/or Programming of interest in any dimension, including, but not limited to: time; frequency; space; and/or any combination thereof. Signal 1720 can be a signal representing a subset or a copy of the entire Advertisement of interest along the time dimension, e.g., a copy of the Advertisement of interest representing a fraction of the entire duration of the Advertisement. In the present embodiment, T₁ is a length of time of Signal 1720, which is shorter than the length of time, T₂, of Signal 1722. Signal 1720 can be a signal representing a subset or copy of the entire Advertisement of interest along the frequency dimension, e.g., a copy of the Advertisement of interest representing a fraction of the signal carrying the entire frequency transmissions of the Advertisement of interest. Signal 1720 can be a signal representing a subset or copy of the entire Advertisement of interest along the space dimension, e.g., a copy of the Advertisement of interest representing a fraction of the image of the Advertisement. For example, Signal 1720 can be a portion of the image of an Advertisement displayed on a Television 0230 or Print publication.

I/O Device 1730 can be any I/O Device connected to or integrated with Wireless Device 0210 capable of receiving, recording, and/or processing any Signal 1710.

Fingerprint 1740 can be any Fingerprint extracted from Signal 1710 by Wireless Device 0210, Metadata Server 0280, and/or another Data Processing System.

Fingerprint Database 1750 can be any database storing one or more Fingerprints of one or more Advertisements and/or Programming transmitted to one or more Media Devices 0810.

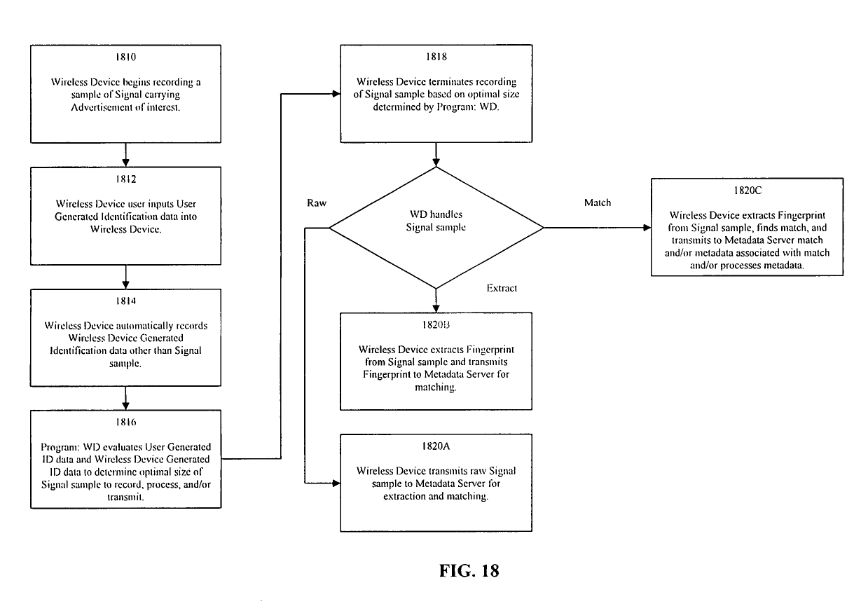

FIG. 18 depicts a flowchart of an exemplary Method 1800 enabling the identification of an Advertisement displayed on a Media Device by utilizing a fingerprinting system. The flowchart is described with reference to the system depicted in FIG. 17. However, the flowchart is not limited to that embodiment. The system can be configured to implement the flowchart with reference to systems utilizing a subset of the components, or additional, related, alternative, and/or equivalent components depicted in FIG. 17. The system can implement the flowchart by executing a subset of the methods, executing the subsets of the methods in different order, and/or executing other or additional related or equivalent portions.

At 1810, Wireless Device 0210 can begin recording a sample of Signal 1710 carrying data representing an Advertisement and/or Programming of interest to Wireless Device 0210 user.

The system can support Method 1800 recording a sample of Signal 1710 carrying data representing not only an Advertisement and/or Programming of interest, but any other Advertisement and/or Programming transmitted at any time after the transmission of the Advertisement and/or Programming of interest. An Advertiser 0220 and/or Media Buyer 0222 typically produces an Advertisement and/or Programming for display on a Television 0230, Radio 0232, and other Media Devices displaying Advertisements in video form which is usually no longer than one minute or 30 seconds. Because of the short duration of most Television and Radio Advertisements, a Wireless Device 0210 user will typically not think about obtaining more information about a product of interest or buying the product of interest until after the Advertisement terminates. By recording any Advertisement and/or Programming that succeeds the transmission of the Advertisement and/or Programming of interest, especially the Advertisements and/or Programming immediately succeeding the Advertisement and/or Programming of interest, the system can identify the Media Operator transmitting the Media Program viewed by Wireless Device 0210 user and facilitate the identification of the Advertisement and/or Programming of interest.

At 1812, Wireless Device 0210 user can input any User Generated Identification Data into Wireless Device 0210.

At 1814, Wireless Device 0210 can automatically record any Wireless Device Generated Identification Data in response to an event, e.g., an User Initiating Input.

At 1816, Program: WD 0338 can evaluate any User Generated Identification Data and/or Wireless Device Generated Identification Data received by Wireless Device 0210 to determine a desirable size of the sample of Signal 1710 Wireless Device 0210 can record to meet one or more objectives of the system, e.g., identify the Advertisement and/or Programming of interest.

At 1818, Wireless Device 0210 can terminate the recording of the sample of Signal 1710 based on a desirable size determined by Program: WD 0338. Wireless Device 0210 can terminate the recording of the sample of Signal 1710 along any dimension, including, but not limited to: terminate the recording of an audio Signal 1710 after the time determined by Program: WD 0338; terminate the recording of an audio or video Signal 1710 within the frequency range determined by Program: WD 0338; and/or limit the size of the image Signal 1710 to the size determined by Program: WD 0338.

Depending on the option selected by Wireless Device 0210 at 1818, the present method can enable Wireless Device 0210 to implement additional methods for different options selected. The different options can include, but are not limited to: (a) at 1820A, Wireless Device 0210 transmitting the raw sample of Signal 1710 to Metadata Server 0280 for extraction and matching of one or more Fingerprints; or Wireless Device 0210 compressing the raw sample of Signal 1710 and transmitting the compressed data to Metadata Server 0280; (b) at 1820B, Wireless Device 0210 extracting one or more Fingerprints from the sample of Signal 1710 and transmitting the Fingerprints to Metadata Server 0280 for matching of Fingerprints at 1820B; or (c) at 1820C, Wireless Device 0210: (i) extracting one or more Fingerprints from the sample of Signal 1710; (ii) matching one or more of the Fingerprints of Signal 1710 sample with Fingerprints in a Fingerprint database stored at Wireless Device 0210, and/or (iii) transmitting to Metadata Server 0280 the matching Fingerprints and/or metadata associated with the matching Fingerprint or processing locally the metadata associated with the matching Fingerprint, e.g., writing into Browser Application 0330 any URL included as metadata associated with the matching Fingerprint.

The size of the Fingerprint database required by the system can be limited to the Fingerprints of the Advertisements and/or Programming transmitted at any given time, T₀, and for some time, T (original ID period), immediately after T₀. The typical Wireless Device 0210 user is most likely to request more information about a product of interest or buy a product of interest within a short time period after the display of the Advertisement and/or Programming promoting the product of interest. T (original ID period) will probably vary depending on the Media Device displaying the Advertisement and/or Programming of interest. For example, a Wireless Device 0210 user will probably request more information about a product of interest or buy a product of interest within minutes of the display on a Television 0230 or Radio 0232 of the Advertisement and/or Programming of interest.

The increasing utilization of DVRs can enable the viewing by a Wireless Device 0210 user of an Advertisement and/or Programming of interest after the time when a Media Operator originally transmitted the Advertisement and/or Programming (e.g., a Time-Shifted Viewing). In the case of Time-Shifted Viewing, the system can require the storage of Fingerprints for Advertisements and/or Programming transmitted for a time period, T (time-shifted ID period), which will probably be longer than T (original ID period). However, because most consumers typically view Advertisements and/or Programming recorded for Time-Shifted Viewing a few days after a Media Operator originally transmitted the Advertisement and/or Programming, T (time-shifted ID period) will probably be no longer than a few days.

There are existing methods of recording a sample of any information signal, extracting a fingerprint from the sample, and/or searching for matching fingerprints in a fingerprint database. The benefits of Method 1800 can include, but are not limited to: helping generate a desirable size of the sample of the signal a Wireless Device 0210 can record in order to meet one or more objectives described in more detail in Section 5.1.3, e.g., generating a P_{FP} below any given threshold T_{ID}, or reduce R in the form of wireless network capacity.

In some embodiments, the system can implement Method 1800 by transmitting any User Generated Identification Data and/or Wireless Device Generated Identification Data, e.g., a sample of Signal 1710, over a voice channel setup by Wireless Device 0210 to Metadata Server 0280, instead of recording the User Generated Identification Data and/or Wireless Device Generated Identification Data and then transmitting the recorded data to Metadata Server 0280. In the case of transmitting any User Generated Identification Data and/or Wireless Device Generated Identification Data over a voice channel, Metadata Server 0280 can process the data, e.g., Metadata Server 0280 can extract and match one or more Fingerprints.

### 5.1.1.1 Media Device Video Transmission

### 5.1.1.1.1 Video Watermark

The system can utilize any method to detect any Watermark in a video Signal 1710. The system can support a Wireless Device 0210 utilizing one or more I/O Devices, e.g., Camera 0374, to receive a video Signal 1710 including a Watermark. The Watermark can include any data which can be included in an Ad Metadata File 0410 and/or Program Metadata File 0510. The system can support the extraction of data, including, but not limited to, MO Identification Data: Watermark, and/or MP Identification Data Watermark, described herein, by any Data Processing System, including, but not limited to: Wireless Device 0210, and/or Metadata Server 0280, which can receive the Watermark through any communications channel from Wireless Device 0210.

In some embodiments, MO Identification Data can be: Watermark as any data included in any Watermark from any signal type, including, but not limited to, video, image, audio, and/or text, which can identify the Media Operator transmitting the Advertisement and/or Programming displayed. In some embodiments, MP Identification Data can be: Watermark from any signal type as any data included in any Watermark which can identify the Media Program displayed.

### 5.1.1.1.1 Video Fingerprint

The system can utilize any method to generate, extract, and/or detect a Fingerprint from and/or in a video Signal 1710. The system can support a Wireless Device 0210 utilizing one or more I/O Devices, e.g., Camera 0374, to receive a video Signal 1710 from which the Wireless Device 0210 can extract a Fingerprint. For example, one existing method includes the following methods: (a) decode video from a file or grabber card; (b) compute a series of bit strings called sub-Fingerprints derived from the decoded video file; and (c) transmit the sub-Fingerprints to a Fingerprint-matching server, which can matches the sub-Fingerprints with any sub-Fingerprints of previously stored original video files in a database. The system can support the extraction of data, including, but not limited to, MO Identification Data: Fingerprint, and/or MP Identification Data: Fingerprint, described herein, by any Data Processing System, including, but not limited to: Wireless Device 0210, and/or Metadata Server 0280, which can receive the Fingerprints through any communications channel from Wireless Device 0210.

In some embodiments, MO Identification Data can be: Fingerprint as any data extracted from one or more Fingerprints of any signal type, including, but not limited to, video, image, audio, and/or text, which can identify the Media Operator transmitting the Advertisement and/or Programming displayed. In some embodiments, MP Identification Data can be: Fingerprint of any signal type as any data extracted from one or more Fingerprints of any type which can identify the Media Program displayed.

### 5.1.1.2 Media Device Audio Transmission

### 5.1.1.2.1 Audio Sample

The system can utilize any method to record a sample of an audio Signal 1710. The system can support a Wireless Device 0210 utilizing one or more I/O Devices, e.g., Audio Receiving Component 0378, to receive a sample of an audio Signal 1710 from which Wireless Device 0210, Metadata Server 0280, and/or any other Data Processing System can extract a Fingerprint.

### 5.1.1.2.2 Audio Watermark

The system can utilize any method to detect any Watermark in an audio Signal 1710. The system can support a Wireless Device 0210 utilizing one or more I/O Devices, e.g., Audio Receiving Component 0378, to receive an audio Signal 1710 including a Watermark. The Watermark can include any data which can be included in an Ad Metadata File 0410 and/or Program Metadata File 0510.

### 5.1.1.2.3 Audio Fingerprint

The system can utilize any method to generate, extract, and/or detect a Fingerprint from and/or in an audio Signal 1710. The system can support a Wireless Device 0210 utilizing one or more I/O Devices, e.g., Audio Receiving Component 0378, to receive an audio Signal 1710 from which the Wireless Device 0210 can extract a Fingerprint.

### 5.1.1.3 Media Device Audio-Video Transmission

### 5.1.1.3.1 Audio-Video Watermark

The system can utilize any method to detect any Watermark in an audio-video Signal 1710. The system can support a Wireless Device 0210 utilizing one or more I/O Devices, e.g., Camera 0374 and/or Audio Receiving Component 0378, to receive an audio-video Signal 1710, which includes a Watermark. The Watermark can include any data which can be included in an Ad Metadata File 0410 and/or Program Metadata File 0510.

### 5.1.1.3.2 Audio-Video Fingerprint

The system can utilize any method to generate, extract, and/or detect a Fingerprint from and/or in an audio-video Signal 1710. The system can support a Wireless Device 0210 utilizing one or more I/O Devices, e.g., Camera 0374 and/or Audio Receiving Component 0378, to receive an audio-video Signal 1710 from which the Wireless Device 0210 can extract a Fingerprint.

### 5.1.1.4 Media Device Data Transmission

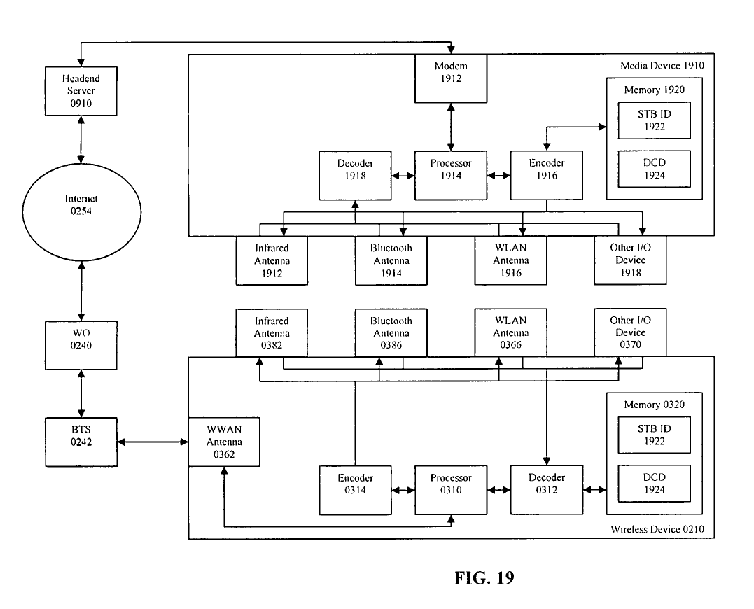

FIG. 19 depicts a block diagram of an exemplary system enabling the identification of an Advertisement displayed on a Media Device through a Wireless Device receiving data from the Media Device.

Media Device 1910 is any Media Device. In some embodiments, Media Device 1910 can be a STB.

Modem 1912 is any device capable of exchanging data between Media Device 1910 and any Data Processing System operated by a Media Operator, e.g., a Headend Server 0910 operated by a cable Television Operator. Modem 1912 can include, but is not limited to: a cable modem; and/or a phone modem.

Processor 1914 can be one or more general- or special-purpose Processor 0104.

Encoder 1916 is one or more devices capable of encoding a signal into a format or protocol for transmission by one or more I/O Devices of Media Device 1910.

Decoder 1918 is one or more devices capable of decoding the format or protocol of a signal received from one or more I/O Devices of Media Device 1910.

Memory 1920 can be configured to, for example, perform any of the functions of Memory 0112, including, but not limited to, storing any application and/or data in Media Device 1910.

STB ID 1922 is any data uniquely identifying Media Device 1910. The unique data can include, but is not limited to: a serial number of the STB; and/or a medium access control (MAC) address of the STB. In some embodiments, the STB ID 1922 can be defined as data uniquely identifying a STB. In some embodiments, the STB ID 1922 can be defined as any data uniquely identifying any type of Media Device 1910.

DCD 1924 is any data identifying the physical and/or logical channel to which Media Device 1910 is tuned, the date/time at which Media Device 1910 tunes to the physical and/or logical channel, and/or the duration for which Media Device 1910 tunes to the physical and/or logical channel (e.g., a Displayed Channel Data). For example, DCD 1924 can specify that from T₁ to T₂ Media Device 1910 displayed logical channel A and at T₂ Media Device 1910 displayed logical channel B. There are existing methods and computer program products capable of recording and/or storing DCD 1924. The system can be configured to utilize any database, e.g., Channel/Operator LUT 1300, to lookup the Media Operator associated with the displayed channel identified through any existing method and/or method disclosed herein. In some embodiments MO Identification Data can be defined: Displayed Channel as any data associated with the Displayed Channel Data which can identify the Media Operator transmitting the Advertisement and/or Programming displayed.

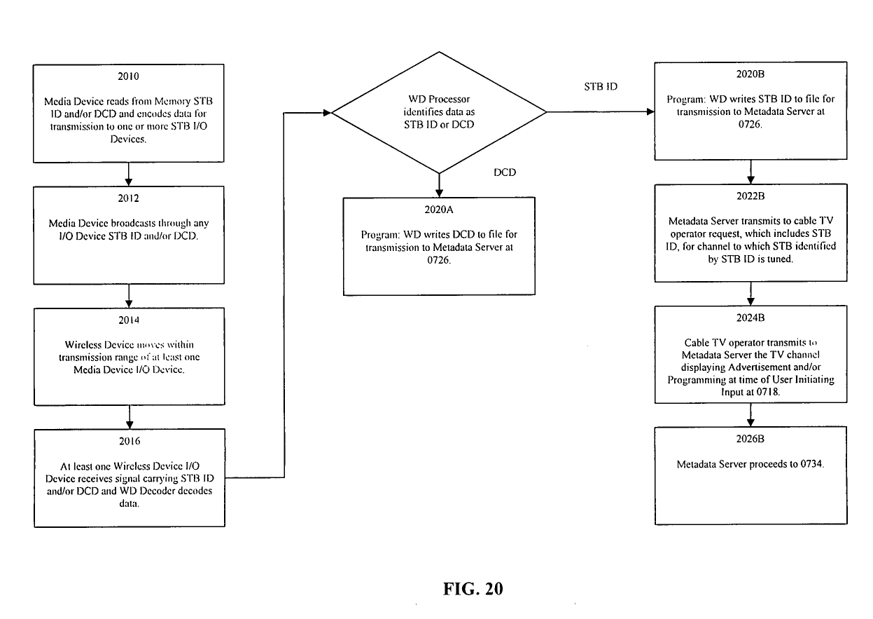

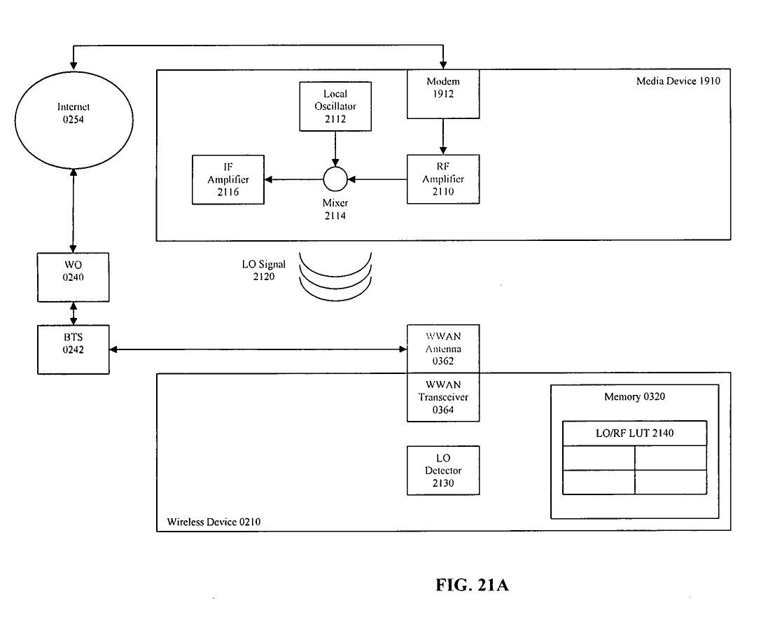

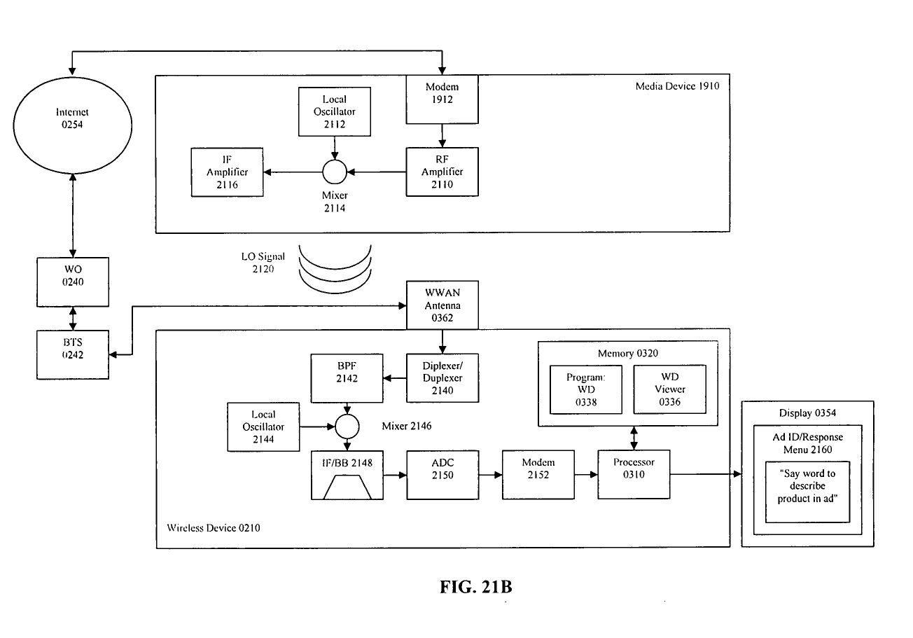

FIG. 20 depicts a flowchart of an exemplary Method 2000 enabling the identification of an Advertisement displayed on a Media Device through a Wireless Device receiving data from the Media Device.

At 2010, Media Device 1910 can read from Memory 1920 any data enabling the system to identify the Advertisement displayed on Media Device 1910. The data can include, but are not limited to: STB ID 1922; DCD 1924; and/or any data Media Device 1910 received from one or more Remote Control Devices. Media Device 1910 can read data from Memory 1920 at any schedule. Existing methods can record the physical and/or logical channel to which a Media Device 1910 is tuned every second. Method 2000 can read from Memory 1920 data at any interval corresponding to the frequency with which Media Device 1910 can record any change in physical and/or logical channel.

The benefits of Method 2000 can include, but are not limited to, enabling the system to identify the Media Operator and/or Media Program transmitting an Advertisement and/or Programming of interest by receiving data from the Media Device displaying the Advertisement and/or Programming. The system can support a Media Device transmitting such data, whether the Media Device is located in a residence, a business, or a public place. For example, while it may be expensive for a cable Television Operator to deploy I/O Devices to each household to equip one or more STBs 1910 to implement Method 2000, it can be more economical for a business or public place, e.g., a restaurant or airport, to equip a STB 1910 with one or more I/O Devices desirable to implement Method 2000.

### 5.1.1.5 Media Device Unintentional Transmission

Media Device 1910 can be any Media Device which receives an electromagnetic signal carrying an Advertisement and/or Programming, including, but not limited to: Television 0230, and/or Radio 0232.

There are existing methods of detecting a LO signal. In a typical Television 0230 and/or Radio 0232, a mixer utilizes a LO signal to convert a received RF signal to an intermediate frequency (IF).

The system can utilize the reception of the LO Signal 2120 to meet a variety of objectives. First, the system can utilize the LO Signal 2120 to identify the RF signal received by a Media Device and therefore in certain cases the channel to which the Media Device is tuned. These cases can include, but are not limited to: an analog STB 1910; an analog Radio 0232; and/or certain digital STBs 1910 or Radios 0232. The system can lookup the Media Operator associated with a RF signal. In some embodiments, the MO Identification Data can be defined as: LO Signal as any data associated with a RF signal received by a Media Device 1910 which can identify the Media Operator transmitting the Advertisement and/or Programming displayed.

Second, the system can utilize the reception of the LO Signal 2120 to enable Wireless Device 0210 to: (a) determine automatically upon reception of LO Signal 2120 when it is within the vicinity of any Media Device 1910 with an LO 2112; and (b) then call an application, e.g., Program: WD 0338, which can execute a variety of functions, including, but not limited to: (i) display on Display 0354 Ad ID/Response Menu 2160 an instruction to Wireless Device 0210 user, e.g., “Say word to describe product in ad”; (ii) call an application to enable Wireless Device 0210 user to speak into Audio Receiving Component 0378 one or more audio commands, e.g., “Get info”; and/or (ii) call Fingerprint Application 0334 which can start upon reception of an audio command the recording a sample of an information signal transmitted by Media Device 1910. The benefit of utilizing LO Signal 2120 and/or any other Media Device Vicinity Data is to reduce the number of methods required to implement the invention. For example, automatically executing the present methods can obviate the need for 0718 in Method 0700.

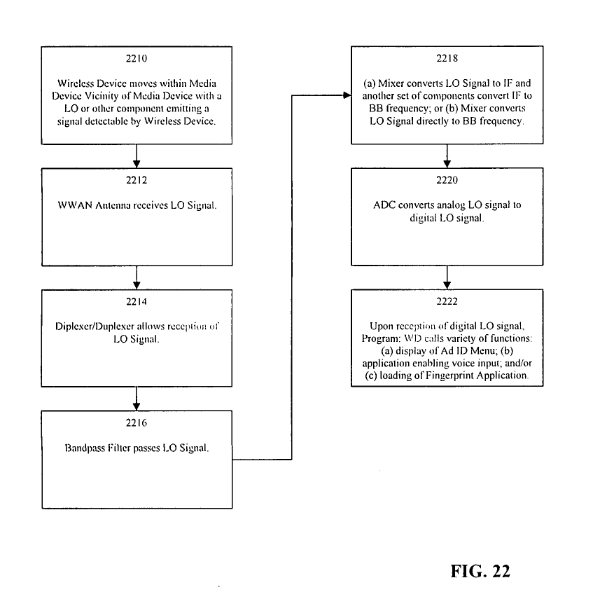

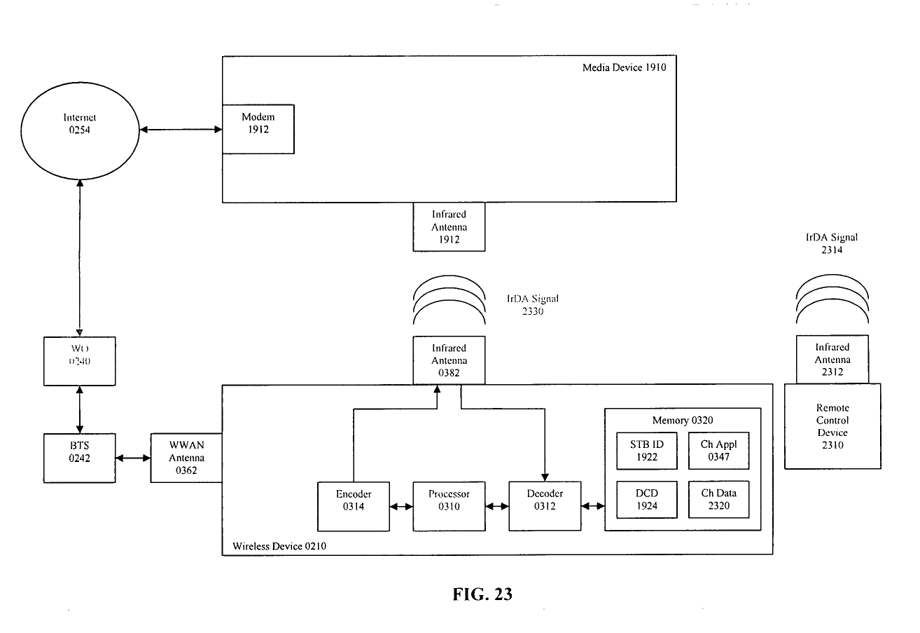

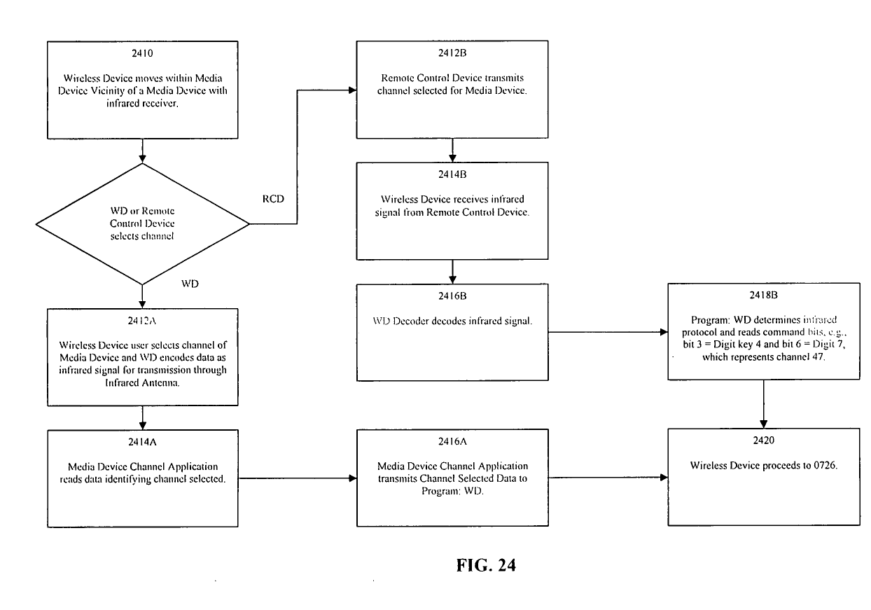

FIG. 22 depicts a flowchart of an exemplary method enabling a Wireless Device to call automatically a variety of functions upon reception of a signal, e.g., a LO signal, from another Media Device.

Existing methods of detecting a LO Signal 2120 typically require a complex set of components, because they attempt to detect the frequency of LO Signal 2120. The present method requires the detection of only the transmission of LO Signal 2120, not the frequency at which LO 2112 emits LO Signal 2120. Therefore, the present method can obviate the requirement of hardware and/or software in Wireless Device 0210 which, e.g., generates a voltage that reflects the frequency of LO Signal 2120, maps the voltage to the RF frequency received by Modem 1912, and/or performs any type of transformation of LO Signal 2120 from the time domain to the frequency domain.

At 2214, Diplexer/Duplexer 2140 can allow the reception of LO Signal 2120.

At 2216, Bandpass Filter 2142 can pass LO Signal 2120. For example, in the United States, a Wireless Operator 0240 exchanges data with one or more Wireless Devices 0210 utilizing a variety of frequency bands, e.g., the 800 MHz and 1900 MHz bands. In a typical STB, a LO for the primary video tuner can transmit a signal in the 1-2 GHz range. The system can support a Bandpass Filter 2142 which can pass a LO Signal 2120 in the same range transmitted by a typical STB.

Existing duplexers, bandpass filters, and other components in the RF front end reject specified frequencies, which can include the frequency at which LO Signal 2120 transmits. The system can support components which can be programmed to pass frequencies other than those carrying data transmitted by Wireless Operator 0240, e.g., LO Signal 2120.

In some embodiments, the system can be configured to utilize existing methods of generating, extracting, and/or detecting a Fingerprint in an audio, video, and/or audio-video Signal 1710 to identify whether Wireless Device 0210 is within the vicinity of any Media Device 1910 even without detecting a LO Signal 2120.

### 5.1.1.6 Wireless Device Remote Control

Channel Data 2320 can include data identifying the logical channel to which Media Device 1910 is tuned.

In some embodiments, MO Identification Data can be defined as: Remote Control as any data received from any encoder of infrared signals which can identify the Media Operator transmitting the Advertisement and/or Programming displayed and/or the logical channel to which Media Device 1910 is tuned.

### 5.1.1.6.1 Wireless Device Transmission of Remote Control Codes

### 5.1.1.6.2 Other Device Transmission of Remote Control Codes

### 5.1.2 User Generated Identification Data

The system can support a variety of means of identifying through Wireless Device 0210 user inputting data: (a) an Advertisement and/or Programming of interest to Wireless Device 0210 user; and/or (b) the Media Operator and/or Media Program displaying an Advertisement and/or Programming of interest to Wireless Device 0210 user. These means include, but are not limited to, the Wireless Device 0210 user: inputting the channel to which another Media Device is tuned; inputting the Media Operator displaying the Advertisement and/or Programming of interest; inputting Keywords/Keyphrases associated with the Advertisement and/or Programming of interest; and/or utilizing one or more I/O Devices, e.g., Camera 0374 or Barcode Reader 0398, to record an image or series of images of an Advertisement and/or Programming or subset of the Advertisement and/or Programming, e.g., a barcode or other symbol containing data about the Advertisement and/or Programming.

FIG. 25 depicts a block diagram of an exemplary system enabling a Wireless Device to transmit a request and Metadata Server to process the request. The system can implement the system by utilizing a subset of the following components, or additional, related, alternative, and/or equivalent components. The system can include, but is not limited to, the following components not disclosed earlier herein.

Ad ID/Response Menu 2160 can be any set of options which Wireless Device 0210 user can select and/or directions for Wireless Device 0210 user to execute. In the present embodiment, Ad ID/Response Menu 2160 can display three options, including, but not limited to: (a) “To GET a web page, say GET [Brand Name] & [Product Name]”; (b) “To BUY a product, say BUY [Brand Name] & [Product Name]; and/or (c) “To SAVE a coupon, say SAVE [Brand Name] & [Product Name].”

Digital Recording 2510 can be any recording by Wireless Device 0210 of an User Request defined herein.

MMS 2512 can be any MMS message capable of transmitting a Digital Recording 2510.

Automatic speech recognition (ASR) program 2514 is any computer program product capable of recognizing human speech, identifying the Command and one or more Keywords/Keyphrases, and/or converting the words identified into data which can be compared against any database in Metadata Server 0280, e.g., LUT 1500.

User Generated ID 2520 can be any file storing one or more Keywords/Keyphrases created by Metadata Server 0280 utilizing any method to recognize speech.

Command Program 2530 can be any computer program product capable of processing an instruction in response to a Command received by Metadata Server 0280. In the present embodiment, Command Program 2530 can process instructions, including, but not limited to: (a) if the Command is “GET,” then Command Program 2530 can retrieve any HTML document stored in Metadata Server 0280, e.g., any HTML document Advertiser 0220 and/or Media Buyer 0222 can include in Ad Metadata File 0410 or Metadata Server 0280 can retrieve which Advertiser 0220 wants a Wireless Device 0210 user to view if the user selects the “GET” Command; (b) if the Command is “BUY,” then Command Program 2530 can retrieve one or more data and/or instructions from Ad Metadata File 0410, Program Metadata File 0510, and/or any Data Processing System, e.g., Advertiser 0220, which includes any data and/or instructions to execute a purchase of the product of interest; and/or (c) if the Command is “SAVE,” then Command Program 2530 can retrieve one or more data and/or instructions from Ad Metadata File 0410, Program Metadata File 0510, and/or any Data Processing System, which includes any data and/or instructions to download an electronic coupon to Wireless Device 0210.

The system can utilize one or more databases, e.g., Keyword/Advertisement LUT 1500, which can include Keywords/Keyphrases most likely to be used by a typical Wireless Device 0210 user to help identify the product, brand, Product Category, and/or vendor promoted in an Advertisement and/or Programming of interest. The system can include in the database one or more Keywords/Keyphrases received from a variety of sources and/or generated through a variety of methods, including, but not limited to: (a) any Keywords/Keyphrases received from Advertiser 0220 and/or Media Buyer 0222; (b) any Keywords/Keyphrases generated by any other entity; and/or (c) any Keywords/Keyphrases the system can learn from observing the Keywords/Keyphrases one or more Wireless Device 0210 users associate in practice with the product, brand, Product Category, and/or vendor promoted in an Advertisement and/or Programming of interest.

For example, Advertiser 0220 can associate a Keyword, “Product X-Express,” with Product X-Express and Advertisement (Product X-Express). However, consumers can utilize a different term in popular usage to refer to Product X-Express, e.g., “Product X.” If enough Wireless Device 0210 users utilize the Keyword, “Product X,” to refer to Product X-Express and the system identifies through the utilization of other Keywords/Keyphrases that “Product X” is most commonly associated with Advertisement (Product X-Xpress), then the system can add to the Keywords/Keyphrases associated with Advertisement (Product X-Xpress) the additional Keyword, “Product X.”

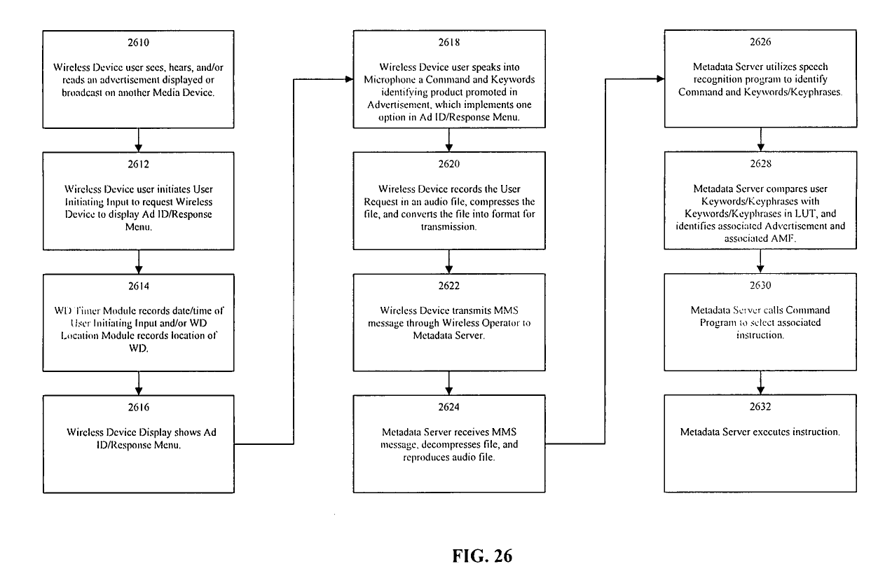

FIG. 26 depicts a flowchart of an exemplary Method 2600 enabling a Wireless Device to transmit a request and a Server to process the request. In some embodiments, Wireless Device 0210 can be enabled to transmit a user request in audio form. The system can support the transmission of an user request through one or more or combination of Wireless Device Input Methods. The flowchart is described with reference to the system depicted in FIG. 25. However, the flowchart is not limited to that embodiment. The system can be configured to implement the flowchart with reference to systems utilizing a subset of the components, or additional, related, alternative, and/or equivalent components depicted in FIG. 25. The system can be configured to implement the flowchart by executing a subset of the methods, executing the methods in different order, and/or executing other or additional related or equivalent methods.

At 2610, Wireless Device 0210 user can see, hear, and/or read an Advertisement displayed and/or broadcast on another Media Device.

At 2612, Wireless Device 0210 user can initiate User Initiating Input to request Wireless Device 0210 to display Ad ID/Response Menu 2160.

At 2614, Wireless Device Timer Module 0322 can record the date/time of User Initiating Input and/or any other event reflecting the interest of Wireless Device 0210 user in an Advertisement and/or Programming. Wireless Device Location Module 0324 can record the location of Wireless Device 0210 at the time of User Initiating Input. In some embodiments, a computer program product located within Wireless Operator 0240 can record the location of Wireless Device 0210 at the time of User Initiating Input.

At 2616, Wireless Device 0210 Display 0354 can show an Ad ID/Response Menu 2160. In the present embodiment, Ad ID/Response Menu 2160 can show a menu of options from which Wireless Device 0210 user can select to transmit a request to Metadata Server 0280.

The system can utilize any type of structure for interpreting the request from Wireless Device 0210. For example, the system can interpret the request, “GET [Brand Name] & [Product Name]” in the following way. The system can define a Command as the first word, “GET,” or any other data. In some embodiments, a Keyword and/or Keyphrase is defined as the words, phrases, or any other data following a Command specified by Wireless Device 0210 user to describe the product of interest. In the present example, any Data Processing System, e.g., Metadata Server 0280, receiving the Wireless Device 0210 request can interpret the word, “GET,” as a Command and the following words [Brand Name] and [Product Name] as Keywords/Keyphrases. In some embodiments, an User Request can be defined as the combination of one or more Commands and one or more Keywords/Keyphrases. In some embodiments, a Command can be defined as a predefined word, e.g., “GET,” “BUY,” or “SAVE,” which any Data Processing System, e.g., Metadata Server 0280, can interpret as a Command and any words associated with the Command in the User Request as Keywords/Keyphrases. In some embodiments, an User Request can be defined as the combination of one or more Commands, one or more Keywords/Keyphrases, and any other data inputted by Wireless Device 0210 user which can enable the system to identify the product of interest, the Advertisement and/or Programming promoting the product of interest, and/or the Media Operator and/or Media Program displaying the Advertisement and/or Programming of interest. For example, the additional data can be any information inputted by Wireless Device 0210 user identifying the Media Operator displayed on the Media Device viewed by the user, e.g., the channel or the Television network to which Television 0230 is tuned.

The system can enable Wireless Device 0210 user to implement an option through any Wireless Device Input Method. While the present method teaches how a Wireless Device 0210 user can input an User Request by speaking into Audio Receiving Component 0378, the system can support any other Wireless Device Input Method or combination of Wireless Device Input Methods. For example, Wireless Device 0210 can present the user the option of touching on a touch-sensitive Display 0354 an icon representing the “GET” Command and speaking into Audio Receiving Component 0378 the Keywords/Keyphrases describing the product of interest.

At 2618, Wireless Device 0210 user can speak into Audio Receiving Component 0378 a Command and Keywords/Keyphrases identifying the product promoted in an Advertisement. The combination of the Command and Keywords/Keyphrases can implement one option in Ad ID/Response Menu 2160.

At 2620, Wireless Device 0210 can record the User Request in an audio file in any format, e.g., WAV, compress the file utilizing any compression protocol, and/or convert the file into any format, e.g., MMS, for transmission. For example, Wireless Device 0210 can record the User Request in a Digital Recording Audio File 2510, may or may not compress the file, and/or convert the file into a format for transmission as a MMS Message 2512. The system can add to the User Request any data received, collected, and/or generated at 2614, and/or any other data the system can utilize to identify the product of interest, the Advertisement and/or Programming promoting the product of interest, and/or the Media Operator and/or Media Program displaying the Advertisement and/or Programming of interest.

At 2622, Wireless Device 0210 can transmit MMS Message 2512 through Wireless Operator 0240 to Metadata Server 0280.

At 2624, Metadata Server 0280 can receive MMS Message 2512, decompress the file if Wireless Device 0210 compressed the file, and reproduce the audio file.

At 2626, Metadata Server 0280 can utilize any ASR computer program product to identify the Command and one or more Keywords/Keyphrases, and/or convert the words identified into data which can be compared against any database in Metadata Server 0280, e.g., LUT 1500.

The system can utilize any ASR computer program product capable of performing speech recognition, any computer program product capable of converting dual-tone multi-frequency (DTMF) signals into their associated data; and/or any computer program product capable of recording any audio received over a voice channel from one or more Wireless Devices 0210. The system can utilize any of the above programs.

The system can utilize any voice gateway or any other Data Processing System capable of exchanging voice and/or data between a PSTN and a WAN, e.g., the Internet.

The system can utilize any protocol which can enable any voice communication between a human and a Data Processing System. These protocols can include, but are not limited to: VoiceXML (VXML). For example, VXML can enable an user to input information through a form and a field element. In some embodiments, the system can utilize VXML to receive any Wireless Device 0210 user input, e.g., a Command and one or more Keywords/Keyphrases; utilize a tag to implement an ASR program; and/or transmit the words converted from a speech signal to a computer program product in Metadata Server 0280 for comparison against a database.

At 2628, Metadata Server 0280 can utilize any method for matching data in an User Request with data in a database. In some embodiments, the data provided by Wireless Device 0210 can be defined as a query string and the data to be matched and stored in a database as a stored record. Query strings will probably have significant variation, which can include, but is not limited to: variation in spelling of Commands and/or Keywords/Keyphrases if a Wireless Device 0210 user provides an User Request in the form of text; variation in the pronunciation and/or accent of Commands and/or Keywords/Keyphrases if a Wireless Device 0210 user provides an User Request in the form of speech; variation in the order of Keywords constituting a Keyphrase; and/or variation in the choice of Keywords/Keyphrases selected by a Wireless Device 0210 user to identify a product of interest. For example, a Wireless Device 0210 user can use the word “car,” “auto,” “SUV,” or “automobile” to describe an automobile. A Wireless Device 0210 user can use different Keywords to describe the brand name or product name associated with the product of interest. For example, a Wireless Device 0210 user can use the formal brand name utilized by Advertiser 0220 or the popularly-known brand name to identify the brand name.

In some embodiments, the system can increase the probability of accurate matching by including in Keyword/Advertisement LUT 1500 or other LUTs the set of Keywords/Keyphrases Advertiser 0220 and/or Media Buyer 0222 expect most Wireless Device 0210 users to utilize in describing the product of interest.

In addition, the system can utilize a variety of existing methods for enabling approximate string matching and/or approximate pattern matching for any type of data, including, but not limited to: text, image, video, and/or audio. For example, the system can utilize any method for approximate record matching presented in Reffle.

At 2630, Metadata Server 0280 can call Command Program 2530 to select the instruction associated with a given Command.

At 2632, Metadata Server 0280 can execute the instruction.

An example of how the present method can support the transmission of an user request through one communications channel and Wireless Device Generated Identification Data through another communications channel follows. An user of Wireless Device 0210 can transmit an user request in the form of a SMS message and Wireless Device 0210 can transmit an audio signal, e.g., a sample of Signal 1710, from which Metadata Server 0280 can extract one or more Fingerprints to provide additional information for identifying the Advertisement and/or Programming of interest and/or the Media Operator displaying any Advertisement and/or Programming.

The present method can support the transmission of one or more user inputs related to a product of interest. The transmission of the user inputs can be serial or in parallel. For example, an user of Wireless Device 0210 can transmit in any form, e.g., speech, an User Request like “BUY [team] ticket.” After receiving data related to the product of interest, Wireless Device 0210 can display information related to the ticket, e.g., potential dates and potential seats. The user can transmit in any form, e.g., speaking one or more words, e.g., “June 10,” or selecting a key or function on Keypad 0350, e.g., a key used to input “Yes,” additional data related to the product of interest.

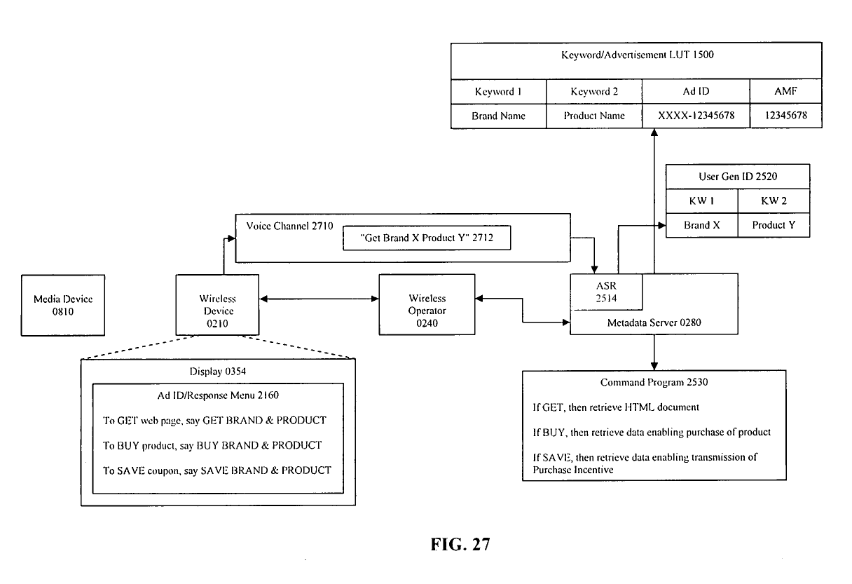

FIG. 27 depicts a block diagram of an exemplary system enabling a Wireless Device to transmit a request over a voice channel and a Server to process the request. The system can implement the system by utilizing a subset of the following components, or additional, related, alternative, and/or equivalent components. The system can include, but is not limited to, the following components not disclosed earlier herein.

Voice Channel 2710 can be any communications channel enabling the transport of an audio signal, in particular, a signal carrying voice frequencies.

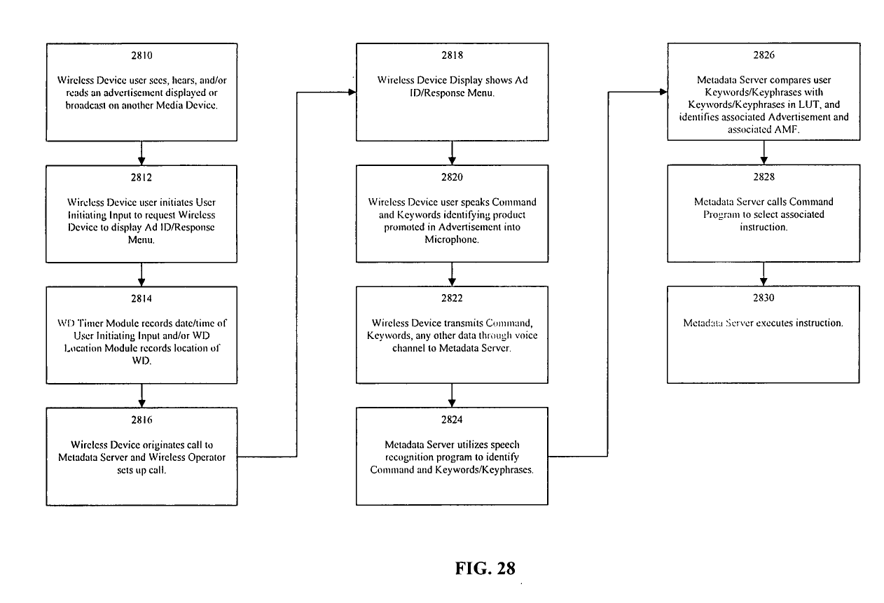

FIG. 28 depicts a flowchart of an exemplary Method 2800 enabling a Wireless Device to transmit a request over a voice channel and Metadata Server to process the request. The flowchart is described with reference to the system depicted in FIG. 27. However, the flowchart is not limited to that embodiment. The system can implement the flowchart with reference to systems utilizing a subset of the components, or additional, related, alternative, and/or equivalent components depicted in FIG. 27. The system can implement the flowchart by executing a subset of the methods, executing the methods in different order, and/or executing other or additional related or equivalent methods.

At 2810 through 2814, the present method can repeat 2610 through 2614.

At 2816, Wireless Device 0210 can originate a voice call through Wireless Operator 0240 to Metadata Server 0280. Wireless Device 0210 can receive through any I/O Device a set of digits representing an address of another Data Processing System, e.g., Metadata Server 0280, and store the set of digits in any memory accessible by a module capable of executing the setup, management, and release of circuits carrying voice and/or data between Wireless Device 0210 and another Data Processing System. Wireless Device 0210 can utilize any protocol to setup, manage, and release circuits carrying voice and/or data between Wireless Device 0210 and another Data Processing System, e.g., Metadata Server 0280. Wireless Device 0210 can support a circuit-switched voice call and/or a packet-switched voice call, e.g., a call utilizing voice over IP (VoIP).

At 2818, Wireless Device 0210 Display 0354 can show Ad ID/Response Menu 2160. Wireless Device 0210 can show Ad ID/Response Menu 2160 before, concurrently, or after it originates a voice call. In the preferred embodiment, Wireless Device 0210 can originate a voice call before Display 0354 shows Ad ID/Response Menu 2160. A Wireless Operator 0240 typically takes about 5-10 seconds to setup a voice call (e.g., Voice Call Setup Time). Because of the duration of the Voice Call Setup Time, originating a voice call at a time approximately equal to the Voice Call Setup Time less the time it takes a typical Wireless Device 0210 user to read Ad ID/Response Menu 2160 can enable a live voice channel capable of transmitting the User Request to Metadata Server 0280.

At 2820, Wireless Device 0210 user can speak into Audio Receiving Component 0378 a Command and one or more Keywords/Keyphrases identifying the product promoted in an Advertisement.

At 2822, Wireless Device 0210 can utilize any method to transmit to Metadata Server 0280 the Command and one or more Keywords/Keyphrases through the voice channel setup by Wireless Device 0210.

The system can add to the User Request any data received, collected, and/or generated at 2614, and/or any other data the system can utilize to identify the product of interest, the Advertisement and/or Programming promoting the product of interest, and/or the Media Operator and/or Media Program displaying the Advertisement and/or Programming of interest.

The system can utilize a variety of methods of transmitting the User Request and data received, collected, and/or generated by Wireless Device 0210, i.e., Wireless Device Generated Identification Data. In some embodiments, the system can transmit the User Request over the voice channel originated by Wireless Device 0210 and the Wireless Device Generated Identification Data over a separate data channel, e.g., in a SMS or MMS message. In some embodiments, the system can utilize any method to convert the User Request and Wireless Device Generated Identification Data into data packets for transmission over VoIP. For example, the system can: (a) convert the User Request inputted as an analog signal to a digital signal at the Wireless Device 0210 or any Data Processing System at Wireless Operator 0240; (b) compress the digital signal utilizing any protocol; (c) convert the Wireless Device Generated Identification Data into data packets; (d) insert the voice packets and data packets utilizing a real-time protocol, e.g., real-time transport protocol (RTP) over user datagram protocol (UDP) over IP; and (e) transmit the packets.

At 2824, Metadata Server 0280 can utilize any ASR computer program product to recognize the Command and Keywords/Keyphrases and compare the converted words into data which can be compared against any database in Metadata Server 0280, e.g., LUT 1500.

At 2826 through 2830, the present method can repeat 2628 through 2632.

An example of how the present method can support the transmission of an user request through one communications channel and Wireless Device Generated Identification Data through another communications channel follows. An user of Wireless Device 0210 can transmit an user request in the form of a SMS message and Wireless Device 0210 can transmit an audio signal, e.g., a sample of Signal 1710, from which Metadata Server 0280 can extract one or more Fingerprints to provide additional information for identifying the Advertisement and/or Programming of interest and/or the Media Operator displaying any Advertisement and/or Programming.

The present method can support the transmission of one or more user inputs related to a product of interest. The transmission of the user inputs can be serial or in parallel. For example, an user of Wireless Device 0210 can transmit in any form, e.g., speech, an User Request like “BUY [team] ticket.” After receiving data related to the product of interest, Wireless Device 0210 can display information related to the ticket, e.g., potential dates and potential seats. The user can transmit in any form, e.g., speaking one or more words, e.g., “June 10,” or selecting a key or function on Keypad 0350, e.g., a key used to input “Yes,” additional data related to the product of interest.

To reduce the cost of implementing the system, the method can be configured to terminate the voice call originated at 2816 after the Metadata Server 0280 has collected enough data to help achieve a desirable false positive rate and/or the false negative rate described in Section 5.1.3.

The system can utilize any data received by Audio Receiving Component 0378 to identify not only the Command and one or more Keywords/Keyphrases inputted by Wireless Device 0210 user, but also any other audio signal which can enable the system to identify the Advertisement and/or Programming of interest. The data received by Audio Receiving Component 0378 can include, but are not limited to: any User Generated Identification Data; and/or any Wireless Device Generated Identification Data. For example, Metadata Server 0280 can process any Command and Keywords/Keyphrases inputted by Wireless Device 0210 user into Audio Receiving Component 0378 and any Wireless Device Generated Identification Data which can be received by Audio Receiving Component 0378, e.g., a sample of Signal 1710.

In some embodiments, Wireless Device 0210 user can at 2820 speak into Audio Receiving Component 0378 a Command and one or more Keywords/Keyphrases. After receiving and recognizing the User Request by utilizing any ASR program, Metadata Server 0280 can delay terminating the voice channel until it receives an audio signal, e.g., a sample of Signal 1710, from which Metadata Server 0280 can extract one or more Fingerprints to provide additional information for identifying the Advertisement and/or Programming of interest and/or the Media Operator displaying any Advertisement and/or Programming. In some embodiments, the system can utilize any audio signal received over a voice channel before Wireless Device 0210 user inputs a Command and/or one or more Keywords/Keyphrases. In some embodiments, the system can utilize any audio signal received in between the input by Wireless Device 0210 user of any given Command and/or Keywords/Keyphrases.

When a Wireless Device 0210 user transmits an User Request, he/she is likely to be in the vicinity of the same Media Device displaying the Advertisement of interest. Therefore, a transmission over a voice channel of the User Request can likely transmit any audio signal received in the vicinity of the Wireless Device 0210, including any audio signal received from the Media Device which displayed the Advertisement of interest.

There are existing methods enabling a Data Processing System to receive through a communications channel one or more words spoken by a Wireless Device 0210 user and utilizing the information to identify an object in a database, e.g., a web page. In some embodiments, the benefits of Methods 2600 and 2800 over existing methods are described in more detail in Section 6.2.1.

Method 2600 and Method 2800 describe means of enabling the system to identify an Advertisement and/or Programming of interest by utilizing Keywords/Keyphrases inputted by Wireless Device 0210 user alone or Keywords/Keyphrases in combination with other data received, collected, and/or generated by Wireless Device 0210, e.g., a sample of Signal 1710 from which the system can extract a Fingerprint to identify the Media Operator displaying an Advertisement and/or Programming. The system can support any disclosed methods utilizing Keywords/Keyphrases identifying not only a product of interest, but also the Media Operator and/or Media Program displaying the Advertisement promoting a product of interest. For example, Ad ID/Response Menu 2160 can provide instructions or suggestions to Wireless Device 0210 user to input Keywords/Keyphrases identifying not only the names of the vendor, brand, product, and/or Product Category, but also the Media Operator, Media Program, logical channel displaying Advertisement and/or Programming on any Media Device, and/or any information identifying a particular Print Publication 0234, issue, and/or page number.

At 2618 or 2820, Wireless Device 0210 user can speak into Audio Receiving Component 0378 Keywords/Keyphrases identifying the above information. For example, Wireless Device 0210 user can say: “Get Vendor B Product A in The XYZ Magazine, January 15 issue, on page XYZ.”

### 5.1.3 Identification Data Optimization Algorithm

The system can be configured to meet simultaneously one or more of the following objectives.

First, the system can be configured to help achieve a desirable false positive rate P_{FP}, i.e., the rate at which the system selects an Advertisement and/or Programming which is not the Advertisement and/or Programming of interest to Wireless Device 0210 user.

Second, the system can be configured to help achieve a desirable false negative rate P_{FN}, i.e., the rate at which the system does not select an Advertisement and/or Programming which is the Advertisement and/or Programming of interest to Wireless Device 0210 user.

The system can reduce P_{FP} and P_{FN} simultaneously by utilizing information which can reduce P_{FP} without increasing P_{FN} and vice versa. After utilizing all or substantially all available information enabling the system to reduce P_{FP} and P_{FN} simultaneously, any further reduction in P_{FP} can increase P_{FN}.

Third, the system can be configured to reduce the number of methods S_{N}, i.e., the number of actions required by Wireless Device 0210 user to view on Display 0354 an Ad Response Menu, information about the product of interest, information enabling Wireless Device 0210 user to purchase the product, an electronic coupon, or any other response desired by Wireless Device 0210 user.

Fourth, the system can be configured to reduce the response time T_{R}, the length of time between: (a) the time Wireless Device 0210 transmits an User Request, e.g., the time of User Initiating Input, and (b) the time Wireless Device 0210 displays on Display 0354 an Ad Response Menu, information about the product of interest, information enabling Wireless Device 0210 user to purchase the product, an electronic coupon, or any other response desired by Wireless Device 0210 user.

Fifth, the system can be configured to reduce the amount of resources R utilized by one or more components of the system enabling Wireless Device 0210 user to respond to an Advertisement and/or Programming. R can be any type of resource or combination of resources, including, but not limited to: (a) capacity of the network of Wireless Operator 0240 expressed in, e.g., bits per second (bps); (b) capacity of the storage devices of Wireless Device 0210, Wireless Operator 0240, Metadata Server 0280, and/or any other Data Processing System; (c) processing power of any component, including, but not limited to, Wireless Device 0210, Wireless Operator 0240, Metadata Server 0280, and/or any other Data Processing System; and/or (d) demand on battery power of Wireless Device 0210. That is, the system can reduce R for any given Wireless Device 0210, a Wireless Operator 0240, an Advertiser 0220, a Media Buyer 0222, or any combination of components and/or entities. For example, if storage capacity in Wireless Device 0210 is limited, wireless network capacity between Wireless Device 0210 and BTS 0242 is limited, and processing power of Metadata Server 0280 is relatively unlimited, the system can generate, collect, and transmit a desirable combination of User Generated Identification Data, Wireless Device Generated Identification Data, and/or Network Identification Data that meets those limitations.

In the preferred embodiment, the system can be configured to meet at least the first objective of generating a P_{FP} below any given threshold T_{ID}. The system can be configured to meet at least this objective, thus a Wireless Device 0210 user requesting information about a product of interest or requesting data enabling the purchase of the product can be configured to receive data from the Ad Metadata File 0410 and/or Program Metadata File 0510 associated with the Advertisement and/or Programming prompting his/her request. If the system achieves desirable levels of other objectives, e.g., T_{R} and R, but transmits an Ad Metadata File 0410 different from the one associated with the Advertisement prompting his/her request, the Wireless Device 0210 user will probably be dissatisfied.

There are existing methods which can dynamically adjust the data collected by a Wireless Device 0210 to generate a sample of Signal 1710. The benefits of the system can include, but are not limited to: dynamically adjusting the type of data and/or the amount of data collected by a Wireless Device 0210 depending on not only parameters related to the Wireless Device 0210, but on the types of other data and/or the amounts of other data collected by Wireless Device 0210. That is, given a target threshold T_{ID} and therefore a desirable P_{FP} tolerated, there is a set of desirable combinations of types of data and/or amount of data the system can collect.

The types of data can include, but are not limited to: (a) one or more types of User Generated Identification Data; (b) one or more types of Wireless Device Generated Identification Data; (c) one or more types of data which can help identify the specific product of interest and/or the Advertisement and/or Programming promoting the product of interest, which is not User Generated Identification Data or Wireless Device Generated Identification Data (e.g., a Network Identification Data), e.g., data located in Wireless Operator 0240 and/or Metadata Server 0280; and/or (c) any combination of User Generated Identification Data, Wireless Device Generated Identification Data, and Network Identification data.

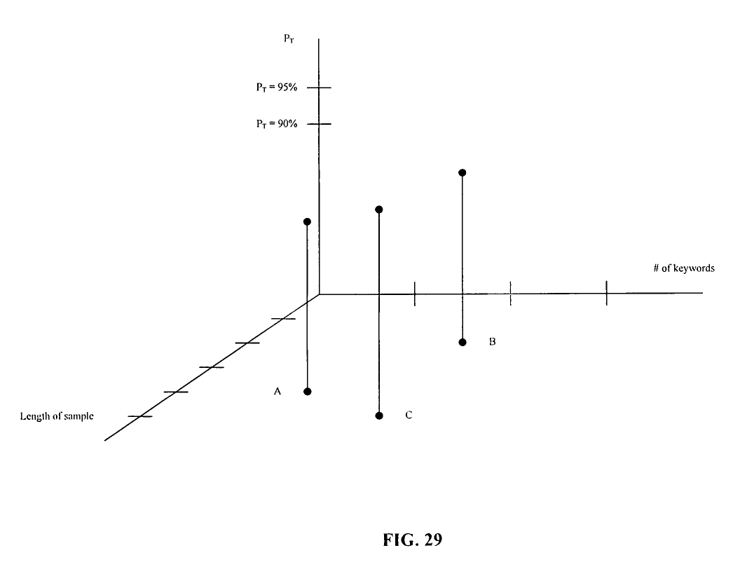

FIG. 29 depicts an exemplary chart showing how different combinations of one type of User Generated Identification Data and one type of Wireless Device Generated Identification Data can increase the probability of correctly identifying the Advertisement of interest.

The exemplary chart has: (a) an x-axis which represents the magnitude of one exemplary User Generated Identification Data, e.g., the number of Keywords inputted by Wireless Device 0210 user; (b) a y-axis which represents the magnitude of one exemplary Wireless Device Generated Identification Data, e.g., the length of time of the sample of Signal 1710 in raw format, e.g., 16 bit PCM, transmitted by Wireless Device 0210; and (c) a z-axis which represents the magnitude of the probability that any combination of values of the number of Keywords inputted by Wireless Device 0210 user and the length of time of the Signal 1710 sample correctly identifies the Advertisement of interest, P_{T}, which is equal to 1−P_{FN}. In the exemplary chart, combinations A and B yield a P_{T} equaling 90 percent, while combination C yields a P_{T} equaling 95 percent. While the present chart shows how different combinations of two types of data can achieve a desirable P_{T}, the system is not limited to that embodiment. The system can support the determination of the combinations of n types of data which can achieve a desirable P_{T}.

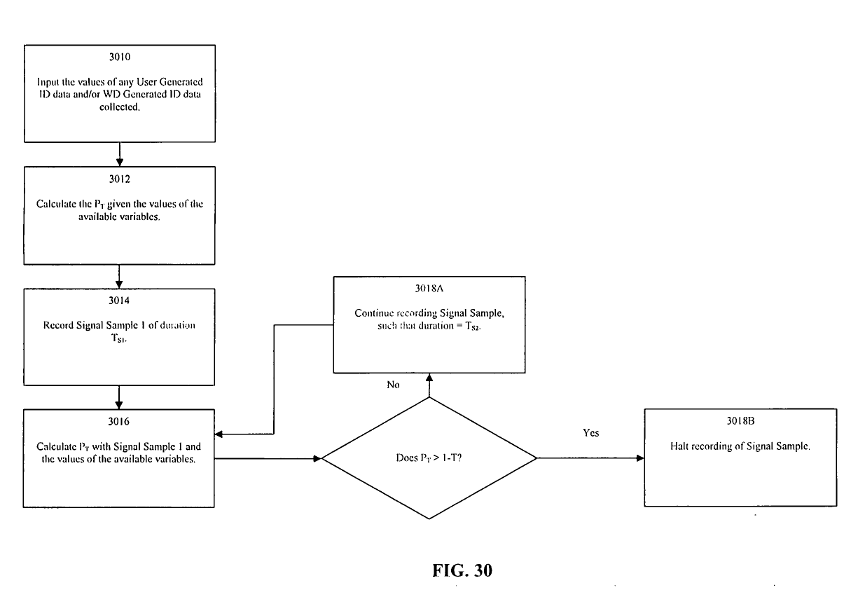

FIG. 30 depicts a flowchart of an exemplary Method 3000 enabling the implementation of an algorithm which can find the combination of User Generated Identification Data, Wireless Device Generated Identification Data, and/or Network Identification Data which meet certain objectives.

Method 3000 can find a desirable value of Signal Sample T_{S}, given values of other variables which the system can collect. While the method can be used to find a desirable value of one variable after measuring the values of other variables which Wireless Device 0210 has already collected, the system is not limited to that embodiment. The system can support the simultaneous determination of a desirable combination of values of a plurality of variables utilizing any method.

In some embodiments, a desirable value of Signal Sample T_{S} can be found after measuring the values of other variables which Wireless Device 0210 has already collected. The system can be configured to support the determination of a desirable value of any other User Generated Identification Data or Wireless Device Generated Identification Data after measuring the values of other variables, including T_{S}, which Wireless Device 0210 has already collected. For example, if Wireless Device 0210 records a Signal Sample whose duration T_{S} equals 5 seconds, the system can determine a desirable number of Keywords Wireless Device 0210 user must input such that P_{T} equals a given threshold, 1−T_{ID}.

In some embodiments, a desirable value of Signal Sample T_{S} can be found after measuring the values of other variables which Wireless Device 0210 has already collected by utilizing a simple iterative procedure. The system can be configured to support the utilization of any method of finding such a desirable value.

At 3010, Method 3000 can input the values of any User Generated Identification Data and/or Wireless Device Generated Identification Data received and/or stored by Wireless Device 0210.

At 3012, Method 3000 can calculate P_{T} given the values of the variables already collected. Method 3000 can determine the relationship between P_{T} and the variables through a variety of means, including, but not limited to: (a) determining the relationship by evaluating a historical database including combinations of values of User Generated Identification Data, Wireless Device Generated Identification Data, and/or Network Identification Data and their respective P_{T} values. For example, a database can collect over time enough data to determine that Wireless Device 0210 user inputting an average of two Keywords and a Signal Sample of average duration equaling 5 seconds results in a P_{T} exceeding 95 percent.

At 3014, Method 3000 can record a Signal Sample 1 of duration T_{S1}=s seconds.

At 3016, Method 3000 can in real-time calculate the P_{T} with Signal Sample 1 and the values of the variables already collected.

Method 3000 then calculates if P_{T} exceeds an acceptable threshold, 1−T_{ID}. If yes, then Method 3000 can halt recording of Signal Sample at 3018B and can transmit the existing raw Signal Sample to: (a) Metadata Server 0280 for extraction of a Fingerprint; or (b) Fingerprint Application 0334 for extraction of a Fingerprint at Wireless Device 0210.

If no, then Method 3000 can continue recording the Signal Sample and calculate the resulting P_{T} until P_{T} exceeds the acceptable threshold at 3018A.

### 5.4 Transmission of Request

### 5.4.1 Communications Protocol

### 5.4.1.1 SMS/MMS

### 5.4.1.2 TCP/IP

### 5.4.1.3 Other Communications Protocol

### 6.2 Processing of Data

### 6.2.1 Identification of Advertisement or Programming

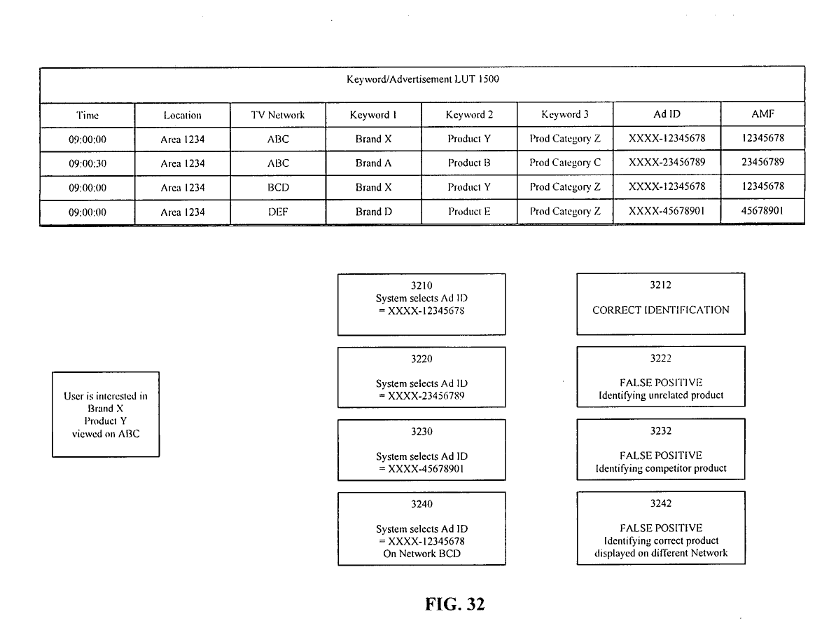

FIG. 32 depicts exemplary cases of the system identifying different Advertisements.

Reducing the false positive rate P_{FP} is important because a Wireless Device 0210 user can be dissatisfied if he/she requests information about a product of interest, but receives information about another product in which he/she is not interested.

In addition, Advertiser 0220 and/or Media Buyer 0222 are interested in a system which achieves a desirable level of P_{FP}, because if their Advertisement stimulates a viewer, listener, and/or reader to inquire about the product promoted in the Advertisement, they want to ensure that the system identifies their Advertisement and not the Advertisement transmitted by another Advertiser 0220 and/or Media Buyer 0222, e.g., the Advertisement of a product unrelated to the product promoted by Advertiser 0220. In FIG. 32, action 3220 produces result 3222, which identifies an Advertisement promoting an unrelated product.

In addition, Advertiser 0220 and/or Media Buyer 0222 are interested in a system which achieves a desirable level of P_{FP}, especially where the system identifies the Advertisement of a product promoted by a competitor to Advertiser 0220. In FIG. 32, action 3230 produces result 3232, which identifies an Advertisement promoting a competing product.

A Media Operator, as well as Advertiser 0220 and/or Media Buyer 0222, is interested in a system which achieves a desirable level of P_{FN} as well as P_{FP}, because the system can credit a Media Operator for the display of an Advertisement if the associated Ad Metadata File 0410 identifies the Media Operator. If a Wireless Device 0210 user requests information about a product promoted in an Advertisement displayed by a Media Operator and the system does not transmit the associated Ad Metadata File 0410 or the data included in the associated Ad Metadata File 0410, then the Media Operator will have lost the opportunity to receive credit for displaying the Advertisement of interest. In FIG. 32, action 3240 produces result 3242, which identifies the product of interest to Wireless Device 0210, but identifies the TV Network BCD, which is different than the TV Network ABC which displayed the Advertisement leading Wireless Device 0210 user to request information about the product of interest.

Reducing P_{FP} and/or P_{FP} can be more important in the systems than in the case of Internet search engines. An Internet search engine typically presents one or more pages of search results, where each page can present a plurality of web pages, each of which can address the query submitted by an user. The probability that at least one of the web pages presented on the first page addresses the query submitted by the user can be significant.

Because the system can be configured to achieve a desirable number of methods S_{N} and the response time T_{R}, the system can be configured to identify accurately the Advertisement promoting the product of interest to Wireless Device 0210 user and transmit information related to the product of interest without requiring Wireless Device 0210 user to exchange data with Metadata Server 0280 or Advertiser 0220 many times.

In addition, because the Display 0354 of a Wireless Device 0210 is typically much smaller than a Personal Computer Display, the system generally cannot present a large number of options of possible matches of the product of interest.

To meet these criteria, an algorithm which can select an Advertisement and/or Programming and reduce to a desirable level at least one and ideally reduce to an desirable level simultaneously both of the following variables: (a) P_{FP}; and/or (b) P_{FN} can be implemented.

There are existing methods of identifying an object in a database which matches a query. The objects can be information in documents, the documents per se, metadata describing documents, and/or data stored in databases. In addition, there are existing methods of utilizing certain types of information to increase the accuracy of identifying an object which matches a query.

In some embodiments, a method can: (a) generate, utilize, and/or process new types of information that can reduce P_{FP} and/or P_{FN}; (b) generate, utilize, and/or process information that can reduce P_{FP} and/or P_{FN}, while reducing to a desirable level the amount of information, e.g., the number of Keywords/Keyphrases, a user must input into Wireless Device 0210; and/or (c) evaluate information in a way which can reduce P_{FP} and P_{FN} by a larger degree, in less time, and/or by utilizing fewer resources than existing methods. For example, the system can be configured to generate, utilize, and/or process information that can reduce P_{FP} and/or P_{FN}, while reducing to a desirable level the number of Keywords/Keyphrases an user must input into Wireless Device 0210. In another example, the system can use the Keywords/Keyphrases inputted by a Wireless Device 0210 user to increase the accuracy with which the utilization of data received, collected, generated, and/or retrieved by Wireless Device 0210 can reduce P_{FP} and/or P_{FN}.

In addition, the short duration of typical Advertisements displayed on Media Devices like Television 0230 and Radio 0232 makes it difficult for a viewer or listener to respond to the Advertisement during its display. Consequently, most Advertisements stimulating a viewer or listener to inquire about the product promoted or purchase the product promoted will have ended before any viewer or listener action. Therefore, any method of identifying an Advertisement of interest typically will require a viewer or listener to provide some information describing the product of interest. In addition to the benefits described above, the system can enable the identification of an Advertisement of interest even after the display of the Advertisement.

In some embodiments, an Advertisement of interest displayed on another Media Device can be identified by utilizing data collected by a Wireless Device 0210 without transmitting any data to the Media Device. The system can support the identification of an Advertisement of interest displayed on another Media Device by utilizing data collected by a Wireless Device 0210 and transmitting and/or receiving data to and/or from the Media Device, e.g., a STB 1910.

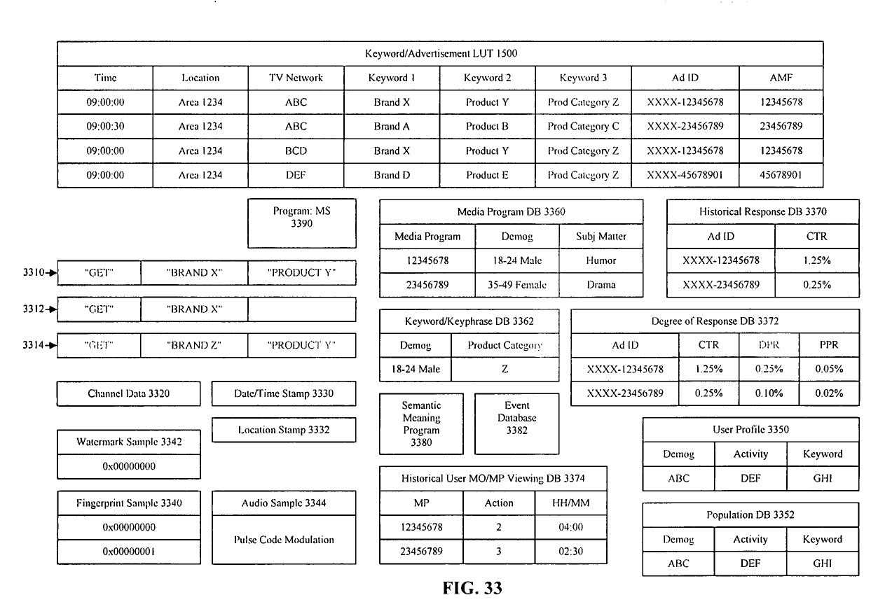

FIG. 33 depicts a diagram of an exemplary System 3300 of data and/or data structures enabling the identification of an Advertisement displayed on a Media Device. The system can be configured to utilize a subset of the following data and/or databases, or additional, related, alternative, and/or equivalent data and/or databases. In some embodiments, a Data Element can be defined as any data received, collected, and/or generated which the system utilizes to identify a product of interest, the Advertisement and/or Programming promoting the product of interest, and/or the Media Operator and/or Media Program displaying an Advertisement and/or Programming of interest. The system can include, but is not limited to, the following Data Elements not disclosed earlier herein.

Query 3310 can be an User Request comprising a “GET” Command and the Keywords, “Brand X” and “Product Y.”

Query 3312 can be an User Request comprising a “GET” Command and the Keywords, “Brand X.”

Query 3314 can be an User Request comprising a “GET” Command and the Keywords, “Brand Z” and “Product Y.”

In the present example, “Brand X” and “Product Y” constitute a description of the specific product of interest to a Wireless Device 0210 user. Query 3312 represents an User Request that includes only the name of the brand of the product of interest and Query 3314 represents an User Request that includes the incorrect name of the brand of the product of interest.

The system includes exemplary Queries 3310, 3312, and 3314 which include Keywords specifying a Brand Name and/or a Product Name. However, the system is not limited to those embodiments. In some embodiments, a system can be configured to include (e.g., support) any Keywords/Keyphrases specifying words and/or phrases other than the Brand Name or the Product Name of the product of interest. These other Keywords/Keyphrases can include, but are not limited to: the Product Category of the product of interest. For example, a Wireless Device 0210 user can view an Advertisement on a Media Device, e.g., Television 0230, and at some time period after the Media Device stops displaying the Advertisement initiate an User Initiating Input. The longer the time period, the lower the probability Wireless Device 0210 user will recall the Brand Name and/or Product Name of the product promoted in the Advertisement. However, the probability is very high that Wireless Device 0210 user will recall at least the Product Category of the product of interest, since he/she can be configured to knows the Product Category in order to request information about a product in the Product Category.

Channel Data File 3320 can include any data identifying and/or data enabling the identification of the Media Operator and/or Media Program transmitting the Advertisement and/or Programming promoting the product of interest. In the case of a Television 0230, Channel Data File 3320 can include data identifying directly the Media Operator and/or Media Program transmitting the Advertisement and/or Programming of interest and/or identifying the logical and/or physical channel to which Television 0230 is tuned. The data can include, but are not limited to: User Generated MO Identification Data; User Generated MP Identification Data; DCD 1924; LO Signal 2120; Channel Data 2320; and/or any other data which Wireless Device 0210 and/or Metadata Server 0280 can retrieve. In the case of a Radio 0232, Channel Data File 3320 can include data identifying directly the Media Operator and/or Media Program transmitting the Advertisement and/or Programming of interest and/or identifying the logical and/or physical channel to which Radio 0232 is tuned. In the case of a Print 0234, Channel Data File 3320 can include data identifying the publication or issue of Print 0234 displaying the Advertisement of interest. Channel Data File 3320 can include data identifying the Media Operator received from Wireless Device 0210 and/or any other Data Processing System, including, but not limited to: the Media Device displaying the Advertisement and/or Programming of interest; and/or any Data Processing System in the network transmitting the Advertisement and/or Programming of interest, e.g., Headend Server 0910.

The system can utilize any database, e.g., Channel/Operator LUT 1300, to identify the Media Operator associated with any logical and/or physical channel to which a Media Device 1910 is tuned.

Date/Time Stamp 3330 can be any data identifying the date/time when Wireless Device 0210 and/or Wireless Device 0210 user performs a function, which can include, but is not limited to: receives data from a Media Device indicating the Media Device is within the vicinity of Wireless Device; viewing a Media Operator; viewing the Advertisement and/or Programming of interest; and/or initiating an User Initiating Input.

Location Stamp 3332 can be any data identifying the location of Wireless Device 0210 user at the time recorded by Date/Time Stamp 3330.

Fingerprint Sample 3340 can be any Fingerprint recorded by and/or received from Wireless Device 0210.

Watermark Sample 3342 can be any Watermark recorded by and/or received from Wireless Device 0210.

Audio Sample 3344 can be a sample of the audio signal transmitted by a Media Device in the vicinity of Wireless Device 0210 and transmitted to Metadata Server 0280. Audio Sample 3344 can be in any format, e.g., 16-bit PCM. In some embodiments, sample 3344 can be a sample of the audio signal. In some embodiments, the system can support Wireless Device 0210 transmitting to Metadata Server 0280 a sample of any type of signal.

User Profile 3350 can include any data provided by Wireless Device 0210 user and/or collected by Wireless Device 0210 and/or any other Media Devices utilized by Wireless Device 0210 user, which the system can utilize to reduce P_{FP} and/or P_{FN}. The data can include, but are not limited to: any demographic data identifying Wireless Device 0210 user; any data describing the interests of Wireless Device 0210 user; any data describing the activity of Wireless Device 0210 and/or the user, e.g., any queries he/she submits to a search engine which can be enable the system to reduce P_{FP} and/or P_{FN}; and/or any Keywords/Keyphrases utilized by Wireless Device 0210 user associated with any given product and/or Product Category.

Population Database 3352 can include any data related to a group of users who are similar to Wireless Device 0210 user in one or more ways, which the system can utilize to reduce P_{FP} and/or P_{FN}. The data can include, but are not limited to: any demographic data identifying the user group; any data describing the interests of the user group; any data describing the activity of the user group; and/or any Keywords/Keyphrases utilized by the user group associated with any given product and/or Product Category. The system can utilize Population Database 3352 in a variety of cases, including, but not limited to: when data from User Profile 3350 is not available. For example, if the system can identify that Wireless Device 0210 is located in a geographical area occupied by an university, it can attribute to Wireless Device 0210 user a high probability that the user is a member of a specific age group and more likely to respond to an Advertisement promoting a product targeted at that age group, even if data from User Profile 3350 is not available.

Media Program Rating Database (not pictured) can include any data describing the estimated number of viewers, listeners, and/or readers or percentage of total viewers, listeners, and/or readers of any Media Programᵢ. The system can utilize data from any source, including, but not limited to, data collected based on asking viewers, listeners, and/or readers to count the incidence and frequency of Media Programs viewed, heard, and/or read; and/or data collected directly from the Media Devices, e.g., a STB, counting the incidence and frequency of Media Programs displayed. The system can utilize data received, collected, and/or generated by any method disclosed herein or from any vendor generating or collecting the data.

Media Program Database 3360 can include any data relating a Media Program with the demographics, interests, and/or other characteristics of the users viewing, listening, and/or reading the Media Program targeted by the Media Operator producing the Media Program. Utilizing the data can enable the system to reduce P_{FP} and/or P_{FN} by increasing the accuracy with which the system can identify the Media Operator and/or Media Program transmitting the Advertisement and/or Programming promoting a product of interest. For example, the system can utilize other information to narrow the population of Advertisements in which a given Wireless Device 0210 user can be potentially interested to two Advertisements, where the first Advertisement was displayed during a Media Program aimed at the 18-24 age male demographic and the second Advertisement was displayed during a Media Program aimed at the 35-49 age female demographic. If the system can identify the Wireless Device 0210 user as a member of the 18-24 age male demographic, then it can utilize that information to select the first Advertisement as the likely Advertisement viewed by the Wireless Device 0210 user.

The data relating a Media Program with the characteristics of viewer, listener, and/or reader of the Media Program can include, but are not limited to: any data based on a standard, either open or proprietary; and/or any non-standard data generated and/or utilized by a given Media Operator used to describe its Media Programs. For example, data based on a standard can be the Program and System Information Protocol (PSIP) developed by the Advanced Television Systems Committee (ATSC). The PSIP includes functionality known as Directed Channel Change (DCC), which classifies a Television Media Program based on a variety of criteria, including, but not limited to: the demographics of the viewers, e.g., age group or gender; and/or the subject matter of the Media Program. The PSIP includes about 140 categories of subject matter to which a Media Operator can assign any given Media Program.

Media Program Database 3360 can include one or more records with any data uniquely identifying a Media Program and any data uniquely identifying the characteristics of the targeted viewers, listeners, and/or readers, e.g., the DCC data. For example, Media Program Database 3360 includes one record with data uniquely identifying Media Program 12345678, which the Media Operator producing the Media Program aimed at the “18-24 Male” demographic and whose subject matter is “Humor.”

Keyword/Keyphrase Database 3362 can include any data relating a Keyword/Keyphrase identifying any brand name, product name, and/or Product Category with the demographics, interests, and/or other characteristics of the user group targeted by Advertiser 0200. Utilizing the data can enable the system to reduce (e.g., substantially reduce) P_{FP} and/or P_{FN} by increasing the accuracy with which the system can identify the Advertisement and/or Programming promoting a product of interest.

Historical Response Database 3370 can include any data relating the historical CTR with an Advertisement. Utilizing the data can enable the system to reduce P_{FP} and/or P_{FN} by increasing (e.g., substantially increasing) the accuracy with which the system can identify the Advertisement and/or Programming promoting a product of interest. The time periods during which Database 3370 can store CTR can include, but are not limited to: any time period of interest to Advertiser 0220 and/or Media Buyer 0222; any time period combined with the Programming during which an Advertisement is displayed, e.g., Database 3370 can include CTR data for Advertisements displayed during a given Media Program; and/or any immediately preceding time period. For example, assuming a large enough sample size, the CTR should be relatively similar for an Advertisement displayed during a Media Program transmitted during eastern standard time (EST) as the same Advertisement displayed during the same Media Program transmitted during pacific standard time (PST) on the same day. Because of the probable similarity in CTR among different time zones, the system can utilize the data to increase the accuracy of identifying the Advertisement and/or Programming promoting a product of interest.

For example, the system can utilize other information to narrow the population of Advertisements in which a given Wireless Device 0210 user can be potentially interested to two Advertisements, where the first Advertisement generated a CTR of 1.25% and the second Advertisement generated a CTR of 0.25%. The system can attribute a relatively high level of confidence in the 1.25% CTR estimate in the PST assumption if the CTR in the EST and other preceding time zones were approximately in the same range. If the difference in the CTR between the two Advertisements is sufficiently significant, then the system can utilize that information to select the first Advertisement as the likely Advertisement viewed by the Wireless Device 0210 user.

Historical Response Database 3370 can include any data collected by Metadata Server 0280 and/or any other Data Processing System.

Degree of Response Database 3372 can include any data relating one or more Advertisements with not only its historical CTR, but also any historical data on other types of responses, including, but not limited to: the rate at which users purchase digital products through their Wireless Devices 0210 and/or other Media Devices (e.g., a Digital Purchase Rate (DPR)); the rate at which users sample digital products (e.g., a Digital Sample Rate (DSR)); the rate at which users purchase products at Physical Retailers (e.g., a Physical Purchase Rate (PPR)); and/or the rate at which users sample physical products (e.g., a Physical Sample Rate (PSR)).

Historical Response Database 3370 and Degree of Response Database 3372 can include data which the system can utilize not only to increase the accuracy with which it can identify the Advertisement and/or Programming promoting a product of interest, but also to generate at least three additional benefits. First, the data from Databases 3370 and/or 3372 can enable Advertiser 0220 and/or Media Buyer 0222 to allocate more efficiently a budget across different advertising channels. If Media Operator A demonstrated a consistently higher CTR, DSR, DPR, PSR, and/or PPR than Media Operator B for a customer group targeted by Advertiser 0220, Advertiser 0220 should prefer buying Media Locations displayed by Media Operator A, all other things being equal. Second, the data from Databases 3370 and/or 3372 can enable Advertiser 0220 and/or Media Buyer 0222 to determine which Advertisement promoting a given product generated a higher CTR, DSR, DPR, PSR, and/or PPR than one or more other Advertisements promoting the same product. Third, a Media Operator can utilize the data from Databases 3370 and/or 3372 to determine which Advertisement is most likely to generate a CTR, DSR, DPR, PSR, and/or PPR and therefore help determine which Advertisement to place in a system where Advertiser 0220 and/or Media Buyer 0222 pay only when an user clicks-through the Advertisement, buys the product promoted in the Advertisement, and/or takes some other action responding to the Advertisement (e.g., a Pay-for-Performance). There are existing methods of utilizing response data to increase revenue from a Pay-for-Performance system for Internet advertising. However, the absence of data measuring CTR, DSR, DPR, PSR, and/or PPR for other media, e.g., Television 0230, Radio, 0232, and/or Print 0234, can make it difficult to implement a Pay-for-Performance system for other media. A Media Operator can utilize the data from Databases 3370 and/or 3372 to place Advertisements which have a higher probability of user response and therefore increase the revenues from implementing a Pay-for-Performance system.

Historical User MO/MP Viewing Database 3374 can include any data identifying the Media Operators and/or Media Programs viewed, heard, and/or read by Wireless Device 0210 user. The data can be collected by any Data Processing System, including, but not limited to: Wireless Device 0210; any other Media Devices utilized by Wireless Device 0210 user; and/or any Data Processing System utilized by an Operator transmitting Advertisements and/or Programming to a Media Device in the vicinity of Wireless Device 0210. For example, the system can receive data identifying one or more Media Operators and/or Media Programs viewed by a Television 0230 over any time period from the cable Television Operator serving the Television 0230. In another example, the system can receive data from Wireless Device 0210 user or any Media Device specifying the logical channels any viewer of the Media Device has programmed as a favorite channel, (which can be referred to as a Favorite Channel). In another example, the system can store in Database 3374 the Media Operators and/or Media Programs viewed, heard, and/or read by Wireless Device 0210 user as identified by any method described herein. For example, the system can transmit along with an User Request an Audio Sample 3344 from which the Metadata Server 0280 can extract a Fingerprint sample and identify the Advertisement and/or Programming associated with Audio Sample 3344. The system can utilize the data identifying the Advertisement and/or Programming of interest not only to identify the product promoted by the Advertisement and/or Programming, but also to store in Database 3374 as a case in which Wireless Device 0210 user viewed the Media Operator and/or Media Program displaying the Advertisement and/or Programming identified.

While the number of Media Operators in a typical cable Television Operator can number in the hundreds, the average household typically views on a regular basis a much smaller number of Media Operators. According to a Nielsen Media Research study, the average American household watched, i.e., spent at least 10 continuous minutes during a yearly survey week, 15.7 Television channels in 2006. While different members of a household may regularly watch different Media Operators, the total number of Media Operators viewed regularly by a household is apparently limited. Identifying the Media Operators viewed regularly by a household can reduce the search space of the number of potential Advertisements of interest likely to promote the product of interest to those Advertisements displayed by the Television Media Operators viewed regularly.

While the number of Media Operators transmitting Advertisement and/or Programming to a Radio 0232 in a given geographical area can number in the hundreds, the average Radio 0232 listener typically listens to a much smaller number of Media Operators. A typical modern Radio 0232 deployed in an automobile has a limited number of buttons enabling the selection of favorite Radio stations. Identifying the Media Operators to which Wireless Device 0210 user listens regularly can reduce the search space of the number of potential Advertisements of interests of interest likely to promote the product of interest to those Advertisements displayed by the Radio Media Operators to which Wireless Device 0210 user listens regularly.

Semantic Meaning Program 3380 is a computer program product capable of performing a variety of functions, including, but not limited to: identifying Keywords/Keyphrases which are not identical, but are related to one or more Keywords/Keyphrases stored in one or more databases utilized by the system to identify an Advertisement and/or Programming, e.g., LUT 1500.

A Wireless Device 0210 user can input one or more Keywords/Keyphrases which are not identical to any of the Keywords/Keyphrases stored in, e.g., LUT 1500, yet are semantically related to such Keywords/Keyphrases. For example, a Wireless Device 0210 user can use a Keyword, “mobile,” to identify a Wireless Device 0210, with which an Advertiser 0220 could have associated a Keyword, “cell phone.”

The system can utilize any method to identify semantically related Keywords/Keyphrases. For example, Wang proposes a method for identifying semantically related words, which can be applied in the system. In another example, Barg et al. propose a method for identifying semantically related data in a semistructured database, which can be applied in the system.

Event Database 3382 can include any data about any event which could affect the CTR, DPR, DSR, PPR, PSR, and/or any other data reflecting the user response to an Advertisement and/or Programming. For example, the broadcast of the baseball World Series can increase the average CTR of any Advertisement promoting baseball products. The system can utilize the scheduling of the baseball World Series in identifying an Advertisement promoting a baseball product.

Program: 3390 is a computer program product capable of performing a variety of functions, including, but not limited to: (a) identifying a product of interest, the Advertisement and/or Programming promoting the product of interest, and/or the Media Operator and/or Media Program displaying an Advertisement and/or Programming of interest by utilizing any existing algorithm and/or any algorithm described herein; and/or (b) processing an User Request which is independent of any Advertisement and/or Programming viewed.

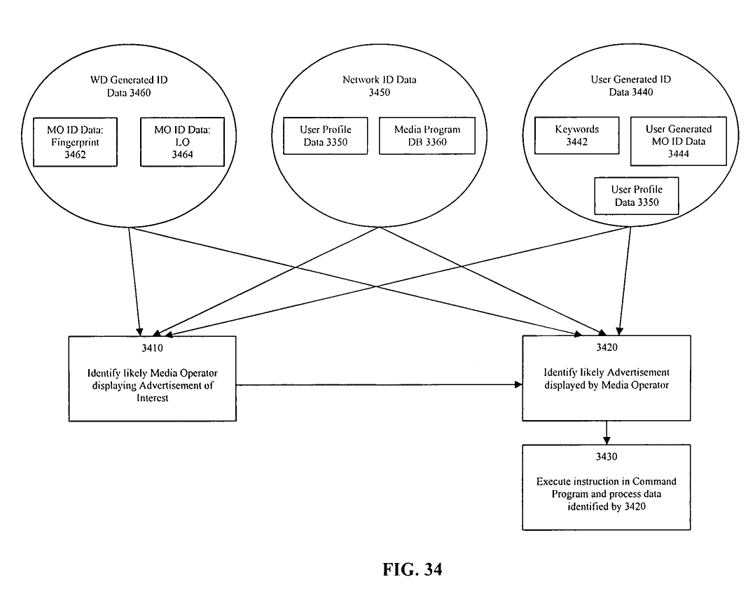

FIG. 34 depicts a flowchart of an exemplary Method 3400 enabling the identification of an Advertisement displayed on a Media Device. The flowchart is described with reference to the system depicted in FIG. 33. However, the flowchart is not limited to that embodiment. The system can implement the flowchart with reference to systems utilizing a subset of the components, or additional, related, alternative, and/or equivalent components depicted in FIG. 33. The system can implement the flowchart by executing a subset of the methods, executing the methods in different order, and/or executing other or additional related or equivalent methods.

In some embodiments, a method can be configured to identify an Advertisement of interest based on an User Request which can include one or more Keywords/Keyphrases. The system can support the identification of an Advertisement of interest based on an User Request which is based on natural language, i.e., a query presented in the form of the syntax expressed by an user in normal conversation.

In some embodiments, a method can be configured to identify an Advertisement of interest based on an User Request. The system can support the identification of any resource related to an User Request even if a Wireless Device 0210 user makes the User Request independently of any Advertisement and/or Programming. For example, a Wireless Device 0210 user can make an User Request for more information about a product of interest or to purchase a product of interest without having viewed an Advertisement promoting the product of interest of interest. The system can support the identification of any resource related to the User Request, e.g., a web page or information enabling the purchase of the product of interest, and transmit the resource to Wireless Device 0210.

The factors which can bear on the system's ability to identify the Advertisement of interest to a Wireless Device 0210 user, can include, but is not limited to, the following.

The number of Television Advertisements displayed in any given geographical area within the time period when a Wireless Device 0210 user is most likely to transmit an User Request on one Television Media Operator (collectively can be referred to as a Potential Advertisements of Interest per Television Media Operator) is typically much smaller than the number of Advertisements displayed across all or selected portion of Television Media Operators during the same time period in the same location. In addition, the number of Potential Advertisements of Interest per Radio Media Operator is typically much smaller than the number of Advertisements displayed across all or a selected portion of Radio Media Operators.

The ability of the system to identify the Potential Advertisements of Interest per Media Operator can be a function of the following factors. First is the number of Advertisements displayed by a Media Operator in any given time period. According to the American Association of Advertising Agencies, the average amount of time broadcast Television networks transmitted Advertisements in 2002 ranged from 16:43 minutes per hour during primetime to 20:53 minutes per hour during daytime. Assuming the average Television Advertisement is about 30 seconds in duration, the average number of Television Advertisements is about 38 per hour.

Second is the distribution of the Advertisements by a Media Operator. Media Operators in certain media, e.g., Television and Radio, typically aggregate the transmission of their Advertisements in groups. In Television and Radio, an Advertisement group is typically called a pod. Television Media Operators and Radio Media Operators typically interrupt their Programming with pods, which can vary in duration and the number of Advertisements displayed in each pod. Given the same total number of Advertisements displayed in any time period, a Media Operator can display a small number of Advertisements per pod and transmit a larger number of pods or a large number of Advertisements per pod and a fewer number of pods. The distribution of Advertisements can have at least two effects on the ability of the system to identify the Potential Advertisements of Interest per Media Operator: (a) the empirical observation that Advertisements displayed during pods of shorter duration have a significantly higher unaided recall level than Advertisements displayed during pods of longer duration, according to a Nielsen Media Research study; and/or (b) a shorter period of time between pods can reduce the number of Potential Advertisements of Interest per Media Operator if a typical viewer or listener is more likely to obtain more information about a product of interest or buy the product of interest during pods rather than during Programming.

Third is the empirical observation that the Advertisements displayed in the first, second, and last pod position have a significantly higher unaided recall level than Advertisements displayed in other pod positions, according to the Nielsen Media Research study. According to the study, Advertisements displayed in the first and second pod positions had a 59% higher unaided recall score than Advertisements displayed in the middle pod positions.

Fourth is the typical practice of Television Media Operators and Radio Media Operators to refrain from displaying Advertisements from competing Advertisers 0220 during any pod or Media Program. Because of this practice, the identification of the Product Category of an Advertisement can reduce the number of potential Advertisements of Interest per Media Operator.

Fifth is the empirical observation that shorter Advertisements have a lower rate of recall than longer Advertisements. According to the Nielsen Media Research study, the unaided recall level of a 15-second Television Advertisement is half that of a 30-second Television Advertisement.

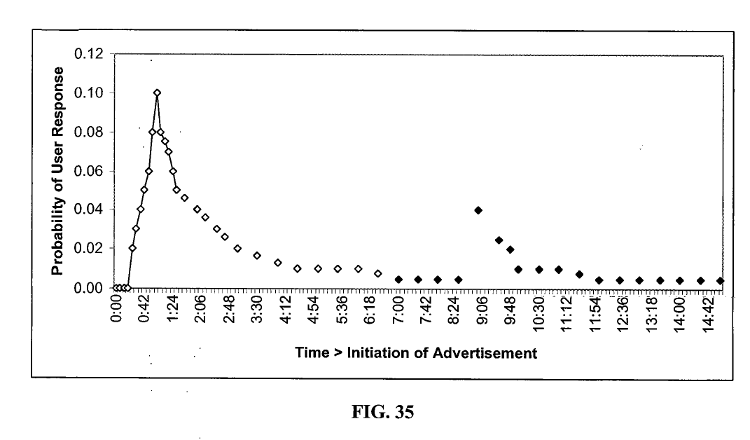

Sixth is the probability of an user response to an Advertisement as a function of time, P_{UR}(t). The probability of an Advertisement stimulating a Wireless Device 0210 user to obtain more information about a product of interest or buy the product of interest is likely highest toward the end of display of the Advertisement or immediately after the display of the Advertisement and likely declines the more time lapses. FIG. 35 depicts an exemplary distribution of the probability of a Wireless Device 0210 user response over a time period during and about 15 minutes after the display of the Advertisement of interest. A Wireless Device 0210 user is highly unlikely to decide to obtain more information about a product of interest or buy the product of interest until the end of a typical 30-second Advertisement. P_{UR}(t) is likely highest from the end of the display of the Advertisement until some time period in the first few minutes after the display of the Advertisement. P_{UR}(t) likely declines until the next pod (which the present example assumes occurs about nine minutes later) for at least two reasons: (a) the resumption of Programming probably diverts the attention of a viewer or listener; and/or (b) the resumption of the next pod can remind the Wireless Device 0210 user of his/her interest in a product promoted in an Advertisement displayed during the previous pod. In some embodiments, it can be assumed that the typical Wireless Device 0210 user initiates an User Initiating Input within 15 minutes of display of the Advertisement of interest.

There can be other factors affecting P_{UR}(t), including, but not limited to: the frequency a given Advertisement is displayed by an Advertiser 0220 and/or Media Buyer 0222 across any Media Operator, e.g., P_{UR}(t) is likely lower for an Advertisement displayed once than the same Advertisement displayed on subsequent occasions; and/or the demographic targeted by a Media Program, e.g., P_{UR}(t) is likely lower for a Media Program aimed at an age group, like children under a certain age, unlikely to use Wireless Devices 0210.

Because of the above factors, the Potential Advertisements of Interest per Television Media Operator within 15 minutes of display can typically number in the single digits. In contrast, the number of total Advertisements across all or a selected portion of Television Media Operators can equal the product of (Potential Advertisements of Interest per Television Media Operator) and (the number of Television Media Operators transmitting Advertisements and/or Programming during the time period). A typical cable Television Operator can transmit simultaneously a large number of Media Operators, which can number in the hundreds. Therefore, the number of Potential Advertisements of Interest per Television Media Operator should typically be much smaller than the number of Advertisements displayed across all or a selected portion of Television Media Operators during the same time period in the same location. The same calculation should apply to Radio 0232 and other comparable Advertising channels where there are a large number of Media Operators from which a Wireless Device 0210 user can select.

At least two factors suggest the preferred embodiment of the method to identify the Advertisement of interest. The first factor is the large disparity between the number of Potential Advertisements of Interest per Television Media Operator and the number of Advertisements displayed across all or a selected portion of Television Media Operators during the same time period in the same location. The second factor is relatively large number of sources of data the system can utilize to identify the Media Operator transmitting the Advertisement of interest.

Because of these factors, in some embodiments, the system can be configured to utilize a two-hierarchical method to identify the Advertisement of interest. The Method 3400 can comprise the sequential solution of two problems of finding an optimal or close to optimal solution: first at 3410, identifying the likely Media Operator transmitting the Advertisement of interest; and second at 3420, identifying the Advertisement of interest transmitted by the Media Operator in the first step. After identifying the Advertisement of interest, the present method can at 3430 execute any instruction in Command Program 2530 utilizing any data associated with the Advertisement identified at 3420.

In some embodiments, a two-step hierarchical method can be used to identify the Advertisement of interest. In some embodiments, one step or more than two steps can be used. In addition, any class of optimization method can be utilized. The classes of optimization methods can include, but are not limited to: (a) combinatorial optimization algorithms, e.g., branch and bound; (b) evolutionary algorithms, e.g., genetic algorithms, or simulated annealing; and/or (c) stochastic programming.

### 6.2.1.1 Identification of Media Operator

In some embodiments, Method 3400 at 3410 can generate, collect, retrieve, and/or utilize data which can identify the Media Operator and/or Media Program viewed, heard, or read by Wireless Device 0210 user. The data can include, but are not limited to: (a) any User Generated Identification Data 3440, including, but not limited to, one or more Keywords/Keyphrases 3442, User Generated MO Identification Data 3444, and/or User Profile Data 3350; (b) any Wireless Device Generated Identification Data 3460, including, but not limited to, MO Identification Data: Fingerprint 3462, and/or MO Identification Data: LO Signal 3464; and/or (c) any Network Identification Data 3450, including, but not limited to, User Profile Data 3350, and/or Media Program Database 3360. Some of the data, e.g., User Profile Data 3350, can be stored and/or retrieved from multiple locations, e.g., Wireless Device 0210 and Metadata Server 0280.

The present method can calculate a score for any Media Operatorᵢ included in any database, e.g., any TV Network listed in LUT 1500, by summing the products of one or more variables and their respective weights, which can include, but are not limited to, the following variables in exemplary Equation 1:

Rank(Media Operatorᵢ)=[((User Generated MO Identification Data)*w₁)+[((User Generated MP Identification Data)*w₂)+((MO Identification Data: Watermark)*w₃)+((MP Identification Data: Watermark)*w₄)+((MO Identification Data: Fingerprint)*w₅)+((MP Identification Data: Fingerprint)*w₆)+((MO Identification Data: Displayed Channel)*w₇)+((MO Identification Data: LO Signal)*w₈)+((MO Identification Data: Remote Control)*w₉)+((Probability of User Viewing MP((User Profile Data 3350),(Media Program Database 3360))*w₁₀)+((Probability of User Group Viewing MP((Population Database 3352),(Media Program Database 3360))*w₁₁)+((Probability of User Viewing MO/MP(Historical User MO/MP Viewing Database 3374))*w₁₂)]*Rank(Media Operatorᵢ)_{ADJ}

subject to:

Media Operatorᵢ is an element of {Media Operators with associated Keywords/Keyphrases where at least one Keyword/Keyphrase matches that a Keyword/Keyphrase in User Request}

The score calculated by Equation 1 indicates the probability that Media Operatorᵢ is the most likely Media Operator to have displayed the Advertisement of interest. Equation 1 can include one or more other variables whose values can enable the system to identify the Media Operator and/or Media Program most likely to have displayed the Advertisement of interest.

While the present method can rank any Media Operatorᵢ, it is not limited to that embodiment. The system can apply any of the disclosed and/or existing systems, methods, and/or computer program products to rank any Media Programᵢ.

In some embodiments, a method can be configured to rank any Media Operatorᵢ by summing the products of one or more variables and their respective weights. The system can support the ranking of any Media Operatorᵢ by utilizing any ranking method.

In some embodiments, the present method can apply one or more filters to the database of Media Operatorsᵢ to limit the number of Media Operators for which the present method can calculate a score to only those Media Operatorsᵢ meeting certain criteria. The criteria can include, but are not limited to, the following three criteria. The first criterion is whether any Media Operatorᵢ has any associated Keyword/Keyphrase matching one or more Keywords/Keyphrases in the User Request. Applying the Keyword/Keyphrase filter can limit the search space to those Media Operators which displayed at least one Advertisement and/or Programming promoting the product of interest as identified by its association with a matching Keyword/Keyphrase. Scoring and ranking only those Media Operators with matching Keywords/Keyphrases can increase the probability that the system identifies the Advertisement and/or Programming which stimulated Wireless Device 0210 user to transmit the User Request. The second criterion is whether any Media Operatorᵢ has any associated Keyword/Keyphrase matching one or more Keywords/Keyphrases in the User Request, where the Media Operatorᵢ transmits one or more Advertisements and/or Programming including the matching Keyword/Keyphrase within any specified time period, e.g., T_{URT}, which is defined later in the present section. The third criterion is whether any Media Operatorᵢ is an element of the set of Media Operators most likely to be viewed, heard, and/or read by Wireless Device 0210 user within any specified time period, e.g., T_{URT}. The system can utilize any method to identify the set of most likely viewed, heard, and/or read Media Operators, e.g., any method described in Section 6.2.1.5.

The system can apply the filters in a variety of ways, including, but not limited to: applying one or more filters before calculating a score for each Media Operatorᵢ and then calculating a score for just those Media Operators meeting the criteria; or applying one or more filters to the Media Operators after calculating their scores. In some embodiments, the system can apply a filter by querying a database, e.g., LUT 1500, for any Media Operatorsᵢ, e.g., a Television Network, which transmitted an Advertisement which includes one or more Keywords/Keyphrases which match any Keywords/Keyphrases in the User Request. In some embodiments, a filter can be applied by utilizing any method described in more detail in Section 6.2.1.5.

The system can convert into a dummy variable each of the values of the variables in Equation 1, including, but not limited to: (a) any variable directly identifying the Media Operator displaying the Advertisement promoting the product of interest, including, but not limited to, User Generated MO Identification Data, MO Identification Data: Watermark, MO Identification Data: Fingerprint, MO Identification Data: Displayed Channel, MO Identification Data: LO Signal, and/or MO Identification Data: Remote Control; and/or (b) any variable indirectly identifying the Media Operator displaying the Advertisement promoting the product of interest, including, but not limited to, User Generated MP Identification Data, MP Identification Data: Watermark, MP Identification Data Fingerprint, Probability of User Viewing MP, and/or Probability of User Group Viewing MP. That is, if, e.g., the User Generated MO Identification Data specifies that the Media Operator displaying the Advertisement promoting the product of interest is, e.g., TV Network BCD, then for Media Operator (BCD) the system can convert the value, “BCD,” into the value, “1.” If the User Generated MO Identification Data specifies that the Media Operator displaying the Advertisement promoting the product of interest is TV Network DEF, then for Media Operator (BCD) the system can convert the value, “DEF,” into the value, “0.”

The present method can utilize any method to calculate Rank (Media Operatorᵢ), e.g., a simple iterative algorithm.

The system can identify the Media Operator transmitting the Media Program identified by the values of the variables, including, but not limited to: User Generated MP Identification Data, MP Identification Data: Watermark, MP Identification Data: Fingerprint, Probability of User Viewing MP, and/or Probability of User Group Viewing MP. That is, if, e.g., the MP Identification Data: Fingerprint specifies that the Media Program during which a Media Operator is displaying the Advertisement promoting the product of interest is, e.g., “Program Block 1” in Fingerprint/Operator LUT 1400, then the system can specify that the Media Operator transmitting the Media Program, “Program Block 1,” is TV Network ABC.

Probability of User Viewing MP is a variable=f((User Profile Data 3350), (Media Program Database 3360)). The independent variable, User Profile Data 3350, can have one or more values specifying any parameter which can be related to one or more parameters in Media Program Database 3360. For example, if User Profile Data 3350 includes a value=18-24 for an attribute=age range, the system can lookup in Media Program Database 3360, for example, an age range attribute which could have a value associated with the 18-24 age range equal to one or more Media Programs displayed during the time period of interest and identified by the code “12345678.” Probability of User Viewing MP can be a function of, inter alia, the number of Media Programs displayed during the time period of interest targeted at viewers in the 18-24 age range, and/or the probability that the Wireless Device 0210 user can view a Media Program targeted at viewers other than the 18-24 age range.

Probability of User Group Viewing MP is a variable=f((Population Database 3352), (Media Program Database 3360)). The independent variable, Population Database 3352, can have one or more values specifying any parameter which can be related to one or more parameters in Media Program Database 3360.

Probability of User Viewing MO/MP is a variable=f((Historical User MO/MP Viewing Database 3374)). The independent variable, Historical User MO/MP Viewing Database 3374, can have one or more values specifying one or more Media Operators and/or Media Programs regularly viewed, heard, and/or read by Wireless Device 0210 user and/or the household in which Wireless Device 0210 user resides. For example, if Database 3374 identifies 16 Television Media Operators regularly viewed by the household in which Wireless Device 0210 user resides, the system can limit the Media Operatorsᵢ searched or attribute a higher Rank (Media Operatorᵢ) to those Media Operators regularly viewed by Wireless Device 0210 user.

The Keywords/Keyphrases inputted by Wireless Device 0210 user can bear on Rank (Media Operatorᵢ). If the Media Operatorᵢ with the highest rank is, e.g., TV Network BCD, and the Keywords/Keyphrases inputted by Wireless Device 0210 user identify a product which has not been displayed on TV Network BCD for a sufficient long time period, then Advertiser 0220 and/or Media Buyer 0222 can reasonably conclude that: (a) Wireless Device 0210 user is interested in obtaining information about the product or buying the product independently of having viewed, heard, or read an Advertisement and/or Programming promoting the product; (b) the system has identified a Media Operatorᵢ which was not transmitting the Advertisement and/or Programming which promoted the product of interest; or (c) the system incorrectly identified the product of interest.

In some embodiments, the present method can reflect the effect of Keywords/Keyphrases on the identification of the Media Operator viewed, heard, or read by Wireless Device 0210 user by multiplying Rank (Media Operatorᵢ) by a factor, Rank (Media Operatorᵢ)_{ADJ}=f(T_{MO DISPLAY}). T_{MO DISPLAY} is a variable equal to the length of time since the Media Operator with the highest rank displayed the Advertisement and/or Programming promoting the product of interest. The shorter the length of time, i.e., the more recently the Media Operator with the highest rank displayed the Advertisement, the larger the value of Rank (Media Operatorᵢ)_{ADJ}. That is, assuming all else equal, a Media Operator with the highest rank displaying an Advertisement promoting the product of interest identified by one or more Keywords/Keyphrases inputted by Wireless Device 0210 user 1 minute before the user initiates an User Initiating Input will have a higher value of Rank (Media Operatorᵢ)_{ADJ} than a Media Operator with the highest rank displaying the Advertisement of interest 1 hour before the user initiates an User Initiating Input. If the Media Operator with the highest rank never displayed or did not display within T_{URT} an Advertisement or Programming promoting the product of interest identified by one or more Keywords/Keyphrases inputted by Wireless Device 0210 user, then the value of Rank (Media Operatorᵢ)_{ADJ} can equal zero.

For one or more of the variables in Equation 1, its variance can affect the Rank (Media Operatorᵢ). That is, some of the variables can have a probability distribution which can be sufficiently spread such that the Rank (Media Operatorᵢ) should be lower.

In one example, for MO Identification Data: Fingerprint, there can be a significant variance around the expected value for a variety of reasons, including, but not limited to: (a) the duration of the Signal 1710 sample may not be long enough for the system to extract an accurate Fingerprint from the signal; (b) there can be significant noise in vicinity of Audio Receiving Component 0378; and/or (c) there can be significant noise in Voice Channel 2710.

MO Identification Data: Fingerprint can be a random variable with a probability distribution which can be described by the following cumulative distribution function:

F(x)=Probability [MO Identification Data: Fingerprint≦x]

If the probability distribution of MO Identification Data: Fingerprint assumes the form of a standard normal distribution, then:

F(x;a,b)=F((x−a)/b;0,1),

where a corresponds to the mean and b corresponds to the standard deviation.

If the probability distribution of MO Identification Data: Fingerprint assumes the form of a distribution other than a standard normal distribution, then the system can calculate its cumulative distribution function utilizing any method.

In another example, where P_{USER VIEWS MP} is a function of User Profile Data 3350 and Media Program Database 3360, there can be a significant variance around the expected value for a variety of reasons, including, but not limited to: (a) the data in User Profile Data 3350 may be incorrect; and/or (b) the correlation between the category of users in which Wireless Device 0210 user is classified and the probability of the user category viewing the Media Program as specified in Media Program Database 3360 can be low.

P_{USER VIEWS MP} can be a random variable with a probability distribution which can be described by the following cumulative distribution function:

F(x)=Probability[P_{USER VIEWS MP}≦x]

If the probability distribution of P_{USER VIEWS MP} assumes the form of a standard normal distribution, then:

F(x;a,b)=F((x−a)/b;0,1),

where a corresponds to the mean and b corresponds to the standard deviation.

If the probability distribution of P_{USER VIEWS MP} assumes the form of a distribution other than a standard normal distribution, then the system can calculate its cumulative distribution function utilizing any appropriate method.

For any variable in Equation 1, the system can adjust the value to reflect any variance by utilizing any appropriate method. For example, the system can calculate the expected value of the variable by calculating the weighted average of its possible values. In some embodiments, the system can adjust Equation 1 by summing the products of one or more of the expected values of the variables and their respective weights as follows:

Rank(Media Operatorᵢ)=[((Expected Value(User Generated MO Identification Data))*w₁)++((Expected Value(Probability of User Viewing MO/MP(Historical User MO/MP Viewing Database 3374)))*w₁₂)]*Rank(Media Operatorᵢ)_{ADJ}

For example, (Probability of User Viewing MO/MP (Historical User MO/MP Viewing Database 3374)) is a continuous random variable. There will be some variance around the expected value of the variable. When the system begins collecting data in Historical User MO/MP Viewing Database 3374, the variance can be large for a variety of reasons, including, but not limited to, the small size of the sample observations of the Media Operators and/or Media Programs viewed, heard, and/or read by Wireless Device 0210 user. Over time as Historical User MO/MP Viewing Database 3374 collects more observations, the variance can decline. So in the latter case, the expected value of the variable can rise.

Equation 1 can include weights, w₁, . . . wₙ, each of which reflects the importance, relevance, and/or availability of the associated variable. If Metadata 0280 does not have access to data for a variable, then the system can assign a value of zero to that weight or assign a value of zero to that variable. If Metadata 0280 does have access to data for a variable, then the system can assign any positive value to that weight which reflects the probability that the value in the variable accurately identifies the Media Operator displaying the Advertisement of interest relative to the value in other variables. For example, if historical or other data show that MO Identification Data: Fingerprint is more accurate in identifying the Media Operator displaying the Advertisement of interest than User Generated MO Identification Data, then W₅ should >w₁.

The system can generate weights, w₁, . . . wₙ, whose sum is unity. In some embodiments, the system can generate weights without consideration of the sum. Since the present method can be configured to select the Media Operator with the highest rank, it can still select the highest ranking Media Operator even if the sum of weights, w₁, . . . wₙ, is not unity.

In some embodiments, the system can fix the weights, w₁, . . . wₙ, during the implementation of Method 3400. That is, Method 3400 can calculate Equation 1 by utilizing predetermined weights, w₁, . . . wₙ.

In some embodiments, the system can vary the weights, w₁, . . . wₙ, during the implementation of Method 3400 to process one User Request. The system can generate a more accurate and/or faster ranking of Media Operatorᵢ by varying in real-time the weights depending on the quantity and/or quality of data received, collected, generated, and/or retrieved for calculation of Equation 1. For example, the system can collect enough data for one variable, e.g., MO Identification Data: Fingerprint, enabling Metadata Server 0280 to achieve a sufficiently accurate identification of the Media Operator displaying the Advertisement of interest which can obviate the need to collect data for other variables. In this example, the system can increase in real-time the weight, W₅, and decrease other weights. The system can set one or more weights at zero if the associated variable has zero effect on Rank (Media Operatorᵢ).

In some embodiments, the system can adjust the weights, w₁, . . . wₙ, during the implementation of Method 3400 across multiple User Requests. The benefits of adjusting the weights can include, but are not limited to: (a) reducing P_{FP} and/or P_{FN}; (b) reducing T_{R}; and (c) reducing R. Adjusting the weights can generate the benefits by incorporating data from prior implementations of Method 3400 so that the present method can learn which set of weights is most effective in generating the benefits.

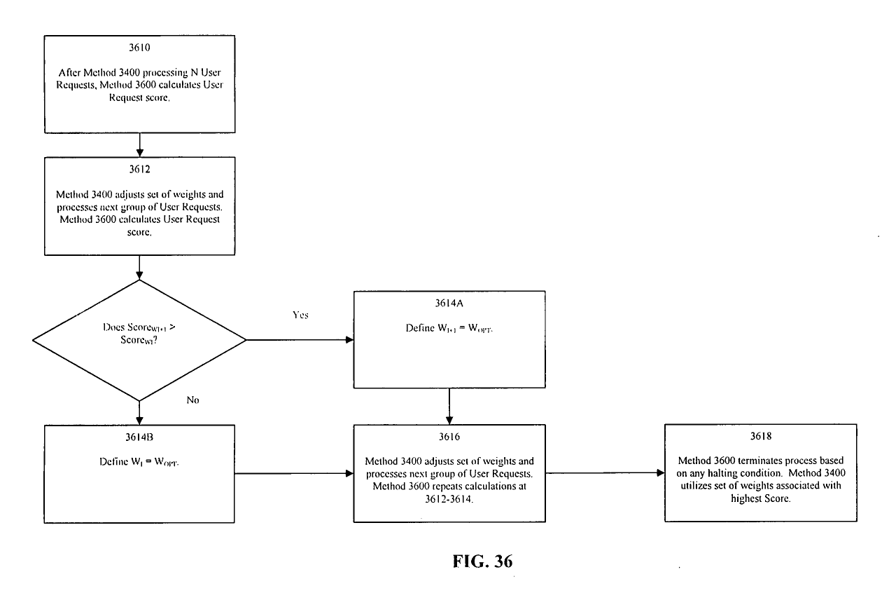

The system can adjust the weights through a variety of methods, including, but not limited to, the following. FIG. 36 depicts a flowchart of an exemplary Method 3600 enabling the adjustment of weights. The system can implement the flowchart by executing a subset of the methods, executing the methods in different order, and/or executing other or additional related or equivalent methods.

At 3610, Method 3400 can start with an initial set of weights, W_{I}. After Method 3400 processes any number N_{I} of User Requests, Method 3600 can calculate a score, Score_{W1} for all or a selected portion of User Requests processed utilizing the set of weights, W_{I}. The Score_{W1} can reflect any outcome valued by Advertiser 0220 and/or Media Buyer 0222. For example, Advertiser 0220 can value: (a) PPR more than PSR; (b) DPR more than DSR; and (c) PSR and DSR more than CTR. The set of values can reflect an Advertiser 0220 valuing purchases more highly than sampling and sampling more highly than a retrieval of a web page. One exemplary Score_{W1} can assign any purchase at a Physical Retailer or Internet Retailer a score of, e.g., 1.00, any sampling at a Physical Retailer or Internet Retailer a score of, e.g., 0.75, and any retrieval of a web page a score of, e.g., 0.50. Method 3600 can sum the values of any purchases, samplings, or web page retrievals for User Requests processed utilizing the set of weights, W₁.

At 3612, Method 3400 can adjust the set of weights to W_{I+1}. After Method 3400 processes the next group of User Requests, Method 3600 can calculate a score, Score_{WI+1}, for User Requests processed utilizing the set of weights, W_{I+1}.

At 3614A, Method 3600 can define W_{I+1} as the most fit set of weights, W_{OPT}, if Score_{WI+1} is higher than Score_{WI}.

At 3614B, Method 3600 can define W_{I} as the most fit set of weights, W_{OPT}, if Score_{WI+1} is lower than Score_{WI}.

At 3616, Method 3400 can adjust the set of weights to W_{I+2}. Method 3600 can repeat the calculations at 3612-3614.

At 3618, Method 3600 can terminate the process based on any halting condition, including, but not limited to: length of time; number or group of User Requests; and/or some Score which one or more Advertisers 0220 and/or Media Buyers 0222 find acceptable. After the halting condition, Method 3400 can utilize the set of weights W associated with the highest Score.

In describing Method 3600, one method of determining a desirable set of weights, W_{OPT} can be defined. However, the system is not limited to that embodiment. The system can support any method of determining a desirable set of weights, W_{OPT}, including, but not limited to: (a) combinatorial optimization algorithms, e.g., branch and bound; (b) evolutionary algorithms, e.g., genetic algorithms, or simulated annealing; and/or (c) stochastic programming.

The system can utilize data to distinguish between Media Operators, e.g., a Television Media Operator and a Radio Media Operator. The data can include, but are not limited to: Location Stamp 3332; and/or Fingerprint Sample 3340. For example, if the data in Location Stamp 3332 or any other type of data identifying the location of Wireless Device 0210 or velocity at which Wireless Device 0210 is moving shows that Wireless Device 0210 is probably moving in an automobile, then Metadata Server 0280 can infer that any User Request transmitted by Wireless Device 0210 probably is related to a Radio Advertisement, rather than a Television Advertisement. In addition, the system can utilize data from Fingerprint Sample 3340 to identify the Media Operator as a Radio Media Operator on the basis of the Programming extracted from Fingerprint Sample 3340.

After ranking each Media Operatorᵢ, Method 3400 can select the Media Operator with the highest Rank (Media Operatorᵢ), which the system identifies as the most probable Media Operator displaying the Advertisement of interest and can identify as Media Operator (Highest Rank).

### 6.2.1.2 Identification of Advertisement or Programming

Having identified Media Operator (Highest Rank), Method 3400 at 3420 can generate, collect, retrieve, and/or utilize data which can identify the Advertisement most likely to have promoted the product of interest to Wireless Device 0210 user. The data can include, but are not limited to: (a) any User Generated Identification Data 3440, including, but not limited to, one or more Keywords/Keyphrases 3442, and/or User Profile Data 3350; (b) any Wireless Device Generated Identification Data 3460, and/or (c) any Network Identification Data 3450, including, but not limited to, User Profile Data 3350.

Having identified the Media Operator most likely to have displayed the Advertisement of interest, Method 3400 can reduce significantly the search space or feasible region of potential Advertisements of interest displayed by all or a selected portion of Media Operators to the Potential Advertisements of Interest per Television Media Operator for the Media Operator selected at 3410. In some embodiments, Television Advertisement of interest at 3420 can be identified, it is not limited to that embodiment. In some embodiments, the system can support the identification of an Advertisement of interest at 3420 displayed on any Media Device.

The present method can calculate a score for any Advertisement displayed by Media Operator (Highest Rank) which is included in any database, e.g., any Advertisement listed in LUT 1500, by summing the products of one or more variables and their respective weights, which can include, but are not limited to, the following variables in exemplary Equation 2:

Rank(Advertisementᵢ)=((Advertisementᵢ Associated with Keyword/Keyphrase 1 Identifying Brand or Product)*w₁)+((Advertisementᵢ Associated with Keyword/Keyphrase 2 Identifying Brand or Product)*w₂)+ . . . ((Advertisementᵢ Associated with Keyword/Keyphrase n Identifying Brand or Product)*wₙ)+((Advertisementᵢ Associated with Keyword/Keyphrase Identifying Product Category)*wₙ₊₁)+((T_{UII}−Time of Display of Advertisementᵢ)*(Decay Rate)*wₙ₊₂)+((Date of Display of Advertisementᵢ)*wₙ₊₃)+((Probability of User Interest in Product Promoted in Advertisementᵢ((User Profile Data 3350),(Keyword/Keyphrase Database 3362), (Keyword/Keyphrase Identifying Brand or Product),(Keyword/Keyphrase Identifying Product Category)))*wₙ₊₄)+((Probability of User Responding to Advertisementᵢ(Advertisementᵢ Placement in Pod of Short Duration v. Pod of Long Duration))*wₙ₊₅)+((Probability of User Responding to Advertisementᵢ(Advertisementᵢ Position in Pod))*wₙ₊₆)+((Probability of User Responding to Advertisementᵢ(Length of Time of Advertisementᵢ))*wₙ₊₇)+((Probability of User Responding to Advertisementᵢ((Date/Time Stamp 3330), (Location Stamp 3332),Product Category)*wₙ₊₈)+((Probability of User Responding to Advertisementᵢ(Event Database 3382), Product Category)*wₙ₊₉)+((Probability of User Responding to Advertisementᵢ(Advertisement Type (Transactional, Non-Transactional))*wₙ₊₁₀)+(P_{UR}(Length of Time>Initiation of Advertisementᵢ)*wₙ₊₁₁)

The score calculated by Equation 2 indicates the probability that Advertisementᵢ is the most likely Advertisement to have promoted the product of interest to Wireless Device 0210 user. Equation 2 can include one or more other variables whose values can enable the system to identify the Advertisement most likely to have promoted the product of interest to Wireless Device 0210 user.

While the present method can be configured to rank any Advertisementᵢ by summing the products of one or more variables and their respective weights, the system is not limited to that embodiment. The system can support the ranking of any Advertisementᵢ by utilizing any appropriate ranking method.

The method can reduce the search space of potential Advertisements of interest to those Advertisements displayed by Media Operator (Highest Rank) during a time period, T_{URT}. In some embodiments, T_{URT} can be defined as the period of time during which historical or other data show when a certain percentage of User Requests for a product promoted by an Advertisement are received by Metadata Server 0280 within initiation of the Advertisement. For example, historical data can show that Metadata Server 0280 receives 90 percent of User Requests within 15 minutes of initial display of the Advertisement promoting the product of interest. The system can then limit the search space of Potential Advertisements of Interest per Television Media Operator to those Advertisements displayed by Media Operator (Highest Rank) within 15 minutes of User Initiating Input. The system is not limited to an embodiment of limiting the search space to those Advertisements displayed within 15 minutes of User Initiating Input. The system can support systems, methods, and computer program products with T_{URT} of any period of time. The system is not limited to an embodiment of defining the threshold for T_{URT} at 90 percent of User Requests. The system can support systems, methods, and computer program products with any threshold for T_{URT}.

T_{URT} can be a function of a variety of variables, including, but not limited to, the following. First, the type of Media Device receiving an Advertisement can affect the duration of T_{URT}. While some listening of Radio 0232 can occur on long drives, the average time spent listening to a Radio 0232 is relatively short. According to a Bridge Ratings study, of Americans spending at least one hour per day commuting in their automobiles, the average listener spent only 25 minutes listening to a Radio 0232. If the system assumes that a typical Wireless Device 0210 user responds to an Advertisement in the same day he/she views, hears, or reads the Advertisement, then T_{URT} can be on the order of an hour or less, which would limit the number of potential Radio Advertisements of interest the system can be configured to evaluate to a smaller number than all or a selected portion of Radio Advertisements transmitted each day. Second, because of the availability of DVRs for Television Programming and utilization of DVRs to record and view Television Programming for Time-Shifted Viewing, T_{URT} can be longer for a Television Advertisement than for Advertisements displayed by other types of Media Programs which are not viewed on a time-shifted basis. Third, T_{URT} can vary depending on the type of Media Program viewed by Wireless Device 0210 user. Viewers typically record some types of Programming more frequently than other types of Programming. For example, a viewer can view a drama or comedy Television Media Program at some time after the original transmission of the Media Program without losing any entertainment benefit. However, a viewer is unlikely to record and view a Media Program presenting daily news after its original transmission, because he/she will most likely learn about the news through other means. Therefore, any Advertisement displayed during a Media Program presenting live news can have a shorter T_{URT} than Advertisements displayed during other types of Media Programs.

The T_{URT} is related to P_{FN} to the extent that the present method excludes from the search space of Potential Advertisements of Interest per Television Media Operator to those Advertisements displayed by Media Operator (Highest Rank) after 15 minutes of initial display of the Advertisement.

The system can adjust T_{URT} to reflect any Time-Shifted Viewing. A Wireless Device 0210 user can view a Television Media Program and its associated Advertisements at some time after a Media Operator originally transmits the Media Program and the associated Advertisements. The increasing utilization of DVRs can affect T_{URT} in a variety of ways, including, but not limited to: (a) to the extent that a viewer utilizes a DVR to watch a Media Program and its associated Advertisements after their original transmission, T_{URT} will increase; or (b) to the extent that a viewer utilizes a DVR to watch a Media Program and skip its associated Advertisements, T_{URT} will not increase. Advertisers are increasing their utilization of product placement within Programming to promote their products. If Wireless Device 0210 users respond to a Media Program which promotes a product of interest and which users view after the original transmission of the Media Program, T_{URT} will increase.

Because most consumers typically view one or more Media Programs recorded for Time-Shifted Viewing and their associated Advertisements a few days after a Media Operator originally transmitted the Advertisement and/or Programming, T_{URT} should typically increase to a maximum of at most a few days.

Time-Shifted Viewing can reduce the search space of potential Advertisements of interest, because a Wireless Device 0210 user viewing one or Media Programs recorded by a DVR can be significantly less likely to change channels. A Wireless Device 0210 user viewing a Media Program recorded by a DVR is probably a more loyal viewer of the Media Program. Any disclosed systems, methods, and/or computer program products can be configured to reflect this effect through a variety of means, including, but not limited to: including a variable in Equation 1 which specifies whether the Media Programᵢ identified by a Watermark and/or Fingerprint is viewed by Wireless Device 0210 user at a time different from the time the Media Operator originally transmitted the Media Programᵢ. The system can distinguish the times by comparing: (a) the Date/Time Stamp 3330 recorded and transmitted by Wireless Device 0210 measuring when Wireless Device 0210 user initiates User Initiating Input in response to an Advertisement and/or Programming displayed during Time-Shifted Viewing which promotes the product of interest; and (b) the date and time the Media Operator originally transmitted the Media Programᵢ which the system can identify by querying a database including the dates and times one or more Media Programs are displayed whose data are supplied by a variety of entities, including, but not limited to: (i) the Media Operators transmitting the Media Programs; (ii) a third-party server in the business of monitoring or verifying the display of Advertisements on any Media Operator; and/or (iii) Metadata Server 0280, which can monitor, record, and/or process any data enabling the identification of a Media Operator and/or Media Program, e.g., one or more Fingerprints of one or more Advertisements and/or Programming displayed during any Media Program. If the system calculates a difference between Date/Time Stamp 3330 and the original transmission Date/Time which is larger than any difference due to standard transmission methods, then the system can classify the Media Programᵢ as one recorded and viewed after the original transmission. The system can limit the search space of potential Advertisements and/or Programming of interest to those Advertisements and/or Programming displayed only during the Media Programᵢ recorded.

The system can convert into a dummy variable each of the values of the variables in Equation 2. For example, Keyword/Keyphrase 1 Identifying Product or Brand can specify “Brand X,” which is promoted by the Advertisement with Ad-ID, “XXXX-12345678” displayed by Media Operator (Highest Rank). In that case, the system can assign to the variable, Advertisement (identified by Ad-ID, XXXX-12345678) Associated with Keyword/Keyphrase 1 Identifying Brand or Product, the value, “1.” If Keyword/Keyphrase 1 Identifying Product or Brand specifies “Brand D,” is not promoted by the Advertisement with Ad-ID, “XXXX-12345678” displayed by Media Operator (Highest Rank), then the system can assign to the variable, Advertisement (XXXX-12345678) Associated with Keyword/Keyphrase 1 Identifying Brand or Product, the value, “0.”

The present method can utilize any method to calculate Rank (Advertisementᵢ), e.g., a simple iterative algorithm.

(T_{UII}—Time of Display of Advertisementᵢ) is a variable equal to the length of time between: (a) the time of User Initiating Input, which can be defined as T_{UII}; and (b) the time Advertisementᵢ is displayed, which can be defined as T_{ADV(I)}. (T_{UII}—Time of Display of Advertisementᵢ) can influence the probability that Wireless Device 0210 user responded to Advertisementᵢ for the reasons described in Section 6.2.1 and illustrated in FIG. 35.

The term, Decay Rate, is a factor explaining the most likely rate at which any Wireless Device 0210 user is likely to transmit an User Request as a function of (T_{UII}—Time of Display of Advertisementᵢ). The system can utilize any method of estimating the appropriate Decay Rate. The system can estimate the Decay Rate through a variety of means, including, but not limited to: (a) fitting the Decay Rate to empirical data measuring P_{UR}(t), where t equals (T_{UII}—Time of Display of Advertisementᵢ); and/or (b) estimating a Decay Rate based on any hypothetical model of the relationship between P_{UR}(t) and (T_{UII}—Time of Display of Advertisementᵢ).

For example, the product (T_{UII}—Time of Display of Advertisementᵢ) and Decay Rate can produce a set of values where a small value of the first term and a given Decay Rate can generate a higher Rank (Advertisementᵢ) than a large value of the first term and a given Decay Rate, all other things being equal.

Date of Display of Advertisementᵢ is a variable with a value specifying if the date Advertisementᵢ is displayed is the same date as the date specified by Date/Time Stamp 3330. The date Advertisementᵢ is displayed can influence the probability that Wireless Device 0210 user responded to Advertisementᵢ. The system can include the Date of Display of Advertisementᵢ variable to reflect the possibility that a Wireless Device 0210 user could be more likely to recall an Advertisement displayed in the same day as Date/Time Stamp 3330 than the same Advertisement displayed during the previous day despite a small difference in (T_{UII}—Time of Display of Advertisementᵢ), all other things being equal. For example, the same or different Media Operator can display the same Advertisement at two different times, T₁ and T₂, where T₁ is, e.g., 11:30 pm the previous night, and T₂ is, e.g., 6:30 am the morning of the day specified by Date/Time Stamp 3330. Assume further that T_{UII} is 11:00 pm on the day specified by Date/Time Stamp 3330. If the Decay Rate displays a form where the P_{UR}(T_{UII}—Time of Display of Advertisementᵢ) is constant after some time period, e.g., 1 hour, then the system would generate the same Rank (Advertisementᵢ) for Advertisement_{T1} and Advertisement_{T2}, even if Wireless Device 0210 user is more likely to recall an Advertisement displayed on the same day than an Advertisement displayed on the previous day.

The present method can utilize User Generated Identification Data which identifies the Product Category to identify the Advertisement of interest. Upon viewing an Advertisement promoting a product of interest, many Wireless Device 0210 users may not be able to recall the name of the brand or product of interest, but can recall the Product Category, e.g., “Pizza.” The probability of Media Operator (Highest Rank) displaying more than one Advertisement promoting the same Product Category is low for several reasons, including: (a) the relatively small number of Potential Advertisements of Interest per Television Media Operator for Media Operator (Highest Rank) during T_{URT}; and (b) the typical practice of Television Media Operators and Radio Media Operators refraining from displaying Advertisements from competing Advertisers 0220 during any pod or Media Program.

For example, if Keyword/Keyphrase Identifying Product Category specifies a value, “Product Category Z,” which is promoted by the Advertisement with Ad-ID, “XXXX-12345678” displayed by Media Operator (Highest Rank), the system can assign to the variable, Advertisementᵢ Associated with Keyword/Keyphrase Identifying Product Category, the value, “1.”

Probability of User Interest in Product Promoted in Advertisementᵢ is a variable=f((User Profile Data 3350), (Keyword/Keyphrase Database 3362), (Keyword/Keyphrase Identifying Brand or Product), (Keyword/Keyphrase Identifying Product Category)). The independent variable, User Profile Data 3350, can have one or more values specifying any parameter which can be related to one or more parameters in Keyword/Keyphrase Database 3362. Given one or more Keywords/Keyphrases Identifying Brand or Product and/or Keywords/Keyphrases Identifying Product Category transmitted by Wireless Device 0210 user, the present method can search for any value in User Profile Data 3350 specifying any parameter related to one or more parameters in Keyword/Keyphrase Database 3362.

For example, if User Profile Data 3350 includes a value=18-24 for an attribute=age range and the Keyword/Keyphrase Identifying Product Category specifies “Product Category Z,” the system can lookup Keyword/Keyphrase Database 3362 to determine if Product Category Z is targeted at the 18-24 age range.

Probability of User Responding to Advertisementᵢ (Placement in Pod of Short Duration v. Pod of Long Duration), Probability of User Responding to Advertisementᵢ (Advertisementᵢ Position in Pod), and Probability of User Responding to Advertisementᵢ (Length of Time of Advertisementᵢ) are variables related to the independent variable listed within their respective functions. For example, independent variable, Advertisementᵢ Position in Pod, can have any value specifying the position of Advertisementᵢ within the pods displayed by Media Operator (Highest Rank) during T_{URT}. If Advertisementᵢ was the first Advertisement displayed by Media Operator (Highest Rank) during the first pod within T_{URT} and research data showed that the first Advertisement displayed in any pod had significantly higher unaided recall level than Advertisements displayed in other positions in the pod, then the present method can assign to Probability of User Responding to Advertisementᵢ (Advertisementᵢ Position in Pod) a higher value than other Advertisementsᵢ with other positions in the pod.

Probability of User Responding to Advertisementᵢ ((Date/Time Stamp 3330), (Location Stamp 3332), Product Category) is a variable=f((Date/Time Stamp 3330), (Location Stamp 3332), Product Category). The independent variable, Date/Time Stamp 3330, can have a value specifying the date/time at which Wireless Device 0210 user initiates an User Initiating Input. The independent variable, Location Stamp 3332, can have a value specifying the location of Wireless Device 0210 user at the time recorded by Date/Time Stamp 3330. The independent variable, Product Category, can have a value specifying the Product Category associated with the set of Keywords/Keyphrases included in User Request.

For certain Product Categories, the probability of Wireless Device 0210 user responding to Advertisementᵢ can depend on the date and/or time of User Initiating Input and/or location of Wireless Device 0210 at the time recorded by Date/Time Stamp 3330. For example, for products which can be delivered to a residence, e.g., pizza, the probability of Wireless Device 0210 user responding to an Advertisement promoting pizza is likely higher in one time period, e.g., when most people eat dinner, than other time periods. In another example, for products whose demand is related to the weather, e.g., snow blowers, the probability of Wireless Device 0210 user responding to an Advertisement promoting snow blowers is likely higher in one location, e.g., where it snows regularly, than other locations.

Probability of User Responding to Advertisementᵢ ((Event Database 3382), Product Category) is a variable=f((Event Database 3382), Product Category). The independent variable, Event Database 3382, can have a value specifying the occurrence of an event which can influence the probability of a Wireless Device 0210 user responding to an Advertisement. For example, for products whose demand is related to a specific type of event, e.g., baseball memorabilia, the probability of Wireless Device 0210 user responding to an Advertisement promoting baseball memorabilia is likely higher during the occurrence of a baseball event, e.g., the broadcast of the baseball World Series.

Probability of User Responding to Advertisementᵢ (Advertisement Type (Transactional, Non-Transactional)) is a variable=f((Advertisement Type (Transactional, Non-Transactional)). The independent variable, Advertisement Type, can have a value specifying if the content in Advertisementᵢ can be configured to persuade the viewer, listener, or reader to act within a relatively short time period to buy the product promoted. For example, if Advertisementᵢ specifies a deadline, the system can attribute a higher probability of Wireless Device 0210 user responding to the Advertisementᵢ than if it did not specify a deadline.

The system can apply the same methods of estimating and/or calculating the probability distributions and cumulative distribution functions of any variable in Equation 2 as the methods applied in Section 6.2.1.1.

For any variable in Equation 2, the system can adjust the value to reflect any variance by utilizing any appropriate method. For example, the system can calculate the expected value of the variable by calculating the weighted average of its possible values. In some embodiments, the system can adjust Equation 2 by summing the products of one or more of the expected values of the variables and their respective weights as follows:

Rank(Advertiserᵢ)=((Expected Value(Advertisementᵢ Associated with Keyword/Keyphrase 1 Identifying Brand or Product))*w₁)+ . . . +((Expected Value(P_{UR}(Length of Time>Initiation of Advertisementᵢ)))*wₙ₊₆)

Equation 2 can include weights, w₁, . . . wₙ, each of which reflects the importance, relevance, and/or availability of the associated variable. The system can apply the same methods of generating, fixing, varying, and/or adjusting the weights as the methods applied in Section 6.2.1.1. For example, the system can utilize the process taught in Method 3600 to determine a desirable set of weights for Equation 2.

After ranking each Advertisementᵢ displayed by Media Operator (Highest Rank) during T_{URT}, Method 3400 can select the Advertisementᵢ with the highest Rank (Advertisementᵢ), which the system can identify as the most probable Advertisement promoting the product of interest to Wireless Device 0210 user and can identify as Advertisement (Highest Rank).

The longer the period of time between the User Initiating Input and the time the Advertisement (Highest Rank) was transmitted by a Media Operator (which can be defined as T_{UR-DELAY}), the higher the probability that the system identified the incorrect Advertisement which stimulated the Wireless Device 0210 user to transmit an User Request. There are at least two reasons why P_{FP} should be higher. First, the longer T_{UR-DELAY}, the higher the probability that the Wireless Device 0210 user or someone else in the vicinity changed the channel to which Media Device 1910 is tuned. In that case, Method 3400 can select a Media Operator (Highest Rank) which is not the Media Operator displaying the Advertisement leading Wireless Device 0210 user to transmit an User Request. Second, the longer T_{UR-DELAY}, the larger the number of Potential Advertisements of Interest per Television Media Operator for Media Operator (Highest Rank), and therefore the higher the probability the present method may identify the incorrect Advertisement leading Wireless Device 0210 user to transmit an User Request.

The system can adjust any method to reflect the relationship between T_{UR-DELAY} and P_{FP} by utilizing any technique, including, but not limited to, the following. After identifying Advertisement (Highest Rank), the system can include in any method one or more additional steps of: (a) calculating T_{UR-DELAY}; (b) selecting a number, n, of the next highest ranking Media Operators, where n is directly related to the magnitude of T_{UR-DELAY}; (c) calculating a score for any Advertisement displayed by the n Media Operators in accordance with any equation, e.g., Equation 2; and (d) selecting the Advertisement (Highest Rank) from the amended set of potential Advertisements of interest.

The system can apply to the selection of Advertisement (Highest Rank) a threshold value, which represents any confidence level set by the system that it identified the correct Advertisement leading Wireless Device 0210 user to transmit an User Request. If the confidence level of Advertisement (Highest Rank) falls below the threshold, then the system can perform a variety of functions, including, but not limited to: (a) transmitting to Wireless Device 0210 the Ad Metadata File 0410 and/or Program Metadata File 0510 associated with Advertisement (Highest Rank); (b) transmitting to Wireless Device 0210 the Ad Metadata Files 0410 and/or Program Metadata Files 0510 associated with a plurality of Advertisements with the highest ranks calculated; or (c) transmitting to Wireless Device 0210 the Ad Metadata File 0410 and/or Program Metadata File 0510 associated with brand, product, and/or Product Category identified by one or more Keywords/Keyphrases transmitted by Wireless Device 0210 user. The number of Ad Metadata Files 0410 and/or Program Metadata Files 0510 selected can vary depending on the size of Display 0354 of Wireless Device 0210.

If Method 3400 does not identify an Advertisement displayed by Media Operator (Highest Rank) during T_{URT} which promotes the product identified by the Keywords/Keyphrases transmitted by Wireless Device 0210 user, then it can: (a) lookup any database including data relating one or more Keywords/Keyphrases identifying the name of a brand, product, and/or Product Category with one or more Ad Metadata Files 0410 and/or Program Metadata Files 0510; and/or (b) transmit to Wireless Device 0210 one Ad Metadata File 0410 and/or Program Metadata File 0510 associated with the brand, product, and/or Product Category identified.

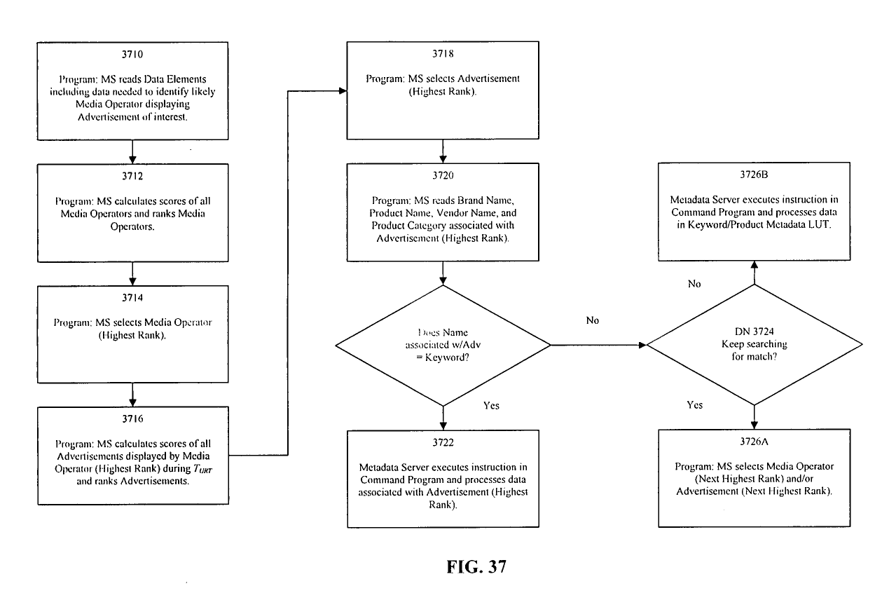

FIG. 37 depicts a flowchart of an exemplary Method 3700 enabling the identification of an Advertisement displayed on a Media Device. The flowchart is described with reference to the system depicted in FIG. 33. However, the flowchart is not limited to that embodiment. The system can implement the flowchart with reference to systems utilizing a subset of the components, or additional, related, alternative, and/or equivalent components depicted in FIG. 33. The system can implement the flowchart by executing a subset of the methods, executing the methods in different order, and/or executing other or additional related or equivalent methods.

At 3710, Program: MS 3390 can read one or more Data Elements described in FIG. 33 which include data desirable by the system to identify the likely Media Operator displaying the likely Advertisement promoting the product of interest. Program: MS 3390 can write the Data Elements to Metadata Server 0280 Memory.

At 3712, Program: MS 3390 can calculate a score for any Media Operatorᵢ included in any database and rank the Media Operators. Program: MS 3390 can calculate for any Media Operatorᵢ a score in accordance with Equation 1. However, the system is not limited to that embodiment. The system can calculate for any Media Operatorᵢ a score utilizing any equation capable of measuring the probability that a Media Operator displays an Advertisement and/or Programming promoting a product of interest.

Equation 1 includes a term, Rank (Media Operatorᵢ)_{ADJ}, which reflects the effect of Keywords/Keyphrases on the identification of the Media Operator (Highest Rank). The system can utilize any Keywords/Keyphrases converted by an ASR Program 2514 to adjust the rank of any Media Operatorᵢ. To affect the calculation of Rank (Media Operatorᵢ), ASR Program 2514 can process any Keywords at or before 3712.

While examples of Television Media Operators are described herein, it is not limited to that embodiment. The system can support the identification of the likely Media Operator and the likely Advertisement for any type of Media Operator. Program: MS 3390 can rank Media Operators transmitting Advertisements and/or Programming to one type of Media Device or Media Operators transmitting Advertisements and/or Programming to multiple Media Devices. Program: MS 3390 can rank Television Media Operators separately, Radio Media Operators separately, both Television Media Operators and Radio Media Operators, or any combination of Media Operator types.

In some embodiments, the system can calculate for any Media Operatorᵢ of any type a score in accordance with Equation 1 and rank the Media Operatorsᵢ.

In some embodiments, the system can, first, apply one or more filters identifying or increasing the probability of identifying the type of Media Operator and, second, calculate a score in accordance with Equation 1 for the Media Operators in the category of Media Operators most likely to display the Advertisement of interest. For example, because MO Identification Data: LO Signal is data associated with the RF signal received by a Media Device, identification of the LO signal can enable the system to identify if the associated Media Device is a Television 0230, Radio 0232, or any other Media Device transmitting a LO signal. Because different types of Media Devices transmit a LO signal at different frequencies, identifying the LO signal can enable the system to distinguish among different types of Media Devices.

At 3714, Program: MS 3390 can select the Media Operatorᵢ with the highest rank, Media Operator (Highest Rank). In some embodiments, the system can select a plurality of Media Operatorsᵢ, if the calculations yield a plurality of Media Operators with scores which are close to the score of Media Operator (Highest Rank). Because a primary objective of the present method is to identify the product of interest and/or the Advertisement most likely to have promoted the product of interest, selecting only the Media Operator (Highest Rank) if the calculations yielded one or more other Media Operatorsᵢ with scores close to the Media Operator (Highest Rank) can unnecessarily increase P_{FN}. The system can utilize any criteria for selecting a plurality of Media Operators with scores within a certain range of the score of Media Operator (Highest Rank). Where the system selects a plurality of Media Operatorsᵢ with scores close to the score of Media Operator (Highest Rank), the system can calculate a score for any Advertisement displayed by the plurality of Media Operators selected.

At 3716, Program: MS 3390 can calculate for any Advertisementᵢ displayed by Media Operator (Highest Rank) or any other Media Operator with scores close to the score of Media Operator (Highest Rank) during T_{URT} a score in accordance with Equation 2. However, the system is not limited to that embodiment. The system can calculate for any Advetisementᵢ a score utilizing any equation capable of measuring the probability that an Advertisement promotes the product of interest.

At 3718, Program: MS 3390 can select the Advertisementᵢ with the highest rank, Advertisement (Highest Rank). In some embodiments, the system can select a plurality of Advertisementsᵢ, if the calculations yield a plurality of Advertisements with scores which are close to the score of Advertisement (Highest Rank). Because a primary objective of the present method is to identify the product of interest and/or the Advertisement most likely to have promoted the product of interest, selecting only the Advertisement (Highest Rank) if the calculations yielded one or more other Advertisementsᵢ with scores close to the Advertisement (Highest Rank) can unnecessarily increase P_{FN}. The system can utilize any criteria for selecting a plurality of Advertisements with scores within a certain range of the score of Advertisement (Highest Rank).

At 3720, Program: MS 3390 can read any Keyword/Keyphrase associated with Advertisement (Highest Rank). The Keywords/Keyphrases can include, but are not limited to, the Brand Name, Product Name, Vendor Name, and/or Product Category, as well as other related Keywords/Keyphrases.

Method 3700 can compare one or more Keywords/Keyphrases associated with Advertisement (Highest Rank) with one or more Keywords/Keyphrases in User Request.

If there is a match among any Keywords/Keyphrases, then Method 3700 can proceed to 3722 where Program: MS 3390 can declare that Advertisement (Highest Rank) is the most likely Advertisement promoting the product of interest. Program: MS 3390 can then execute any instruction associated with the Command converted by ASR Program 2514 in accordance with Command Program 2530 and utilize any data associated with Advertisement (Highest Rank). For example, Program: MS 3390 can declare that an Advertisement_{XY} is the most likely Advertisement promoting Brand X Product Y identified by the User Request transmitted by Wireless Device 0210 user. If Wireless Device 0210 user included in his/her User Request a Command of “Save,” then Metadata Server can execute the instruction associated with “Save,” e.g., transmit an electronic coupon enabling Wireless Device 0210 user to save money on his/her next purchase of Brand X Product Y in a Physical Retailer.

If there is not a match among any Keywords/Keyphrases, then Method 3700 can proceed to Decision Node 3724.

At Decision Node 3724, Program: MS 3390 can decide whether to continue searching for a match between Keywords/Keyphrases in the User Request and Keywords/Keyphrases associated with other Advertisements.

If Program: MS 3390 decides to continue searching, then Method 3700 can proceed to 3726A and perform a variety of actions, including, but not limited to: (a) select at 3718 the Advertisement with the next highest rank and continue processing Method 3700 until there is a match between any Keywords/Keyphrases in User Request and any Keywords/Keyphrases associated with the Advertisement searched; and/or (b) select at 3714 the Media Operator with the next highest rank and continue processing Method 3700 until there is a match between any Keywords/Keyphrases in User Request and any Keywords/Keyphrases associated with the Advertisement searched.

If Program: MS 3390 decides at Decision Node 3724 to stop searching, then Method 3700 can proceed to 3726B. By terminating the search at Decision Node 3724, the system can implicitly conclude that Wireless Device 0210 user transmitted the User Request independently of any Advertisement and/or Programming promoting the product identified by the Keywords/Keyphrases in the User Request. For example, Wireless Device 0210 user can transmit an User Request, “Get [Brand Name] pizza” without having seen, heard, or read an Advertisement/Programming promoting the Brand Name pizza. The system can distinguish Method 3700 terminating the search: (a) at Decision Node 3724, which assumes that Wireless Device 0210 user transmitted the User Request independently of any Advertisement and/or Programming; and (b) at 3722, where Method 3700 has already identified a match between one or more Keywords/Keyphrases in User Request and one or more Keywords/Keyphrases in an Advertisement with the highest rank or close to the highest rank.

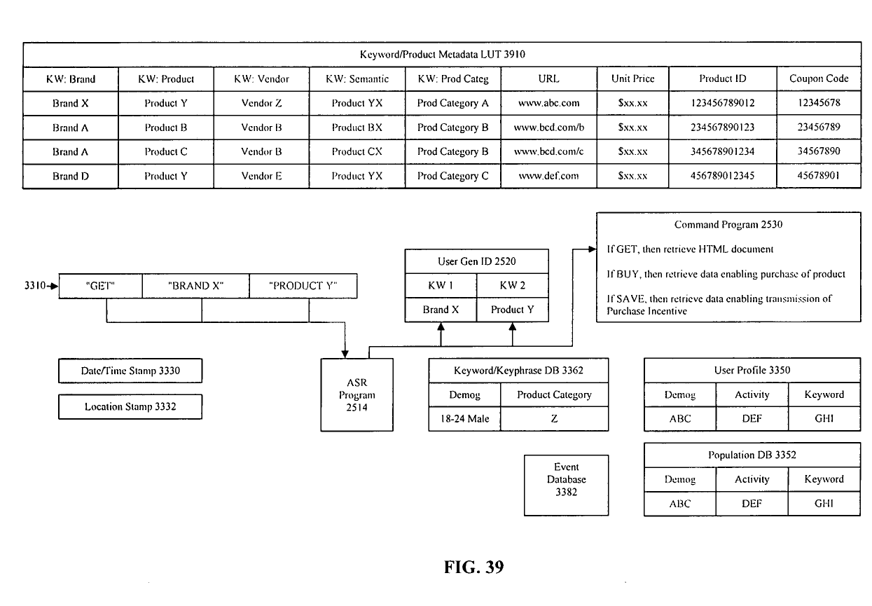

At 3726B, Metadata Server 0280 can execute any instruction associated with the Command converted by ASR Program 2514 in accordance with Command Program 2530 and utilize any data in a database which includes data associating one or more Keywords/Keyphrases and data which Metadata Server 0280 can transmit to Wireless Device 0210 implementing any User Request. The system can include a database dedicated to serving data in response to User Requests transmitted independent of any Advertisement and/or Programming, e.g., Keyword/Product Metadata LUT 3910 depicted in FIG. 39 or an existing database which includes data associated with one or Keywords/Keyphrases, e.g., Operator/Advertisement/Programming LUT 1500. For example, Metadata Server 0280 can store in any database a web page associated with “[Brand Name] pizza,” which it can serve to Wireless Device 0210 in response to the Command, “Get.”

In some embodiments, Method 3700 can utilize any Keyword/Keyphrase match to influence the selection of Advertisement (Highest Rank). The system can assume that P_{UR}(t) follows a distribution similar in form to that depicted in FIG. 35. Given the assumed probability distribution, a match between the Keywords/Keyphrases in an User Request and the Keywords/Keyphrases associated with Advertisement (Highest Rank) where Advertisement (Highest Rank) occurs at a time when P_{UR}(t) is low can lead Method 3700 to evaluate other Media Operatorsᵢ and Advertisementsᵢ with ranks close to those of Media Operator (Highest Rank) and Advertisement (Highest Rank), respectively.

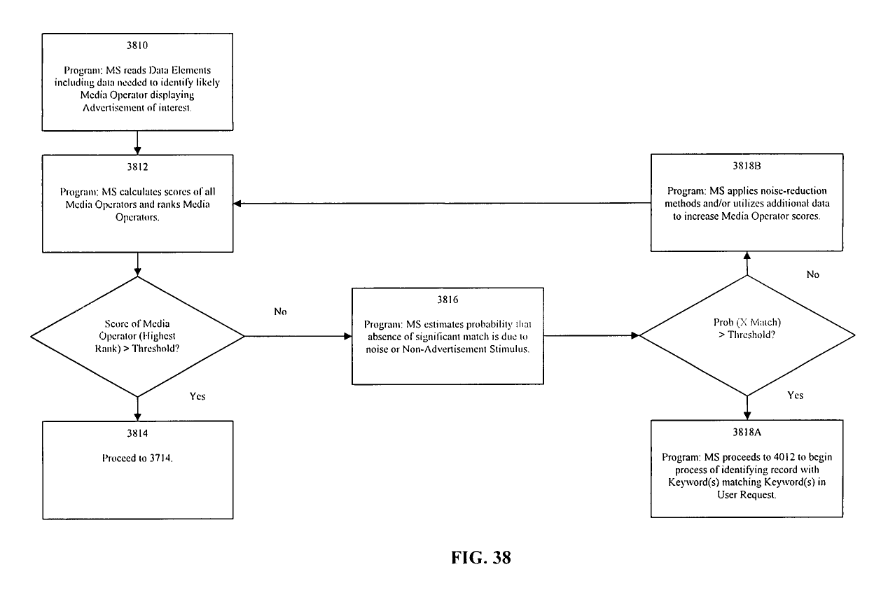

FIG. 38 depicts a flowchart of an exemplary Method 3800 enabling the identification of an Advertisement displayed on a Media Device. The flowchart is described with reference to the system depicted in FIG. 33. However, the flowchart is not limited to that embodiment. The system can implement the flowchart with reference to systems utilizing a subset of the components, or additional, related, alternative, and/or equivalent components depicted in FIG. 33. The system can implement the flowchart by executing a subset of the methods, executing the methods in different order, and/or executing other or additional related or equivalent methods.

At 3810, Program: MS 3390 can be configured to execute 3710.

At 3812, Program: MS 3390 can be configured to execute 3712.

If the score of Media Operator (e.g., Highest Rank, specified rank) exceeds any threshold set (e.g., defined by a user), then Method 3800 can proceed to 3714. The application of a threshold enables the system to reject a Media Operator (Highest Rank) which fails to generate a statistically significant score either at an absolute level or relatively to other Media Operators.

If the score of Media Operator (Highest Rank) does not exceed any threshold set (e.g., defined by a user), then Method 3800 can at 3816 estimate the probability that the absence of a statistically significant match is due to: (a) any type of noise, e.g., in Voice Channel 2710, reducing the ability of the system to identify Media Operator (Highest Rank) utilizing certain methods, e.g., Fingerprint matching; or (b) Wireless Device 0210 user transmitting an User Request independently of any Advertisement and/or Programming. The system can utilize any method of estimating the probability that the absence of a statistically significant match is due to noise.

If the probability of the absence of a statistically significant match exceeds any threshold set (e.g., defined by a user), then Program: MS at 3818A can proceed to 4012 to begin the process of identifying a record with one or more Keywords/Keyphrases matching one or more Keywords/Keyphrases in User Request.

If the probability of the absence of a statistically significant match does not exceed any threshold set (e.g., defined by a user), Program: MS at 3818B can utilize any method to perform a variety of functions, including, but not limited to: (a) utilizing existing methods to reduce, offset, or other compensate for any noise, e.g., in Voice Channel 2710; (b) extending the duration of a voice call originated in Method 2800 to receive additional data enabling a Fingerprint match; (c) transmitting a message to Wireless Device 0210 in Method 2600 to record one or more additional samples of the information signal from the Media Device displaying the Advertisement and/or Programming of interest; and/or (d) utilizing additional Data Elements not utilized earlier in Method 3800. After performing one or more of the functions, Method 3800 can proceed to 3812.

### 6.2.1.3 Advertisement-Independent User Request

A Wireless Device 0210 user can transmit an User Request regarding a product not only in response to viewing an Advertisement and/or Programming displayed on another Media Device promoting the product of interest, but also independently of an Advertisement and/or Programming. The factors which can stimulate a Wireless Device 0210 user to obtain more information about or to buy a product of interest can include, but are not limited to: (a) an event stimulating the User Request which is not an Advertisement and/or Programming; or (b) a random event.

FIG. 39 depicts a diagram of an exemplary system of Data Elements enabling the transmission of data in response to an User Request independent of an Advertisement and/or Programming. The system can be configured to utilize a subset of the following Data Elements, or additional, related, alternative, and/or equivalent Data Elements. The system can include, but is not limited to, the following Data Elements not disclosed earlier herein.

Keyword/Product Metadata LUT 3910 is an exemplary data structure, which can include a variety of data, including, but not limited to: one or more records with data identifying one or more Keywords/Keyphrases associated with a product, brand, vendor, and/or Product Category; and/or any data describing the product, brand, vendor, and/or Product Category described by the associated Keyword/Keyphrase. The data describing the product, brand, vendor, and/or Product Category can be any data type, including, but not limited to: alphanumeric string; text; image, video, and/or audio. For example, LUT 3910 can include the HTML document of the web page produced by a vendor for a brand and product, the HTML code enabling a Browser Application 0330 to render the web page on Wireless Device 0210, and/or the URL enabling Wireless Device 0210 to retrieve the web page.

Each record in Keyword/Product Metadata LUT 3910 can include an unique set of Keywords/Keyphrases associated with an unique product which can be identified by any unique code, e.g., UPC. Each product should have an unique set of Keywords/Keyphrases identifying the brand and product associated with, e.g., one UPC.

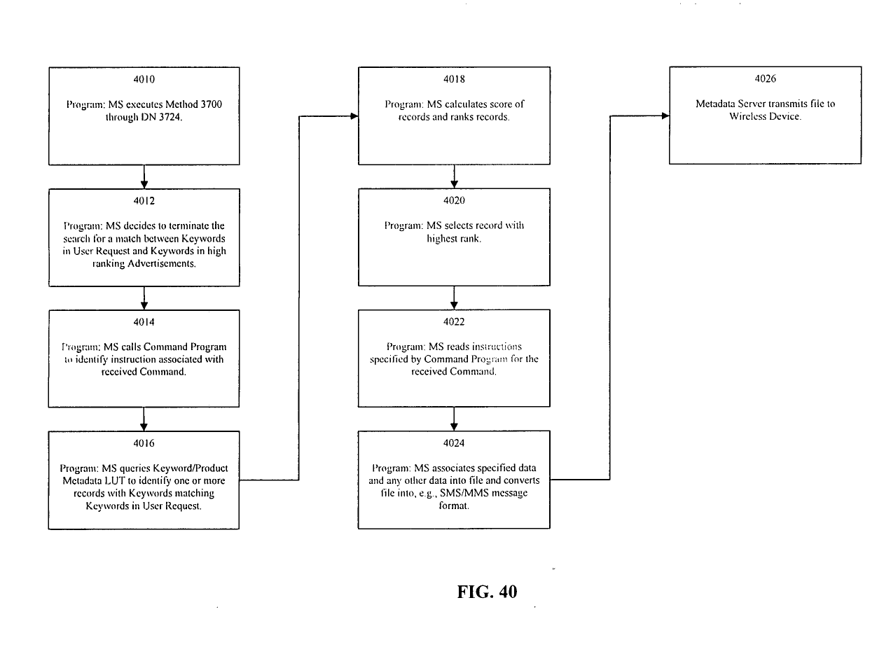

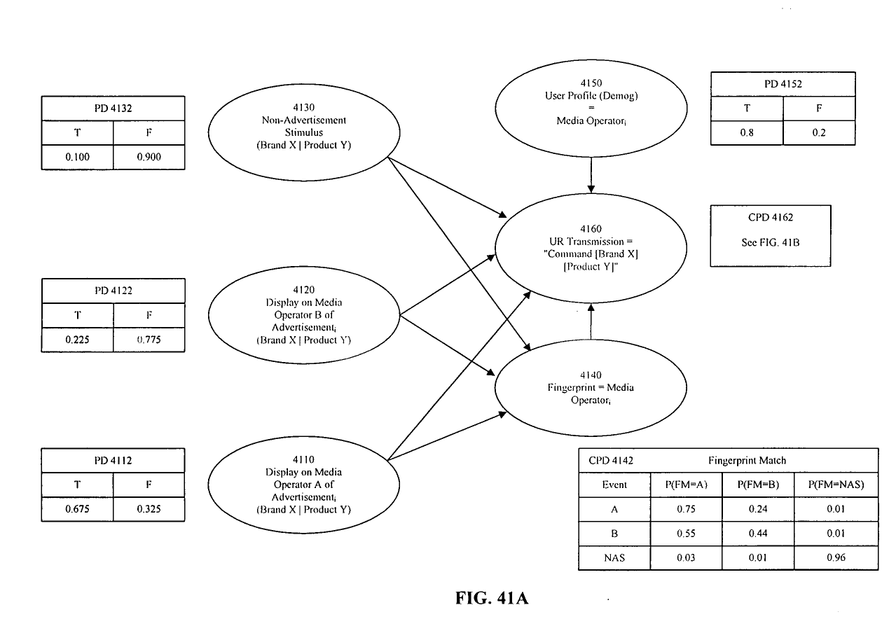

FIG. 40 depicts a flowchart of an exemplary Method 4000 utilizing Data Elements enabling the transmission of data in response to an User Request independent of an Advertisement and/or Programming. The flowchart is described with reference to the system depicted in FIG. 39. However, the flowchart is not limited to that embodiment. The system can implement the flowchart with reference to systems utilizing a subset of the components, or additional, related, alternative, and/or equivalent components depicted in FIG. 39. The system can implement the flowchart by executing a subset of the methods, executing the methods in different order, and/or executing other or additional related or equivalent methods.

At 4010, Program: MS 3390 can execute Method 3700 through Decision Node 3724.

During the execution of Method 3700, ASR Program 2514 can receive an User Request, e.g., Query 3310, comprising a “GET” Command and two Keywords, “BRAND X” and “PRODUCT Y.” ASR Program 2514 can utilize any method of speech recognition to identify (e.g., accuratley identify) the words, “GET,” “BRAND X,” and “PRODUCT Y.”

At 4012, Program: MS 3390 can decide to terminate the search for a match between one or more Keywords/Keyphrases in User Request and one or more Keywords/Keyphrases in Advertisement (Highest Rank) and/or any other high ranking Advertisements.

At 4014, Program: MS 3390 can call Command Program 2530, which can identify one or more instructions associated with the Command in User Request.

At 4016, Program: MS 3390 can query Keyword/Product Metadata LUT 3910 to identify one or more records which include one or more Keywords/Keyphrases which match one or more Keywords/Keyphrases in User Request.

At 4018, Program: MS 3390 can calculate for any record in Keyword/Product Metadata LUT 3910 a score which reflects the probability that the product associated with a given set of Keywords/Keyphrases is the product of interest to Wireless Device 0210 user.

One exemplary method of calculating a score for each Product ID can sum the products of one or more variables and their respective weights, which can include, but are not limited to, the following variables in Equation 3:

Rank(Product IDᵢ)=(Degree of match between one or more Keywords/Keyphrases in User Request and one or more Keywords/Keyphrases in record for Product IDᵢ)*w₁)

((Probability of User Interest in Product IDᵢ((User Profile Data 3350), (Keyword/Keyphrase Database 3362),(Event Database 3382))*w₂)+((Probability of User Interest in Product IDᵢ(Population Database 3352))*w₃)+((Probability of User Interest in Product IDᵢ((Date/Time Stamp 3330), (Location Stamp 3332)))*w₄)

At 4020, Program: MS 3390 can select the Product IDᵢ with the highest rank, Product ID (Highest Rank).

At 4022, Program: MS 3390 can read the data specified by Command Program 2530 for the received Command. That is, for each received Command, Command Program 2530 can write to any computer program product, e.g., Program: MS 3390, the instructions specified. For example, if the received Command is “SAVE,” the specified set of instructions can be to retrieve data enabling the transmission of Purchase Incentive. Program: MS 3390 can then read from Keyword/Product Metadata LUT 3910 the value(s) in any field including data identifying the Purchase Incentive associated with Product ID (Highest Rank).

At 4024, Program: MS 3390 can associate in any file any data retrieved in accordance with the specified set of instructions and any other data enabling the system to fulfill the User Request. Program: MS 3390 can convert the file into, e.g., a SMS or MMS message format.

At 4026, Metadata Server 0280 can transmit the file to Wireless Device 0210.

The system can apply the same methods applied in Section 6.2.1.1. to Equation 3 for a variety of functions, including, but not limited to: (a) converting into a dummy variable each of the values of the variables; (b) adjusting the values of the variables to reflect any variance; (c) estimating and/or calculating the probability distributions and cumulative distribution functions of any variable; and/or (d) adjusting the weights, w₁, . . . wₙ to reflect the importance of each variable.

### 6.2.1.4 Bayesian Network

In some embodiments, the system can apply a method utilizing a Bayesian network to identify the most likely Advertisement of interest or confirm any result generated from any disclosed system and/or method. Because of the potentially large number of variables the system can evaluate to identify the Advertisementᵢ most likely to stimulate the User Request, representing the relationships among the variables as a Bayesian network and utilizing Bayes' inference rules can significantly reduce the number of calculations desirable to identify the most likely Advertisement of interest.

The system can be configured to identify the single event most likely to have stimulated an User Request, which the system can define as Event_{CAUSE}. An Event_{CAUSE} can be an Advertisement and/or Programming most likely to have stimulated an User Request, which the system can identify as Advertisement_{CAUSE}, or a Non-Advertisement Stimulus most likely to have stimulated an User Request. Event_{CAUSE} is a variable which is not observed by Metadata Server 0280. Moreover, Event_{CAUSE} may not be observed by even Wireless Device 0210 if Wireless Device 0210 user initiates an User Initiating Input after the termination of the display of Advertisement_{CAUSE} or if Wireless Device 0210 user transmits an User Request in response to a Non-Advertisement Stimulus for which data cannot be received by any Wireless Device 0210 I/O Device.

To simplify an example, suppose that there are three observable variables: (a) an User Request which includes a Command, a Keyword specifying the Brand Name, and a Keyword specifying the Product Name; (b) a Fingerprint match identifying an Advertisement or Programming displayed at the time Wireless Device 0210 user initiates an User Initiating Input, which may or may not be Advertisement_{CAUSE}; and (c) an User Profile specifying any characteristics about Wireless Device 0210 user, e.g., age group and/or gender. However, the system is not limited to a system of three observable variables. The system can support a system with any number of observable variables.

An observable variable is any variable for which any Data Processing System can generate, collect, and/or receive data, in general, and data related to a product of interest, in particular. For example, Wireless Device 0210 and/or Metadata Server 0280 can receive an User Request which includes one or more words related to a product of interest.

A non-observable variable is any variable for which any Data Processing System cannot generate, collect, and/or receive data. A Data Processing System can utilize one or more present methods to infer one or more values for a non-observable variable.

Assume further there are only two Media Operators, A and B. However, the system is not limited to a system with two Media Operators. The system can support the identification of the single Event_{CAUSE} most likely to stimulate an User Request with any number of Media Operators.

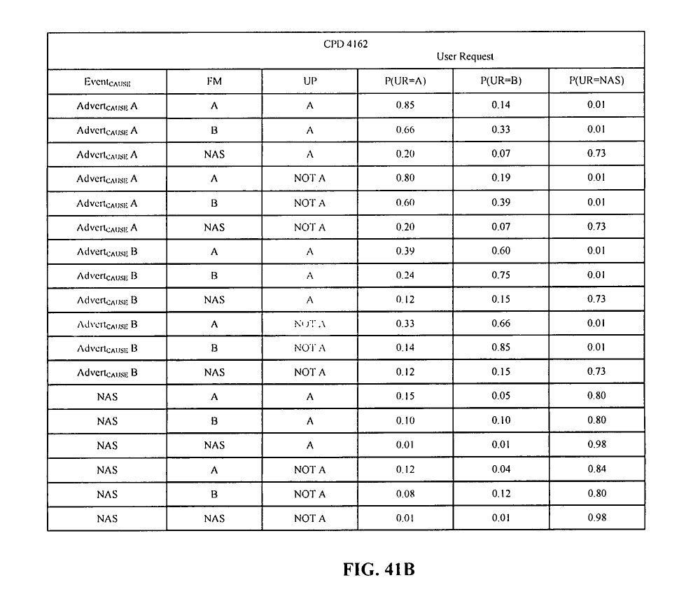

Assume further the relationships among the observable variables and non-observable variables depicted in FIG. 41A. However, the system is not limited to a system with the depicted relationships. The system can support a system with any set of relationships.

In the present example depicted in FIG. 41A, the display of Advertisement_{CAUSE} on Media Operator A is the event that caused Wireless Device 0210 user to transmit an User Request. The application of a Bayesian Network to identify Media Operator A given certain values of observable variables is described herein.

FIG. 41A depicts a diagram of an exemplary Bayesian Network 4100 outlining the relationships among the three observable variables and two instances of the non-observable variable, Advertisement_{CAUSE} and another non-observable variable, Non-Advertisement Stimulus. The Bayesian Network can enable the identification of the most likely event stimulating an User Request given the observable variables. The system can implement the present Bayesian Network by utilizing a subset of the following variables, or additional, related, alternative, and/or equivalent variables. The present Bayesian Network can include, but is not limited to, the following variables.

Advertisement_{CAUSE} (A) 4110 is an instance of Event_{CAUSE}, which represents an Advertisement promoting a product with a Brand X and Product Y equal to the Brand X and Product Y specified in User Request where the Advertisement is displayed on Media Operator A. In some embodiments, the exemplary Bayesian Network can include Probability Distribution 4112 which specifies the probability that Media Operator A displays Advertisement_{CAUSE} relative to the instances of Event_{CAUSE} occurring on other non-observable variables. In some embodiments, the exemplary Bayesian Network can include the actual number of Advertisements_{CAUSE} displayed on Media Operator A to which Wireless Device 0210 can be exposed during any T_{URT}. That is, for any given T_{URT} and assuming the system has access to Data Elements like Date/Time Stamp 3330 and Location Stamp 3332, the Bayesian Network can include data counting the actual number of Advertisements_{CAUSE} displayed on Media Operator A in the location served by, e.g., a cable Television Operator, during any T_{URT}. For example, if Wireless Device 0210 user transmits an User Request at 9:00 pm in Location XYZ, the exemplary Bayesian Network can count the actual number of Advertisements_{CAUSE} displayed on Media Operator A during the time period, 9:00 pm less T_{URT}.

Advertisement_{CAUSE} (B) 4120 is an instance of Event_{CAUSE}, which represents an Advertisement promoting a product with a Brand X and Product Y equal to the Brand X and Product Y specified in User Request where the Advertisement is displayed on a Media Operator which is Media Operator B. That is, Advertisement_{CAUSE} (B) 4120 can be the same Advertisement_{CAUSE} (A) 4110, but displayed on a different Media Operator. In some embodiments, the exemplary Bayesian Network can include Probability Distribution 4122 which specifies the probability that Media Operator B displays Advertisement_{CAUSE} relative to the instances of Events_{CAUSE} occurring on other non-observable variables. In some embodiments, the exemplary Bayesian Network can include the actual number of Advertisements_{CAUSE} displayed on Media Operator B to which Wireless Device 0210 can be exposed during any T_{URT}.

For example, if the exemplary Bayesian Network receives an User Request at 9:00 pm, T_{URT} is 1 day (to reflect Time-Shifted Viewing), the number of Advertisements_{CAUSE} displayed on Media Operator A during T_{URT} is 3, the number of Advertisements_{CAUSE} displayed on Media Operator B during T_{URT} is 1, then: (a) the prior probability of Advertisement_{CAUSE} (A) is 3/(3+1)=75%; and (b) the prior probability of Advertisement_{CAUSE} (B) is 1/(3+1)=25%.

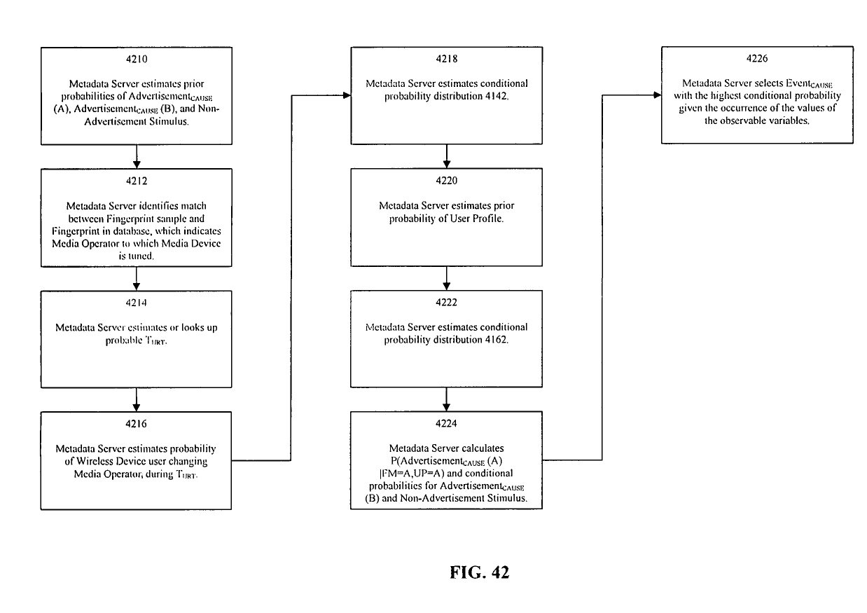

Probability Distribution 4112 can show a higher probability of Media Operator A displaying Advertisement_{CAUSE} than Media Operator B, because the probability of two Media Operators displaying the same Advertisement in the same location within the same T_{URT} is low. While an Advertiser 0220 and/or Media Buyer 0222 can buy a large number of Media Locations across a national, regional, or local market, a typical Advertiser 0220 tends to spread the display of an Advertisement over time. There can be exceptions to this practice. For example, an Advertiser 0220 promoting a product which must be consumed by a certain date, e.g., the opening weekend of a movie, can concentrate Advertisements within a certain time period. To reflect this exception, any method described herein can be amended. In Method 4200 described in FIG. 42, the system can adjust Probability Distribution 4112 and Probability Distribution 4122 to reflect the higher probability that Media Operator B can display the same Advertisement as Media Operator A in the same location with the same T_{URT}. In Method 3400, the system can include a variable in Equation 1 which reflects the probability that a plurality of Media Operatorsᵢ can display the same Advertisement in the same location within the same T_{URT}.

Non-Advertisement Stimulus (NAS) 4130 can represent any event which is not an Advertisement and/or Programming which stimulated the User Request. That is, Wireless Device 0210 user can transmit an User Request for Brand X and Product Y independently of having viewed, heard, or read an Advertisement and/or Programming promoting Brand X and Product Y.

Probability Distribution 4132 can specify the probability that Non-Advertisement Stimulus 4130 stimulates the User Request relative to the instances of other non-observable variables. While the absolute probability of Wireless Device 0210 user not viewing, hearing, or reading an Advertisement promoting Brand X and Product Y is high, the probability of Wireless Device 0210 user transmitting an User Request including Brand X and Product Y independently of an Advertisement and/or Programming promoting Brand X and Product Y is low in the present example.

Fingerprint Match 4140 can be a variable specifying if there is a match between one or more Fingerprints extracted from an information signal received by Wireless Device 0210 and Fingerprints in a database of information signals, e.g., an audio signal, transmitted by any Media Operatorᵢ. Fingerprint Match 4140 can specify either: (a) a match between the extracted Fingerprints and Fingerprints in a database; or (b) the absence of a match between the extracted Fingerprints and Fingerprints in a database. The absence of a match can reflect either: (a) the significant variance around the probability of a match due to noise; or (b) Wireless Device 0210 user transmitting an User Request independent of any Advertisement and/or Programming viewed. In some embodiments, the system can generate a plurality of values for Fingerprint Match 4140, which can include not only the highest ranking Media Operator and/or Media Program identified by the Fingerprint match, but also a n number of the next highest ranking Media Operators and/or Media Programs identified by Fingerprint matches.

FIG. 41A shows a relationship between Fingerprint Match 4140 and any instance of Advertisement_{CAUSE} or Non-Advertisement Stimulus 4130. Fingerprint Match 4140 does not directly reflect the probability that any instance of Advertisement_{CAUSE} is the Advertisement and/or Programming most likely to have stimulated the User Request. However, if the Media Operator viewed by Wireless Device 0210 user at the time he/she initiates an User Initiating Input is also the Media Operator displaying Advertisement_{CAUSE}, then finding a Fingerprint Match 4140 between fingerprints of any Programming displayed on Media Operatorᵢ and Fingerprints in a database can significantly increase the probability the system can identify Advertisement_{CAUSE}. The shorter T_{UR-DELAY}, the higher the probability that the system identified the correct Advertisement_{CAUSE}.

The relationship between Fingerprint Match 4140 and Advertisement_{CAUSE} A 4110 can reflect the conditional probability, P(FM=A|ADV=A), which is the probability of a Fingerprint Match 4140 between one or more Fingerprints of any Advertisement and/or Programming displayed on Media Operator A and Fingerprints in a database, given that Advertisement_{CAUSE} A 4110 is the Advertisement and/or Programming most likely to have stimulated the User Request.

The relationship between Fingerprint Match 4140 and Advertisement_{CAUSE} B 4120 can reflect the conditional probability, P(FM=B|ADV=B), which is the probability of a Fingerprint Match 4140 between one or more Fingerprints of any Advertisement and/or Programming displayed on Media Operator B and Fingerprints in a database, given that Advertisement_{CAUSE} B 4120 is the Advertisement and/or Programming most likely to have stimulated the User Request.

The relationship between Fingerprint Match 4140 and Non-Advertisement Stimulus 4130 can reflect the conditional probability, P(FM=NAS|NAS), which is the probability of the absence of a Fingerprint Match 4140, given that Non-Advertisement Stimulus is the event most likely to have stimulated the User Request. If the system does not identify a Fingerprint Match and the failure to identify the Fingerprint Match is not due to noise or other factors reducing the ability of a Fingerprint Application to identify reliably a Fingerprint Match, then the present method can conclude that the event most likely to have stimulated the User Request was not an Advertisement or Programming displayed by a Media Operatorᵢ.

The Fingerprint Match 4140 node can have a set of conditional probabilities. Conditional Probability Distribution (CPD) 4142 is a table specifying the conditional probabilities that the system identifies a Fingerprint Match for a certain event given the occurrence of a given event, whether the event is Media Operator A displaying Advertisement_{CAUSE}, Media Operator B displaying Advertisement_{CAUSE}, Media Operatorᵢ displaying Advertisement_{CAUSE}, or a Non-Advertisement Stimulus.

The conditional probability of a Fingerprint Match given the occurrence of a given event where the event is a Media Operatorᵢ displaying Advertisement_{CAUSE} can vary depending on the magnitude of T_{UR-DELAY}. As described herein, the longer T_{UR-DELAY}, the higher the probability that Wireless Device 0210 user or someone else in the vicinity changed the channel to which Media Device 1910 is tuned. If Media Device 1910 displays, e.g., Media Operator B at the time of User Initiating Input, which is different than Media Operator A displaying Advertisement_{CAUSE}, then the probability that the Advertisement displayed by the Media Operator B is Advertisement_{CAUSE} should decline. If, e.g., T_{UR-DELAY} is only 1 minute, then Fingerprint Match 4140 identifying Media Operator B probably means that Wireless Device 0210 user was viewing Advertisement_{CAUSE} on Media Operator B. But if T_{UR-DELAY} is 1 day, then Fingerprint Match 4140 identifying Media Operator B can mean that Wireless Device 0210 user was viewing Advertisement_{CAUSE} on Media Operator A and that Wireless Device 0210 user changed the channel to Media Operator B some time during T_{UR-DELAY}.

The present method assumes that it can calculate the magnitude of T_{UR-DELAY}, which requires the estimation of the date/time when any Media Operator displays Advertisements_{CAUSE}. One exemplary method of estimating the date/time is by identifying Advertisement (Highest Rank) in Method 3400. If the present method cannot calculate the magnitude of T_{UR-DELAY}, then Method 4200 can assume a set of conditional probabilities of a Fingerprint Match that does not vary depending on the magnitude of T_{UR-DELAY}.

In CPD 4142, the first row of the table shows the conditional probability of a Fingerprint Match 4140 identifying the instance of each observable and non-observable variable given the display of Advertisement_{CAUSE} on Media Operator A. For example, if Media Operator A in fact displayed Advertisement_{CAUSE} at the location and during T_{URT}, then the probability that Fingerprint Match 4140 identifies Media Operator A is 80%, the probability Fingerprint Match 4140 identifies Media Operator B is 19%, and the probability of an absence of a Fingerprint Match 4140 is 1%.

In the present example, P(FM=A|ADV=B), 60%, can exceed P(FM=B|ADV=B), 39%, for a variety of reasons, including, but not limited to: (a) Media Operator A is more likely than Media Operator B to display Advertisement_{CAUSE} during T_{URT}; (b) the longer the period between the time Media Operator A displays Advertisement_{CAUSE} and the time Wireless Device 0210 user initiates User Initiating Input, the more likely Wireless Device 0210 user or another user changed the channel of Media Device 1910 to Media Operator B; (c) User Profile 4150 specifies characteristics of Wireless Device 0210 user indicating that he/she is more likely to view Programming displayed by Media Operator A than Media Operator B.

In the present example, P(FM=A|NAS) and P(FM=B|NAS) are very low because if Wireless Device 0210 user transmitted the User Request independently of an Advertisement and/or Programming promoting Brand X and Product Y, then the probability that Wireless Device 0210 user viewed Media Operator A or Media Operator B at the location and time he/she transmitted the User Request is very low.

User Profile 4150 can be a variable specifying a category in which Wireless Device 0210 user falls which is related to the Programming he/she is likely to view. The category can be based on any criteria, e.g., demographic like age and gender. For example, if User Profile 3350 specifies that the Wireless Device 0210 user is in, e.g., the 18-24 age group, then the probability is low that Wireless Device 0210 user is viewing Programming whose subject matter addresses, e.g., retirement.

The User Profile 4150 node can have a set of probabilities, Probability Distribution 4152, specifying the probability that Wireless Device 0210 user actually is a member of the category specified in User Profile 4150. Even if Wireless Device 0210 user supplies the data included in User Profile 4150, the probability that Wireless Device 0210 user actually is a member of any given category can be less than 100%, because of a variety of conditions, including, but not limited to: (a) Wireless Device 0210 user can supply incomplete information, e.g., the user can identify his gender, but not his age; and/or (b) Wireless Device 0210 user can supply inaccurate information. In the example depicted in FIG. 41A, one set of probabilities can be the Probability that Wireless Device 0210 user actually is a member of the specified category=80% and the Probability Wireless Device 0210 user is not such a member=100%−80%=20%.

User Request Transmission 4160 can be a variable specifying the transmission of an User Request for a set of Keywords/Keyphrases identifying Brand X and Product Y.

FIG. 41A shows an exemplary causal relationship between User Request Transmission 4160 and Advertisement_{CAUSE} (A) 4110, Advertisement_{CAUSE} (B) 4120, and Non-Advertisement Stimulus 4130.

The User Request Transmission 4160 node can have a set of conditional probabilities depicted in FIG. 41B. CPD 4162 is a table specifying the conditional probabilities that Wireless Device 0210 transmitted an User Request including the Keywords/Keyphrases “Brand X” and “Product Y” given certain instances of the observable variables, Fingerprint Match 4140 and User Profile 4150.

In CPD 4162, the first row of the table shows the conditional probability of an User Request including the Keywords/Keyphrases “Brand X” and “Product Y” given a Fingerprint Match 4140 identifying Media Operator A and User Profile 4150 specifying that Wireless Device 0210 user is, e.g., a member of a demographic group likely to view Programming on Media Operator A. Given a Fingerprint Match (FM) identifying Media Operator A and an User Profile (UP) indicating Media Operator A, the probability of Advertisement_{CAUSE} displayed on Media Operator A stimulating Wireless Device 0210 user to transmit User Request, or P(UR=A|(FM=A,UP=A), is 95%, the probability of Advertisement_{CAUSE} displayed on Media Operator B stimulating Wireless Device 0210 user to transmit User Request is 4%, and the probability of Non-Advertisement Stimulus stimulating Wireless Device 0210 user to transmit User Request is 1%.

In the present example, P(UR=A|(FM=B,UP=A), 66%, can exceed P(UR=B|(FM=B,UP=A), 33%, for the same reasons P(FM=A|ADV=B) can exceed P(FM=B|ADV=B).

In the present example, P(UR=A|FM=A,UP=B), 85%, can be slightly lower than P(UR=A|FM=A,UP=A), 95%, because the effect of User Profile on the conditional probability P(UR|FM,UP) can be modest.

In the present example, P(UR=A|FM=NAS,UP=NOT A) can be a significant value, 15%, despite the absence of a Fingerprint Match, because of the possibility that the absence of a Fingerprint Match is due to noise, instead of the occurrence of a Non-Advertisement Stimulus.

FIG. 42 depicts a flowchart of an exemplary Method 4200 utilizing Bayesian inference to identify the Events_{CAUSE} most likely to have stimulated Wireless Device 0210 user to transmit an User Request specifying the product of interest. The flowchart is described with reference to the system depicted in FIG. 41. However, the flowchart is not limited to that embodiment. The system can implement the flowchart with reference to systems utilizing a subset of the components, or additional, related, alternative, and/or equivalent components depicted in FIG. 41. The system can implement the flowchart by executing a subset of the methods, executing the methods in different order, and/or executing other or additional related or equivalent methods.

At 4210, Metadata Server 0280 can estimate the prior probabilities of any Events_{CAUSE} at the location and time any Wireless Device 0210 user transmits an User Request. In the present example, Metadata Server 0280 can estimate the prior probabilities of Advertisements_{CAUSE} (A) 4110, Advertisement_{CAUSE} (B) 4120, and Non-Advertisement Stimulus 4130 at the location and time Wireless Device 0210 user transmits an User Request. The system can utilize any method disclosed herein or a mathematic equation (e.g., relationship) to estimate the prior probabilities. For example, Metadata Server 0280 can identify n number of Advertisements promoting Brand X and Product Y at a given location within a given T_{URT}. Metadata Server 0280 can query one or more databases which can include this data, e.g., LUT 1500. To estimate the prior probability of Advertisement_{CAUSE} (A) 4110, Metadata Server 0280 can calculate the ratio of: (a) the number of Advertisements displayed on Media Operator A including one or more Keywords/Keyphrases specifying Brand X and Product Y; to (b) the total number of Advertisements displayed on all or a selected portion of Media Operators including one or more Keywords/Keyphrases specifying Brand X and Product Y. To estimate the prior probability of Advertisement_{CAUSE} (B) 4120, Metadata Server 0280 can calculate the ratio of: (a) the number of Advertisements displayed on Media Operator B including one or more Keywords/Keyphrases specifying Brand X and Product Y; to (b) the total number of Advertisements displayed on all or a selected portion of Media Operators including one or more Keywords/Keyphrases specifying Brand X and Product Y. Metadata Server 0280 can adjust the two prior probabilities by estimating the prior probability that Wireless Device 0210 user will transmit an User Request including Brand X and Product Y independently of any Advertisement promoting Brand X and Product Y. For example, if Metadata Server 0280 estimates that the prior probability of Non-Advertisement Stimulus 4130 is 10%, then Metadata Server can multiply by 90% the prior probabilities of Advertisement_{CAUSE} (A) 4110 and Advertisement_{CAUSE} (B) 4120.

At 4212, Metadata Server 0280 can identify any match between: (a) a Fingerprint sample received or recorded by Wireless Device 0210 at the time of User Initiating Input; and (b) Fingerprints in any database, e.g., LUT 1400. Any match between the Fingerprints can indicate a high probability that Wireless Device 0210 is in the vicinity of a Media Device 1910 transmitting a Media Program identified by the match. For example, a match can indicate Wireless Device 0210 user is exposed to Media Operator A displaying Programming X at T_{UII}.

At 4214, Metadata Server 0280 can estimate or look up the probable T_{URT}. The system can generate an estimate of T_{URT} utilizing any method, e.g., reviewing historical data to estimate T_{URT}. T_{URT} is almost certainly a longer time period than any given T_{UR-DELAY}. By utilizing T_{URT} instead of T_{UR-DELAY}, the exemplary Bayesian Network can decrease the accuracy with which it can identify the single Advertisement most likely to have stimulated an User Request. If the exemplary Bayesian Network has access to or can estimate T_{UR-DELAY}, it can utilize that data.

At 4216, Metadata Server 0280 can estimate the probability that Wireless Device 0210 user changes the Media Operatorᵢ during T_{URT}. The probability of Wireless Device 0210 user changing Media Operatorᵢ can depend on a variety of factors that are described in more detail in Section 6.2.1.5.

At 4218, Metadata Server 0280 can estimate CPD 4142.

At 4220, Metadata Server 0280 can estimate the prior probability of any other observable variable. In the present example, Metadata Server 0280 can estimate the prior probability that Wireless Device 0210 user actually is a member of the category specified in User Profile 4150.

At 4222, Metadata Server 0280 can estimate CPD 4162.

At 4224, Metadata Server 0280 can calculate the conditional probability of any Events_{CAUSE}, given certain values of any observable variables. In the present example, Metadata Server 0280 can calculate Event_{CAUSE} given the observable variables, Fingerprint Match 4140, User Profile 4150, and User Request Transmission 4160. The system can utilize any method to calculate the conditional probability of any instance of Advertisement_{CAUSE} or Non-Advertisement Stimulus given certain values of the observable variables, which can be referred to as the posterior probability.

In the present example, Metadata Server 0280 can calculate the posterior probability, P(Advertisement_{CAUSE} (A) FM=A,UP=A), as follows:

$$\begin{matrix}= P ( FM = A , UP = A , {Advertisemen t}_{CAUSE} ( A ) ) / P ( FM = A , \\ UP = A ) \\ = P ( FM = A , UP = A , {Advertisement}_{CAUSE} ( A ) ) / \\ {\sum }_{Event ( Cause ) is element of \{ A , B , NAS \}} P ( FM = A , UP = A , {Event}_{CAUSE} ) \\ = ( 0.85 * 0.675 ) / ( ( 0.85 * 0.675 ) + ( 0.14 * 0.225 ) + ( 0.01 * 0.100 ) ) \\ = ( 0.57375 ) / ( ( 0.57375 ) + ( 0.0315 ) + ( 0.001 ) ) = ( 0.608 ) / ( 0.62744 ) \\ = 94.6 \%\end{matrix}$$

Utilizing the same method of calculating the posterior probability, Metadata Server 0280 can calculate P(Advertisement_{CAUSE} (B)|FM=A,UP=A) and P(Non-Advertisement Stimulus|FM=A,UP=A).

At 4226, Metadata Server 0280 can select Event_{CAUSE} with the highest conditional probability given the occurrence of the values of the observable variables. In the present example, Metadata Server 0280 can select Advertisement_{CAUSE} (A) as the Event_{CAUSE}, or the event most likely to have stimulated Wireless Device 0210 user to transmit the User Request given the occurrence of a Fingerprint Match identifying Media Operator A and an User Profile suggesting a preference for Media Operator A. In the present example, Metadata Server 0280 can select Advertisement_{CAUSE} (A) despite some uncertainty in the Fingerprint Match, which showed an 75% probability of a Fingerprint Match identifying Media Operator A.

Method 4200 demonstrates how the system can identify with a high confidence level an Event_{CAUSE}, in this case an Advertisement displayed on Media Operator A, where Wireless Device 0210 user can supply a limited amount of information, i.e., an User Request including only a small number of Keywords/Keyphrases. By combining an User Request with other data, e.g., data previously supplied by Wireless Device 0210 user, e.g., User Profile 4150, and Wireless Device Generated Identification Data, e.g., Fingerprint Match 4140, the system can identify an Event_{CAUSE} with a high confidence level.

Method 4200 is method related to enabling the identification of Event_{CAUSE} by utilizing a Bayesian Network depicted in FIG. 41A and FIG. 41B. The system can utilize a Bayesian Network defined by any person. However, the system is not limited to that embodiment. The system can utilize a Bayesian Network defined by any Data Processing System, e.g., Metadata Server 0280. Metadata Server 0280 can define any element of a Bayesian Network, including, but not limited to: (a) the identification and specification of one or more observable variables and/or non-observable variables; (b) the identification of a desirable structure of the Bayesian Network, i.e., the relationships among one or more observable variables and/or non-observable variables; and (c) the identification and specification of the probability distribution and/or conditional probability distribution of one or more observable variables and/or non-observable variables. The system can utilize any method of enabling any Data Processing System to define a desirable set of Bayesian Network elements.

### 6.2.1.5 Media Operator Selection

Two variables which have the potential of significantly influencing the ability of the system to reduce to a desirable level P_{FP} and P_{FN} are the duration of the time period between T_{UII} and T_{ADV-CAUSE} and the probability of a Wireless Device 0210 user or any other person viewing the same Media Device as Wireless Device 0210 to change the Media Operatorᵢ during the time period between T_{UII} and T_{ADV-CAUSE}, a practice commonly referred to as “channel-surfing.” A Wireless Device 0210 user or any other person can channel-surf any Media Device with a plurality of Media Operators and the capability of easily changing Media Operators, including, but not limited to: Television 0230; and/or Radio 0232. The longer time period between T_{UII} and T_{ADV-CAUSE} and the more likely viewers channel-surf, the larger the number of Media Operators which Wireless Device 0210 user could have viewed or heard, the larger the number of Media Operators which could have displayed Advertisement_{CAUSE}, and therefore the larger the number of Potential Advertisements of Interest per Media Operator, which collectively can increase P_{FP}.

If a typical Wireless Device 0210 user randomly selects one or more Media Operators to view or hear before arriving at the Media Operator displaying Advertisement and/or Programming at the time Wireless Device 0210 user initiates an User Initiating Input (e.g., a Media Operator_{UII}), then the system might need to evaluate all or a selected portion of Media Operators transmitting Advertisement and/or Programming at a given location during the entire period T_{URT} in order to identify: (a) the Media Operator which actually displayed Advertisement_{CAUSE} (e.g., a Media Operator_{ADV-CAUSE}) and/or (b) Advertisement_{CAUSE}.

However, Television 0230 viewers and Radio 0232 listeners typically do not randomly select Media Operators. In fact, not only is the set of Media Operators viewed or heard by Television 0230 viewers or Radio 0232 listeners, respectively, unlikely to be random, the sequence of Media Operators viewed or heard is unlikely to be random as well. For Television 0230, viewers typically use a Remote Control Device to select the Media Operator displaying a Programming of interest. Specifically, viewers typically use one or more functions on a Remote Control Device to select the Media Operator, which can include: (a) a sequence of number keys specifying a logical channel to which a Media Device is tuned (e.g., a Channel Number Keys); (b) a channel up key which can increment by 1 the logical channel to which a Media Device is tuned (e.g., a Channel Up Key); (c) a channel down key which can decrement by 1 the logical channel to which a Media Device is tuned (e.g., a Channel Down Key); (d) a next key which can increment the logical channel to which a Media Device is tuned to the next highest Favorite Channel (e.g., a Channel Next Key); and/or (e) a last key which can select the last logical channel to which a Media Device was tuned (e.g., a Channel Last Key).

For Radio 0232, listeners typically use certain controls to select the Media Operator displaying a Programming of interest. These controls can include: (a) a key or button which can increment the logical channel of the Radio 0232 to the next highest or lowest radio frequency with a minimal or close to minimal signal strength; and/or (b) one or more keys or buttons which can select any preprogrammed logical channel, e.g., any channel in a set of Favorite Channels.

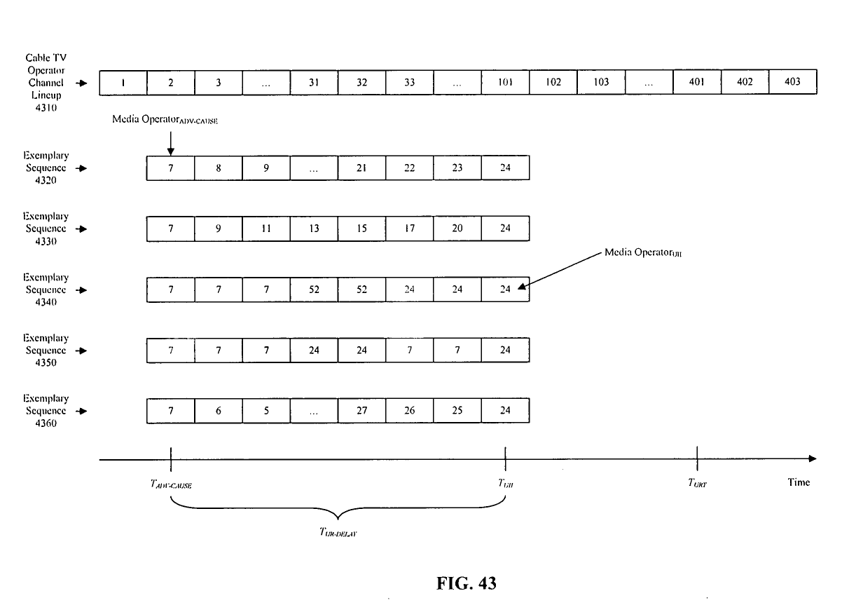

FIG. 43 depicts a set of exemplary sequences of Television Media Operators or television channels which can precede the Television Media Operator displaying an Advertisement and/or Programming at the time Wireless Device 0210 user initiates an User Initiating Input. In some embodiments, methods of narrowing the range of potential Television Media Operators_{ADV-CAUSE} and Television Advertisements_{CAUSE} can be implemented. The system can support any method of narrowing the range of potential Media Operators_{ADV-CAUSE} and Advertisements_{CAUSE} displayed on any Media Device, not just Television 0230.

Each of the Exemplary Sequences depicted in FIG. 43 start at channel 7 at T_{ADV-CAUSE} and end at channel 24 at T_{UII}. However, each of the Exemplary Sequences arrive at channel 24 through a different sequence.

Exemplary Sequence 4320 represents a sequence of Television Media Operators selected by a viewer utilizing the Channel Up Key on most Remote Control Devices.

Exemplary Sequence 4330 represents a sequence of Television Media Operators selected by a viewer utilizing the Channel Next Key on most Remote Control Devices where a typical STB can store a set of channels programmed as Favorite Channels.

Exemplary Sequence 4340 represents a sequence of Television Media Operators where the viewer selected channel 24 by selecting a sequence of Channel Number Keys, “2” and “4” on a Remote Control Device after viewing channel 7 and channel 52 for some time period after T_{ADV-CAUSE}.

Exemplary Sequence 4350 represents a sequence of Television Media Operators selected by a viewer utilizing the Channel Last Key on most Remote Control Devices by alternating between channel 7 and channel 24 from T_{ADV-CAUSE} to T_{UII}.

Exemplary Sequence 4340 and Exemplary Sequence 4350 can represent sequences of Television Media Operators which are not selected randomly by a viewer. In Exemplary Sequence 4340, a viewer is typically watching a Media Program when he/she selects a sequence of Channel Number Keys to select a new Logical Channel (MO). The Media Program he/she is watching is typically not a random selection. In Exemplary Sequence 4340, a viewer typically utilizes the Channel Last Key to alternate between two Media Operators displaying separate Media Programs of interest. While the logical channels preceding the selection of the Channel Number Keys in Exemplary Sequence 4340 and the Channel Last Key in Exemplary Sequence 4340 can be random, the logical channels can also be non-random selections. Therefore, the system labels the logical channel preceding the utilization of Channel Number Key 4430 and Channel Last Key 4440 as Pseudo-Random to reflect the possibility that the Logical Channel (Pseudo-Random) can be random or non-random.

Exemplary Sequence 4360 represents a sequence of Television Media Operators selected by a viewer utilizing the Channel Down Key on most Remote Control Devices.

There can be sequences other than Exemplary Sequences 4320, 4330, 4440, 4450, and 4460 (e.g., a Other Exemplary Sequences). For example, a Wireless Device 0210 user can select a combination of different keys on a typical Remote Control Device which can yield a sequence other the depicted Exemplary Sequences. However, since one objective of the system is to narrow the range of potential Television Media Operators_{ADV-CAUSE} and Television Advertisements_{CAUSE}, most Other Exemplary Sequences likely will have the effect of generating a set of Logical Channels (MOᵢ) within the set of Logical Channels (MOᵢ) generated by either Exemplary Sequence 4330 or Exemplary Sequence 4460. Exemplary Sequences 4330 and 4460 will very likely generate the largest set of Logical Channels (MOᵢ), i.e., widest range of Logical Channel (MO_{UII}) and: (a) the lowest value of Logical Channel (MOᵢ) selected by Exemplary Sequence 4330; or (b) the highest value of Logical Channel (MOᵢ) selected by Exemplary Sequenced 4360. Most Other Exemplary Sequences will likely result from a Wireless Device 0210 user moving back and forth between a Channel Up Key or Channel Down Key within any Exemplary Sequence. The effect of such selection would reduce the probability of an Other Exemplary Sequence generating a set of Logical Channels (MOᵢ) larger than Exemplary Sequences 4330 and 4460.

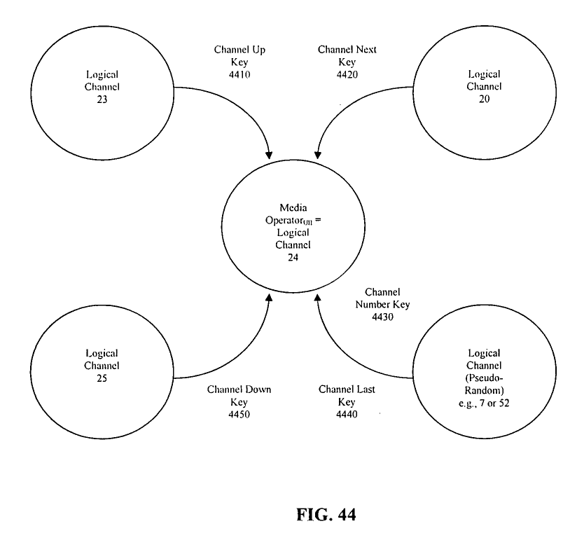

FIG. 44 depicts a set of functions enabling a Wireless Device 0210 user utilizing a typical Remote Control Device to arrive at Television Media Operator_{UII} from another Television Media Operator_{UII-1} through one of the following functions selected on the Remote Control Device: (a) selecting the Channel Up Key; (b) selecting the Channel Next Key; (c) selecting a sequence of Channel Number Keys; (d) selecting the Channel Last Key; or (e) selecting the Channel Down Key. While the present embodiment depicts methods of arriving at Television Media Operator_{UII} from another Television Media Operator_{UII-1}, the system is not limited to that embodiment. The system can support methods of arriving at any Television Media Operatorᵢ from another Television Media Operatorᵢ₋₁. While the present embodiment depicts methods of arriving at Television Media Operator_{UII} from another Television Media Operator_{UII-1}, the system is not limited to that embodiment. The system can support methods of arriving at a Media Operator other than a Television Media Operator, e.g., a Radio Media Operator.

Selecting the Channel Up Key 4410 can change the logical channel displayed on STB 1910 from Logical Channel (MO_{UII}−1) to Logical Channel (MO_{UII}). For example, if Logical Channel (MO_{UII}) is equal to the value, 24, then Logical Channel (MO_{UII}−1) is equal to the value, 23, as shown in Exemplary Sequence 4320.

Selecting the Channel Next Key 4420 can change the logical channel displayed on STB 1910 to Logical Channel (MO_{UII}), if Logical Channel (MO_{UII}) is an element of the set, {Favorite Channels}, from either: (a) the Logical Channel (MO<MO_{UII}), which is the Favorite Channel immediately preceding Logical Channel (MO_{UII}); or (b) a Logical Channel whose value is equal to any positive integer lower than Logical Channel (MO_{UII}). For example, if Logical Channel (MO_{UII}) is equal to 24, then Logical Channel (MO<MO_{UII}) can be equal to 20, as shown in Exemplary Sequence 4330.

Selecting a sequence of Channel Number Keys 4430 can change the logical channel from: (a) a Logical Channel whose value is equal to any positive integer between 1 and the highest Logical Channel transmitted by the cable Television Operator in the location of Wireless Device 0210, which can be defined as Logical Channel (Pseudo-Random); to (b) Logical Channel (MO_{UII}) whose value is equal to the sequence of Channel Number Keys 4430 inputted in the Remote Control Device. For example, if Logical Channel (MO_{UII}) is equal to 24, the Logical Channel (Pseudo-Random) can be equal to 7, as shown in Exemplary Sequence 4340.

Selecting the Channel Last Key 4440 can change the logical channel from a Logical Channel (Pseudo-Random) to Logical Channel (MO_{UII}) which was the last logical channel displayed by STB 1910 before it displayed Logical Channel (Pseudo-Random). For example, if Logical Channel (MO_{UII}) is equal to 24, the Logical Channel (Pseudo-Random) can be equal to 7, as shown in Exemplary Sequence 4350.

Selecting the Channel Down Key 4450 can change the logical channel displayed on STB 1910 from Logical Channel (MO_{UII}+1) to Logical Channel (MO_{UII}). For example, if Logical Channel (MO_{UII}) is equal to the value, 24, then Logical Channel (MO_{UII}+1) is equal to the value, 25.

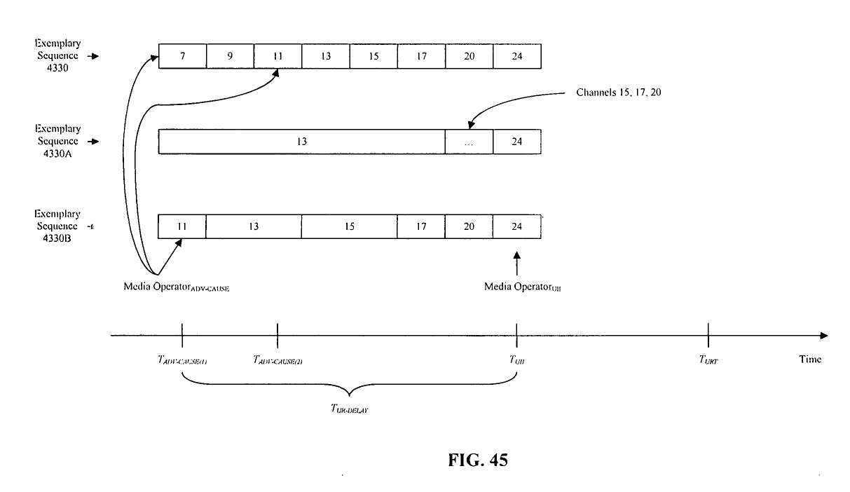

FIG. 45 depicts a set of exemplary sequences of Television Media Operators selected utilizing the Next Channel Key. Exemplary Sequence 4330 can have a variety of potential sequence subsets, including, but not limited to, Exemplary Sequence 4330A and Exemplary Sequence 4330B. Exemplary Sequences 4330, 4330A, and 4330B all or a selected portion of can terminate at the same Media Operator_{UII} e.g., logical channel 24. Assume that logical channel 7 and logical channel 11 displayed the same Advertisement_{CAUSE} promoting the product specified in an User Request.

Each exemplary sequence can originate at a different Media Operatorᵢ, depending on whether Wireless Device 0210 user stops at one or more Media Operators whose logical channel value lies between Logical Channel (MO_{ADV-CAUSE}) and Logical Channel (MO_{UII}). For example, Exemplary Sequence 4330 can originate at logical channel 7 on which Wireless Device 0210 user viewed Advertisement_{CAUSE}. For a given (T_{UII}−T_{ADV-CAUSE}), Wireless Device 0210 user can utilize the Channel Next Key to select the sequence of Media Operators from Media Operator_{ADV-CAUSE} to Media Operator_{UII}. If Wireless Device 0210 user does not stop to view any Media Operator in Exemplary Sequence 4330, the number of Media Operators in Exemplary Sequence 4330 will be larger than if Wireless Device 0210 user does stop to view one or more Media Operators and therefore, the probability is higher that Logical Channel (MO_{ADV-CAUSE}) will have a lower value, all other things being equal. The origination of Exemplary Sequence 4330 at logical channel 7 and the inclusion of logical channel 11 in the sequence means that Exemplary Sequence 4330 can expose a viewer to Advertisement_{CAUSE} two times.

Exemplary Sequence 4330A can originate at logical channel 13. Even though Exemplary Sequence 4330A can follow the same logical channel sequence from 13 to 24, the origination at logical channel 13 means that Exemplary Sequence 4330A excludes logical channel 7 and logical channel 11, which displayed Advertisement_{CAUSE}.

Exemplary Sequence 4330B can originate at logical channel 11, which displayed Advertisement_{CAUSE}.

Identifying the actual or most likely Media Operators selected by Wireless Device 0210 user or another user between the time Media Operator_{ADV-CAUSE} displays Advertisement_{CAUSE}, T_{ADV-CAUSE}, and the time Wireless Device 0210 user initiates an User Initiating Input, T_{UII}, can enable the system to narrow the range of potential Media Operators_{ADV-CAUSE} and Advertisements_{CAUSE}. For example, if Wireless Device 0210 user selected Television Media Operators in Exemplary Sequence 4330 from T_{ADV-CAUSE} to T_{UII} and the system can identify Exemplary Sequence 4330, then the system can narrow the range of potential Media Operators_{ADV-CAUSE} to Television channels, 7, 9, 11, 13, 15, 17, 20, and 24, instead of the typically hundreds of Television Media Operators carried by an average cable Television Operator.

The system can utilize a variety of methods to identify the actual or most likely sequence of Media Operators selected by Wireless Device 0210 user or another user before the Media Device displays Media Operator_{UII}, which can be defined as Media Operator Sequence_{<UII}, including, but not limited to, the following three methods.

### 6.2.1.5.1 Media Device Data

In the first method of identifying the actual or most likely Media Operator Sequences_{<UII}, the system can retrieve and transmit to Metadata Server 0280 one or more records of the Media Operator Sequence_{<UII} from the Media Device displaying Advertisement and/or Programming in the vicinity of Wireless Device 0210 either directly from the Media Device or indirectly from the Television Operator transmitting Advertisement and/or Programming from one or more Television Media Operators to the Media Device, e.g., STB 1910. The system can utilize any method disclosed herein or any existing method for retrieving one or more records of Media Operator Sequence_{<UII} from the Media Device through one or more I/O Devices of the Media Device and Wireless Device 0210. In addition, the system can utilize any method disclosed herein or any existing method for retrieving one or more records of Media Operator Sequence_{<UII} from any Data Processing System operated by the Television Operator, e.g., Headend Server 0910.

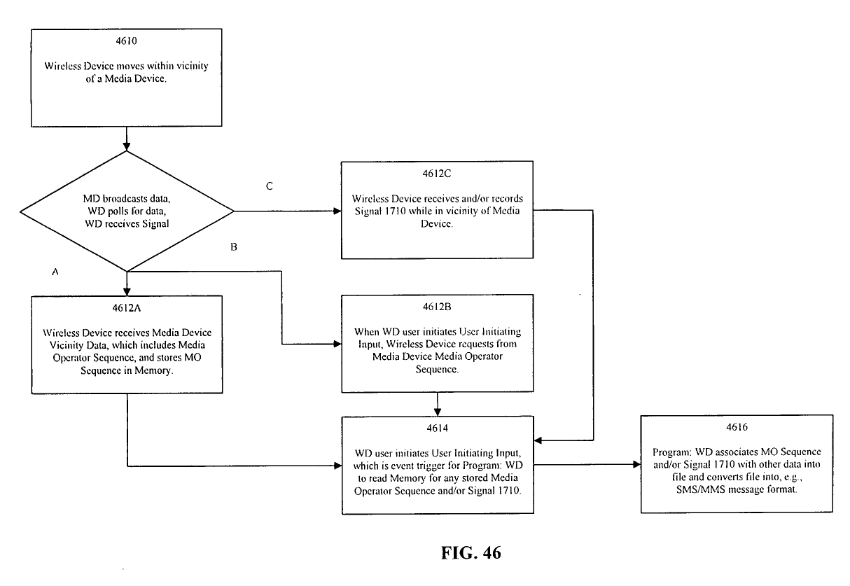

In some embodiments, FIG. 46 depicts a flowchart of an exemplary Method 4600 of retrieving data describing the Media Operator Sequence_{<UII} directly from a Media Device. The flowchart is described with reference to the system depicted in FIG. 19. However, the flowchart is not limited to that embodiment. The system can implement the flowchart with reference to systems utilizing a subset of the components, or additional, related, alternative, and/or equivalent components depicted in FIG. 19. The system can implement the flowchart by executing a subset of the methods, executing the methods in different order, and/or executing other or additional related or equivalent methods.

At 4610, a Wireless Device 0210 can move within vicinity of a Media Device 1910.

At 4612, Wireless Device 0210 can receive any data enabling the system to identify Media Operator Sequence_{<UII}. The system can enable the reception of the data through a variety of means, including, but not limited to: (a) Media Device 1910 can broadcast Media Device Vicinity Data, which Wireless Device 0210 can receive through one or more I/O Devices; (b) at the time of an User Initiating Input, Wireless Device 0210 can broadcast any signal requesting Media Operator Sequence_{<UII} from a Media Device capable of transmitting any Advertisement and/or Programming; and/or (c) Wireless Device 0210 can periodically receive and/or record any signal transmitted by the Media Device, which can enable the system to identify the Media Operator displayed on the Media Device at regular intervals.

In the first embodiment of 4612, 4612A, Media Device Vicinity Data can include the Media Operator Sequence selected over any time period for the Media Device in the vicinity of Wireless Device. When a Wireless Device 0210 moves within the vicinity of Media Device 1910, it can receive Media Device Vicinity Data which can include DCD 1924. Wireless Device 0210 can store DCD 1924 in Memory 0320 for subsequent transmission to Metadata Server 0280. If Media Operator Sequence includes a date/time stamp indicating the time and/or duration Media Device displayed any Media Operator and Wireless Device 0210 associates a Date/Time Stamp 3330 with the reception of Media Device Vicinity Data, the system can utilize the data to identify the Media Operator Sequence for the Media Device while Wireless Device 0210 is within its vicinity.

In the second embodiment of 4612, 4612B, Wireless Device 0210 can at the time of an User Initiating Input broadcast any signal requesting: (a) an acknowledgement from a Media Device capable of transmitting any Advertisement and/or Programming; and/or (b) any data from a Media Device specifying the Media Operator Sequence for any time period, e.g., DCD 1924. If Wireless Device 0210 receives an acknowledgement from a Media Device 1910, then Wireless Device 0210 can transmit a request for data, e.g., DCD 1924. If Wireless Device 0210 receives data, e.g., DCD 1924, it can store DCD 1924 in Memory 0320 and/or immediately associate the data with other data for transmission to Metadata Server 0280.

In the third embodiment of 4612, 4612C, the system can identify the Media Operators displayed on a Media Device in the vicinity of Wireless Device 0210 by utilizing the following method. First, Wireless Device 0210 can record periodically a sample of any signal, e.g., an audio signal, which one or more of its I/O Devices, e.g., Audio Receiving Component 0378, can receive (e.g., a Signal Sample). Wireless Device 0210 can record the Signal Sample at any regular interval in any format or protocol. While recording the Signal Sample frequently can increase the accuracy with which the system can identify the Media Operators displayed at regular intervals, frequent recordings can utilize more storage and transmission capacity. The system can utilize any method to identify how frequently Wireless Device 0210 can record a Signal Sample to balance the objectives of increasing accuracy and reducing demand on storage and transmission capacity.

Second, Wireless Device 0210 can generate a Date/Time Stamp 3330 and/or Location Stamp 3332 recording the date/time of the Signal Sample and the location of Wireless Device 0210 at the time of the Signal Sample.

Third, Wireless Device 0210 can store any recorded Signal Sample and its associated Date/Time Stamp 3330 and/or Location Stamp 3332 in Memory 0320 until Wireless Device 0210 transmits data to Metadata Server 0280 within any method enabling the identification of the product of interest, the Advertisement and/or Programming promoting the product of interest, and/or the Media Operator and/or Media Program displaying the Advertisement and/or Programming of interest, including, but not limited to: 0726 in Method 0700, 2620 in Method 2600, and/or 2822 in Method 2800.

By recording periodically a Signal Sample and utilizing any application, e.g., Fingerprint Application 0334 located at Wireless Device 0210 or any other Data Processing System like Metadata Server 0280, to identify if the Signal Sample is part of an Advertisement and/or Programming displayed on any Media Operator transmitting at the date/time and location, the system can increase the probability of identifying the Media Operator Sequence_{<UII}. While the Wireless Device 0210 user and/or another user viewing the Media Device can select a Media Operator different from the one displaying at the time Wireless Device 0210 periodically records a Signal Sample, the combination of identifying the Media Operator to which the Media Device is tuned and the probability of the users executing one of a small set of possible Media Operator Sequences_{<UII} can enable the system to narrow the potential Media Operators_{ADV-CAUSE}.

At 4614, Wireless Device 0210 user can initiate an User Initiating Input, which can be an event trigger for Program: WD 0338 to read Memory 0320 for any data enabling the system to identify Media Operator Sequence_{<UII}, which can include, but are not limited to: any Media Operator Sequence recorded by Media Device; and/or Signal Sample.

At 4616, Program: WD 0338 can associate the data enabling the identification of Media Operator Sequence_{<UII} with any other data into a file, and convert the file into any format or protocol, e.g., a SMS/MMS message format, for transmission to Metadata Server 0280.

The benefits of utilizing Method 4600 can include, but are not limited to, enabling the identification of an Advertisement and/or Programming promoting a product of interest even after the termination of the display of the Advertisement and/or Programming. By identifying the actual or likely Media Operator Sequence_{<UII}, the system can narrow the potential Media Operators_{ADV-CAUSE} and potential Advertisements_{CAUSE}.

The system can utilize any method to assist Method 4600 to identify the actual or most likely Media Operator Sequences_{<UII}. These methods can include, but are not limited to: utilizing a hidden Markov model (HMM) to identify the hidden Media Operatorᵢ and/or hidden Media Operator Sequence from the observable parameters, e.g., a sequence of periodically recorded audio samples. A hidden Media Operatorᵢ is a Media Operatorᵢ whose value cannot be observed directly and must be inferred from observing other variables.

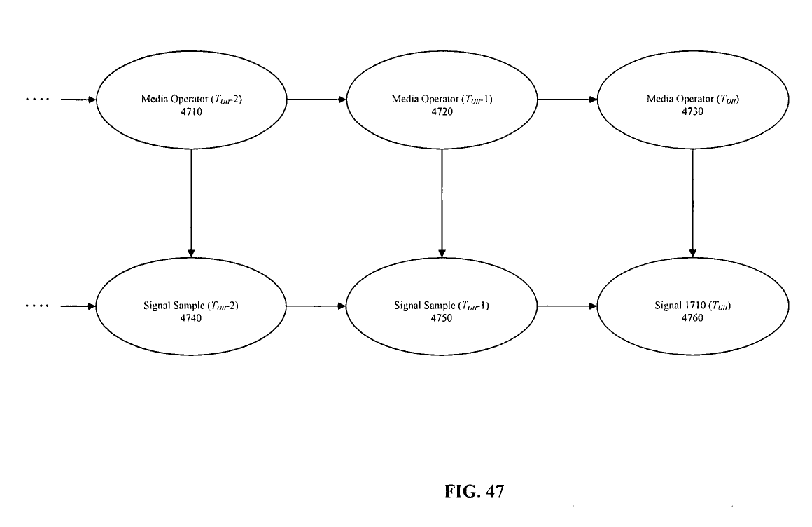

FIG. 47 depicts an exemplary architecture of a HMM 4700 for identifying the actual or most likely Media Operator Sequences_{<UII}. While the present embodiment shows how the system can identify the actual or more likely Media Operator Sequences_{<UII} by estimating the probability of observing the variable, Signal Sample, e.g., a sample of the audio signal transmitted by the Media Operator, the system is not limited to that embodiment. The system can support using a HMM to estimate the probability of observing any variable and/or sequence of observable states, which can be received, collected, and/or generated by any Data Processing System, including, but not limited to: Wireless Device 0210; Media Device 1910; and/or Metadata Server 0280. While the present embodiment shows how the system can identify the most likely sequence of hidden states, e.g., the Media Operator displayed on a Media Device, which could have generated the sequence of observable states, the system is not limited to that embodiment. The system can support using a HMM to identify the most likely sequence of any type of hidden states which could have generated a sequence of observable states that can be received, collected, and/or generated by any Data Processing System, as long as the sequences meet the conditions of a HMM, e.g., where the stochastic process has the Markov property.

Given the parameters of exemplary HMM 4700, the system can utilize any method to identify the most likely sequence of hidden states, which can include, but is not limited to, a Viterbi algorithm. Exemplary HMM 4700 can meet the assumptions for implementing the Viterbi algorithm. The observed events of a Signal Sample and the hidden events of the Media Operatorᵢ at the date/time Wireless Device 0210 receives a Signal Sample are in a sequence corresponding to time, the sequences are aligned, and the most likely hidden sequence up to a certain T depends on the observed event at T and the most likely sequence at T−1. Because most Wireless Device 0210 users will use a Remote Control Device to select one or more Media Operators which can constitute one or more potential Media Operator Sequences_{<UII}, there will be a finite number of states which the system can examine. The system can examine most or all or a selected portion of the potential Media Operator Sequences_{<UII} leading to the selection of the identified Media Operator_{UII} and select the most likely Media Operator Sequence_{<UII}.

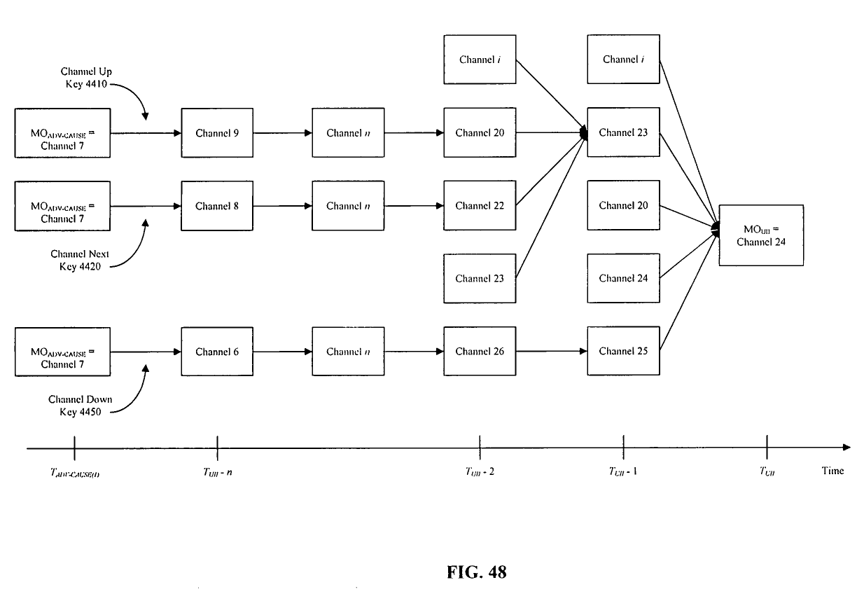

FIG. 48 depicts an exemplary set of potential Media Operator Sequences_{<UII} which can originate at one or more initial states, e.g., where Media Operator_{ADV-CAUSE} equals Channel 7, and terminates at Media Operator_{UII} equals the observed state, Channel 24. The system can include in FIG. 48 other potential Media Operator Sequences_{<UII} originating at different initial states, e.g., where Media Operator_{ADV-CAUSE} equals Channel 7, and terminates at the observed state, Channel 24. In executing a Viterbi algorithm, the system can, in some embodiments, list all or a selected portion of potential Media Operator Sequences_{<UII} as partially shown in FIG. 48.

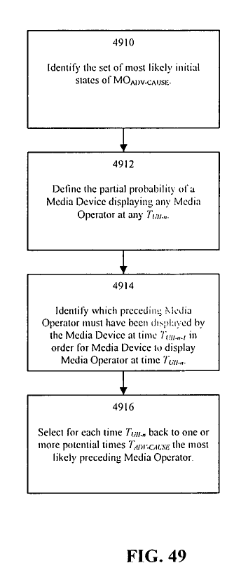

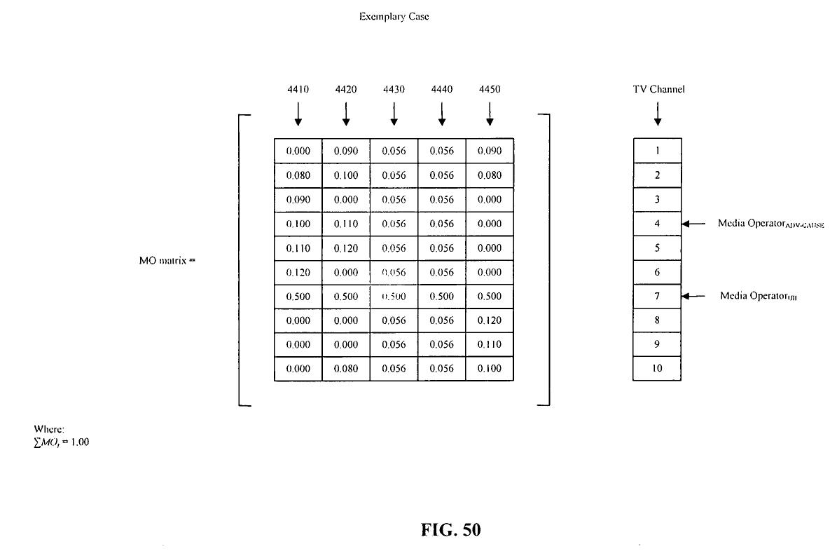

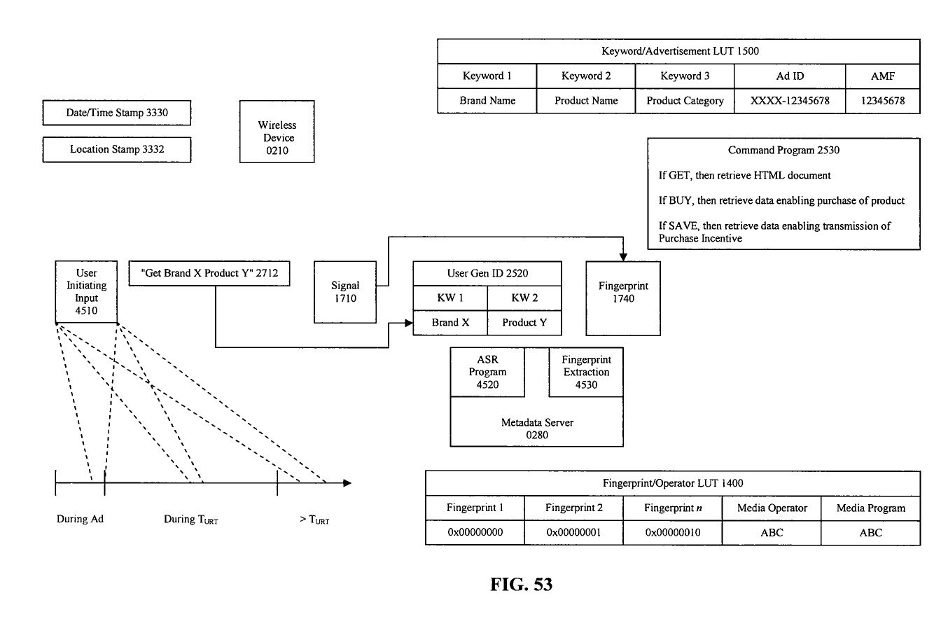

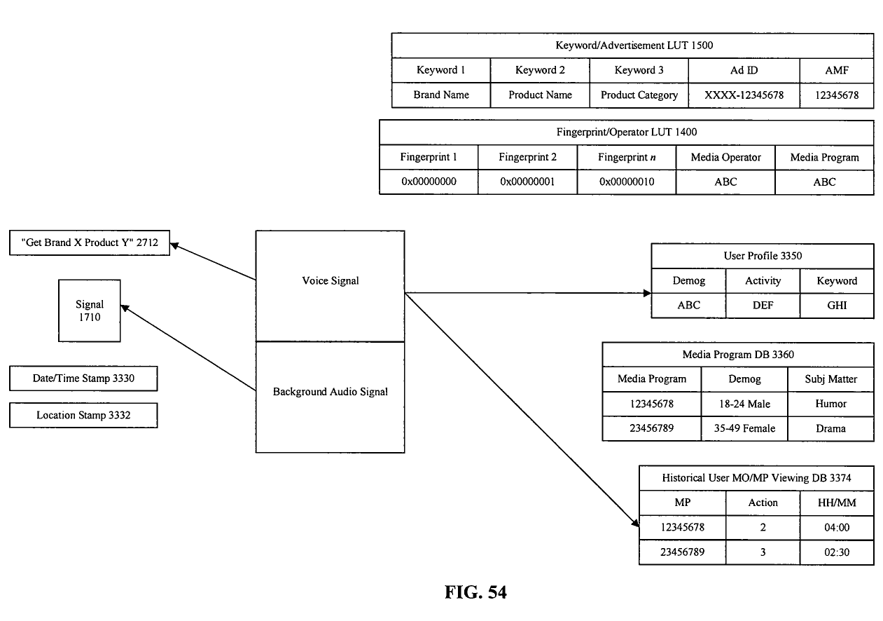

FIG. 49 depicts a flowchart of an exemplary Method 4900 of identifying the most likely Media Operator Sequence_{<UII} given the sequence of observed Signal Samples utilizing a Viterbi algorithm. The system describes the flowchart with reference to the systems and examples depicted in FIG. 47 and FIG. 48. However, the flowchart is not limited to that embodiment. The system can implement the flowchart with reference to systems and examples utilizing a subset of the components, or additional, related, alternative, and/or equivalent components depicted in FIG. 47 and FIG. 48. The system can implement the flowchart by executing a subset of the methods, executing the methods in different order, and/or executing other or additional related or equivalent methods.

The system can execute the Viterbi algorithm with the following modifications to apply the Viterbi algorithm to the problem of identifying the most likely Media Operator Sequence_{<UII} given the sequence of observed Signal Samples.

At 4910, the system can identify the set of most likely initial states of Media Operators_{ADV-CAUSE} utilizing any method described herein.

At 4912, the system can define the partial probability of a Media Device displaying any Media Operatorᵢ at any time, T_{UII-n}, The system can utilize any variables whose values are identified in Equation 4 described in Section 6.2.1.5.3 to assist in the calculation of the partial probability. For example, the partial probability can be a function of the number of potential Logical Channels (MOᵢ) a Wireless Device 0210 user can select utilizing a Remote Control Device and/or the likely Logical Channels (MOᵢ) selected.

At 4914, the system can identify which preceding Media Operator must have been displayed by Media Device at the time T_{UII-n-1} in order for Media Device to make the transition to a Media Operatorᵢ at time T_{UII-n}. The system can utilize an argmax operator to select the Media Operator which maximizes the partial probability.

At 4916, the system can select for each time T_{UII-n} back to one or more potential times T_{ADV-CAUSE} the most likely preceding Media Operator.

If there are more than one potential Media Operators_{ADV-CAUSE}, then the Viterbi algorithm can select the Media Operator Sequence_{<UII} which includes a Media Operator closest in value to the Logical Channel (MO_{ADV-CAUSE}).

### 6.2.1.5.2 Wireless Device Data

In the second method of identifying the actual or most likely Media Operator Sequences_{<UII}, the system can retrieve and transmit to Metadata Server 0280 one or more records of the Media Operator Sequence_{<UII} from the Media Device by recording the Media Operator Sequence_{<UII} on Wireless Device 0210 if Wireless Device 0210 acts as a Remote Control Device selecting the logical channel of the other Media Device or receives one or more infrared transmissions of a logical channel selected by another Remote Control Device.

The first two methods of identifying Media Operator Sequence_{<UII} can enable any method, e.g., Method 3400, to limit with a high confidence level the number of potential Media Operators_{ADV-CAUSE} to those Media Operators selected in actual Media Operator Sequence_{<UII} retrieved from the Media Device in the vicinity of Wireless Device 0210 at T_{UII}. If Wireless Device 0210 user views Advertisement_{CAUSE} on another Media Device, e.g., a Television 0230 in another room, then identifying Media Operator Sequence_{<UII} can increase P_{FP}. However, if Wireless Device 0210 user views Advertisement_{CAUSE} on the same Media Device as the Media Device displaying Advertisement and/or Programming at T_{UII}, then identifying Media Operator Sequence_{<UII} can enable the system to limit reliably the number of potential Media Operators_{ADV-CAUSE}.

### 6.2.1.5.3 Statistical Methods

In the third method of identifying the most likely Media Operator Sequences_{<UII}, the system can infer the most likely or set of most likely Media Operator Sequences_{<UII} utilizing any method.

By inferring the most likely or set of most likely Media Operator Sequences_{<UII}, the system can achieve at least the following objective. Identifying the Media Operators which are elements of the most likely or set of most likely Media Operator Sequences_{<UII} can enable any method, e.g., Method 3400, to narrow the range of potential Media Operators_{ADV-CAUSE} to those Media Operators selected in the most likely or set of most likely Media Operator Sequences_{<UII}.

In some embodiments, the system can utilize one or more of the disclosed systems, methods, and computer program products, e.g., a Fingerprint Application, to identify Media Operator_{UII}. Having identified Media Operator_{UII}, the system can analyze the factors enabling the identification of the Media Operator_{ADV-CAUSE} or set of most likely Media Operators_{ADV-CAUSE}.

In some embodiments, the relationship between the conditional probability, P(Logical Channel (MOᵢ)=(MO_{ADV-CAUSE})|Logical Channel (MO_{UII})), and the factors affecting the selection of logical channels between Logical Channel (MO_{ADV-CAUSE}) and Logical Channel (MO_{UII}) can be expressed in the following exemplary Equation 4.

P(Logical Channel(MOᵢ)=Logical Channel(MO_{ADV-CAUSE})|Logical Channel (MO_{UII}))=f((P(Type of Media Operator Sequence_{<UII} Selected)),(P(WD User Viewing one or more of the Media Operatorsᵢ in Media Operator Sequence_{<UII} Selected)),(T_{UII}−T_{ADV-CAUSE}))

While Equation 4 can include the specified independent variables, the system is not limited to that embodiment. The system can support utilizing Equation 4 with a subset of, additional, related, alternative, and/or equivalent independent variables.

The independent variable, P(Type of Media Operator Sequence_{<UII}), can in turn be a function of other variables, which can include, but are not limited to, the following.

First, the type of Media Device in the vicinity of Wireless Device 0210 can determine the type of controls utilized to select a Media Operator. For example, a viewer typically controls a Television 0230 through a Remote Control Device, which can have a limited number of methods for selecting a Media Operator and/or Media Operator Sequence.

Second, the number of functions typically utilized by an user controlling a Media Device can determine the probability of any particular function utilized. For example, a Remote Control Device selecting a Logical Channel (MOᵢ) on a Television 0230 typically has five frequently utilized functions. Assuming that the typical Wireless Device 0210 user utilizes a Remote Control Device to select the logical channels for a Television 0230, Type of Media Operator Sequence_{<UII} can have one of five potential values: (a) a Media Operator Sequence_{<UII} selected by utilizing the Channel Up Key 4410 depicted in FIG. 44; (b) a Media Operator Sequence_{<UII} selected by utilizing the Channel Next Key 4420; (c) a Media Operator Sequence_{<UII} selected by utilizing the Channel Number Key 4430; (d) a Media Operator Sequence_{<UII} selected by utilizing the Channel Last Key 4440; and/or (e) a Media Operator Sequence_{<UII} selected by utilizing the Channel Down Key 4450. The Type of Media Operator Sequence_{<UII} can influence the probability of Media Operatorᵢ=Media Operator_{ADV-CAUSE} given the system identifying Media Operator_{UII}. That is, assuming there exists an actual Advertisement and/or Programming which stimulated Wireless Device 0210 user to transmit the User Request, Wireless Device 0210 user or another viewer of Television 0230 utilizing a Remote Control Device must have selected one of the five potential functions, 4410, 4420, 4430, 4440, or 4450 so that STB 1910 displayed Media Operator_{ADV-CAUSE} at T_{ADV-CAUSE} and Media Operator_{UII} at T_{UII}. If Wireless Device 0210 user transmitted the User Request independently of any Advertisement and/or Programming promoting the product of interest, then there should be no Media Operator_{ADV-CAUSE} and the system can utilize the disclosed methods in Sections 6.2.1.3 and 6.2.1.4 to respond to the User Request.

If most Wireless Device 0210 users utilize the different functions depicted in FIG. 44 with equal probability, then P(Type of Media Operator Sequence_{<UII}) for Television 0230 would equal ⅕ for any Type of Media Operator Sequence_{<UII}.

If most Wireless Device 0210 users utilize the different functions depicted in FIG. 44 with different probabilities, then P(Type of Media Operator Sequence_{<UII}) for Television 0230 would have different values for any Type of Media Operator Sequence_{<UII}. For example, if most Wireless Device 0210 users utilize the Channel Up Key 4410 and Channel Next Key 4420 more frequently than the Channel Down Key 4450 to channel-surf, then Logical Channel (MO_{ADV-CAUSE}) will be more likely to have a value that is smaller than Logical Channel (MO_{UII}), all other things being equal.

The Channel Next Key 4420 specifies the function of selecting a Media Operator by utilizing the Channel Next Key on a Remote Control Device. A typical STB 1910 can store one or more Media Operators and/or the logical channels identifying one or more Media Operators a viewer has selected as a Favorite Channel (e.g., a Favorite Channel Selections) in any type of memory. The system can utilize the Favorite Channel Selections data to narrow the range of potential Television Media Operators_{ADV-CAUSE} to those Television Media Operators stored in the Favorite Channel Selections. The system can retrieve the Favorite Channel Selections data through a variety of methods, including, but not limited to, transmitting a request to STB 1910 to retrieve the data through any method described in Section 5.1.1.4.

A Radio 0232 typically has three frequently utilized functions. Type of Media Operator Sequence_{<UII} can have one of three potential values: (a) a Media Operator Sequence_{<UII} selected by utilizing the Channel Up Key 4410; (b) a Media Operator Sequence_{<UII} selected by utilizing the Channel Down Key 4450; and/or (c) a Media Operator Sequence_{<UII} selected by utilizing a Favorite Channel function.

The independent variable, P(WD User Viewing one or more of the Media Operatorsᵢ in Media Operator Sequence_{<UII} Selected) can in turn be a function of one or more other independent variables related as follows, f(Media Program Rating Database, User Profile 3350, Population Database 3352, Media Program Database 3360, Historical User MO/MP Viewing Database 3374). The probability of a Wireless Device 0210 user viewing one or more Media Operatorsᵢ in the Media Operator Sequence_{<UII} selected can influence the probability of Media Operatorᵢ=Media Operator_{ADV-CAUSE} given the system identifying Media Operator_{UII}. If Wireless Device 0210 user views one or more Media Programs displayed by one or more Media Operators in the Media Operator Sequence_{<UII} selected and the Wireless Device 0210 user utilized the Channel Up Key 4410, Channel Next Key 4420, or Channel Down Key 4450 to channel-surf, then the absolute value of (Logical Channel (MO_{ADV-CAUSE})−Logical Channel (MO_{UII})) will probably be smaller in magnitude than if Wireless Device 0210 user does not view any Media Programs displayed on any Media Operator between Logical Channel (MO_{ADV-CAUSE}) and Logical Channel (MO_{UII}).

In some embodiments, the system can initialize P(WD User Viewing one or more of the Media Operatorsᵢ in Media Operator Sequence_{<UII} Selected) with data drawn from Media Program Rating Database. The system can utilize data, e.g., Television ratings data, for any Media Program displayed for each Media Operator in any Media Operator Sequence_{<UII} to determine the probability that Wireless Device 0210 user will stop while channel-surfing and view Media Programᵢ while proceeding from Logical Channel (MO_{ADV-CAUSE}) to Logical Channel (MO_{UII}). After initializing P(WD User Viewing one or more of the Media Operatorsᵢ in Media Operator Sequence_{<UII} Selected), the system can adjust the probability of viewing any Media Programᵢ by utilizing data from the other independent variables, which can include, but are not limited to: User Profile 3350; Population Database 3352; Media Program Database 3360; and/or Historical User MO/MP Viewing Database 3374. For example, data drawn from Media Program Rating Database can show that the share of Television households viewing Media Program (XYZ) displayed at time period T₁ is x percent and a Media Operator targets Media Program (XYZ) at males 12-24. However, even if User Profile 3350 for a Wireless Device 0210 user shows that the user is in the 18-34 male category, the storage of Media Program (ABC) displayed at the same time period targeted at males 25-49 in Historical User MO/MP Viewing Database 3374 can reduce the probability the system can assign to the initialized x percent.

The independent variable, (T_{UII}−T_{ADV-CAUSE}), can have a value specifying the length of time of (T_{UII}−T_{ADV-CAUSE}). (T_{UII}−T_{ADV-CAUSE}) can influence the probability of Media Operatorᵢ=Media Operator_{ADV-CAUSE} given the system identifying Media Operator_{UII}. That is, the larger the value of (T_{UII}−T_{ADV-CAUSE}), the higher the probability that Wireless Device 0210 user viewed a Media Operator whose Logical Channel had a value more distant from Logical Channel (MO_{UII}). If Wireless Device 0210 user utilized Channel Up Key 4410, Channel Next Key 4420, and/or Channel Down Key 4450 during the time period between T_{ADV-CAUSE} and T_{UII}, then a larger value of (T_{UII}−T_{ADV-CAUSE}) can increase the number of potential Media Operators_{ADV-CAUSE} and therefore, increase the probability that Wireless Device 0210 user viewed any Media Operatorᵢ.

If Advertisement (Highest Rank) is actually Advertisement_{CAUSE}, then T_{UR-DELAY} will equal (T_{UII}−T_{ADV-CAUSE}) as depicted in FIG. 45.

If any existing method or methods disclosed in the system can identify Media Operator_{UII}, then T_{UII} is an observable parameter and T_{UII} can be a known value. If Wireless Device 0210 user initiates an User Initiating Input during the display of an Advertisement_{CAUSE}, then T_{ADV-CAUSE} can be a known value. If Wireless Device 0210 user initiates an User Initiating Input after the termination of the display of Advertisement_{CAUSE}, then T_{ADV-CAUSE} is a hidden parameter.

The system can utilize any method to identify the actual T_{ADV-CAUSE} or the set of most likely T_{ADV-CAUSE}, including, but not limited to, the following methods. First, if Wireless Device 0210 user initiates an User Initiating Input and transmits an User Request which includes Keywords/Keyphrases identifying a product promoted in an Advertisement displayed on Media Operator_{UII} at T_{UII}, then the probability that T_{UII} equals T_{ADV-CAUSE} is very high.

Second, if the Keywords/Keyphrases transmitted by a Wireless Device 0210 user identify a product promoted in an Advertisement, the system can select one or more records in any database, e.g., LUT 1500, which includes the identified product. The system can then lookup the associated Advertisements and define the set of most likely T_{ADV-CAUSE} to include those dates/times at which the associated Advertisements were displayed on any Media Operator.

In some embodiments, the system can utilize Equation 4 as one method of calculating the partial probability for any given state at any time, T_{UII-n}.

### 6.2.1.6 Automatic Speech Recognition

It is well known that the accuracy rate of ASR programs can depend on, inter alia, the size of the vocabulary, the utilization of a grammar, and if they are speaker-dependent or speaker-independent.

In some embodiments, a Wireless Device 0210 user can input an User Request by speaking a Command and one or more Keywords/Keyphrases into Audio Receiving Component 0378. The system can require that a Wireless Device 0210 user identify only: (a) the action he/she wants Wireless Device 0210 to execute, e.g., “Get” a web page, “Buy” the product promoted, or “Save” a coupon for the product promoted; and (b) the name of the brand, product, vendor, and/or product category. Because of the limited requirements, the system can significantly restrict the vocabulary size of the utilized ASR program. The system can restrict the vocabulary size in at least two ways. First, the system can require a Wireless Device 0210 user to specify a Command as the first word in any User Request. Such a requirement can limit any words inputted by Wireless Device 0210 user after a Command to nouns, because any Keywords/Keyphrases would describe a brand, product, or product category. Second, the system can restrict the vocabulary size to the Commands and those Keywords/Keyphrases associated with Advertisements displayed during any limited time period before the User Initiating Input. That is, if a Wireless Device 0210 user inputs an User Request in response to an Advertisement and if the vast majority of User Requests occur within a specified time period, e.g., 15 minutes, 3 hours, or 3 days, after a Media Operator displays the Advertisement, the number of Keywords/Keyphrases that need to be searched can be a subset of the total number of Keywords/Keyphrases in a database, e.g., LUT 1500.

### 6.2.1.7 Exemplary Cases

The present section illustrates the implementation of the system in exemplary cases. There are three possible cases for which the system can attempt to identify the Advertisement most likely to have promoted the product of interest to Wireless Device 0210 user. First, Wireless Device 0210 user can initiate User Initiating Input during the display of the Advertisement which stimulated Wireless Device 0210 user to transmit an User Request regarding the product promoted by the Advertisement. Second, Wireless Device 0210 user can initiate User Initiating Input after the Advertisement stimulating the user to transmit an User Request terminates, but within T_{URT}. Third, Wireless Device 0210 user can initiate User Initiating Input after T_{URT}. In addition, there is a scenario where Wireless Device 0210 user can initiate User Initiating Input independent of any Advertisement and/or Programming, e.g., when Wireless Device 0210 user can simply want pizza. The system can process the User Requests as follows.

In the following examples, the system utilizes the following data depicted in FIG. 66 to identify the Advertisement most likely to have promoted the product of interest. The data received from Wireless Device 0210 can include: (a) User Request 2712; (b) Signal Sample; (c) Date/Time Stamp 3330; (d) Location Stamp 3332; and (e) User Profile 3350. The data stored at Metadata Server 0280 can include: (a) Media Program Database 3360; (b) Historical User MO/MP Viewing Database 3374; (c) Fingerprint/Operator LUT 1400; and (d) Keyword/Advertisement LUT 1500. The system can utilize any combination of data described in FIG. 33 or any other data enabling the system to identify the product of interest, the Advertisement and/or Programming promoting the product of interest, and/or the Media Operator and/or Media Program displaying an Advertisement and/or Programming of interest. However, for purposes of the following examples, the system utilizes the data depicted in FIG. 41.

### 6.2.2 Lookup of Associated AMF/PMF

### 7.3 Broadcasting

In some embodiments, systems and methods for transmitting to each Wireless Device 0210 a specific Ad Metadata File 0410 and/or Program Metadata File 0510 associated with an Advertisement and/or Programming of interest can be implemented. Transmitting a specific Ad Metadata File 0410 and/or Program Metadata File 0510 to a specific Wireless Device 0210 user can utilize a given Wireless Operator 0240 network efficiently in a variety of cases, including, but not limited to: (a) where there are relatively few Wireless Devices 0210 requesting an Ad Metadata File 0410 and/or Program Metadata File 0510; or (b) where there are many unique Ad Metadata Files 0410 and/or Program Metadata Files 0510 the system can be configured to transmit to many Wireless Devices 0210 simultaneously. In some embodiments the system must transmit to many Wireless Devices 0210 simultaneously.

However, there can be cases where broadcasting or multicasting utilizing any method a specific Ad Metadata File 0410 and/or Program Metadata File 0510 to a plurality of Wireless Devices 0210 can utilize one or more Wireless Operator 0240 networks more efficiently. For example, if many Wireless Devices 0210 request a given Ad Metadata File 0410 simultaneously or within some short time period, broadcasting to all or a selected portion of Wireless Devices 0210 the Ad Metadata File 0410 or some data within Ad Metadata File 0410 can utilize less wireless bandwidth than transmitting the Ad Metadata File 0410 to each Wireless Device 0210 requesting it. Broadcasting certain large data files, e.g., audio, images, or video, that can be part of an Ad Metadata File 0410 can utilize less bandwidth.

11.4 Matching of Event Exposure with Purchase Response

FIG. 65 depicts a block diagram of an exemplary system: (a) enabling an advertiser to verify that any given event is directly related to a purchase in a Physical Retailer; and (b) billing the advertiser and crediting any entity enabling the transaction. The system can implement the system by utilizing a subset of the following components, or additional, related, alternative, and/or equivalent components. The system can include, but is not limited to, the following components not disclosed earlier herein.

Wireless Device 0210 can store in PR Data File 0346 one or more electronic coupons, Coupon 0520. Each Coupon 0520 can contain data, including, but not limited to: (a) any code, e.g., Ad-ID, uniquely identifying the Advertiser 0220 and/or Media Buyer 0222 transmitting the Advertisement and/or Programming associated with the Ad Metadata File 0410 and/or Program Metadata File 0510 from which Wireless Device 0210 retrieved the data constituting Coupon 0520; (b) any code, e.g., UPC, uniquely identifying the product promoted in the Advertisement and/or Programming associated with the Ad Metadata File 0410 and/or Program Metadata File 0510 from which Wireless Device 0210 retrieved the data constituting Coupon 0520; and/or (c) any code, e.g., UCC Coupon Code, uniquely identifying the Purchase Incentive included in the Ad Metadata File 0410 and/or Program Metadata File 0510 from which Wireless Device 0210 retrieved the data constituting Coupon 0520.

Wireless Device 0210 can store in PR Data File 0346 one or more Payment Receipts 0530. Payment Receipt 0530 is any file containing data verifying the purchase of one or more products. Payment Receipt 0530 can contain data including, but not limited to: (a) any code, e.g., UPC, uniquely identifying a product purchased in any given transaction; (b) the number of units of the product purchased in any given transaction; and/or (c) the unit price of the product purchased in any given transaction.

Retailer Server 0272 can store in one or more Transaction Databases 6530 one or more records of transactions, which can contain data including, but not limited to: (a) any code uniquely identifying a transaction; (b) any code uniquely identifying a customer; (c) any code, e.g., UPC, uniquely identifying one or more products purchased in any given transaction; and/or (d) any code, e.g., UCC Coupon Code, uniquely identifying one or more Purchase Incentives utilized in any given transaction.

Retailer Server 0272 can store in one or more Customer Databases 5042 one or more records of customers, which can contain data including, but not limited to: (a) any code uniquely identifying a customer (e.g., a Customer ID), which can include, but is not limited to: the Shopper Loyalty ID; the name and address of the customer; and/or one or more phone numbers of the customer; (b) any code uniquely identifying a transaction; (c) any code, e.g., UPC, uniquely identifying one or more products purchased in any given transaction; and/or (d) the number of units of one or more products purchased in any given transaction.

Electronic Coupon Redemption (ECR) 6540 is a Data Processing System which can perform a variety of functions, including, but not limited to: exchanging data with one or more Retailer Servers 0272 and/or Metadata Server 0280. ECR 6540 can be an entity which processes the redemption of physical and/or electronic coupons received from one or more retailers.

FIG. 66 depicts a flowchart of an exemplary Method 6600 for (a) enabling an advertiser to verify that any given event is directly related to a purchase in a Physical Retailer; and (b) billing the Advertiser and crediting any entity enabling the transaction. The flowchart is described with reference to the system depicted in FIG. 65. However, the flowchart is not limited to that embodiment. The system can implement the flowchart with reference to systems utilizing a subset of the components, or additional, related, alternative, and/or equivalent components depicted in FIG. 65. The system can implement the flowchart by executing a subset of the methods, executing the methods in different order, and/or executing other or additional related or equivalent methods.

There are existing methods of enabling the redemption of an electronic coupon transmitted to a Wireless Device 0210. For example, Slyman et al. disclose an invention enabling a wireless device to receive an electronic coupon and a merchant to validate the redemption of the electronic coupon.

Method 6600 can generate benefits, including, but not limited to: (a) enabling the validation of the redemption of an electronic coupon presented by a Wireless Device 0210 to a POS System 0270 by receiving and processing data from Retailer Server 0272, ECR 6540, Advertiser 0220, or any other entity; (b) enabling the validation of the redemption of an electronic coupon presented by a Wireless Device 0210 to a POS System 0270 by searching for matches between: (i) one or more Product IDs and/or one or more Purchase Incentive IDs in one or more Payment Receipts 6520 and/or Transaction Records; and (ii) one or more Ad Metadata Files 0410 and/or Program Metadata Files 0510; and/or (c) enabling the identification and crediting of one or more entities enabling a Wireless Device 0210 user to: (i) view the Advertisement and/or Programming promoting the product purchased in a Physical Retailer; and/or (ii) respond to the Advertisement and/or Programming of interest by receiving any data, e.g., Ad Metadata File 0410 and/or Program Metadata File 0510, which can include the data constituting a Purchase Incentive subsequently redeemed at a Physical Retailer.

For example, a Wireless Device 0210 user can view during a Media Program XYZ transmitted by a Media Operator XYZ a Television Advertisement promoting a product XYZ of interest. Utilizing the methods disclosed in the system, Wireless Device 0210 can receive from Metadata Server 0280 through a Wireless Operator XYZ an Ad Metadata File 0410 including a Purchase Incentive, which Wireless Device 0210 user subsequently redeems at a Physical Retailer. The system can identify: (a) the Media Operator XYZ transmitting the Media Program XYZ displaying the Advertisement of interest; (b) the Wireless Operator XYZ enabling the transmission of an Ad Metadata File 0410 including the Purchase Incentive redeemed; and/or (c) the Metadata Server 0280 processing the request from Wireless Device 0210 for the Ad Metadata File 0410. Because the system can generate the above data, it can enable the crediting of any entity enabling the redemption of a Purchase Incentive at a Physical Retailer.

At 6610, Wireless Device 0210 user can select an option in Ad Response Menu to store an electronic coupon in Memory 0320.

At 6612, when Wireless Device 0210 user is at the checkout in a Physical Retailer, the user can transmit through one or more I/O Devices the stored electronic coupon, Shopper Loyalty ID, and/or other data to POS System 0270. The methods of transmitting the data can include, but are not limited to: (a) Wireless Device 0210 calling any function to display in Display 0354 the stored electronic coupon, Shopper Loyalty ID, and/or other data in a form which can be read by one or more I/O Devices of POS System 0270, e.g., a barcode reader; and/or (b) Wireless Device 0210 transmitting through one or more I/O Devices, e.g., NFC Antenna 0390, the stored electronic coupon, Shopper Loyalty ID, and/or other data.

At 6614, POS System 0270 can receive through one or more I/O Devices the electronic coupon and credit Wireless Device 0210 user for the value of the electronic coupon. For example, a barcode reader attached to or integrated with POS System 0270 can read one or more barcodes displayed in Display 0354 whose symbol represents the stored electronic coupon.

At 6616, POS System 0270 can verify receipt and/or processing of the electronic coupon through a variety of means, including, but not limited to: (a) transmitting data directly to Wireless Device 0210 from one or more I/O Devices of POS System 0270 to one or more I/O Devices of Wireless Device 0210, e.g., POS System 0270 can include a device which can transmit data over the NFC protocol to NFC Antenna 0390 of Wireless Device 0210; and/or (b) transmitting data through Retailer Server 0272 to any Data Processing System capable of receiving data verifying POS System 0270 receipt of the electronic coupon, where the Data Processing System can include, but is not limited to: Advertiser 0220, Media Buyer 0222, Metadata Server 0280, Wireless Device 0210, ECR 6540, and/or any Data Processing System operated by Wireless Operator 0240. For example, Retailer Server 0272 can transmit to Wireless Device 0210 any data verifying POS System 0270 receipt of one or more electronic coupons in one or more transactions through any means, including, but not limited to: an email message, and/or a SMS message.

At 6618A, Wireless Device 0210 can receive through one or more I/O Device a Payment Receipt including data, which can include, but are not limited to: the Product ID, e.g., the UCC, of one or more products purchased in the transaction; and/or the Purchase Incentive, e.g., the basic UCC Coupon Code, received by POS System 0270 and processed in the transaction.

At 6620A, Wireless Device 0210 can search any Payment Receipts received and electronic coupons stored during a time period of interest for matches of data in the Payment Receipts and electronic coupons. For example, Wireless Device 0210 can search for matches between: (a) any Product ID included in Payment Receipts and Product ID included in electronic coupons; and/or (b) any UCC Coupon Code included in Payment Receipts and UCC Coupon Code included in electronic coupons. Any match would confirm that Wireless Device 0210 user utilized an electronic coupon when buying a product promoted in an Advertisement previously viewed. In some embodiments, Wireless Device 0210 can search for any Payment Receipts received and Ad Metadata Files 0410 and/or Program Metadata Files 0510 received during a time period of interest for matches of data in the Payment Receipts and metadata files. Any match would confirm that Wireless Device 0210 purchased a product promoted in an Advertisement previously viewed.

At 6622A, Wireless Device 0210 can transmit to Metadata Server 0280 a record of the electronic coupon redemption and the matching Ad Metadata File 0410 and/or Program Metadata File 0510. Metadata Server 0280 can parse Ad Metadata File 0410 and/or Program Metadata File 0510 for any data identifying: (a) the Advertiser 0220 and/or Media Buyer 0222 transmitting the Advertisement and/or Programming promoting the product purchased by Wireless Device 0210 user; and/or (b) any entity enabling the transaction.

At 6624A, Metadata Server 0280 can bill Advertiser 0220 and/or Media Buyer 0222 and credit any entity enabling the transaction.

At 6618B, Retailer Server 0272 can transmit to Metadata Server 0280 one or more records of a transaction including the reception and/or processing of an electronic coupon from one or more Wireless Devices 0210. A Transaction Record can be defined as any record of a transaction including the purchase of one or more products. Transaction Record may or may not include the utilization of an electronic coupon in any given transaction. In some embodiments, Metadata Server 0280 can receive from any other Data Processing System, e.g., ECR 6540, one or more Transaction Records.

At 6620B, Metadata Server 0280 can search any Transaction Records received and a database storing one or more Ad Metadata Files 0410 and/or Program Metadata Files 0510 stored during a time period of interest for matches of data in the Transaction Records, electronic coupons, and/or Purchase Incentives.

At 6622B, Metadata Server 0280 can parse any matching Ad Metadata Files 0410 and/or Program Metadata Files 0510 for any data identifying: (a) the Advertiser 0220 and/or Media Buyer 0222 transmitting the Advertisement and/or Programming promoting the product purchased by Wireless Device 0210 user; and/or (b) any entity enabling the transaction.

At 6624B, Metadata Server 0280 can bill Advertiser 0220 and/or Media Buyer 0222 and credit any entity enabling the transaction.

In some embodiments, the system can identify if a Retailer Server 0272 received and/or processed an electronic coupon from any given Wireless Device 0210 user through the following methods: (a) POS System 0270 can read the electronic coupon and any data uniquely identifying the Wireless Device 0210 user, e.g., the Shopper Loyalty ID; (b) Retailer Server 0272 can write the data representing the electronic coupon or the reception of the electronic coupon to Transaction Database 6530; (c) Metadata Server 0280 or any other Data Processing System can transmit to one or more Retailer Servers 0272 a list of electronic coupons, Purchase Incentives, and data identifying the Wireless Devices 0210 storing the electronic coupons and/or Purchase Incentives, e.g., the Shopper Loyalty ID, which Metadata Server 0280 can retrieve from any Wireless Device 0210 whose user had previously inputted into Wireless Device 0210; (d) the Retailer Server 0272 can search through Transaction Database 6530 for matches between data identifying the Wireless Device 0210, e.g., Shopper Loyalty ID, in (i) data received from Metadata Server 0280; and (ii) data in the Transaction Records; and/or (e) Retailer Server 0272 transmit to Metadata Server 0280 any matches and data identifying the Wireless Device 0210 user transmitting to POS System 0270 the matching electronic coupon and/or Purchase Incentive. By matching the transaction in which a Wireless Device 0210 user presented an electronic coupon with data uniquely identifying the Wireless Device 0210 user, e.g., a Shopper Loyalty ID, the system can identify the Advertisement and/or Programming leading the Wireless Device 0210 user originally to store the electronic coupon.

For example, Advertiser 0220 can be an entity which operates a Physical Retailer. A Wireless Device 0210 user can store an electronic coupon encouraging the purchase of, e.g., a specific cereal brand, at 0744F of Method 0700. At a store operated by the Physical Retailer, Wireless Device 0210 user can present the electronic coupon, e.g., by displaying any code representing the electronic coupon in Display 0354, which POS System 0270 can read and transmit to Transaction Database 6530. The present method can then implement Methods (c)-(e) described in the previous paragraph. After receiving data identifying the Wireless Device 0210 presenting the electronic coupon, Metadata Server 0280 can search through any database storing one or more records of Wireless Devices 0210 and the Advertisements and/or Programming to which the Wireless Device 0210 user responded. The present method can identify the Wireless Device 0210 user presenting the electronic coupon even if he/she does not use Wireless Device 0210 to present the Shopper Loyalty ID but presents a physical card including the Shopper Loyalty ID, because Retailer Server 0272 can identify the Shopper Loyalty ID associated with the redemption of any electronic coupon. After identifying the Advertisement and/or Programming which stimulated Wireless Device 0210 user to store the electronic coupon, the present method can identify the Advertiser, i.e., the Physical Retailer in the present example, for billing purposes and any entities enabling the present method for crediting purposes.

The benefits of the present embodiment can include, but are not limited to, enabling the system to identify if a Physical Retailer received and/or processed an electronic coupon and the Advertisement and/or Programming leading to the Wireless Device 0210 user storing the electronic coupon without requiring the Physical Retailer to transmit any data directly to the Wireless Device 0210.

In some embodiments, the system can enable a Wireless Device 0210 user to transmit an electronic coupon and/or an Advertiser 0220 to verify that the Wireless Device 0210 user purchased the product promoted in the Advertisement which stimulated the user to download the electronic coupon through the following method.

At or after the time the Wireless Device 0210 user purchases a product for which he/she has an electronic coupon, he/she can call any computer program product, e.g., Program: WD 0338, capable of reading PR Data File 0346 or any other file storing an electronic coupon for the product of interest.

Program: WD 0338 can transmit the data representing an electronic coupon to any computer program product capable of converting the data into one or more messages in SMS or any other communications format, which Wireless Device 0210 can transmit through any I/O Device, e.g., WWAN Antenna 0362, over a wireless WAN and/or a WAN, e.g., Internet 0254, to Retailer Server 0272.

Program: WD 0338 can identify the communications address to which Wireless Device 0210 can transmit an electronic coupon through a variety of means, including, but not limited to: reading from the Ad Metadata File 0410 the communications address, e.g., an IP address, of a Physical Retailer at which Advertiser 0220 wants the Wireless Device 0210 user to redeem the electronic coupon. To reduce the number of communications address an Ad Metadata File 0410 can be configured to include, the system can enable Metadata Server 0280 to limit the communications addresses included in any Ad Metadata File 0410 to those addresses for Physical Retailers within the geographical region within which the Wireless Device 0210 user is likely to purchase the product promoted in the Advertisement associated with the Ad Metadata File 0410.

Wireless Device 0210 user can redeem the electronic coupon in a variety of ways, including, but not limited to: scanning the electronic coupon as described in 6612; and/or transmitting the electronic coupon to Retailer Server 0272, which can redeem the electronic coupon in the present transaction or subsequently through another method.

The electronic coupon can include data uniquely identifying the specific event where a Wireless Device 0210 user downloaded the electronic coupon. For example, the electronic coupon can include not only the data identifying the Purchase Incentive, e.g., an UCC/EAN 128 Coupon Extended Code, but also data identifying the specific instance of the Wireless Device 0210 user downloading the electronic coupon (e.g., a Purchase Incentive Storage Event ID). The data identifying the Purchase Incentive Storage Event ID can include, but are not limited to: (a) any data uniquely identifying the Wireless Device 0210 and the date/time stamp of the Purchase Incentive Storage Event; and/or (b) any data uniquely identifying the transmission and/or reception of the specific electronic coupon to a specific Wireless Device 0210.

In the case where Wireless Device 0210 transmits to Retailer Server 0272 data identifying at least the Purchase Incentive Storage Event ID, Retailer Server 0272 can retransmit to Metadata Server 0280 the Purchase Incentive Storage Event ID. Metadata Server 0280 can query any database which includes one or more records of any transmission of a specific electronic coupon to a specific Wireless Device 0210. If Metadata Server 0280 identifies any matches, then it can lookup the associated Advertisement ID, e.g., the Ad-ID code. Therefore, Advertiser 0220 and/or Media Buyer 0222 can verify that a Wireless Device 0210 user downloaded an electronic coupon in response to a specific Advertisement and subsequently purchased the product promoted in the Advertisement.

In the case where Wireless Device 0210 transmits to Retailer Server 0272 the data representing an electronic coupon and does not transmit the Purchase Incentive Storage Event ID, the present method can still associate the viewing of an Advertisement and the purchase of the promoted product as follows.

Retailer Server 0272 can store any electronic coupon received in a database which includes any Customer ID. Retailer Server 0272 can transmit to Metadata Server 0280 the data representing the electronic coupon and the Customer ID. If Metadata Server 0280 had stored in any database a record including the Customer ID, then it can query the database for any matches between a Customer ID received from Retailer Server 0272 and a Customer ID stored in a Metadata Server 0280. If Metadata Server 0280 identifies any matches, then it can lookup any associated Purchase Incentive transmitted to a Wireless Device 0210 associated with the Customer ID.

FIG. 68 depicts a flowchart of an exemplary Method 6800 for (a) enabling an Advertiser to verify that any given Advertisement is directly related to a sampling and/or purchase in a Physical Retailer without a barcode reader; and (b) billing the Advertiser and crediting any entity enabling the transaction. The flowchart is described with reference to the system depicted in FIG. 67. However, the flowchart is not limited to that embodiment. The system can implement the flowchart with reference to systems utilizing a subset of the components, or additional, related, alternative, and/or equivalent components depicted in FIG. 67. In some embodiments, a method of a Wireless Device 0210 transmitting data representing one or more Sample Incentives and/or matching data identifying Sample Incentives can be implemented. However, the system is not limited to that embodiment. The system can support a Wireless Device 0210 transmitting data representing any data, including, but not limited to, a Purchase Incentive, and the matching of any data provided by a given Wireless Device 0210 and one or more Retailer Servers 0272, including, but not limited to: data identifying a Purchase Incentive. The system can implement the flowchart by executing a subset of the methods, executing the methods in different order, and/or executing other or additional related or equivalent methods.

At 6810, Wireless Device 0210 user sees an Advertisement which promotes a product, e.g., an automobile, and invites the user to sample the product, e.g., take a test drive. While the present method teaches how the system can enable verification of a product sample, it can support verification of a product purchase.

At 6812, Wireless Device 0210 can store a Sample Incentive at 0744F.

At 6814, Wireless Device 0210 user can visit a Physical Retailer, e.g., the automobile dealer selling the automobile promoted in the Advertisement viewed.

At 6816, Wireless Device 0210 can transmit to any Data Processing System, e.g., a Personal Computer, operated by the Physical Retailer through any Wireless Device 0210 I/O Device, e.g., Bluetooth Antenna 0386, the PR Data File 0346 and/or any data included in PR Data File 0346, which can include the Sample Incentive.

At 6818, the Personal Computer can receive through any of its I/O Devices, e.g., Bluetooth Antenna 6712, the PR Data File 0346.

At 6820, Program: PC 6716 can store PR Data File 0346 in Memory 6714 and/or transmit PR Data File 0346 or any data included in PR Data File 0346 to Retailer Server 0272, which can be operated by the Physical Retailer, e.g., the automobile dealer.

At 6822, Retailer Server 0272 can read the data from PR Data File 0346 and write some or all of the data to Customer Database 6720.

The present method can enable a variety of methods of verifying that Wireless Device 0210 user actually sampled the product, e.g., took a test drive of the automobile promoted in the Advertisement viewed.

At 6824A, Wireless Device 0210 user can call Program: WD 0338, which can transmit to Metadata Server 0280 some or all data from PR Data File 0346 and/or any other data supporting Wireless Device 0210 user's claim that he/she actually sampled the product. Metadata Server 0280 can query Transaction LUT 6734 for any matches of the Sample Incentive included in PR Data File 0346 received from Wireless Device 0210 and any Sample Incentives received from one or more Retailer Servers 0272. For example, PR Data File 0346 includes a Sample Incentive with an ID of 00001234 in FIG. 67. Metadata Server 0280 can receive over any time period after the transmission of the Advertisement of interest one or more Sample Incentives from one or more Retailer Servers 0272, which Metadata Server 0280 can write to Transaction LUT 6734. Transaction LUT 6734 includes one Sample Incentive with an ID of 00001234 received from Retailer Server 0272. The match of the Sample Incentive provided by Wireless Device 0210 and the Sample Incentive provided by Retailer Server 0272 can confirm that Wireless Device 0210 user actually sampled the product.

At 6824B, Retailer Server 0272 can receive from Metadata Server 0280 a list of Sample Incentives stored by one or more Wireless Devices 0210, search Customer LUT 6720 for any matches in Sample Incentives received from Metadata Server 0280 and directly from one or more Wireless Devices 0210, and transmit any matches to Metadata Server 0280.

At 6824C, Retailer Server 0272 can transmit any Sample Incentives received from one or more Wireless Devices 0210 to Metadata Server 0280, which it can store in Transaction LUT 6734.

At 6826, Metadata Server 0280 can: (a) identify the Advertisement, Programming, Ad Metadata File 0410, and/or Program Metadata File 0510 associated with the matching Sample Incentives identified at 6824A, 6824B, and/or 6824C; (b) read in Ad Metadata File 0410 the Advertiser 0220 and/or Media Buyer 0222, which transmitted the Advertisement leading Wireless Device 0210 user to store the Sample Incentive; (c) read in Ad Metadata File 0410 the Media Operator and/or Media Program transmitted the Advertisement of interest, identify the Wireless Operator 0240 enabling Wireless Device 0210 user to store the Sample Incentive, and/or identify any other entity enabling the sampling; (d) bill the Advertiser 0220 and/or Media Buyer 0222 for the WD Click-Through, i.e., the storage of the Sample Incentive and actual sampling of the product, e.g., Wireless Device 0210 user taking a test drive of the automobile promoted in the Advertisement of interest; and/or (e) crediting the Media Operator, Media Program, Wireless Operator 0240, and/or any other entities enabling the actual sampling of the product.

In some embodiments, at 6816, Wireless Device 0210 can transmit PR Data File 0346 and/or any data included in PR Data File 0346, which can include the Sample Incentive, directly to any Data Processing System operated by the Physical Retailer, e.g., Retailer Server 0272, through a wired and/or wireless WAN, e.g., Internet 0254.

FIG. 69 depicts a block diagram of an exemplary system: (a) enabling an Advertiser 0220 to verify that any given Advertisement is directly related to a purchase in a Physical Retailer without requiring a Wireless Device 0210 user to take any explicit action to redeem a coupon; and (b) billing the Advertiser 0220 and crediting any entity enabling the transaction. While the present embodiment can enable the verification of an Advertisement displayed on a Media Device in the vicinity of a Wireless Device 0210, the system is not limited to that embodiment. The system can support the verification of an Advertisement displayed on any Media Device, e.g., Personal Computer 0238, where the Media Device, instead of Wireless Device 0210, executes the request for and/or downloading of an electronic coupon. That is, the system can enable a Media Device user to request an electronic coupon and the system can verify that the Media Device user purchased the product associated with the electronic coupon as long as the Media Device user inputs a code with which a Physical Retailer can identify the Media Device user, e.g., Shopper Loyalty ID. The system can implement the system by utilizing a subset of the following components, or additional, related, alternative, and/or equivalent components. The system can include, but is not limited to, the following components not disclosed earlier herein.

Customer LUT 6940 can include a variety of data, including, but not limited to: any data uniquely identifying a purchase incentive, e.g., UCC Coupon Code or UCC/EAN 128 Coupon Extended Code. LUT 6940 can receive the purchase incentive from any Data Processing System, including, but not limited to: Wireless Device 0210; Metadata Server 0280; Advertiser 0220; and/or Media Buyer 0222. In the present embodiment, LUT 6940 shows a customer with a Shopper Loyalty ID 6910 purchasing in one transaction, Transaction ID 00000001, two products, UPC 123456789012 and UPC 234567890123, of which the first product is associated with the customer redeeming an electronic coupon identified by UCC Coupon Code 123456789012.

FIG. 70 depicts a flowchart of an exemplary Method 7000: (a) enabling an Advertiser 0220 to verify that any given Advertisement is directly related to a purchase in a Physical Retailer without requiring a Wireless Device 0210 user to take any explicit action to redeem a coupon; and (b) billing the Advertiser 0220 and crediting any entity enabling the transaction. The system can implement the flowchart by executing a subset of the methods, executing the methods in different order, and/or executing other or additional related or equivalent methods.

At 7010, an user can input into Wireless Device 0210 utilizing any Wireless Device Input Method one or more Shopper Loyalty IDs 6910. In the preferred embodiment, Wireless Device 0210 user can input the Shopper Loyalty IDs 6910 when he/she downloads and/or installs any computer program product enabling the systems and methods disclosed herein. Wireless Device 0210 can transmit Shopper Loyalty IDs 6910 to Metadata Server 0280, which can store the data in Wireless Device LUT 6732, which in turn can associate with any Shopper Loyalty ID 6910 any Advertisements_{CAUSE} the system concludes stimulated any User Request by the Wireless Device 0210 associated with Shopper Loyalty ID 6910. If Wireless Device 0210 user transmits any User Request for an electronic coupon, then LUT 6732 can associate with Shopper Loyalty ID 6910 the data uniquely identifying the purchase incentive, e.g., UCC Coupon Code or UCC/EAN 128 Coupon Extended Code, requested by Wireless Device 0210 user. In some embodiments, the system can enable the redemption of an electronic coupon requested by a Media Device by having the user input to the Media Device, e.g., Personal Computer 0238, one or more Shopper Loyalty IDs 6910.

At 7014, Metadata Server 0280 can: (a) download a Purchase Incentive to Wireless Device 0210; and/or (b) write the Purchase Incentive to a record identified by Shopper Loyalty ID 6910 in Wireless Device LUT 6732. Because Method 7000 can enable electronic coupon redemption without requiring Wireless Device 0210 user to present the electronic coupon to POS 0270, Metadata Server 0280 can simply transmit to Wireless Device 0210 a confirmation that Wireless Device 0210 user will qualify for the savings represented by an electronic coupon upon his/her next purchase of the product associated with the electronic coupon and/or promoted in Advertisements_{CAUSE}.

At 7016, Metadata Server 0280 can transmit to the Retailer Server 0272 operated by a retailer, e.g., a Physical Retailer, issuing the Shopper Loyalty ID 6910: (a) the Shopper Loyalty ID 6910 which enables Physical Retailer to identify the customer who can subsequently redeem any electronic coupons; and (b) one or more Purchase Incentives requested by the Wireless Device 0210 user associated with the Shopper Loyalty ID 6910. In some embodiments, Metadata Server 0280 can transmit to Retailer Server 0272 any data uniquely identifying Advertisement_{CAUSE}, e.g., Ad-ID, which the system concludes stimulated the User Request for the electronic coupon.

At 7018, Retailer Server 0272 can store the Purchase Incentives received from Metadata Server 0280. Retailer Server 0272 can utilize any method of reading the Purchase Incentive and/or any associated data specifying any limitation to amend the Purchase Incentive, e.g., deleting the Purchase Incentive on the expiration date specified in the Purchase Incentive.

At 7022, if Customer LUT 6940 includes one or more Purchase Incentives associated with Shopper Loyalty ID, Retailer Server 0272 can process the Purchase Incentives in the transaction executed by the customer. If Customer LUT 6940 does not include any Purchase Incentives, Retailer Server 0272 does not provide any savings enabled the Purchase Incentives.

At 7024, Retailer Server 0272 and/or POS 0270 can execute any instructions specified by the Purchase Incentive, e.g., reducing the unit price of any purchased product identified by Purchase Incentive, or not charging for one or more additional units if the customer purchases the minimum number of units specified by Purchase Incentive. Retailer Server 0272 and/or POS 0270 can execute the same instructions for providing the savings it would apply to any product for which it provides savings to customers participating in a Shopper Loyalty program.

In some embodiments, the system can enable Retailer Server 0272 to record and/or print on the payment receipt received by Wireless Device 0210 user a string specifying the savings provided to Wireless Device 0210 user through the automatic redemption of the electronic coupons enabled by the system, e.g., “You saved $x.xx by downloading electronic coupons to your phone!”

The benefits of utilizing Method 7000 can include, but are not limited to: (a) enabling an user of any Media Device, e.g., Wireless Device 0210, to save money on the purchases in a Physical Retailer of a product promoted in an Advertisement and/or Programming simply by transmitting an User Request, e.g., “Save [Brand Name] [Product Name], without performing any further action, e.g., having to present a physical or electronic coupon to POS 0272; (b) encouraging Wireless Device 0210 users to join Shopper Loyalty programs and/or purchase products promoted in Advertisements for which they can transmit User Requests for electronic coupons through their Wireless Devices 0210; and/or (c) enabling Advertiser 0220 and/or Media Buyer 0222 to associate the purchase of a product in a Physical Retailer with the Advertisement_{CAUSE} identified by the system.

### 14. Enabling Advertiser to Differentiate Among Potential Customers

The system can use any data to determine a desirable product, Advertisement, Programming, and/or offer an Advertiser 0220 and/or Media Buyer 0222 can present to a Wireless Device 0210 user. Advertiser 0220 and/or Media Buyer 0222 can initiate the presentation or make the presentation in response to an User Request.

### 20. Conclusion

The present application includes headings herein for reference and to aid in locating certain sections. The present application does not intend these headings to limit the scope of the concepts described therein. The present application may apply the concepts in other sections throughout the entire specification. While the present application describes how to format data, assign names to variables, and assign names to values that are written in the English language, the data, variables, and values can be written in alternative languages. Modification of the systems, methods, apparatuses, and/or computer program products can be made to operate with data, variables, and values in languages different from English. Various modifications to these embodiments can be made. Generic principles may be applied to other embodiments without departing from the spirit or scope of the claims.

What is claimed is:

1. A method, comprising:
establishing an audio communication channel with a device having an audio receiving component;
receiving via the audio communication channel a first audio signal defined based on a first sound acquired via the audio receiving component, the first sound being produced by a first source;
receiving via the audio communication channel a second audio signal defined based on a second sound not produced by the first source and produced outside of the device by a second source, the second sound being acquired via the audio receiving component; and
determining at least a portion of a user request based on the first audio signal and the second audio signal.

2. The method of claim 1, further comprising:
identifying a keyword based on the first audio signal; and
identifying at least one of a media operator or a media program based on the second audio signal, the determining includes determining based on the keyword and based on the identifying associated with the at least one of the media operator or the media program.

3. The method of claim 1, further comprising modifying the audio communication channel in response to the determining.

4. The method of claim 1, further comprising terminating the audio communication channel in response to the determining.

5. The method of claim 1, further comprising terminating the audio communication channel when a probability of accurately performing the determining satisfies a threshold condition.

6. The method of claim 1, further comprising terminating the audio communication channel when the determining satisfies a threshold condition associated with at least one of a false positive rate or a false negative rate.

7. The method of claim 1, further comprising receiving, via the audio communication channel, data defined using the device, the determining includes determining based on the data.

8. The method of claim 1, wherein the device is a first media processing device, the second sound is produced by a second media processing device.

9. The method of claim 1, wherein the user request is a request for information related to a product, the first source is a user of the device, the device is a wireless device.

10. A method, comprising:
receiving a first portion of a signal from a communication device via a communication channel;
determining, based on the first portion of the signal, a parameter value used for identification of a product of interest;
calculating a probability value associated with identification of the product of interest based on the parameter value; and
receiving a second portion of the signal when a threshold condition is unsatisfied based on the probability value.

11. The method of claim 10, wherein the calculating includes calculating a first probability value at a first time, the parameter value is a first parameter value,
the method further comprising:
determining, based on the second portion of the signal, a second parameter value used for identification of the product of interest; and
calculating a second probability value at a second time based on the first parameter value and the second parameter value.

12. The method of claim 10, further comprising:
terminating the communication channel when the threshold condition is satisfied based on the second probability value.

13. The method of claim 10, wherein the signal is an audio signal defined using a microphone associated with the communication device, the communication channel is an audio communication channel.

14. A method, comprising:
receiving a signal from a communication device via a communication channel;
determining, based on the signal, a parameter value used for identification of a product of interest;
modifying a duration of the receiving when a threshold condition is unsatisfied based on a probability value calculated based on the parameter value, the probability value being associated with identification of the product of interest.

15. The method of claim 14, wherein the signal is an audio signal defined using a microphone associated with the communication device, the communication channel is an audio communication channel.

16. The method of claim 14, wherein the communication device is a wireless device.

17. The method of claim 14, wherein the modifying includes increasing.

18. The method of claim 14, wherein the modifying includes terminating.

19. The method of claim 14, wherein the communication channel is automatically established via an application installed at the communication device.

20. A method, comprising:
receiving from a wireless device a signal defined in response to an input by a user of the wireless device;
determining a keyword based on the signal; and
determining, with reference to a metadata database, an identifier associated with a product based on the keyword, the identifier being different than the keyword.

21. The method of claim 20, wherein the input is a sound produced by the user.

22. A method, comprising:
receiving a request from a user, the user defining the request in response to a transmission of at least one of an advertisement of interest or a media program of interest;
identifying a media operator associated with the transmission of the at least one of the advertisement or the media program of interest in response to the request; and
identifying the at least one of the advertisement of interest or the media program of interest based on the identifying of the media operator.

23. The method of claim 22, wherein the identifying includes identifying the media operator from a plurality of rank ordered media operators.

24. The method of claim 22, wherein the identifying the media operator includes identifying based on a rank ordering defined using an equation that is a function of at least two of user generated identification data, media program probability data, media program identification data, and media operator identification data.

25. The method of claim 22, wherein the at least one of the advertisement of interest or the media program of interest includes identifying based on a rank ordering defined using an equation that is a function of at least two of a keyword data, a time associated with the transmission, a user profile data, and a duration of the transmission.

26. The method of claim 22, wherein the identifying the media operator includes identifying based on extrinsic parameter values.

27. The method of claim 22, wherein the identifying the media operator includes identifying based on a probability condition.

28. The method of claim 22, wherein the transmission is completed at a first time, the identifying the media operator is triggered at a second time after the first time.

29. The method of claim 22, wherein the request is related to at least one of a data or an action unrelated to the transmission.

30. A method, comprising:
receiving an indicator that a user request has been defined;
receiving an observable variable value associated with the user request, the observable variable being at least one of acquired by an electronic device or defined by the electronic device;
receiving a plurality of non-observable variable values; and
determining a probability value indicating a probability that a non-observable variable from the plurality of non-observable variable values stimulated the user request, the determining includes determining based on a Bayesian network that includes the observable variable and the plurality of non-observable variable values.

31. The method of claim 30, further comprising:
calculating a plurality of probability values associated with the plurality of non-observable variables based on the Bayesian network, the probability value being included in the plurality of probability values;
selecting the non-observable variable based on a rank-ordering of the probability values; and
sending a notification in response to the selecting.

32. The method of claim 30, wherein the non-observable variable is associated with at least one of a transmission of at least one of an advertisement or a media program.

33. The method of claim 30, wherein the non-observable variable is associated with a non-advertisement stimulus.

34. The method of claim 30, wherein the observable variable is at least one of defined within the user request, a fingerprint defined based on at least one of an advertisement or a media program, or a user profile parameter value.

35. A method, comprising:
receiving from a wireless device a signal acquired at the wireless device;
determining that the signal is substantially similar to a fingerprint signature accessed from a database that includes a plurality of fingerprint signatures; and
calculating a plurality of probability values associated with a plurality of events based on a Bayesian network that includes the plurality of events and based on the determining that the signal is substantially similar to the fingerprint signature, each event from the plurality of events being associated with at least one of a location from which or a time that a request is transmitted from the wireless device.

36. The method of claim 35, wherein the calculating is based on a prior probability value associated with an observable variable associated with the request.

37. The method of claim 35, further comprising calculating a conditional probability value associated with at least one event from the plurality of events based on an observable variable associated with the request, the calculating associated with the plurality of probability values is based on the conditional probability value.

38. The method of claim 35, further comprising selecting an event from the plurality of events based on a rank-ordering of the plurality of probability values.

39. A method, comprising:
receiving a request for information associated with a product from a first media device, the request being triggered by a user of the first media device;
receiving a record of a transmission sent to a second media device, the transmission being associated with at least one media operator; and
determining a set of events having a probability of stimulating the user to trigger the request based on the record of the transmission.

40. The method of claim 39, further comprising:
determining at least one of a hidden media operator or a hidden media operator sequence based on an observable parameter value, the determining associated with the set of events is based on the determining associated with the at least one of a hidden media operator or the hidden media operator sequence.

41. The method of claim 40, wherein the determining associated with the at least one of the hidden media operator or the hidden media operator sequence is based on a hidden Markov model.

42. The method of claim 39, wherein at least one event from the set of events is an advertisement associated with the at least one media operator.

43. The method of claim 39, wherein at least one event from the set of events is a media program associated with the at least one media operator.
